(19) United States
(12) Patent Application Publication
(10) Pub. No.: US 2007/0199049 A1
(43) Pub. Date: Aug. 23, 2007

(54) Broadband network security and authorization method, system and architecture

(75) Inventor: William Ziebell, Portland, OR (US)

Correspondence Address: ATER WYNNE LLP, 222 SW COLUMBIA, SUITE 1800, PORTLAND, OR, 97201-6618, US

(73) Assignee: UbiquityNet, Inc.

(21) Appl. No.: 11/239,624

(22) Filed: Sep. 28, 2005

(51) Int. Cl. H04L 9/32

(52) U.S. Cl. 726/3

(57) ABSTRACT

A systems and process architecture which mandates, automates and manages network security and authorization for Internet broadband provider broadband modems and their customer's connectable host device(s), and provides and facilitates real-time automation of service order fulfillment and account processing. An Internet broadband IPsec, PKC, and QoS systems and process architecture which mandates, automates, and manages IPsec, PKC, and QoS for Internet broadband provider broadband modems and their customer's connectable host device(s). A systems and process architecture for determining broadband customer type including one of new, expired, roaming and current.

### BACKGROUND OF THE INVENTION

Internet broadband service is available to consumers primarily through telephone and cable service providers. With the advent of the Internet network, based on the Transmission Control Protocol/Internet Protocol (TCP/IP), cable company and telephone service offerings have become less autonomous. Telephone companies have extended their basic offering beyond telephone service to include Internet broadband and media services, and cable companies now offer telephone and Internet broadband services in addition to media.

Internet broadband providers (IBP) typically use xDSL, which collectively refers to all types of digital subscriber lines including ADSL, SDSL, HDSL, and VDSL, and Cable networks to implement service. Customers, or subscribers, require a Cable or xDSL modem to access the network via telephone or coax cable. Subscribers of these services utilize network routers to create a TCP/IP based Wireless Local Area Network (WLAN) or wired Local Area Network (LAN) in the home to connect their TCP/IP host devices (computer workstations, laptops, Personal Digital Assistants (PDAs), Voice over Internet Protocol (VoIP) telephones and home entertainment systems). Wireless network routers, or Wireless Fidelity (Wi-Fi) Access Points, utilize the Institute of Electrical & Electronic Engineers (IEEE) 802.11 specifications for WLAN technology. Subscribers provide Internet access to their TCP/IP host devices by connecting their Wi-Fi Access Point to the modem provided by telephone and cable companies offering Internet broadband service.

Internet broadband providers traditionally think of the customer, or ‘subscriber’, as the modem device. In other words, Internet broadband providers treat the residential installation of a modem device as a singular broadband services subscription, and allocate bandwidth and project revenues based on a single-subscriber per modem business model.

This, despite the flood of home networking devices, Wi-Fi Access Points or wired network routers that are connectable to a given modem within the subscriber's residence itself. The traditional business model by which Internet broadband providers deliver service fails to acknowledge the growing home networking industry and, as a result, loses significant bandwidth market and revenue potential. This is because multiple users-within and outside the ‘subscriber's’ residence-freely utilize broadband bandwidth by having their often portable host devices search for, in the case of Wi-Fi Access Points, available channels within range, or connect multiple wired host devices directly to a wired network router. The same happens with businesses when host devices access Wi-Fi Access Points or wired network routers.

According to the Based on National Cable & Telecommunications Associations' cable piracy survey conducted in 1999, the industry loses an estimated $6.6 billion in unrealized basic and premium revenue annually. The industry categorizes Theft of Service into two types, Passive Theft and Active Theft. Passive theft occurs when someone moves into a new residence or business facility, notices that the premises receives services without an account, but nevertheless does not take any steps to become a subscriber or have the service disconnected. Active Theft is contrary to the common understanding of cable theft—that it involves only the theft of cable television services—cable theft also includes:
Uncapping of Modems—Some dishonest users hack into their modem and uncap their bandwidth limits. Individuals who uncap their modems and steal excessive bandwidth slow down their neighbor's transmission rates.
Wi-Fi Theft—Wi-Fi theft occurs when someone installs a wireless network in a residence or business location and intentionally enables others to receive broadband free service over their wireless network.
   The impact of Theft of Service on paying subscribers is reduced quality of service, lower bandwidth speeds, and higher subscription fees.

WLAN use raises concerns about security (e.g., safety and privacy), and liability for subscribers, Internet broadband providers, and society in general. They allow potential criminals and terrorists to send untraceable communications, or allow an individual to download illegal materials, such as copyrighted or obscene material that would lead back to the subscriber's modem. Moreover, compromising wired equivalent privacy (WEP) WLAN security is easy. Most subscribers do not enable security measures on their Wi-Fi Access Points, given the complexity of setting up security protocols (e.g., WEP or Wi-Fi protected access (WPA)), and the vast majority of home networking consumers are simply ignorant that they need to utilize security measures or that security measures even exist. Customers often transfer sensitive financial and credit data during on-line purchases and other transactions. Financial and credit data transmitted over WLANs can be stolen by an unauthorized user and used to embarrass or injure an authorized Internet broadband subscriber. An unauthorized hijacker can use Internet website access and other sensitive information to embarrass or harass an authorized broadband customer. Identity theft is a potent example.

Subscribers of Internet broadband service illustrate another example of security and liability concerns through their use of increasingly popular VoIP telephones on WLANs. Traditional wiretapping requires the listener to physically connect to the wire used for a telephone communication. WLAN transmissions go beyond the walls of homes and apartments. Would-be listeners need only connect a wireless capable laptop to sniff out and record unsecured transmissions. Worse, WLAN security measures (WEP and WPA) are a deterrent at best, as they are easily hacked with ‘Brute Force’ or ‘Man in the Middle’ attacks.

Internet broadband providers lack the technologies and processes to make secure communications within the customer's home automated and mandatory. Until a solution is found, concerns about security and liability will abound, and Internet broadband providers and paying subscribers will continue to experience the impact of Theft of Service. Paying subscribers will continue to experience reduced quality of service, lower bandwidth speeds, and higher subscription fees, while Internet broadband providers will forgo lost revenues and incur higher operating costs.

Traditional fulfillment of an order for Internet broadband service requires many steps and resources. As an illustration, consider the cable Internet broadband service order fulfillment process. Service orders typically start with a telephone call to an IBP customer service representative. A customer service representative receives an order, enters the customer data into the order system, issues a credit check, and pushes the order information into a fulfillment processing system. The fulfillment processing system dispatches a service technician, or a “Truck-roll” as it is known in the industry, to a new subscriber's home to complete the manual tasks necessary to install the Internet broadband modem. Subscribers are required to be available at their home for the notorious two to four hour visit with the cable technician. The fulfillment processing system then pushes data in the provisioning processing system, which in turn configures the Internet broadband provider's network and subscriber's modem to enable network access. The provisioning processing system then notifies the billing system that the service is ready for billing, and the billing system retrieves the account data from the ordering system.

Traditional billing and payment processing for a subscriber's subscription requires printing and mailing a bill or invoice to the subscriber, awaiting mail delivery, writing a check and mailing it back to the Internet broadband provider. When there is a problem with service, or account problems, the subscriber calls the Internet broadband provider's customer service or technical support representatives. Subscribers often face a maze of numbers and menus, and they can spend hours on the telephone. Sometimes technical support requires another expensive visit to the subscriber's home. The industry tracks the all-inclusive financial cost of fulfilling a service order. It is know as the Subscriber Acquisition Cost (SAC). The estimated cable industry SAC is about $1,200. Internet broadband providers who employ xDSL to deliver service utilize an even more complex process for service order fulfillment, and incur an even higher associated SAC.

Accordingly, even if there were no Theft of Service problem, service order fulfillment, and ongoing account management—the human and capital resource, systems, and processes that make up the infrastructure to implement the current paradigm—would remain very expensive. This is because of the old paradigm wherein an Internet broadband provider treats a modem—rather than a device connectable thereto—as its ‘subscriber.’ The Internet broadband provider can realize—under a paradigm shift that acknowledges that the connectable host devices within a subscriber's WLAN or LAN rather than the modem is the subscriber or potential subscriber—significantly elevated revenues and reduced costs from a greatly expanded base of putative subscribers. This paradigm shift also involves new responsibilities for the Internet broadband provider to manage its expanded subscriber base in areas of security and liability against hijacking of bandwidth, theft of sensitive subscriber data, monitoring of subscriber activity, and policing of systems that might be tampered with or destroyed.

A skyrocketing demand for wireless Internet broadband access by users to e-mail, multimedia offerings, web browsing, web conferencing, VoIP communication, Instant Messaging, and other audio-visual applications seemingly knows no bounds. Thus, Cable and xDSL Internet broadband is not the only field of use of the present invention. Fiber, Worldwide Interoperability for Microwave Access (WiMAX), Third Generation of next generation of mobile communications systems (3G), and other high-bandwidth network providers also lend themselves to solutions to the problem of requiring, automating, and managing secure communications for Internet broadband subscribers.

FIG. 1 is a use case diagram that illustrates the conventional IBP subscriber differentiation as it relates to order processing and security; it includes the IBP security domain, subscriber, and their WLAN home network, authorized user, security issues, and services.

FIG. 1 illustrates a typical home WLAN network whereby the Internet broadband subscriber actor, block 236, utilizes two host devices, a computer at block 238, and VoIP at block 240, connected to a Wi-Fi Access Point at block 242. The network host devices gain access to the Internet through a connection between the Access Point and the broadband modem at block 244. The Wi-Fi radio range collaboration, block 232, demonstrates that the network range exceeds the subscriber's home boundary at block 234. The use case trace connectors depict an unauthorized user, block 260, and his or her laptop, block 262, having access to the home network, host devices, and the Internet, and illustrates that network security is not implemented or is compromised by the unauthorized user. The security domain collaboration, block 246, details the extent of the security abilities of the IBPs—it restricts access to the Internet and the IBP back office to valid broadband modems; expressing the on-off design of the business process model that is currently being utilized by IBPs. The broadband security issues collaboration, block 250, expresses the security problems associated with the IBP business process model; it contains the safety use case, block 252, privacy use case, block 254, liability use case 256, and the theft of service use case at block 258.

The cable modem activation collaboration, block 222, contains the customer service order processing use case, block 224, network provisioning system use case, block 226, truck-rolls use case, block 228, and the fulfillment processing system use case at block 230. These use cases state the complex, often manual and labor-intensive, systems and processes that implement on-off design of the IBP business model.

FIG. 2 is a use case diagram that illustrates the conventional IBP operations support system cable modem activation process. As illustrated in the Order Broadband Internet Service use case, block 424, a new Internet broadband subscriber actor, block 422, orders Internet service by placing a telephone call to customer service, block 426, and speaking with an IBP customer service representative, as represented by the realize connectors between blocks, 422, 424, and 426.

The customer service representative receives an order, enters the customer data into the order system, represented by the customer service order processing use case at block 428, and pushes the order information into the fulfillment processing system, depicted by the fulfillment processing system use case at block 430. The realize connector illustrates the relationship between blocks 428 and 430. The fork, block 432, serves to signify concurrency in the activation process. The fulfillment processing system use case highlights the fulfillment processing system that dispatches a “Truck-roll,” as illustrated by the truck-rolls use case, block 434, to a new subscriber's home to complete the manual tasks necessary to install the cable modem.

The truck-roll entails a technical service representative visit to the customer's home to install the broadband modem—illustrated by the deliver use case, block 436, broadband modem install collaboration, block 444, wire use case, block 452, connect computer to broadband modem use case, block 450, and the plug in power supply use case at block 448. The realize connectors depict the relationships between blocks 432, 434, 436, 444, 452, 450, and 448. Concurrent with the truck-rolls, the provisioning servers use case, block 438, denotes the provisioning of service order data (e.g., broadband modem machine access code (MAC) address) that is pushed into the provisioning servers of the network operating center (NOC). The fork following the provisioning servers use case signifies alternate paths in the activation process. As illustrated by the network provisioning system use case, block 440, the provisioning servers use the network provisioning system to configure the broadband modem using the dynamic host configuration protocol (DHCP) and trivial file transfer protocol (TFTP) file configurations. Upon modem activation, the billing system use case, block 442, describes notification from the provisioning servers to the billing system that the service is ready for billing—the billing system receives the account data from the ordering system. The realize connectors depict the relationships between blocks 432, 438, 440, and 442.

### BRIEF DESCRIPTION OF THE DRAWINGS

FIG. 1 is a use case diagram that illustrates the conventional IBP subscriber differentiation as it relates to order processing and security; it includes the IBP security domain, subscriber, and their WLAN home network, authorized user, security issues, and services.

FIG. 2 is a use case diagram that illustrates the conventional IBP operations support system cable modem activation process.

FIG. 3 is a use case diagram that illustrates a high-level view of the RockIt™ Security Internet Protocol Security (IPsec) and Public Key Infrastructure (PKI) use case systems and relationships.

FIG. 4 is a use case diagram that illustrates several examples of network topologies supported by the invention's security architecture.

FIG. 5 is a use case diagram that illustrates the business process model for the real-time automation of subscriber differentiation, whereby the invention articulates its capacity to distinguish new, roaming, or expired customers.

FIG. 6 is a use case diagram that illustrates the new service order fulfillment process and experience for a new customer.

FIG. 7 is a use case diagram that illustrates the service order fulfillment process for a new service request.

FIG. 8 is a use case diagram that illustrates the business process model to provide new Internet broadband customers the capacity to access the Internet broadband provider's Intranet resources without a current account.

FIG. 9 is a use case diagram that illustrates the service order fulfillment use case for payment of a new service order request.

FIG. 10 is a use case diagram that illustrates the service order fulfillment RockItClient™ software install and configuration. This service order fulfillment RockItClient™ software install and configuration use case provides a greater level of detail for the RockItClient™ install and configuration process than FIG. 9.

FIG. 11 is a use case diagram that illustrates the RockItRouter Security System™ utilized by the service order fulfillment process.

FIG. 12 is a use case diagram that illustrates the RockItRouter™ HTTP (an acronym for the HyperText Transport Protocol) Redirector utilized by RockItRouter Security System™ during the service order fulfillment process.

FIG. 13 is a use case diagram that illustrates the service order fulfillment process for a requesting service renewal. This drawing is analogous to FIG. 7, Service Order Fulfillment (Requesting New Service), except that it illustrates the use case for issuing a renewal service order fulfillment request for expired subscriptions.

FIG. 14 is a use case diagram that illustrates the service order fulfillment use case for payment of a renewal service order request.

FIG. 15 is a use case diagram that illustrates the RockItSwitch™ automated subscription renewal processing. This primary back office process is responsible for processing recurring real-time billing for a customer subscription.

FIG. 16 is a use case diagram that illustrates the roaming service order fulfillment process for customers requesting roaming service.

FIG. 17 is a use case diagram that illustrates the service order fulfillment use case for payment of a roaming service order request.

FIG. 18 is a communication diagram that illustrates the RockIt™ Public Key Certificate (PKC) roaming subscriber processing. The RockIt™ PKC roaming subscriber processing provides the communication and processing details for authorizing a roaming subscriber.

FIG. 19 is a use case diagram that illustrates the RockIt™ Systems and Components resident in the Subscriber's Home and Internet Broadband Provider's Network Operating Center.

FIG. 20 is a high-level layout diagram that illustrates the proper arrangement of FIGS. 21A-21B for comprehensive viewing.

FIGS. 21A-21B are high-level activity diagrams that illustrate the RockIt™ IPsec, PKC, and Quality of Service (QoS) architecture components, processes and communication details for the RockItClient™, RockItRouter™, and RockItSwitch™ systems.

FIG. 22 is an activity diagram that illustrates the RockIt™ IPsec and PKI Management system. It details the relationships between the subsystems that provide new PKC during new service order fulfillment (through the PKC enrollment and registration process), PKC validation services, and IPsec configuration.

FIG. 23 is an activity diagram that illustrates PKC revocation, renewal, rekey, and update of the RockIt™ PKC architecture.

FIG. 24 is an activity diagram that illustrates the RockItRouter IPsec processing.

FIG. 25 illustrates the RockIt™ PKC current subscriber processing for a current customer using a RockItClient™ host device connected to a RockItRouter™ broadband modem.

FIG. 26 is a communication diagram that illustrates the RockItRouter Security System™ and HTTP Redirector processing for a new customer.

FIG. 27 is a communication diagram that illustrates the communication and processing details for issuing renewal service order fulfillment for a customer with an expired subscription.

FIG. 28 is a high-level layout diagram that illustrates the proper arrangement of FIGS. 29A-29B for comprehensive viewing.

FIGS. 29A and 29B are a sequence diagram that illustrates the Service Order Fulfillment process involving RockItRouter™ Install, Configuration, and Update.

FIG. 30 is a high-level layout diagram that illustrates the proper arrangement of FIGS. 31A-31B for comprehensive viewing.

FIGS. 31A and 31B are a sequence diagram that illustrates the RockItRouter™ IPsec and PKC management systems and process flow.

FIGS. 32A and 32B are a glossary of terms explaining the objects and variables used by the PKC systems and processes that implement the RockIt™ security architecture.

FIG. 33 is a glossary of terms explaining the objects and variables used by the IPsec systems and processes that implement the RockIt™ security architecture.

FIG. 34 is a high-level layout diagram that illustrates the proper arrangement of FIGS. 35A-35B for comprehensive viewing.

FIGS. 35A and 35B are a sequence diagram that illustrates the Service Order Fulfillment process including Support Services.

FIG. 36 is a high-level layout diagram that illustrates the proper arrangement of FIGS. 37A-37C for comprehensive viewing.

FIGS. 37A through 37C are a sequence diagram that illustrates the Service Order Fulfillment process including Subscriptions.

FIG. 38 is a high-level layout diagram that illustrates the proper arrangement of FIGS. 39A-39B for comprehensive viewing.

FIGS. 39A and 39B are a sequence diagram that illustrates the Service Order Fulfillment process including RockItClient™ Install, Configuration, and Update.

FIG. 40 is a high-level layout diagram that illustrates the proper arrangement of FIGS. 41A-41C for comprehensive viewing.

FIGS. 41A through 41C are a sequence diagram that illustrates the RockItClient™ IPsec and PKC Management processes for a new customer.

FIG. 42 is a sequence diagram that illustrates the PKC Service Management process.

FIG. 43 is a glossary of terms explaining the objects and variables used by the RockIt™ architecture for Systems Processing.

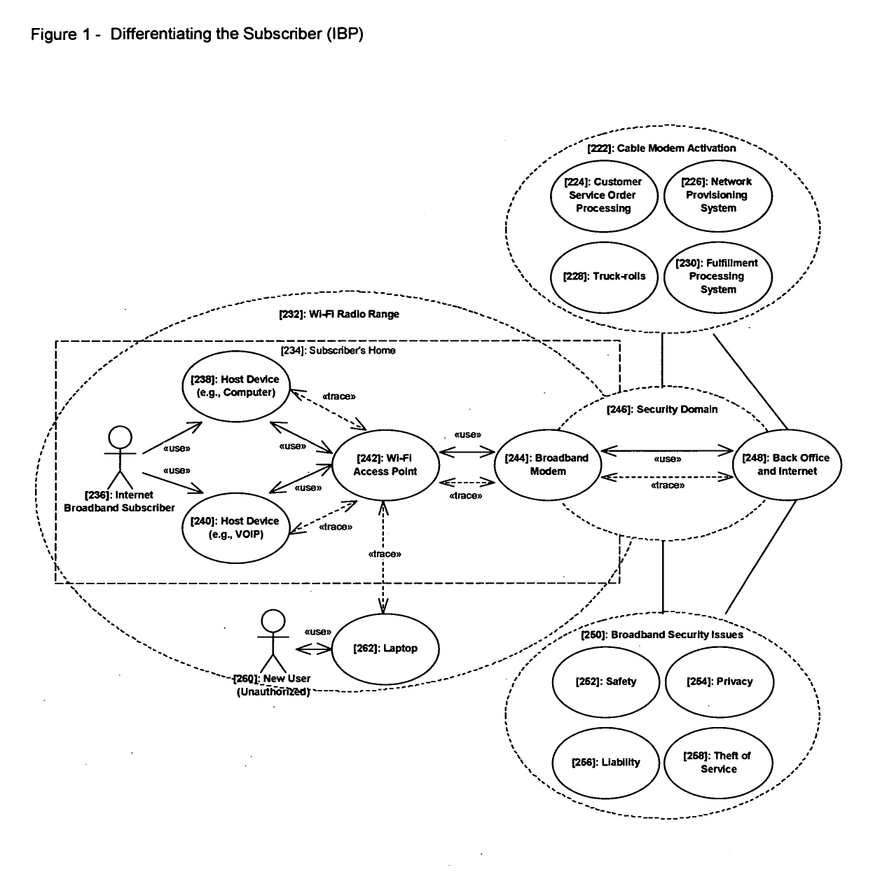

### DETAILED DESCRIPTION OF THE PREFERRED EMBODIMENTS

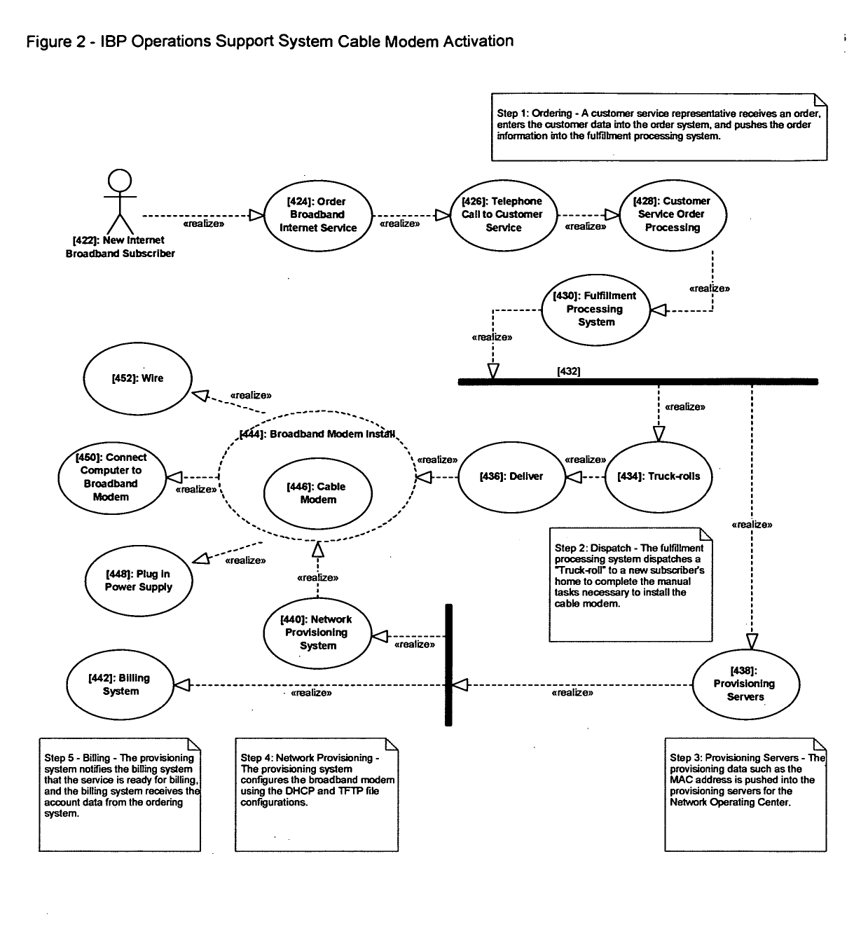

In the traditional Internet broadband provider's (IBP) view, the customer, or subscriber, broadband modem correlates to the customer account. They do not distinguish host network devices connected to the broadband modem to the customer account. Their business models provide a one-to-one relationship of subscriber to broadband modem for accounting. Subscribers typically circumvent Service Level Agreements (SLA) by creating home networks. These home networks are typically wireless Wi-Fi networks—contributing to security issues such as safety, privacy, liability, and theft of service. Currently, IBP business models, and their systems and processes, manage account activation in an on or off manner. Following traditional utility business models, Internet broadband access is in an “On” state as long as a subscriber's account is current in the provider's accounting systems. As illustrated in the Use Case diagram above (FIG. 2), the Internet broadband provider's security domain is limited to the “On” or “Off” control of the communications accessing the Internet through the broadband modem. When a customer's account is past due, IBPs turn service “Off” by at the cable modem or in some cases by disconnecting the cable wiring connection. The process to disconnect or reconnect service is generally a costly manual process involving service technicians and/or customer service representatives.

The invention will be understood to use Internet Protocol Security (IPsec, in accordance with Request For Comments (RFC) 2401 titled Security Architecture for the Internet Protocol) set of protocols developed by the Internet Engineering Task Force (IETF), which are believed robustly to protect the invented system from piracy, and the other related technologies, such as Public Key Infrastructure (PKI, in accordance with RFC 3280 titled Internet X.509 Public Key Infrastructure Certificate and Certificate Revocation List (CRL) Profile). Table 1 lists applicable PKI and Related RFCs:

TABLE 1

| RFC | Title |
|---|---|
| RFC 2459 | Internet X.509 Public Key Infrastructure Certificate and CRL Profile |
| RFC 2510 | Internet X.509 Public Key Infrastructure Certificate Management Protocols |
| RFC 2511 | Internet X.509 Certificate Request Message Format |
| RFC 2527 | Internet X.509 Public Key Infrastructure Certificate Policy and Certification |
| Obsoleted by | Practices Framework |
| RFC 3647 | |
| RFC 2528 | Representation of Key Exchange Algorithm (KEA) Keys in Internet X.509 |
| | Public Key Infrastructure Certificates |
| RFC 2559 | Internet X.509 Public Key Infrastructure Operational Protocols - LDAPv2 |
| Obsoleted by | |
| RFC 3494 | |
| RFC 2585 | Internet X.509 Public Key Infrastructure Operational Protocols: FTP and HTTP |
| RFC 2587 | Internet X.509 Public Key Infrastructure LDAPv2 Schema |
| RFC 2560 | X.509 Internet Public Key Infrastructure Online Certificate Status Protocol - |
| | OCSP |
| RFC 2797 | Certificate Management Messages over CMS |
| RFC 2875 | Diffie-Hellman Proof-of-Possession Algorithms |
| RFC 3039 | Internet X.509 Public Key Infrastructure Qualified Certificates Profile |
| Obsoleted by | |
| RFC 3739 | |
| RFC 3029 | Internet X.509 Public Key Infrastructure Data Validation and Certification |
| | Server Protocols |
| RFC 3161 | Internet X.509 Public Key Infrastructure Time Stamp Protocols (TSP) |
| RFC 3279 | Algorithms and Identifiers for the Internet X.509 Public Key Infrastructure |
| | Certificate and CRI Profile |
| RFC 3280 | Internet X.509 Public Key Infrastructure Certificate and CRL Profile |
| RFC 3281 | An Internet Attribute Certificate Profile for Authorization |
| RFC 3379 | Delegated Path Validation and Delegated Path Discovery Protocol Requirements |
| RFC 3628 | Policy Requirements for Time-Stamping Authorities |
| RFC 3647 | Internet X.509 Public Key Infrastructure Certificate Policy and Certification |
| | Practices Framework |
| RFC 3709 | Internet X.509 Public Key Infrastructure: Logotypes in X.509 certificates |
| RFC 3739 | Internet X.509 Public Key Infrastructure: Qualified Certificates Profile |
| RFC 3770 | Certificate Extensions and Attributes Supporting Authentication in PPP and |
| | Wireless LAN |
| RFC 3779 | X.509 Extensions for IP Addresses and AS Identifiers |
| RFC 3820 | Internet X.509 Public Key Infrastructure Proxy Certificate Profile |

TABLE 2

| RFC | Title |
|---|---|
| RFC 1320 | The MD4 Message-Digest Algorithm |
| RFC 1321 | The MD5 Message-Digest Algorithm |
| RFC 1828 | IP Authentication using Keyed MD5 |
| RFC 1829 | The ESP DES-CBC Transform |
| RFC 2040 | The RC5, RC5-CBC, RC5-CBC-Pad, and RC5-CTS |
| | Algorithms |
| RFC 2085 | HMAC-MD5 IP Authentication with Replay Prevention |
| RFC 2104 | HMAC: Keyed-Hashing for Message Authentication |
| RFC 2144 | The CAST-128 Encryption Algorithm |
| RFC 2202 | Test Cases for HMAC-MD5 and HMAC-SHA-1 |
| RFC 2268 | A Description of the RC2(r) Encryption Algorithm |
| RFC 2401 | Security Architecture for the Internet Protocol |
| RFC 2402 | IP Authentication Header |
| RFC 2403 | The Use of HMAC-MD5-96 within ESP and AH |
| RFC 2404 | The Use of HMAC-SHA-1-96 within ESP and AH |
| RFC 2405 | The ESP DES-CBC Cipher Algorithm With Explicit IV |
| RFC 2406 | IP Encapsulating Security Payload (ESP) |
| RFC 2407 | The Internet IP Security Domain of Interpretation for |
| | ISAKMP |
| RFC 2408 | Internet Security Association and Key Management Protocol |
| | (ISAKMP) |
| RFC 2409 | The Internet Key Exchange (IKE) |
| RFC 2410 | The NULL Encryption Algorithm and Its Use With IPsec |
| RFC 2411 | IP Security Document Roadmap |
| RFC 2412 | The OAKLEY Key Determination Protocol |
| RFC 2451 | The ESP CBC-Mode Cipher Algorithms |
| RFC 2631 | Diffie-Hellman Key Agreement Method |

UbiquityNet, Inc.'s RockIt™ security architecture implements and utilizes IPsec and PKI standards—systems, processes, policies, certificates, etc.—creating a mandatory, automated and managed security mechanism on the subscriber's home network.

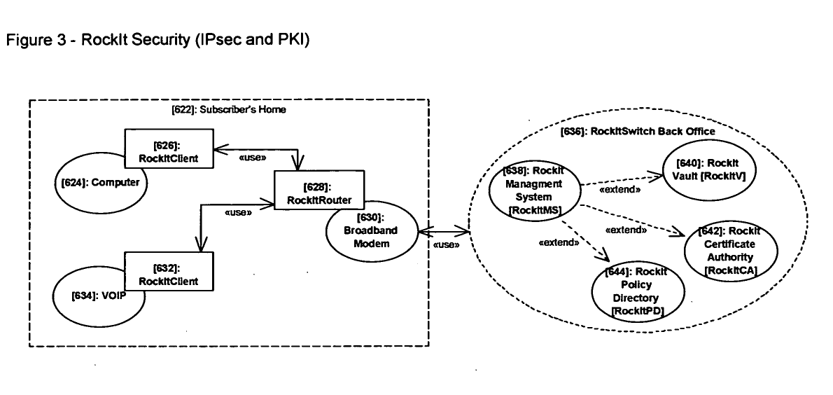

FIG. 3 is a use case diagram that illustrates a high-level view of the RockIt™ Security IPsec and PKI use case systems and relationships. In FIG. 3, the subscriber's home boundary, block 622, contains the computer and VoIP use cases, blocks 624 and 634 respectively, these use cases include RockItClient™ parts, blocks 626 and 632 respectively, which use the RockItRouter™ part, block 628, connected to the broadband modem use case at block 630. The use connectors represent the relationships between blocks 628 and 626; and 628 and 632, respectively.

FIG. 3 illustrates that the RockItClient™ software on each host device interfaces with RockItRouter™ software on the broadband modem to facilitate IPsec communications. The home network devices utilize the RockIt Policy Directory™, block 644, RockIt Certificate Authority™, block 642, and RockIt Vault™, block 640, use cases located in the RockItSwitchr™ back office collaboration, block 636, for PKC and IPsec services that comprise the RockIt™ IPsec security architecture. The use connector illustrates the relationship between blocks 630 and 638. The RockIt Management System™ use case, block 638, illustrates the RockItSwitch™ back office system responsible for managing the PKC and IPsec security for the RockItClient™ and RockItRouter™ systems. The extend connectors depict the relationships between blocks 638 and 644, 638 and 642, and 638 and 640, respectively.

IPsec is implemented to provide authentication of the identity of the customer via certificates on the their host device, integrity to assure that customer data is not changed in transmit and confidentiality via encryption of the customer data so that it cannot be read by anyone who does not have the correct key. The security architecture secures all communication on the subscriber's home network, creating safety and privacy, and eliminating the theft of service problem for IBPs. IPsec operates at the network layer (Layer 3) of the open systems interconnection (OSI) model; thus, it is compatible with network devices comprising a customer's home network and backhaul networks utilized by Internet broadband providers (e.g., xDSL, cable, WiMAX, 3G, etc.).

The invention creates a new paradigm, by extending the relationship of the customer as related to the broadband modem in the conventional business process model. The invention creates a one-to-many relationship by correlating the customer account to their host devices (e.g., computers, VoIP) connected to the Internet broadband modem. The transformation of the conventional business process model, and corresponding automated and real-time business systems and processes used to create the expanded view, creates economic efficiencies-generating increased revenues and reduced costs for IBPs.

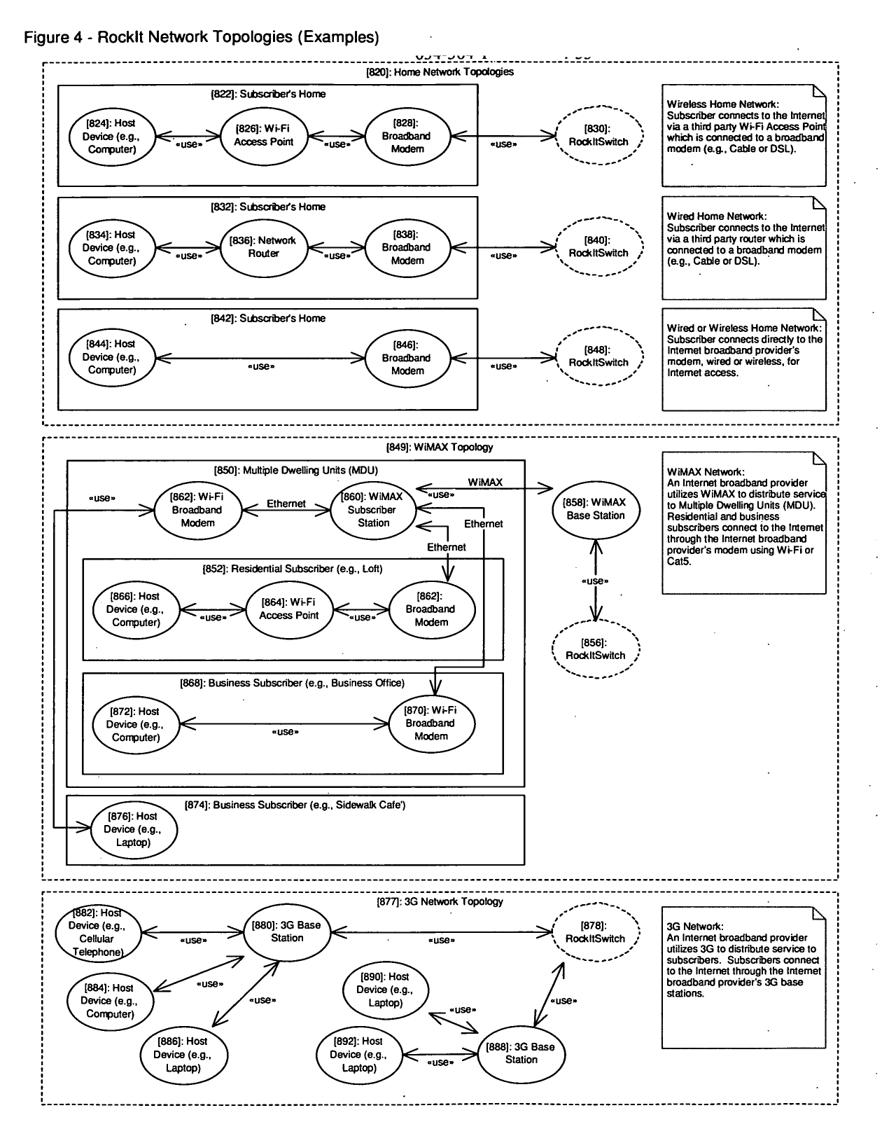

FIG. 4 is a use case diagram that illustrates several examples of network topologies supported by the invention's security architecture. The boundary labeled, “Home Network Topologies,” at block 820, details the three most common home network topologies. The first topology illustrates a Wi-Fi home network in which the customer connects to the Internet via a third party Wi-Fi Access Point which is connected to a broadband modem (e.g., Cable or xDSL), as depicted by the host device, Wi-Fi Access Point, and broadband modem use cases, at blocks 824, 826, and 828, respectively. The RockItSwitch™ use case, block 830, illustrates the relationship to the network topology. The use connectors depict the relationship between blocks 824, 826, 828, and 830.

The second topology illustrates a wired home network. A customer connects to the Internet via a third party router that is connected to a broadband modem (e.g., Cable or xDSL). Connections utilizing category 5 cable (Cat5) between host and network devices as depicted by the host device, network router, and broadband modem use cases, at blocks 834, 836, and 838, respectively. The RockItSwitch™, block 840, illustrates the relationship to the network topology. The use connectors depict the relationship between blocks 834, 836, 838, and 840.

The third topology illustrates a wired or Wi-Fi home network. Customers connect directly to a wired or wireless Internet broadband modem for Internet access, as depicted by the host device and broadband modem use cases, at blocks 844 and 846, respectively. The RockItSwitch™, block 848, illustrates the relationship to the network topology. The use connectors depict the relationship between blocks 844, 846, and 848.

The boundary labeled “WiMAX Topology”, at block 849, details a simple view of a WiMAX network topology. An Internet broadband provider utilizes WiMAX backhaul to distribute service to Multiple Dwelling Units (MDU). The RockItSwitch™ use case, block 856, resides in the Internet broadband provider NOC and connects to the WiMAX base station use case at block 858, as depicted by the bi-directional use connector between blocks 856 and 858. The WiMAX base station, block 858, connects to the WiMAX subscriber station use case, block 860, to form a point to multipoint backhaul topology. The bi-directional use connector labeled, “WiMAX,” between blocks 858 and 860 depicts the relationship between blocks 858 and 860. Typical WiMAX backhaul implementations utilize encryption to secure communications between base stations and subscriber stations. The WiMAX subscriber station is situated at a Multiple Dwelling Units (MDU) building. This is illustrated by the boundary labeled “Multiple Dwelling Units (MDU)” at block 850.

The WiMAX subscriber station is an Internet broadband aggregation point for all broadband connections in and around the building. The WiMAX subscriber station connects to a Wi-Fi broadband modem use case at block 862. The Wi-Fi broadband modem illustrates a “hot spot” or physical location where Wi-Fi Internet broadband service is available to the wireless users. The boundary labeled “Business Subscriber (e.g., Sidewalk Café)”, block 874, and the host device use case, block 876, as well as the bi-directional use connector between blocks 874 and 876 illustrate Internet broadband service use external to the MDU.

Internet broadband service use internal to the MDU is depicted by the boundaries labeled “Residential Subscriber (e.g., Loft)”, block 852, and “Business Subscriber (e.g., Business Office)”, block 868, and their respective network topologies. The Residential Subscriber (e.g., Loft) boundary details a WLAN, including a broadband modem use case, block 862, Wi-Fi Access Point use case, block 864, and host device use case at block 866. The bi-directional connector labeled “Ethernet”, between blocks 860 and 862, illustrates the Ethernet connection between the WiMAX subscriber station and the residential subscriber's broadband modem, which provides Internet broadband access. The Business Subscriber (e.g., Business Office) boundary details a WLAN including a Wi-Fi broadband modem use case, block 870, and host device use case at block 872. The bi-directional connector labeled “Ethernet”, between 860 and 870, illustrates the Ethernet connection between the WiMAX subscriber station and the business subscriber's broadband modem, which provides Internet broadband access.

The 3G network topology is illustrated within the boundary labeled “3G Network Topology”, at block 877. The 3G network topology is simplified—it does not detail the Incumbent Local Exchange Carrier (ILEC) connections to the base stations of the mobile communications systems and the Mobile Telephone Switching Office (MTSO), where the RockItSwitch™ use case, block 878, is assumed to be located. The RockItSwitch is connected via the mobile communications systems to the base stations. This is illustrated by the two 3G base station use cases at blocks 880 and 888, and the bi-directional use connectors between blocks 878 and 880, and 878 and 888, respectively. Network host devices utilize the 3G base stations for Internet broadband access. This is illustrated by the host device use cases at blocks 882, 884, and 886, and their respective connections to block 880, as well as the bi-directional use connectors between blocks 882 and 880, 884 and 880, and 886 and 880, respectively. It is further illustrated by the host device use cases at blocks 890 and 892, and their respective connections to block 888, as well as the bi-directional use connectors between blocks 890 and 888, and 892 and 888, respectively.

The interoperability of the RockIt™ security architecture supports many network topologies (and their underlying technologies) used to deliver Internet broadband access. In each of these topologies, host devices utilize RockItClient™ software, broadband modems utilize RockItRouter™ software and the RockItSwitch systems reside in the Internet broadband provider back office.

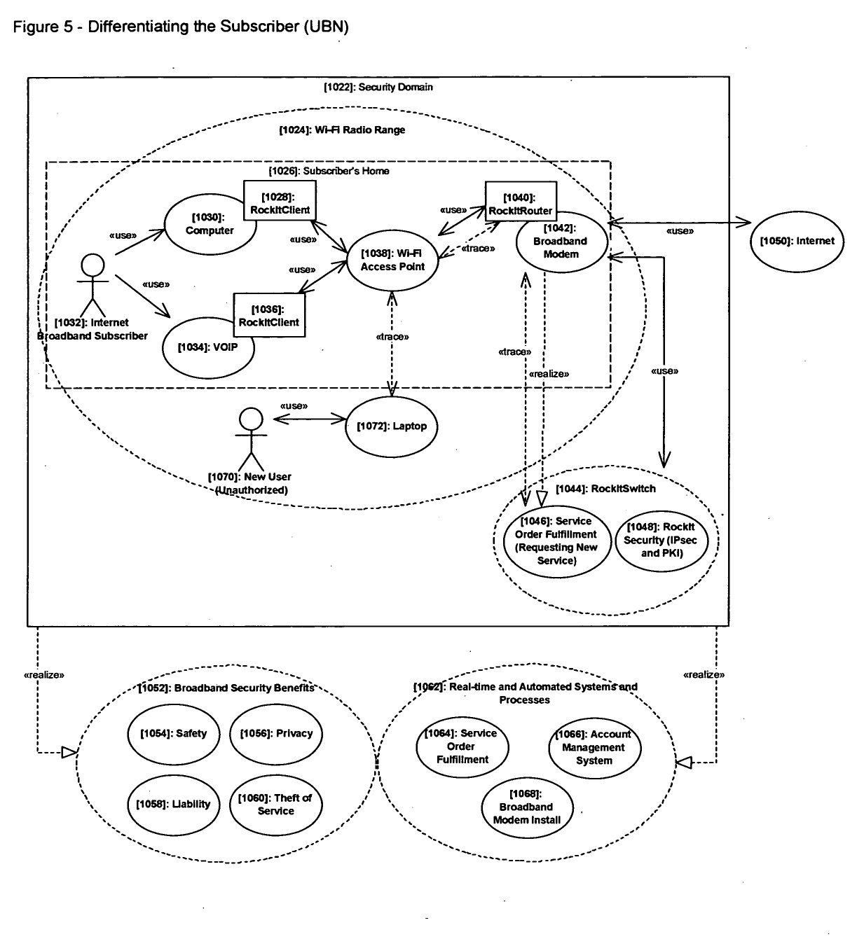

FIG. 5 is a use case diagram that illustrates the business process model for the real-time automation of subscriber differentiation, whereby the invention articulates its capacity to distinguish new, roaming, or expired customers. FIG. 5 illustrates a typical subscriber's home, block 1026, WLAN via the Wi-Fi radio range, block 1024, whereby the subscriber has two host devices, a computer, and VoIP, connected to a Wi-Fi Access Point—as depicted by the Internet broadband subscriber actor, block 1032, computer use case, block 1030, the VoIP use case, block 1034, and the Wi-Fi Access Point use case at block 1038. The network host devices gain access to the Internet through the Wi-Fi Access Point, broadband modem, and the broadband modem connection to the Internet; illustrated by the broadband modem use case, block 1042, the Internet use case, block 1050, and the use connectors that depict the connections between blocks 1028 and 1038, 1036 and 1038, 1038 and 1040, and 1042 and 1050, respectively.

FIG. 5 also illustrates the possibility that Wi-Fi network security is not implemented or is compromised by an unauthorized user, as depicted by the new user (unauthorized) use case, block 1070, the new user's laptop, block 1072, and the use connector between blocks 1070 and 1072, and the trace connector between blocks 1072 and 1038, respectively. The Security Domain boundary, block 1022, depicts that the security domain contains the home network (host devices, Wi-Fi Access Point, and broadband modem) and RockItSwitch™ back office.

The benefits of the security architecture are illustrated by the broadband security benefit collaboration, block 1052, and the realize connector between blocks 1022 and 1052. The broadband security benefit collaboration contains the safety use case, block 1054, privacy use case, block 1056, liability use case, block 1058, and the theft of service use case at block 1060. Furthermore, RockIt™ technology supplements and manages the basic IPsec security architecture to provide a real-time and automated processes for service order fulfillment and account management; as illustrated by the real-time and automated systems and processes collaboration, block 1062, and the realize connector between blocks 1022 and 1062. The real-time and automated systems and processes collaboration contains the service order fulfillment use case 1064, account management system use case, and broadband modem install use case at block 1068. The RockIt™ security architecture provides a new business process model for all types of TCP/IP broadband delivery including Cable, xDSL, WiMAX, Fiber, and Satellite.

FIG. 5 depicts RockItClient™ software installed on the customer's host devices represented by the RockItClient™ parts, blocks 1028 and 1036. RockItClient software works in conjunction with the broadband modem outfitted with RockItRouter™ software, detailed by the RockItRouter™ part at block 1040. The use connectors depict the relationships between blocks 1032 and 1030, 1032 and 1034, 1036 and 1038, 1028 and 1038, and 1038 and 1040, respectively. FIG. 5 illustrates RockItClient software and a RockItRouter™ broadband modem interacting with RockItSwitch™, block 1044, systems to provide for service order fulfillment, represented by the service order fulfillment (requesting new service) use case, block 1046, and RockIt™ security—depicted by the RockIt™ security (IPsec and PKI) use case at block 1048. The use connector depicts the relationship between blocks 1042 and 1044.

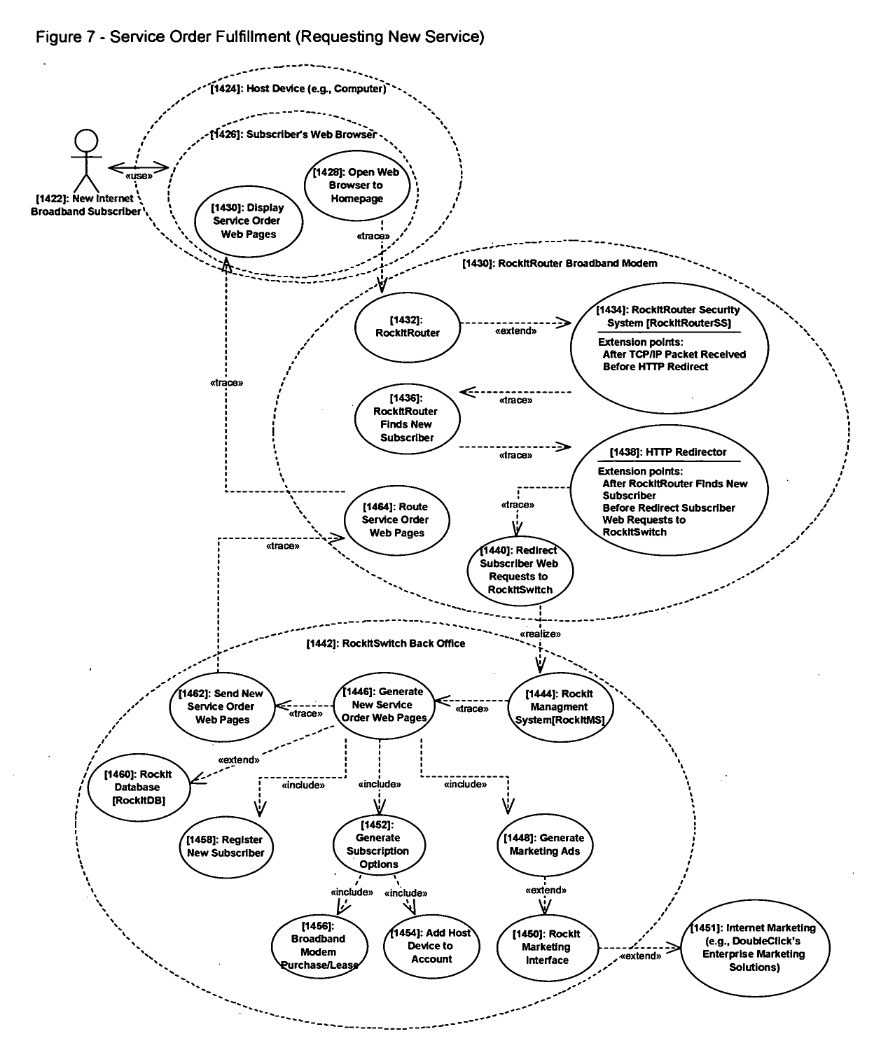

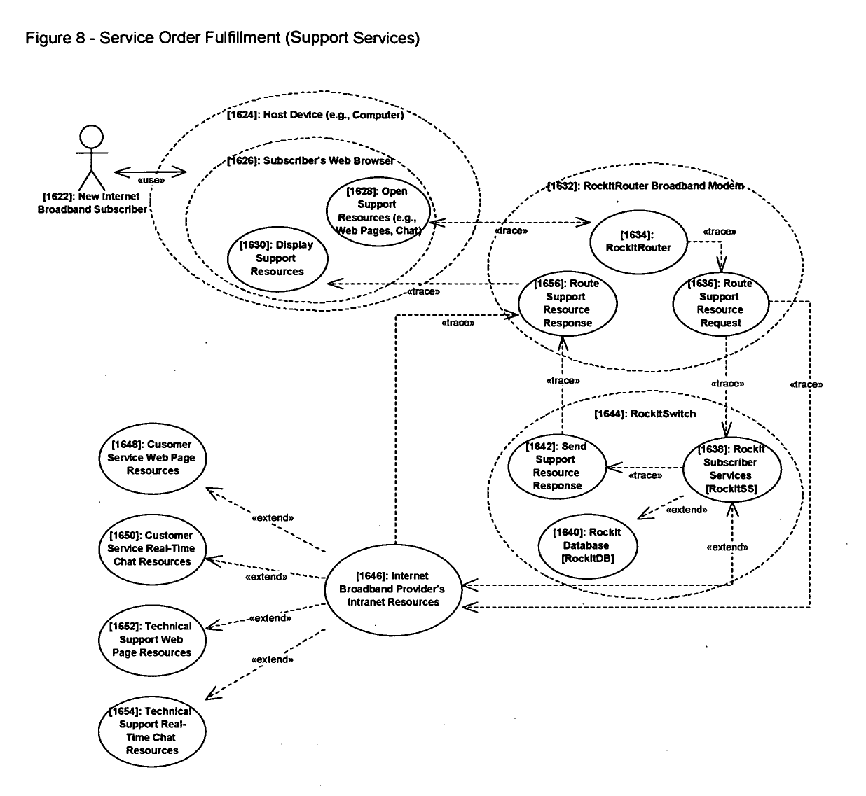

FIG. 5 illustrates an unauthorized users' limited access of the home network and Internet connection, in that they only have access to the new service order fulfillment systems and other IBP resources. See FIG. 8—Service Order Fulfillment (Support Services) and the FIG. 8 narrative below for the service order fulfillment support services processing and communications details. The bi-directional traces, between blocks 1072 and 1038, 1038 and 1040, 1042 and 1046, respectively, illustrate the new service order fulfillment process the business case utilizes to manage a new, or unauthorized, customer. See FIG. 7—Service Order Fulfillment (Requesting New Service) and the FIG. 7 narrative below for the new service order fulfillment processing and communications details. The realize connector, between blocks 1042 and 1046, illustrates that the RockItRouter™ broadband modem implements the services of the RockItSwitch™ back office to instantiate and process a new service order fulfillment request. The unauthorized user can see the wireless communications data transmitted between the host devices and broadband modem, as depicted by the Wi-Fi radio range, but these communications are secure.

The business process model enables IBPs to distinguish between new, roaming, or expired customers automatically and in real-time. New customers are subscribers who have never signed up for service with an IBP. Roaming subscribers have an account with an IBP, and are said to be using services on another subscriber's service connection. Expired subscribers are current subscribers with an expired subscription.

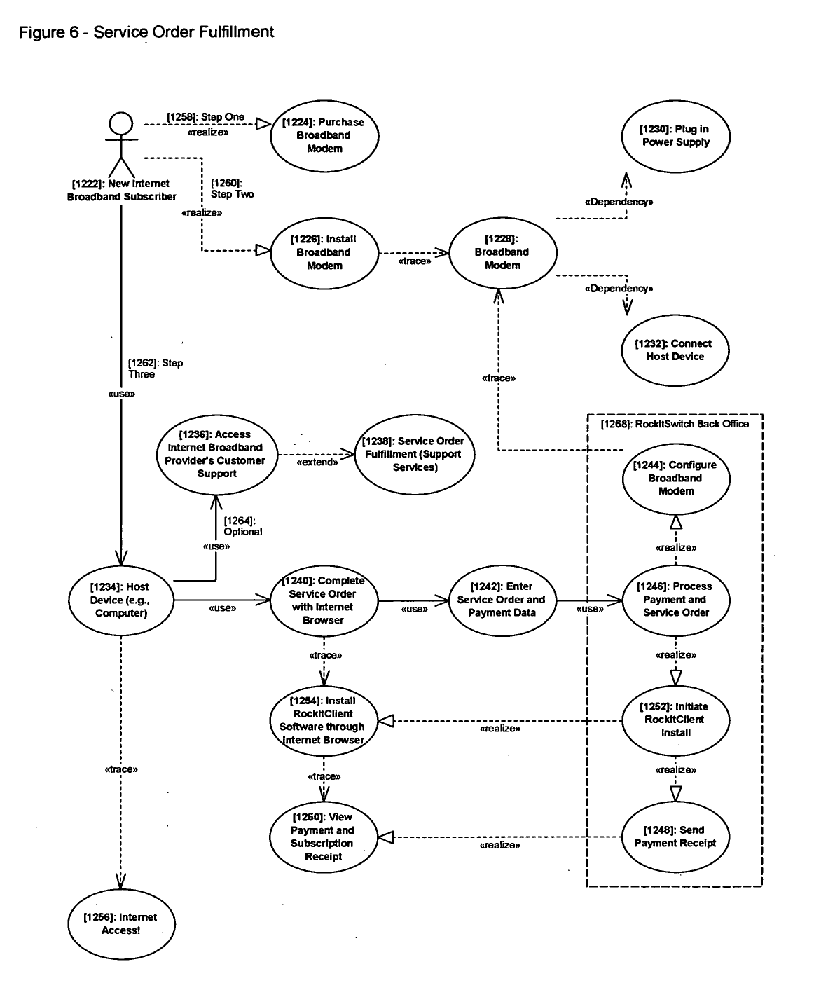

FIG. 6 is a use case diagram that illustrates the new service order fulfillment process and experience for a new customer. In Step One, a new customer, represented by the new internet broadband subscriber actor, block 1222, first purchases a broadband modem powered by UbiquityNet, Inc.'s RockIt™ technology. This is illustrated by the purchase broadband modem use case, block 1224, and the realize connector, labeled, “Step One,” between blocks, 1222 and 1024. New customers purchase RockIt™ powered broadband modems over the Internet or from a retailer.

Step Two is the broadband modem installation, depicted by the Install broadband modem use case at block 1226 and the realize connector labeled, “Step Two,” between blocks 1222 and 1226. The broadband modem install is dependent upon connections to a power supply and host devices. As illustrated by the plug in power supply use case, block 1230, connect host devices use case, block 1232, and the dependence connectors between blocks 1228 and 1230, and 1228 and 1232, respectively. The host device connection can be direct, as in connecting directly to the broadband modem, or indirect, as in connecting to the broadband modem over the home network where a router or Wi-Fi Access Point is in use.

In Step Three, the new customer uses their computer's Internet browser to complete the service order. This is illustrated by the host device (e.g., computer) use case, block 1234, complete service order with Internet browser use case at block 1240 and the use connector between blocks 1234 and 1240. Optionally, the new subscriber has complete access to the broadband provider's service order fulfillment support services, illustrated by the access Internet broadband provider's customer support, block 1236, and service order Fulfillment (support services) at block 1238. The use connector depicts the relationship between blocks 1234 and 1236, and the extend connector depicts the relationship between blocks 1236 and 1238. See FIG. 8—Service Order Fulfillment (Support Services) and the FIG. 8 narrative below for the processing and communications details of support service available to customers during the new service order fulfillment.

The enter service order and payment data use case, block 1242, and process payment and service order use case, block 1246, illustrate that the new customer navigates the e-commerce web site and enters service order and payment data. The use connectors depict the relationship between blocks 1240 and 1242, and 1242 and 1246, respectively. The payment and service order is then processed by the RockItSwitch™ back office, block 1268, to enable Internet access; this is depicted by the configure broadband modem use case at block 1244 and the trace connector between blocks 1244 and 1228, and represents the real-time and automated process of configuring the broadband modem. After the broadband modem configuration, the RockItSwitch™ then sends back an install RockItClient™ web page to the new customer's web browser to facilitate the RockItClient™ software install on the new customer's host device. This is illustrated by initiate RockItClient™ install use case, block 1252, the install RockItClient™ software through Internet browser use case, block 1254, and the realize connectors between blocks 1248 and 1252, and blocks 1252 and 1254, respectively.

Upon completing the RockItClient™ install, the RockItSwitch™ back office processes financial clearing of payment for service and sends a transactional receipt to the customer as illustrated by the send payment receipt use case, block 1248, the view payment and subscription receipt, block 1250, and the realize connectors between blocks 1252 and 1248, and 1248 and 1250, respectively. The trace connector between blocks 1240 and 1250, and 1254 and 1250, represent the progression of steps for the new subscriber during Step Three of the new service order fulfillment process.

Upon completion of the new service order fulfillment process the new customer has secure access to the Internet, as illustrated by the Internet access use case, block 1256, and the trace connector between blocks 1234 and 1256.

FIG. 7 is a use case diagram that illustrates the service order fulfillment process for a new service request. A new Internet broadband subscriber actor, block 1422, uses a web browser, block 1426, on their host device, block 1424, to access the internet. A new Internet broadband subscriber is either a new customer ordering service or a current customer adding a new host device to an existing account. The open web browser to homepage use case, block 1428, illustrates the web browser request for the browser home page. The requested URL (an acronym for the Uniform Resource Locator) is sent to the RockItRouter broadband modem, block 1430.

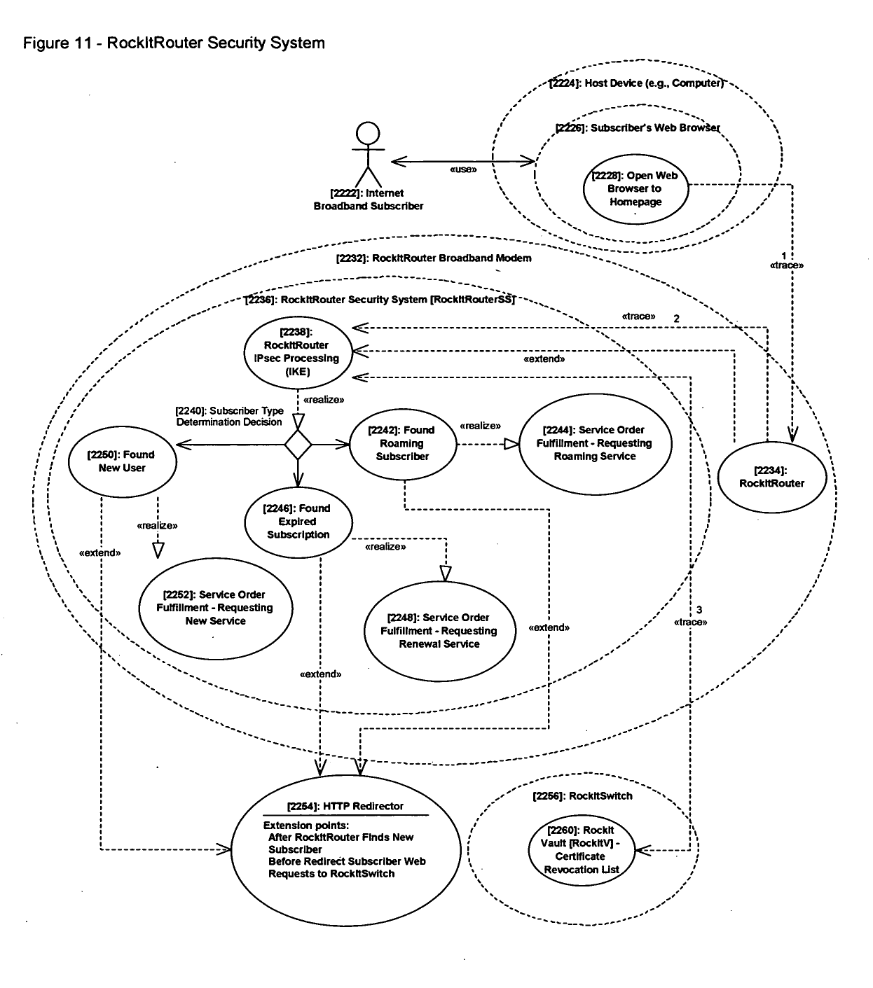

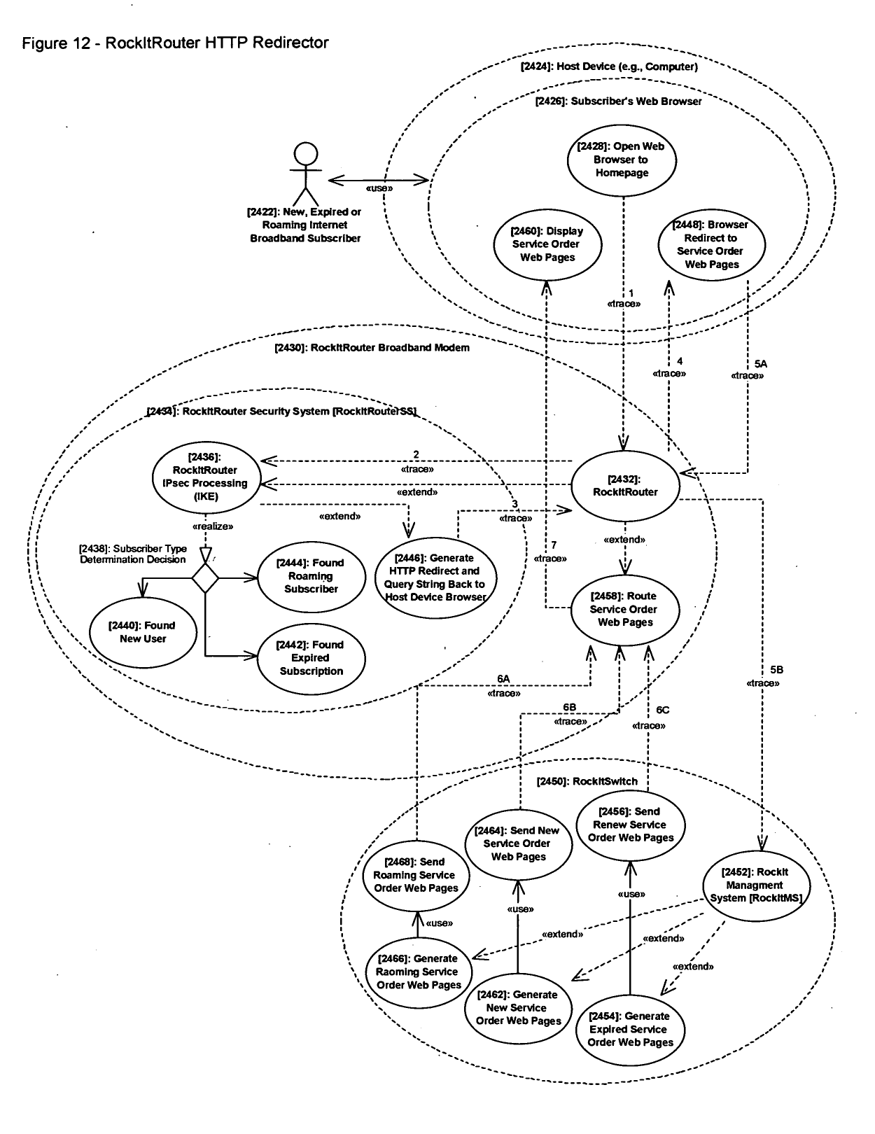

The RockItRouter broadband modem collaboration contains the RockItRouter™, block 1432. The use case trace depicts the flow of TCP/IP packets between blocks 1428 and 1432. The RockItRouter™ utilizes IPsec and PKC technologies to manage all TCP/IP communications. The use case extend indicates that the RockItRouter Security System (RockItRouterSS), block 1434, sub-process manages the TCP/IP communications. See FIG. 11 and the FIG. 11 narrative below for the RockItRouter Security System™ processing and communications details. As illustrated by the use case extension points in block 1434, the sub-process starts after a TCP/IP packet is received and before the HTTP Redirector, block 1438, takes over processing for the RockItRouterSS. Following the use case trace from block 1434 to block 1436, FIG. 7 indicates that the RockItRouter Security System™ finds a new subscriber. The use case trace continues from block 1436 to block 1438, the HTTP Redirector. The HTTP Redirector extension points indicate the sub-processing occurs after the RockItRouter Security System™ finds a new subscriber and before the redirect subscriber web requests to the RockItSwitch™ process. The use case trace continues between blocks 1438 and 1440. Block 1440 describes the URL redirect process whereby a URL Redirect is issued back to the host device web browser for further processing. See FIG. 12 and the FIG. 12 narrative below for the URL Redirector processing and communications details.

The use case realize connector between the redirect subscriber web requests to the RockItSwitch™ Back Office, block 1442, and the RockIt Management Systems™ (RockItMS), block 1444 illustrates the first step in the request for new service after HTTP Redirector processing. An alternative path not illustrated in FIG. 7, would be a direct HTTP request from the web browser to the subscription web page hosted on the RockItMS. In this scenario, a packet filter triggered during IPsec processing would route packets form the host device directly to the RockItMS, thereby bypassing the RockItRouter Security Systems™ and HTTP Redirector.

Once a URL redirect is received by the RockItMS, the URL redirect query string is parsed to determine how to process the request. The RockItSwitch™ Back Office collaboration, block 1442, illustrates the service order process. The use case trace from the RockItMS use case to the generate new service order web pages use case, block 1446, denotes the main sub-process responsible for generating the service order web page response. The generate new service order web pages sub-process includes three sub-processes: the generate marketing ads, block 1448, generate subscription options, block 1452, and the register new subscriber, block 1458. The use case include is depicted between block 1446 to blocks 1448, 1452, and 1458 to illustrate the relationship between the sub-processes.

The generate marketing ads sub-process, block 1448, utilizes the RockIt™ Marketing Interface, block 1450, to connect to internet marketing services for the process of generating marketing ads for the service order web pages. Use case Internet marketing (e.g., DoubleClick's Enterprise Marketing Solutions), block 1451, illustrates and Internet marketing system used to generate marketing ads. The use case extend depicts this relationship between blocks 1448, 1450 and 1451, respectively. The generate subscription options use case, block 1452, is the sub-process responsible for generate subscription options based on profiles that consider geographic location, special offers, cost, duration, and bandwidth. The generate subscription options use case includes two sub-processes. The add host device to account use case, block 1454, represents the sub-process responsible for creating an “Add New Host Device” option for an active service account. The broadband modem purchase or lease use case, block 1456, denotes the sub-process responsible for creating “Broadband Modem Purchase or Lease” options for the business case whereby new subscribers request new service through a current subscriber's connection or where current customers who are leasing have an option to purchase a new broadband modem. The use case include depicts this relationship between blocks 1452, 1454 and 1456, respectively. The register new subscribers use case, block 1458, represents the business case whereby a RockItRouter™ is in active service with no associated host devices. The register new subscribers sub-process creates a new subscriber account and associates the account with the RockItRouter™ broadband modem for future processing.

The generate new services order web pages sub-process, and related sub-process, utilize the RockIt™ database (RockIt), block 1460, for system processing. The use case extend depicts the relationship between block 1446 and 1460. The send new service order web page use case, block 1462, illustrates the final processing of sending the service order web page from the RockItSwitch™ back office to route service order web pages use case, block 1464, contained in the RockItRouter™ broadband modem collaboration. The use case trace between block 1462 and 1464 denotes the process path. The route service order web pages use case, represents the IPsec filter action for the routing incoming packets from the RockItSwitch™. The use case trace between block 1464 and the display service order web page use case, block 1430, illustrates the routed packets. The display service order web page use case represents the service order web page that is displayed in the subscriber's web browser. The new Internet broadband subscriber uses the web page to order or modify service.

FIG. 7, the Service Order Fulfillment (Requesting New Service) use case, demonstrates the business process model for starting the service order fulfillment process when requesting new service. The business process model is implemented through a system that provides network security for the home network and the Internet broadband provider network, by restricting unlimited access to Internet broadband modem to current customers. The system detects new customers and redirects their TCP/IP HTTP traffic to the back office automated order entry system for service order fulfillment processing. The back office system automatically processes service orders by generating and displaying subscription options—based on profiles that consider geographic location, special offers, cost, duration, and bandwidth—for new customers. The back office system enables customers, new and current, to purchase or lease an Internet broadband modem, and provides for automated process to add additional host devices to their existing accounts. The back office system also provides for automated generation and delivery of real-time marketing ad content during service order fulfillment.

FIG. 8 is a use case diagram that illustrates the business process model to provide new Internet broadband customers the capacity to access the Internet broadband provider's Intranet resources without a current account. The business use case provides new and current customers automated support access to real-time customer service and technical support web pages and chat services (i.e., real-time, synchronous, text-based communication via computer). Additionally, the RockIt™ systems that provide the business use case expose interfaces to the RockIt™ systems data for customer service and technical support representatives, and their systems to support customers via telephone.

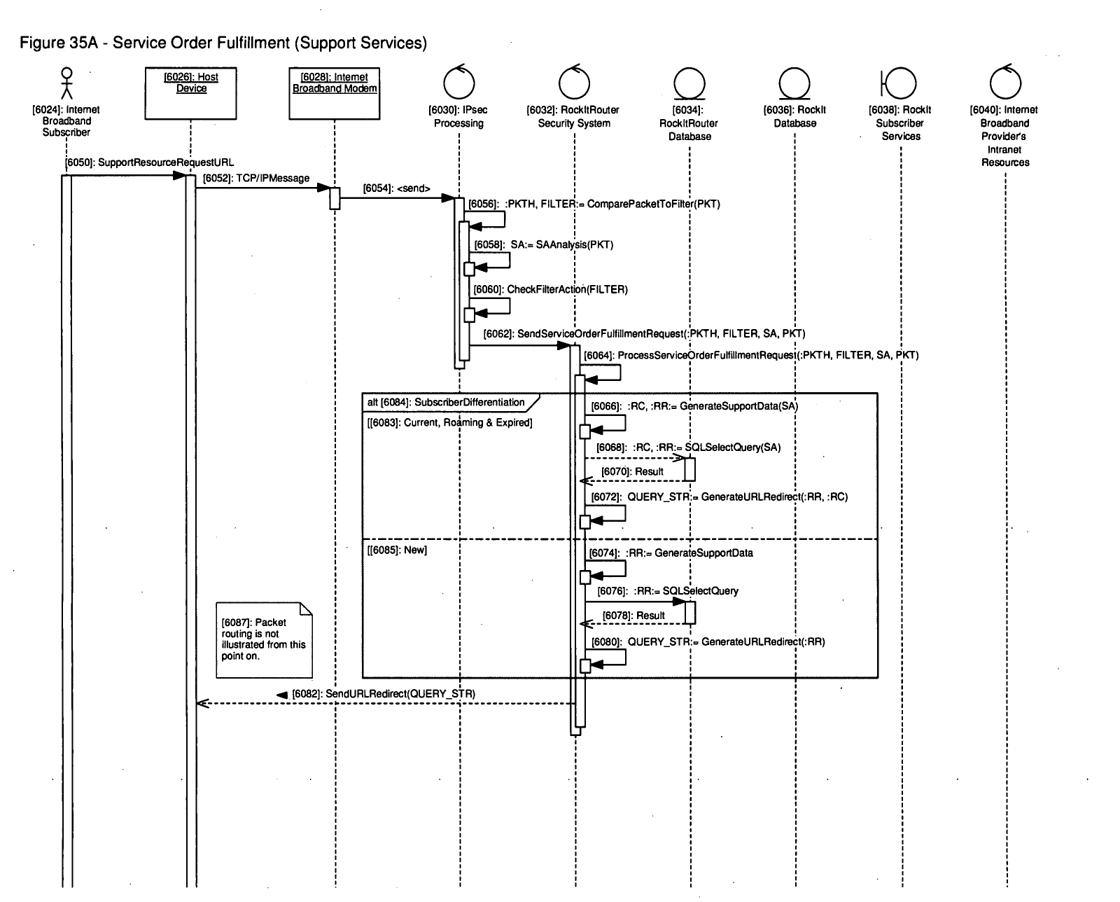

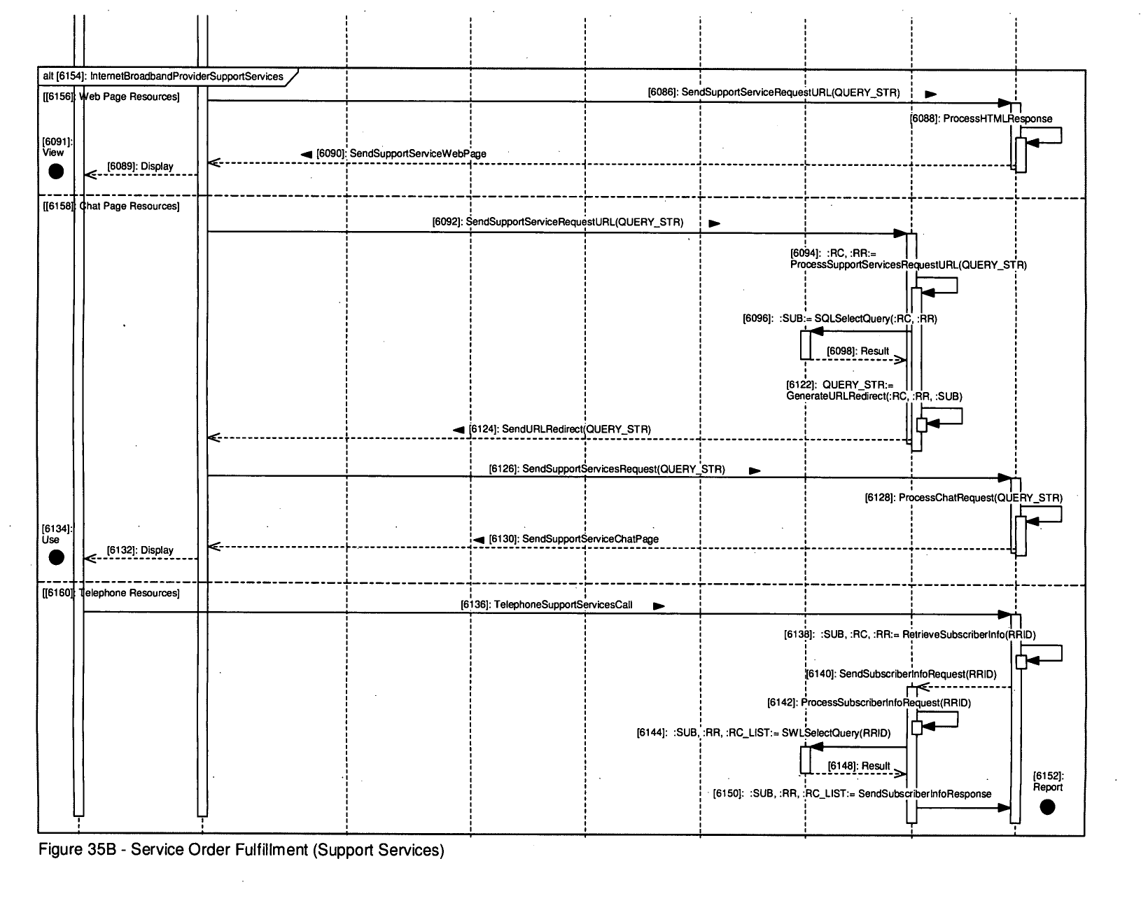

A new Internet broadband subscriber actor, block 1622, utilizes their host device, block 1624, and their web browser, block 1626, to access intranet resources via block 1628, Open Support Resources (e.g., web pages and chat). The bi-directional use case trace connector between block 1628 and the RockItRouter™, at block 1634, depicts the URL redirect generated by RockItRouterSS and the HTTP Redirector. The URL redirect includes an appended query string that contains information about the subscriber, and their systems, software and Internet broadband modem. See FIGS. 35A-B, Service Order Fulfillment (Support Services), and the narrative for these drawings below for the processing and communications details.

The use case trace connector between the RockItRouter™ and the route support resource request use case, block 1636, represents the TCP/IP packet filter action of the RockItRouter™ IPsec processing. The route support resource request sends the URL redirect to the RockItSwitch™, block 1638, or to the Internet broadband provider's Intranet resources, block 1646.

In case of customer service or technical support web page resources, the route support resource request sends the URL redirect to the Internet broadband provider's Intranet resources—bypassing the RockItSwitch™. The use case trace connector between blocks 1636 and 1646 depicts this communication. The customer service web pages resources use case, block 1648, and technical support web page resources use case, block 1652, depict the web page resources available to the customer. The use case extend represents the relationship between blocks 1646, 1648, and 1652 respectively. The web servers that provide the customer service or technical support web page resources parse the query string of the URL that made the request. The parsed content is used by the web servers to profile web content specific to the customer. In an example of the use of the URL query string data by a web server, model and version information about the RockItRouter™ broadband modem may be used to generate specific and pertinent technical web page content for the customer; saving customers the time and difficulty of finding relevant technical support documents. Additionally, customer support web servers utilize the URL query string data to generate pertinent web page content dynamically; making subscription information and other customer specific information readily at hand and easy to find. The customer support web servers can automatically generate web page subscription content to subscribers based on their demographic and geographic information. The use case traces between blocks, 1646, 1656, and 1630, depict the path of the web page response to the support service request by the Internet broadband provider's intranet resources use case and the display support use case, block 1630.

In case of customer service or technical support chat resources, the route support resource request sends the URL redirect TCP/IP packets to the RockItSwitch™ block 1644 where it is serviced by the RockIt™ Subscriber Services (RockItSS), block 1638. Upon receipt of the URL redirect from the customer host device, the RockItSS parses the query string, queries the RockIt™ Database (RockItDB), block 1640, for additional customer information, and generates a new support services URL redirect query string. The URL redirect is sent back to the web browser via the send support resource response use case, block 1642. The use case trace depicts the communication relationship between blocks 1638 and 1642. The URL redirect follows the use case trace connector between blocks 1642 and 1656. Upon receiving the URL redirect, the web browser requests the support resource through the use case traces between blocks 1634, 1636, and 1646. The route of the TCP/IP packets to the destination support resources bypass the RockItSwitch™ and arrive at the Internet broadband provider's Intranet resources use case for servicing.

The customer service real-time chat resources use case, block 1650, and the technical support real-time chat resources use case, block 1654 depict the chat resources available to the customer. The use case extend represents the relationship between blocks 1646, 1650, and 1654 respectively. The chat servers that facilitate the conversation between the customer service or technical support representative, and customer, parse the query string of the URL that made the request. The parsed content is used by the chat servers to profile web content specific to the customer for use by the support representative. In an example of the use of the URL query string data by a chat server, model and version information about the RockItRouter™ broadband modem may be to aid the technical support representative during a chat conversation with the customer. Customers are no longer burdened by the time consuming difficulties of understanding, finding, and communicating the technical details about their systems that give them Internet access to gain support access. The use case traces between blocks, 1646, 1656, and 1630, depict the path of the chat response to the support service request by the Internet broadband provider's intranet resources use case and the display support use case, block 1630.

Optionally, support software used by customer service or technical support representatives may use the RockIt™ Subscriber Service interface to query information about the subscriber, and their systems, software and Internet broadband modem. This latter example of Internet broadband provider support software using the RockIt™ Subscriber Services interface to support customer service and technical support representatives can be used to those providers and customers who use VoIP or traditional telecommunications services. Customer support representatives now have, in real-time, subscriber account information to aid them during the support process, making account history and billing information readily available to the customer support representative. Moreover, technical support representatives can utilize real-time information about the subscriber, and their systems, software and Internet broadband modem to aid them in supporting the customer.

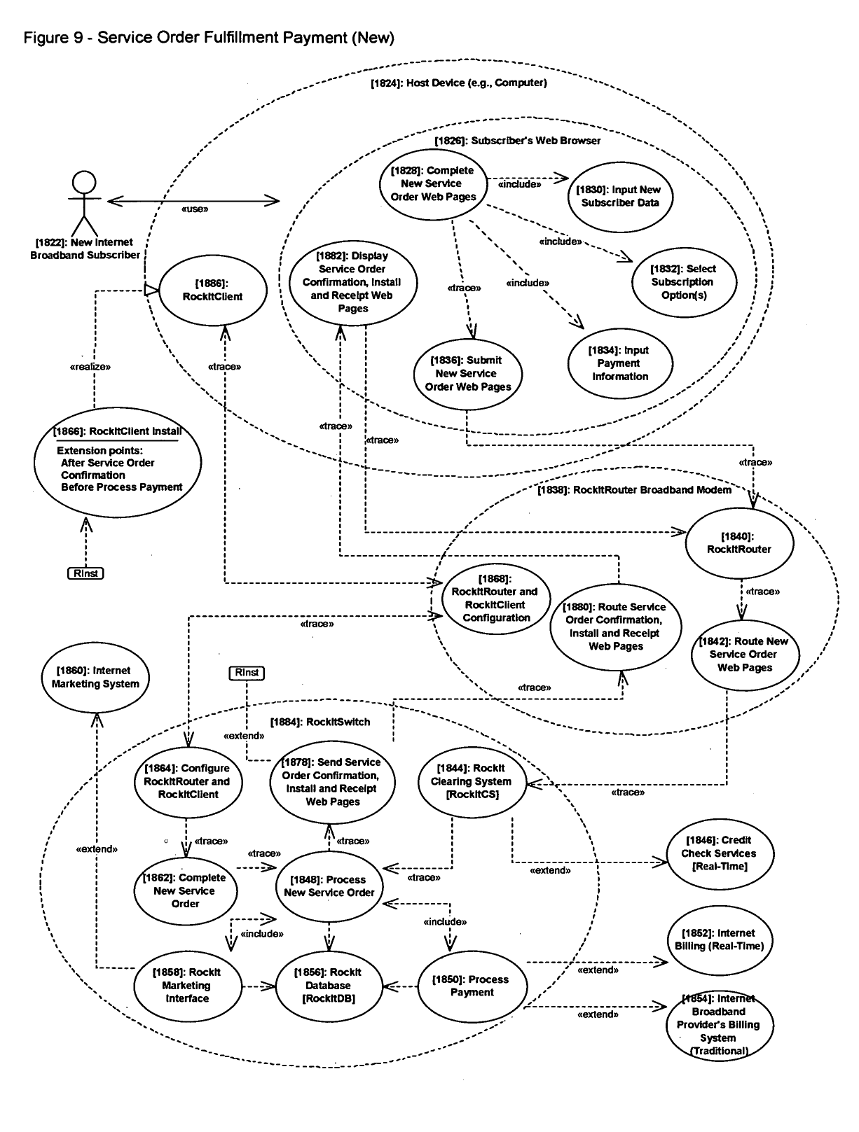

FIG. 9 is a use case diagram that illustrates the service order fulfillment use case for payment of a new service order request. A new Internet broadband subscriber actor, block 1822, uses a web browser, block 1826, on their host device, block 1824, to complete payment for a new service order. This drawing starts where FIG. 7, display service order web pages use case, block 1430, leaves off. As the reader will recall, the display service order web pages use case, on FIG. 7, represents the service order web page that is displayed in the subscriber's web browser. The new Internet broadband subscriber uses the web pages to order or modify service, as represented by the complete new service order web pages use case, block 1828, in FIG. 9. To complete a service order, a new customer inputs their subscriber data, inputs payment information, and selects a subscription option(s), as depicted by the use cases, Input new subscriber data, block 1830, input payment information, block 1834, and select subscription option(s), block 1832. The use case include connectors depict the relationship between block 1828, and blocks 1830, 1832, and 1834, respectively.

The use case trace connector between the complete new service order web pages use case and the submit new service order web pages use case, denotes the steps the customer takes to process payment. The customer then submits the new service order web pages, as illustrated by use case submit new service order web page, block 1836. The browser then sends the completed service order URL and query string to the RockItRouter™ broadband modem, block 1838, where it is routed via the RockItRouter™, block 1840, as represented by the use case trace connector between blocks 1836 and 1840. The use case trace connector represents the TCP/IP packet filter action of the RockItRouter™ IPsec processing between the RockItRouter™ and the route new service order web pages use case, block 1842. The route new service order web pages use case sends the competed service order URL and query string to the RockItSwitch™ use case collaboration, block 1884 for processing, and is depicted by the use case trace between blocks 1842 and 1844.

The RockIt™ Clearing System use case, block 1844, is the central RockIt™ Switch process used to manage the completion of the service order. The RockIt™ Clearing System is the RockItSwitch™ process responsible for optional credit check servicing, financial clearing, generating the web pages and HTML content (e.g., service order confirmation, RockItClient™ install, receipt, and marketing ads), RockItClient™ install, and RockItClient™ and RockItRouter™ configuration. During the service order completion process, customers may have the option of selecting a traditional billing method, or bill in the mail, used by Internet service providers. The credit check service (real-time) use case, block 1846, represents the external systems used to perform a credit check for customers who use traditional billing. The use case extend connector depicts the relationship between blocks 1844 and 1846.

The RockIt™ Clearing System then forwards the complete service order request to the process new service order use case, block 1848, depicted by the use case trace connector between blocks 1844 and 1848. The process new service order use case manages the real-time internet and traditional financial clearing, by passing the complete service order request to the process payment use case, block 1850. The use case include connector depicts the relationship between blocks 1848 and 1850. The process payment use case manages the financial transactions through the Internet real-time billing use case, block 1852, and Internet broadband provider's traditional billing system use case at block 1854. Payments made through the Internet real-time billing use case process Automatic Clearing House (ACH, e.g., check and debit card clearing), credit card (e.g., MasterCard and Visa), and PayPal transactions. Customers may have the option of setting up recurring billing while completing the new service order to provide, in real-time, automated monthly billing. The use case extend connectors depict the relationship between block 1850, and 1852 and 1854, respectively.

The process new service order use case utilizes the RockIt™ Marketing Interface, block 1858, to connect to the Internet marketing system use case, block 1860. The RockIt™ Marketing Interface utilizes external Internet marketing systems (e.g., DoubleClick's Enterprise Marketing Solutions) for the process of generating marketing ads for the new service order web pages. The use case include and extend connectors depict the relationship between blocks 1848 and 1858, and 1858 and 1860, respectively.

The process new service order use case issues several response web pages back to the customer to confirm the order, install the RockItClient™ software, and provide a transactional receipt (e.g., service order and payment receipt). The process new service order use case utilizes the send services order confirmation, install, and receipt web pages use case, block 1878, to send web pages to the customer. Web pages are sent back to the customer through the RockItRouter™, block 1868, and handled by the route service order confirmation, install, and receipt web pages use case, block 1880. The use case trace connector depicts the path of the sent web pages between blocks 1878 and 1880. The route service order confirmation, install, and receipt web pages use case, block 1880, represents the IPsec filter action for routing incoming packets from the RockItSwitch™, block 1884. The use case trace connector between block 1880 and the display service order confirmation, install, and receipt web pages use case, block 1882, illustrate the routed packets. The display service order confirmation, install, and receipt web pages use case represents the service order confirmation, RockItClient™ installation, and transactional receipt web pages that are displayed in the subscriber's web browser.

The use case traces connectors, starting at block 1882, and indicating a direction toward the RockItSwitch™ collaboration use case, pass between blocks 1840, 1842, 1844, and ending at the process new service order use case, block 1848, illustrate the communication flow of web pages from the web browser to the RockItSwitch™ that facilitates new service order completion.

The RockItSwitch™ processes a new service order in the following order: order confirmation, RockItClient™ install, RockItRouter™ and RockItClient™ configuration, and payment processing. Customers use the service order confirmation web page to verify their subscription options, cost, and payment information. If real-time Internet billing is utilized by the system during order confirmation, financial authorization is performed through the process payment use case, block 1850. If a problem is encountered with payment authorization, an exchange of web pages is sent between the RockItSwitch™ and the customer, and results in a successful financial authorization or the decline of the new service order. A successful financial authorization results in the installation of the RockItClient™ software.

After service order confirmation, and financial authorization in the case of real-time billing, customers view and use the RockItClient™ install web page to install the RockItClient™ software on their host device. The extend use case connector, and connector segment labeled “RInst,” depict that the RockItClient™ install use case following the customer's viewing and initiating the RockItClient™ install from the display service order confirmation, install and receipt web pages use case, block 1882. The realize use case between the RockItClient™ install use case, block 1866, and the RockItClient™ use case, block 1886 represents that the RockItClient™ is installed, or realized, through the RockItClient™ install use case. The RockItClient™ install use, block 1866, case contains the extension points, after service order confirmation and before process payment, to illustrate the order of the RockItClient™ install in relationship to order confirmation and payment processing.

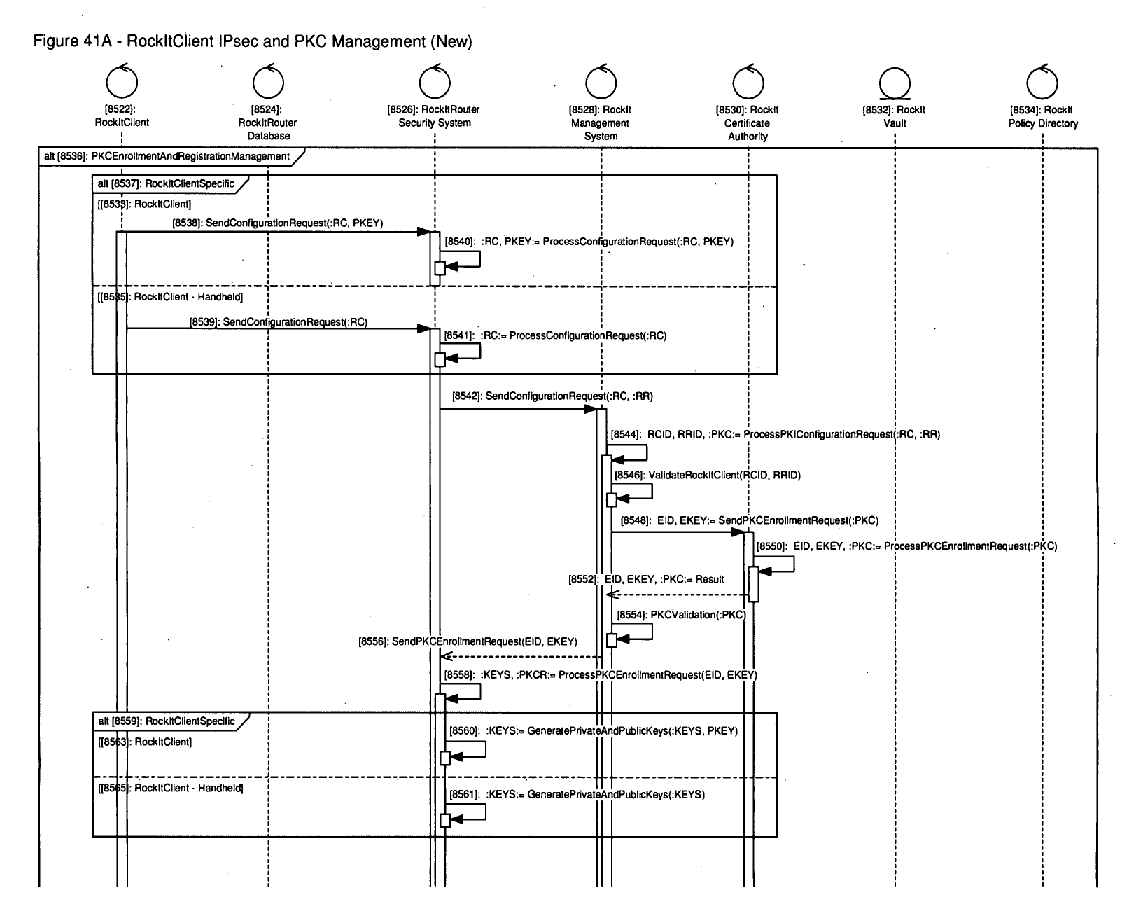

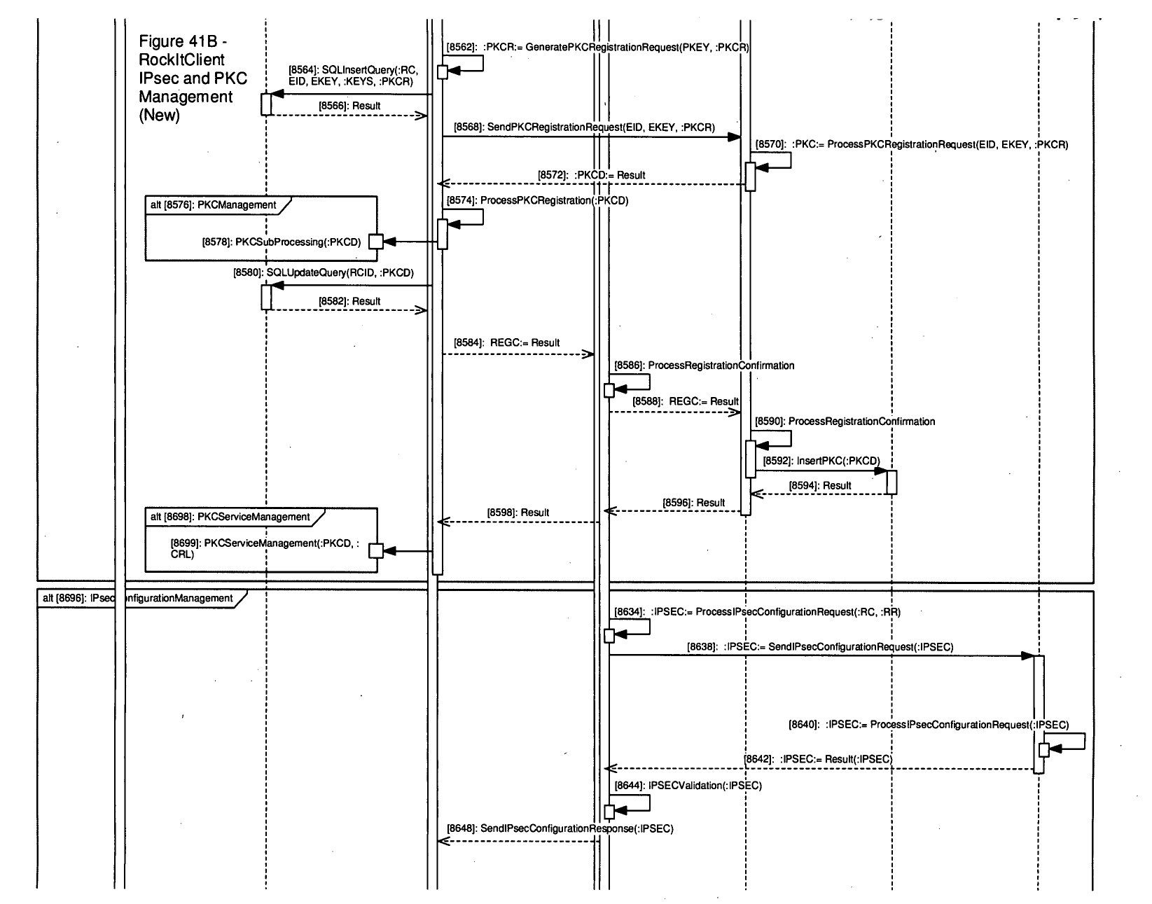

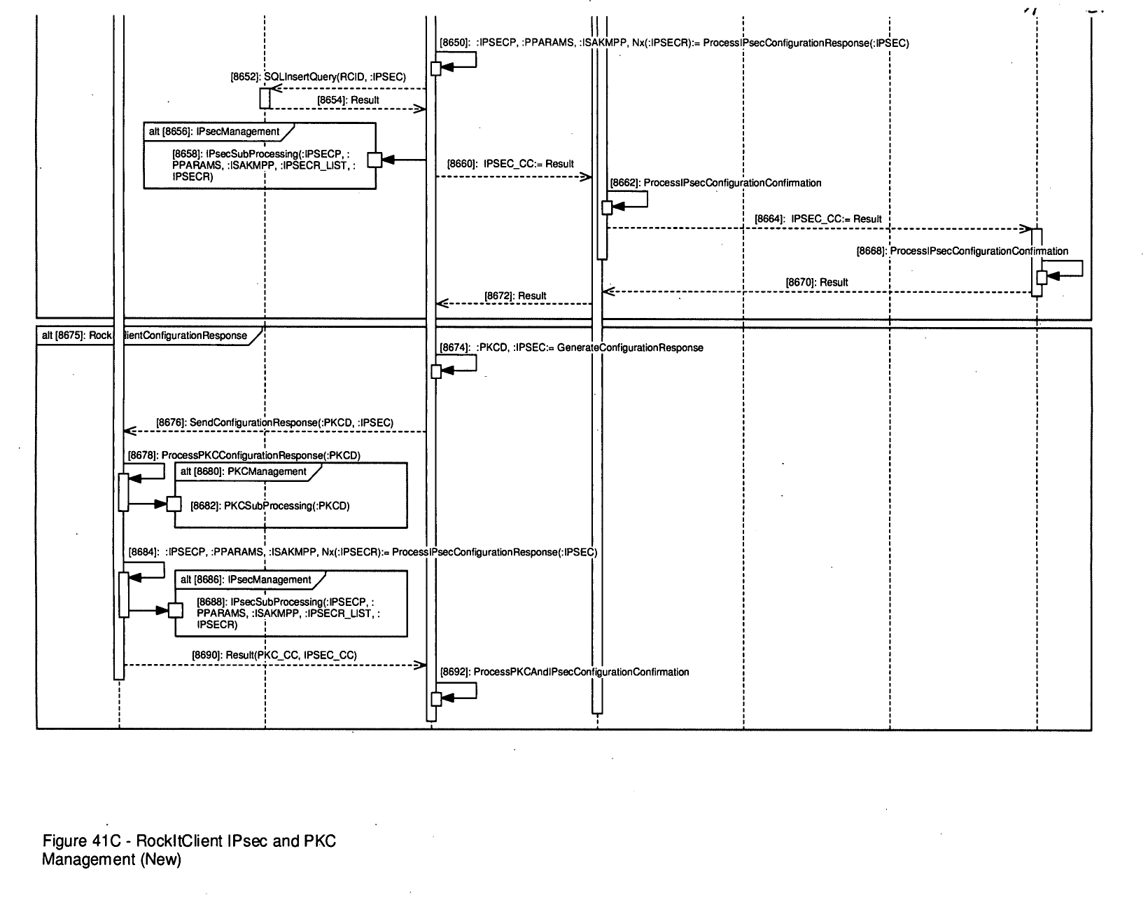

Upon completion of the RockItClient™ install, the RockItClient™ use case sends a configuration request to the RockItRouter™. This is illustrated by the bi-directional trace use case connector between the RockItClient™ use case, block 1886, and RockItRouter™ and RockItClient™ configuration use case, block 1868. The RockItRouter™ and RockItClient™ configuration use case, block 1868, plays a pivotal role in RockItClient™ configuration. See FIGS. 41A-C and the FIGS. 41A-C narrative below for the RockItClient™ IPsec and PKC Management (New) use case processing and communications details. Additionally, the RockItRouter™ and RockItClient™ configuration use case is responsible for the configuration of the RockItRouter™ service, routing tables, and IPsec, PKC, and bandwidth allocation systems for a specific host device. The RockItRouter™ and RockItClient™ configuration use case utilizes the RockItSwitch™ back office to configure the RockItRouter™ and RockItClient™. Configuration request, and responses are received and sent by the RockItRouter™ to the configure RockItRouter™ and RockItClient™ use case block 1864. The bi-directional trace use case connector illustrates the communication flow between the blocks 1868 and 1864. During configuration, the configure RockItRouter™ and RockItClient™ use case coordinates the processes and communication between RockItClient™ software and RockItRouter™ systems with the RockItSwitch™ back office systems: RockIt Management System, RockIt Certificate Authority™, RockIt Vault™, and RockIt Policy Directory™.

After the RockItRouter™ confirms successful configuration to the configure RockItRouter™ and RockItClient™ use case, the service order fulfillment process is marked for completion by the complete new service order use case, block 1862. The trace use case connector represents the relationship between blocks 1864 and 1862. The complete new service order use case communicates that the service order fulfillment process is ready for completion to the process new service order, as depicted by the trace use case connector between blocks 1862 and 1848. The process new service order use case then performs the financial clearing of the payment for the customer. The bi-directional trace use case connector between block 1848 and 1850 depicts the communication flow between the process new service order and the process payment use cases. Following the completion of the financial clearing of payment, the process new service order use case generates and sends a service order receipt to the customer to conclude the service order fulfillment payment use case.

FIG. 9, the Service Order Fulfillment Payment (New) use case, demonstrates the business process model for completing the new service order fulfillment payment process. The business process model is implemented through a system that provides an automated, real-time, payment process that eliminates, for customers, the time consuming process to order Internet broadband service. Customers are no longer required to place telephone calls to Internet broadband provider customer service representatives, or to use an Internet broadband provider's web site, to order service. The typical time period to implement Internet service, resulting in days or weeks before service activation, is eliminated. Internet broadband providers reduce SAC by gaining economic efficiencies through a business process that implements real-time automation of service order processing. IBPs reduce costs, by reducing labor and capital requirements of customer service and technical support representatives to process service order requests, payment, and fulfillment.

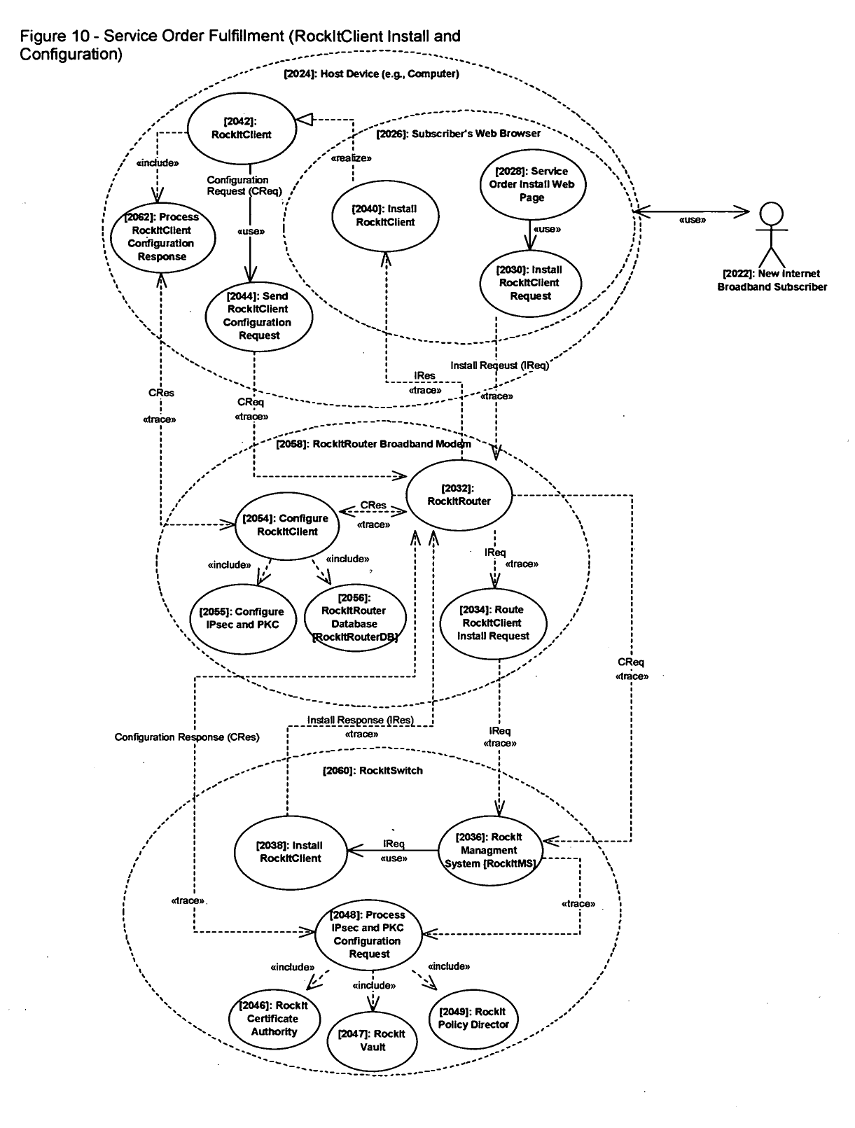

FIG. 10 is a use case diagram that illustrates the service order fulfillment RockItClient™ software install and configuration. This service order fulfillment RockItClient™ software install and configuration use case provides a greater level of detail for the RockItClient™ install and configuration process than FIG. 9. A new Internet broadband subscriber actor, block 2022, uses a web browser, block 2026, on their host device, block 2024, to complete the RockItClient™ software install. This drawing starts where FIG. 9, display service order confirmation, install, and receipt web pages use case, block 1882, leaves off. As the reader will recall, the display service order confirmation, install, and receipt web pages use case, on FIG. 9, represents several web pages that are displayed in the subscriber's web browser during service order fulfillment. The new Internet broadband subscriber uses the web page to initiate the RockItRouter™ software install, as represented by the service order install web page use case, block 2028, on FIG. 10. The service order install web page use case represents a web page that details the RockItClient™ install process and a button that starts the process, as illustrated by the install RockItClient™ request use case, block 2030. The use case use connector illustrates the relationship between blocks 2028 and 2030.

Once the install RockItClient™ request use case is instantiated, the web page issues an install request (IReq) to the RockItSwitch™ back office, block 2060. The browser then sends the IReq URL and query string to the RockItRouter™ broadband modem, block 2058, where it is routed via the RockItRouter™, block 2032, as represented by the use case trace between blocks 2030 and 2032; this trace is labeled, “Install Request (IReq).” The use case trace connector, labeled, “IReq,” between the RockItRouter™ and the route RockItClient™ install request use case, block 2034, represents the TCP/IP packet filter action of the RockItRouter™ IPsec processing. The route RockItClient™ install request use case sends the IReq URL and query string to the RockItSwitch™ use case collaboration, block 2060, for processing, and is depicted by the use case trace, labeled, “IReq,” between blocks 2034 and 2036. The RockIt Management System™ (RockItMS), block 2036, is the RockItSwitch™ process that is responsible for managing the RockItClient™ install. Upon receiving the IReq, the RockItMS parses the IReq query string for relevant data need to service the request, performs validation, registration, data persistence, and generates RockItClient™ configuration data. An install response (IRes) URL and query string, containing the RockItClient™ configuration data, is created and sent back to the host device for further processing. The use case install RockItClient™, block 2038, is used, as illustrated by the use case use labeled “IReq” connector between blocks 2036 and 2038, by the RockIt Management System™ use case to send the IRes to the host device. The install RockItClient™, block 2038, sends the request to the client through the RockItRouter™ use case, block 2032, arriving at the install RockItClient™, block 2040. The RockItRouter™ use case represents the IPsec filter action for routing incoming packets from the RockItSwitch™, block 2060. The use case trace connector between block 2038 and 2032 depicts the path of the communication between the install RockItClient™, block 2038, and RockItRouter™ use case, block 2032; it is labeled “Install Response (IRes).” The use case trace labeled “IRes” connector between block 2032 and 2040 depicts the path of the communication between the RockItRouter™ use case, block 2032, and the install RockItClient™, block 2040.

The install RockItClient™ use case starts the RockItClient™ install on the subscriber's host device, block 2024. The subscriber's web browser, block 2026, may issue a confirmation dialog requesting confirmation of the software install. The RockItClient™ install results in the RockItClient™ use case at block 2042. The realize use case connector between blocks 2040 and 2042 depicts the installation of the RockItClient™ software. After successful install of the RockItClient™ software, processing RockItClient™ software updates and install confirmation, the install process initiates a configuration request (CReq) message, as illustrated by the send RockItClient™ configuration request use case, block 2044.

The send RockItClient™ configuration request use case sends the CReq message and data to the RockItRouter™ for processing. The use case trace connector labeled “CReq” depicts the communication flow between blocks 2044 and 2032. The RockItRouter™ processes the CReq adding data for processing, and forwards the CReq to the RockIt Management System™, as illustrated by the use case trace connector labeled “CReq” between blocks 2032 and 2036. The RockIt Management System™ use case passes the CReq to the process IPsec and PKC configuration request use case, block 2048. The use case trace connector depicts the communication flow between blocks 2036 and 2048. The process IPsec and PKC configuration request use case manages all IPsec and PKC configuration processing and communication between the RockIt Management System™, RockItRouter Security System™, RockIt Certificate Authority™, block 2046, RockIt Vault™, block 2047, and RockIt Policy Directory™, block 2049. The RockIt Certificate Authority™ is the PKC certificate authority system, the RockIt Vault™ is the PKC repository system, and the RockIt Policy Directory™ is the IPsec policy system. These systems perform the lower level implementation of the EPsec and PKC configuration processing and communication. The use case include between block 2048, and blocks 2046, 2047 and 2049, respectively, depicts the relationship between the systems. The use case trace connector labeled “Configuration Response (CRes)” represents the bi-directional communication between the RockItSwitch™ and RockItRouter™ systems.

The RockItRouter™ use case, block 2032, sends and receives CRes messages between the configure RockItClient™ use case, block 2054, or the process IPsec and PKC configuration request use case, block 2048. The configure RockItClient™ use case manages the EPsec and PKC configuration for the RockItRouter™ and the RockItClient™; it includes the configure IPsec and PKC use case, block 2055, and the RockItRouter™ Database use case, block 2056. Use case configure IPsec and PKC processes the CRes and performs the RockItRouter™ IPsec and PKC configuration for the RockItClient™. Configuration includes setting up IPsec policy and system (e.g., filters and IPsec system wide parameters), and storing PKC data locally. Additionally, the configure IPsec and PKC processes use case provides processes for handling the RockItClient™ IPsec and PKC setup (e.g., private key generation), and facilitates IPsec and PKC communications for configuration between the RockItSwitch™ IPsec and PKC systems and the RockItClient™. The process RockItClient™ configuration response use case, block 2062, processes the CRes communications to and from the configure RockItClient™ use case; the use case trace labeled “CRes” depicts the communication flow. Use case process RockItClient™ configuration response illustrates the EPsec system (e.g., filters and IPsec system wide parameters) configuration and PKC processing (e.g., public and private key generation). After RockItRouter™ and RockItClient™ IPsec and PKC processing, configuration and confirmation are complete, service order fulfillment proceeds to payment.

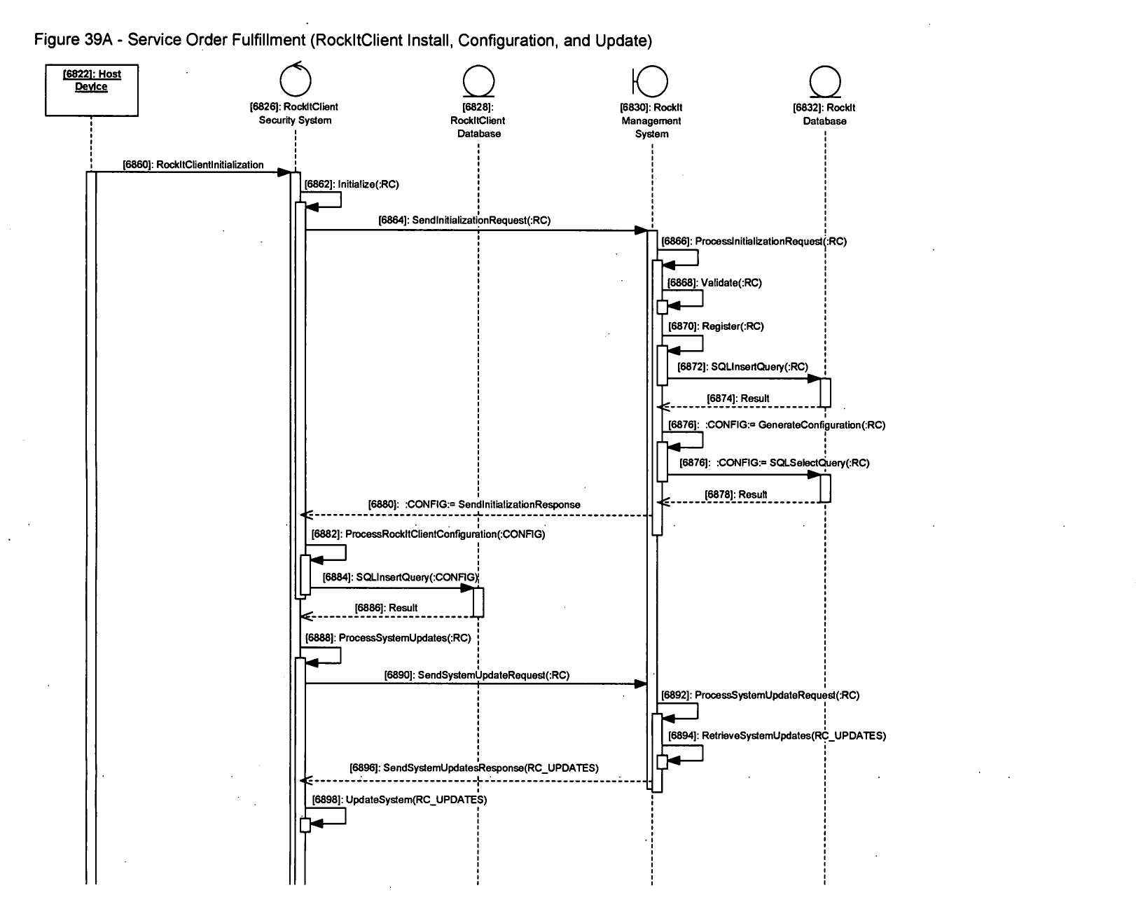

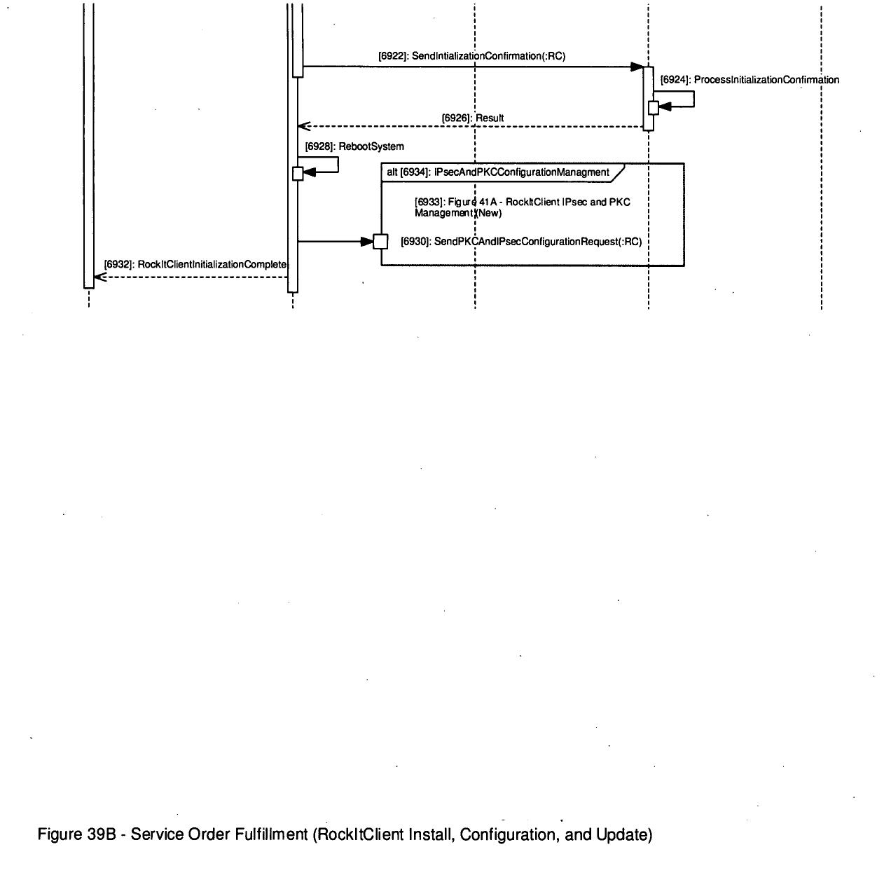

See FIGS. 39A-B—Service Order Fulfillment (RockItClient™ Install, Configuration, and Update) and 41A-C—RockItClient™ IPsec and PKC Management (New), and the related narratives for these drawings below, which illustrate and discuss the lower level implementation details for FIG. 10.

FIG. 11 is a use case diagram that illustrates the RockItRouter Security System™ utilized by the service order fulfillment process. FIG. 7 illustrates the new service order fulfillment process use of the security system for determining the presence of a new subscriber; recall the RockItRouter Security System™, FIG. 7, block 1434. This drawing explains the RockItRouter Security System™ for determining the presence of a new customer, as well as the presence of roaming and expired customers.

An Internet broadband subscriber actor, block 2222, uses a browser, as depicted by the subscriber's web browser, on their host device, block 2224. Once the subscriber's Internet web browser is instantiated, it sends a URL request for the browser home page, depicted by the open web browser, to homepage, block 2226. FIG. 11 illustrates a request for a web browser home page; however, any URL request is handled by the system. The URL request for the web browser home page is depicted by the use case trace labeled “1.” The URL request is sent to the RockItRouter™, block 2234, contained in the RockItRouter™ broadband modem collaboration, block 2232. The RockItRouter Security System™ use case collaboration, block 2236, contains the RockItRouter™ IPsec processing (IKE) use case, block 2238. The use case trace labeled “2” between blocks 2234 and 2238 depicts the communication path of the TCP/IP packets containing the URL request. The RockItRouter™ IPsec (IKE) use case represents the Internet Key Exchange (IKE) exchange and resulting distinction of new, roaming, and expired subscriber types, as represented by the subscriber type determination decision use case, block 2240. The RockItRouter Security System™ utilizes IKE and certificate authorization to manage TCP/IP packets during IPsec processing.

The subscriber type determination decision use case results in the system distinguishing the type of TCP/IP packet types found by the system: new, expired or roaming. The found new user use case, block 2250, found expired subscription, block 2246, and found roaming subscriber, block 2242, illustrate the TCP/IP packet distinction. Each distinction results in a corresponding service order fulfillment request requesting new service use case, block 2252, service order fulfillment requesting renewal service use case, block 2248, and service order fulfillment requesting roaming service use case, block 2244. The use case realize connectors represent the resulting service request for each subscriber type determination; depicted between blocks 2250 and 2252, blocks 2246 and 2248, and blocks 2242 and 2244, respectively. The RockItRouter Security System™ utilizes the HTTP Redirector, block 2254, to instantiate the new, renewal, or roaming service order requests. The use case extend connectors represent that the HTTP Redirector extends the processing of the RockItRouter Security System™ between blocks 2250 and 2254, 2246 and 2254, and 2242 and 2254, respectively.

In the case of expired and expired subscribers, the RockItRouter Security System™ validates PKC certificates locally before referring to the RockIt Vault™, block 2260, contained in the RockItSwitch™ use case collaboration, block 2256. The use case trace connector labeled “3” depicts the communication between the blocks 2238 and 2260. The RockIt Vault™ provides PKC certificate revocation list (CRL) lookups to determine if the subscription is current or a subscriber has a roaming subscription. In the case of an expired subscriber, the RockItRouter Security System™ requests CRL confirmation from the RockIt Vault™ as a redundancy measure, before issuing the service order fulfillment for requesting subscription renewal. If the subscriber's certificate is found in the RockIt Vault™ CRL, the RockItRouter Security System™ issues a service order fulfillment request for subscription renewal.

In the case of roaming subscribers, a host device may have a valid certificate that is not in the RockItRouter Security System™ certificate store or CRL. The RockItRouter Security System™ sends a certificate validation request and a CRL lookup to the RockIt Vault™ to determine how to process the TCP/IP packets from a subscriber host device. If the certificate is valid but is not in the RockIt Vault™ CRL, the RockItRouter Security System™ stores the certificate and allows the host device access to the Internet. If the certificate is valid, but the subscription does not include roaming service, the RockItRouter Security System™ issues a service order fulfillment request for a roaming subscription.

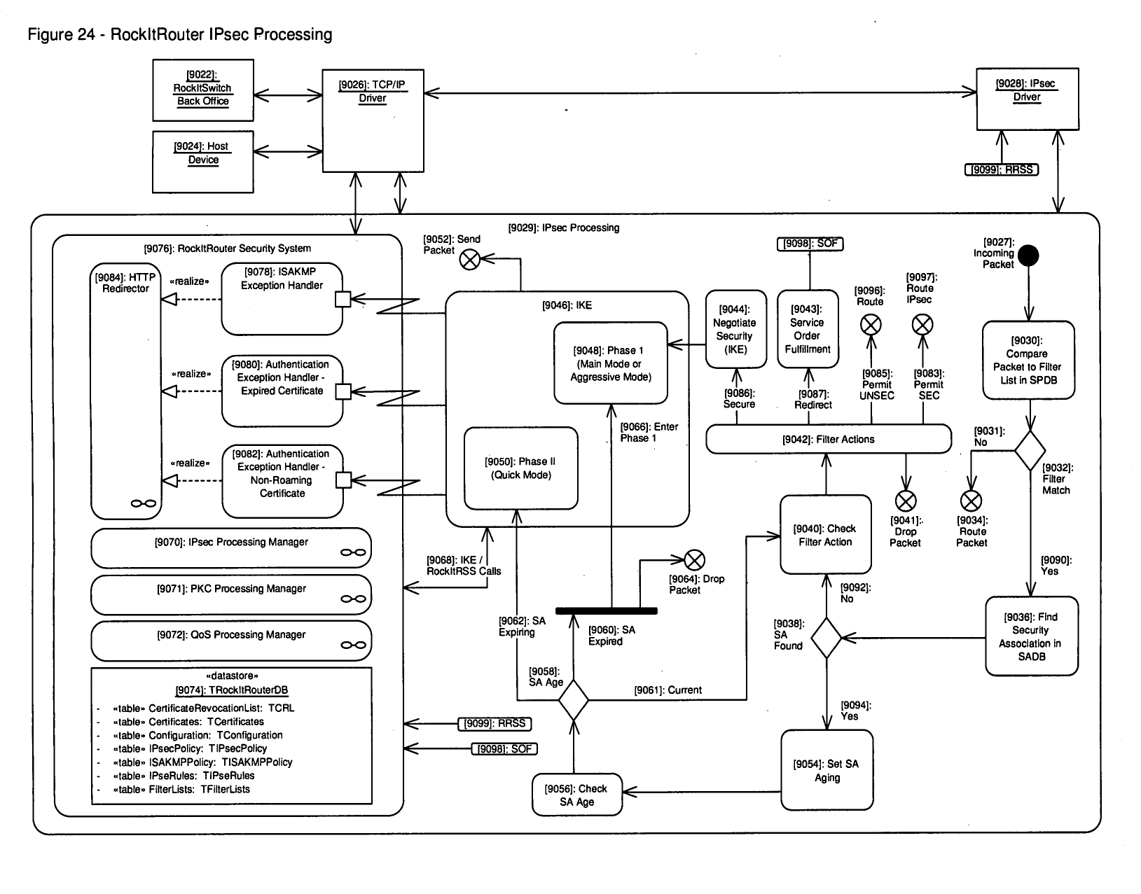

FIGS. 24—RockItRouter™ IPsec Processing, Configuration, and Update), 26—RockItRouter Security System™ and HTTP Redirector (New), and 27—RockItRouter Security System™ and HTTP Redirector (Roaming and Expired), and the related narratives for these drawings below, illustrate and discuss the lower level implementation details for FIG. 11.

FIG. 12 is a use case diagram that illustrates the RockItRouter™ HTTP Redirector utilized by RockItRouter Security System™ during the service order fulfillment process. FIG. 11 illustrated the RockItRouter Security System™ subscriber type differentiation process used to determine the presence of new, roaming, or expired customers. The reader will recall that HTTP Redirector, FIG. 11, block 2254, extends the processing of the RockItRouter Security System™ to instantiate the new, renewal, or roaming service order requests. FIG. 12 further details the business process model for service order fulfillment, illustrating the role of the HTTP Redirector in facilitating communication flow of URL requests from new, roaming, or expired subscribers host devices to the RockItSwitch™ for service order fulfillment processing.

A new, expired, or roaming Internet broadband subscriber actor, block 2422, uses a browser, as depicted by the subscriber's web browser, block 2426, on their host device, block 2424. Once the subscriber's Internet web browser is instantiated, it sends a URL request for the browser home page, depicted by the open web browser to homepage, block 2428. FIG. 12 illustrates a request for a web browser home page; however, any URL request is handled by the system. The URL request for the web browser home page is depicted by the use case trace labeled “1.” The URL request is sent to the RockItRouter™, block 2432, contained in the RockItRouter™ broadband modem collaboration, block 2430. The RockItRouter Security System™ use case collaboration, block 2434, contains the RockItRouter™ IPsec processing (IKE) use case, block 2436. The use case trace labeled “2” between blocks 2432 and 2436 depicts the communication path of the TCP/IP packets containing the URL request. The RockItRouter™ IPsec (IKE) use case represents the IKE exchange and resulting distinction of new, roaming, and expired subscriber types, as represented by the subscriber type determination decision use case, block 2438. The RockItRouter Security System™ utilizes IKE and certificate authorization to manage TCP/IP packets during IPsec processing.

The subscriber type determination decision use case results in the system distinguishing the type of TCP/IP packet types found by the system: new, expired or roaming. The found new user use case, block 2440, found expired subscription, block 2442, and found roaming subscriber, block 2444, illustrates the TCP/IP packet distinction. The reader will recall from FIG. 11 that each distinction results in a corresponding service order fulfillment request—depicted in FIG. 11 at blocks 2252, 2248, and 2244. The generate HTTP redirect and query string back to host device use case, block 2446, illustrates the process for facilitating communication flow of URL requests from new, roaming, or expired subscriber host devices to the RockItSwitch™ for service order fulfillment processing. The use case extend connector, between blocks 2436 and 2446, illustrates that the HTTP Redirector extends the processing of the RockItRouter Security System™. After the URL redirect, and appended query string, is created, it is sent back to the host device, passing through the RockItRouter™, and arriving at the browser redirect to service order web pages use case, block 2448. The use case trace connectors labeled “3” and “4” between blocks 2446 and 2432, and 2432 and 2448, respectively, depict the communication flow of the URL redirect.

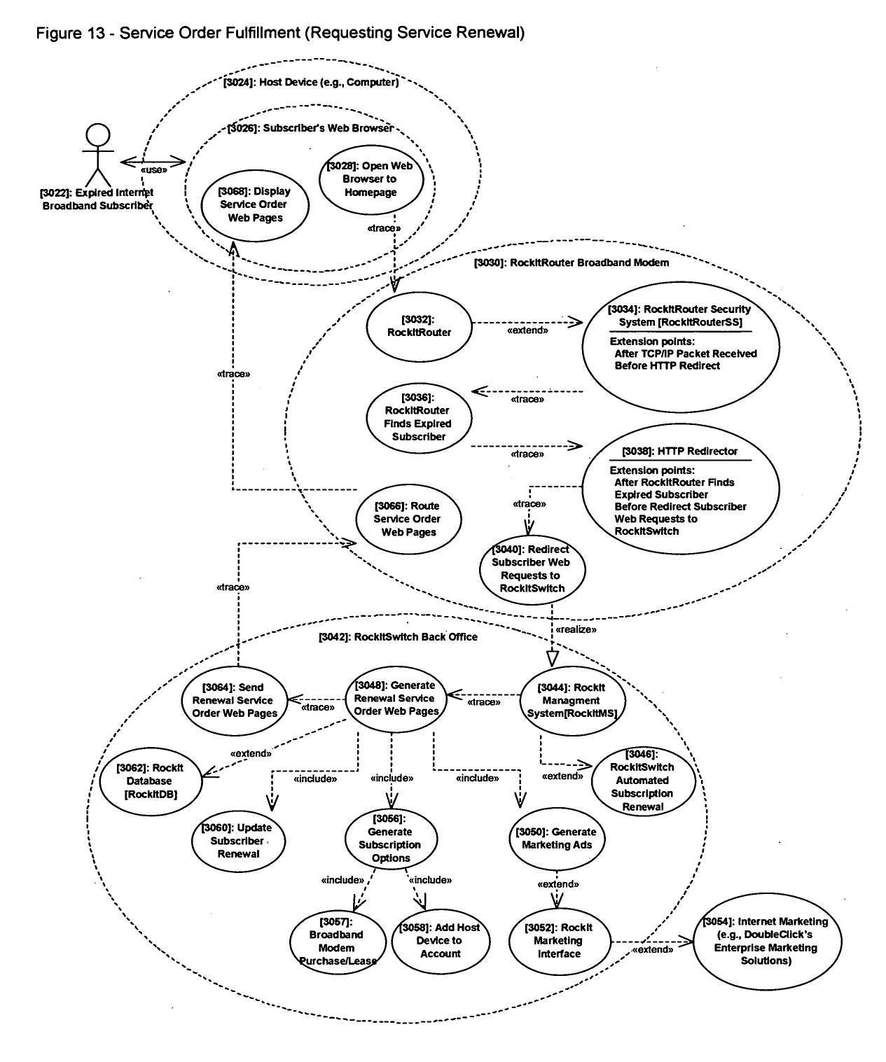

The browser redirect to service order web pages use case represents the browser's handling of the URL redirect—it is sent to the RockItSwitch™ use case collaboration, block 2450, back office for service order fulfillment. The RockIt Management System™ use case, block 2452, contained in the RockItSwitch™ use case collaboration, block 2450, receives the service order fulfillment URL, and initiates processing. The use case trace connectors labeled “5A” and “5B” illustrate the communication path for the TCP/IP packets that contain the URL redirect from block 2448, passing through, 2432—(illustrating the IPsec filter action of the RockItRouter™ for routing outgoing packets to the RockItSwitch™), and arriving at block 2452. The RockIt Management System™ use case utilizes the generate service order web pages use cases for new, expired and roaming subscribers. FIG. 12 illustrates that these use cases as the generate expired service order web page, block 2454, generate new service order web pages use case, block 2462, and the generate roaming service order web pages use case, block 2466. The use case extend connectors between blocks 2452 and 2454, 2452 and 2462, and 2452 and 2466, respectively, depict that processing is extended from the RockIt Management System™ to the individual generate service order web pages use cases. The generate new service order web pages use case, block 2462, is the same use case that is illustrated in FIG. 7 at block 1446. The generate expired service order web page and generate new service order web pages use case are similar by analogy. See FIGS. 13—Service Order Fulfillment (Requesting Service Renewal) and 16—Service Order Fulfillment (Requesting Roaming Service), and the related narratives for these drawings below.

The generate service order web pages use cases use the send service order web pages use cases to send the web pages back to the subscriber for service order fulfillment; as illustrated by the use case use between blocks 2454 and 2456, 2462 and 2464, and 2466 and 2468, respectively. Messages sent back to the subscriber's browser for display proceed from the individual send service order web pages use cases, pass through the route service order web pages use case, block 2458, contained in the RockItRouter™ broadband modem collaboration, and arrive at the display service order web pages use case, block 2460, contained in the subscriber's web browser use case collaboration. The use case trace connectors labeled “6A” “6B” and “6C” between blocks 2468 and 2458, 2464 and 2458, and 2456 and 2458, respectively, depict the flow of TCP/IP packets to from the RockItSwitch™ to the RockItRouter™. The route service order web pages, block 2458, illustrates the IPsec filter action of the RockItRouter™ for routing incoming packets from the RockItSwitch™ to the host device. The use case trace connector labeled “7” depicts the flow of communication between blocks 2458 and 2460. The display service order web pages use case, block 2460, is the same use case that is illustrated in FIG. 7 at block 1430. The display service order web pages use case for expired and roaming subscribers are similar by analogy. See FIGS. 13—Service Order Fulfillment (Requesting Service Renewal) and 16—Service Order Fulfillment (Requesting Roaming Service), and the related narratives for these drawings below.

FIG. 12 illustrates the HTTP Redirector use case and its role in the business process model for service order fulfillment.

FIG. 13 is a use case diagram that illustrates the service order fulfillment process for a requesting service renewal. This drawing is analogous to FIG. 7, Service Order Fulfillment (Requesting New Service), except that it illustrates the use case for issuing a renewal service order fulfillment request for expired subscriptions.

An expired Internet broadband subscriber actor, block 3022, uses a web browser, block 3026, on a host device, block 3024, to access the Internet. An expired Internet broadband subscriber is an Internet broadband customer with an expired subscription. A subscription may be expired for several reasons, account payment method is no longer valid (e.g., expired credit card), traditional billing methods have gone unanswered, or the subscription purchased has expired (e.g., non-recurring subscription). The open web browser to homepage use case, block 3028, illustrates the web browser request for the browser home page. The requested URL is sent to the RockItRouter™ broadband modem, block 3030.

The RockItRouter™ broadband modem collaboration contains the RockItRouter™, block 3032. The use case trace depicts the flow of TCP/IP packets between blocks 3028 and 3032. The RockItRouter™ utilizes IPsec and PKC technologies to manage all TCP/IP communications. The use case extend indicates that the RockItRouter Security System (RockItRouterSS), block 3034, use case manages the TCP/IP communications. See FIG. 11 and the FIG. 11 narrative above for the RockItRouter Security System™ processing and communications details. As illustrated by the use case extension points in block 3034, the use case starts after a TCP/IP packet is received and before the HTTP Redirector, block 3038, takes over processing for the RockItRouterSS. Following the use case trace from block 3034 to block 3036, the drawing indicates that the RockItRouter Security System™ finds an expired subscriber, as depicted by the RockItRouter™ finds expired subscriber, block 3036. The use case trace continues from block 3036 to block 3038, the HTTP Redirector use case. The HTTP Redirector extension points indicate that the use case occurs after the RockItRouter Security System™ finds an expired subscriber and before the redirect subscriber web requests to the RockItSwitch™ use case. See FIG. 24 and the FIG. 24 narrative below for the RockItRouter™ IPsec processing and communications details. The use case trace continues between blocks 3038 and 3040. Block 3040 describes the URL redirect process whereby a URL Redirect is issued back to the host device web browser for further processing. See FIG. 12 and the FIG. 12 narrative above for the URL Redirector processing and communications details.

The use case realize connector between the redirect subscriber web requests to the RockItSwitch™, block 3040, and the RockIt Management System™ (RockItMS), block 3044 illustrates the first step in the request for service renewal after HTTP Redirector processing. An alternative path not illustrated in FIG. 13, would be a direct HTTP request from the web browser to the subscription web page hosted on the RockItMS. In this scenario, a packet filter triggered during IPsec processing would route packets form the host device directly to the RockItMS, thereby bypassing the RockItRouter Security System™ and HTTP Redirector.

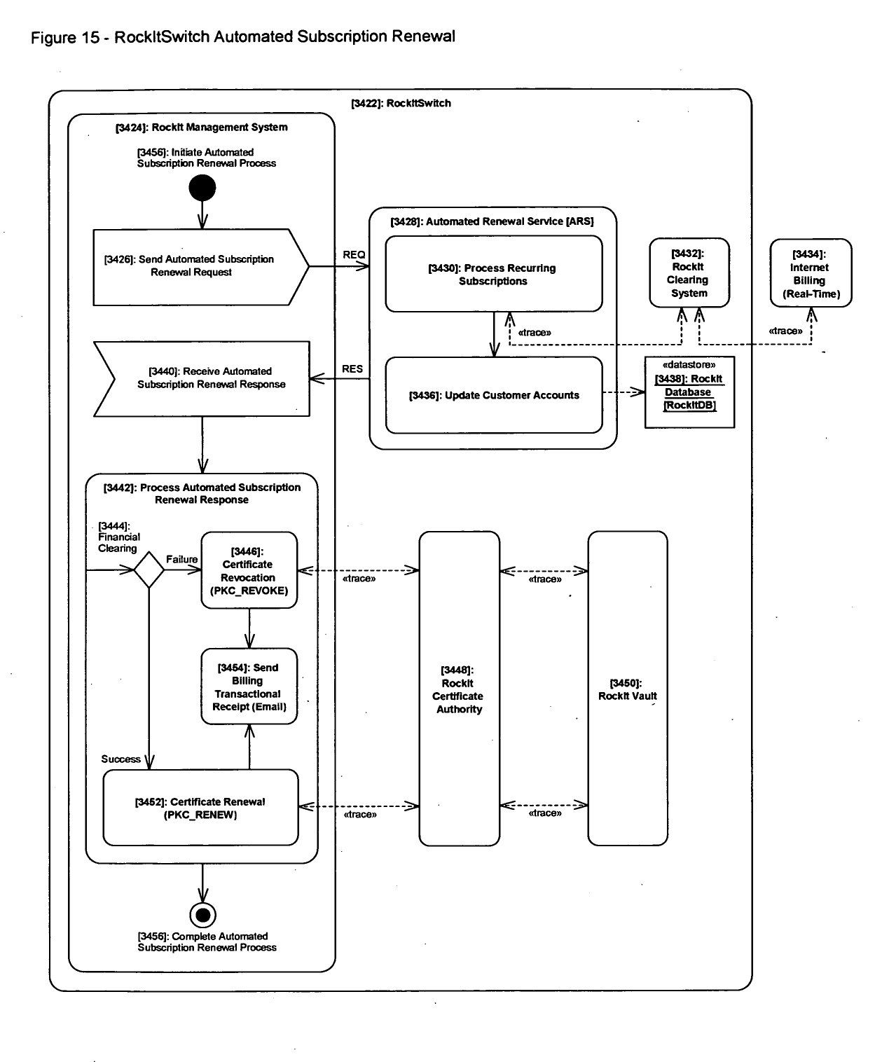

Once a URL redirect is received by the RockItMS, the URL redirect query string is parsed to determine how to process the request. The RockItSwitch™ back office collaboration use case, block 3042, illustrates the renewal service order process. Use case RockItSwitch™ automated subscription renewal, 3046, is responsible for processing recurring real-time billing for the customer's subscription. The RockItSwitch™ automated subscription renewal process automatically processes payment to renew subscriptions for customers who opt in for recurring billing. Following successful financial clearing, the PKC system, and underling updates the customer's host device certificate, is utilized by the RockItSwitch™ automated subscription renewal to sustain subscription account activation. If the automated subscription renewal financial clearing fails (e.g., expired credit card) the Service Order Fulfillment (Requesting Service Renewal) use case, that is the use case represented by FIG. 13, enables the system to automatically process customer service order requests for renewal. Customers have an automated system for updating their personal and billing information to ensure successful financial clearing, as well as an opportunity to opt in to the automated recurring financial clearing system. Moreover, in the case of customers who use traditional billing the system provides a paradigm shift in the business process model to address service revocation when subscribers do not pay their monthly bill. Internet service providers can leverage the RockIt™ business process model that enables them to issue, automatically, subscription revocation notices and a real-time system that provides customers an opportunity to make payment for past-due bills. See FIG. 15 and the FIG. 15 narrative below for the RockItSwitch™ automated subscription renewal processing and communications details. The use case extend depicts the relationship between the RockIt Management System™ and the RockItSwitch™ automated Subscription renewal use cases, blocks 3044 and 3046, respectively.

The use case trace from the RockItMS use case to the generate renewal service order web pages use case, block 3048, denotes the use case responsible for generating the service order web pages response. The generate renewal service order web pages use case includes three use cases: the generate marketing ads, block 3050, generate subscription options, block 3056, and the update subscriber renewal, block 3060. The use case include depicts the relationship between block 3048 and blocks 3050, 3056, and 3060, respectively.

The generate marketing ads sub-process, block 3050, utilizes the RockIt™ Marketing Interface, block 3052, to connect to internet marketing services for the process of generating marketing ads for the service order web pages. Use case Internet marketing (e.g., DoubleClick's Enterprise Marketing Solutions), block 3054, illustrates and Internet marketing system used to generate marketing ads. The use case extend depicts this relationship between blocks 3050, 3052 and 3054, respectively. The generate subscription options use case, block 3056, is the use case responsible for generating subscription options based on profiles that consider geographic location, special offers, cost, duration, and bandwidth. The generate subscription options use case includes to two use cases. The add host device to account use case, block 3058, represents the use case responsible for creating a “Add New Host Device” option for an active service account, whereby a customer may wish to add a host device(s) during renewal. The broadband modem purchase or lease use case, block 3057, denotes the use case responsible for creating “Broadband Modem Purchase or Lease” options for the business case where renewal customers have an option to purchase or lease a broadband modem. The use case include depicts this relationship between blocks 3056, 3058 and 3057, respectively. The update subscriber renewal use case, block 3060, is the use case responsible for updating the customer account records; it updates the subscriber account and the account association with the customer's RockItRouter™ broadband modem for future processing.

The generate renewal services order web pages use case, and related use cases, utilize the RockIt™ database (RockItDB), block 3062, for system processing. The use case extend depicts the relationship between block 3048 and 3062. The send renewal service order web pages use case, block 3064, illustrates the final processing by the RockItSwitch™, sending the service order web pages from the RockItSwitch™ back office to the route service order web pages use case, block 3066, contained in the RockItRouter™ broadband modem collaboration, block 3030. The use case trace between block 3064 and 3066 denotes the path TCP/IP packets. The route service order web pages use case, represents the IPsec filter action for the routing incoming packets from the RockItSwitch™. The use case trace between block 3066 and the display service order web pages use case, block 3068 illustrate the routed packets. The display service order web page use case represents the service order web pages that are displayed in the subscriber's web browser. The expired Internet broadband subscriber uses the web pages to renew and modify service.

FIG. 13, the Service Order Fulfillment (Requesting Service Renewal) use case, demonstrates the business process model for service order fulfillment renewal. The business process model is implemented through a system that provides network security for the home network and the Internet broadband provider network, by restricting unlimited access to Internet broadband modem to current customers. The system detects customers with expired or revoked subscriptions and redirects their TCP/IP HTTP traffic to the back office automated order entry system for service order fulfillment processing. The back office system automatically processes service orders by generating and displaying subscription options—based on profiles that consider geographic location, special offers, cost, duration, and bandwidth—for renewal customers. The back office system enables customers to purchase or lease an Internet broadband modem, and provides for automated process to add additional host devices to their existing account. The back office system also provides for automated generation and delivery of real-time marketing ad content during service order fulfillment.

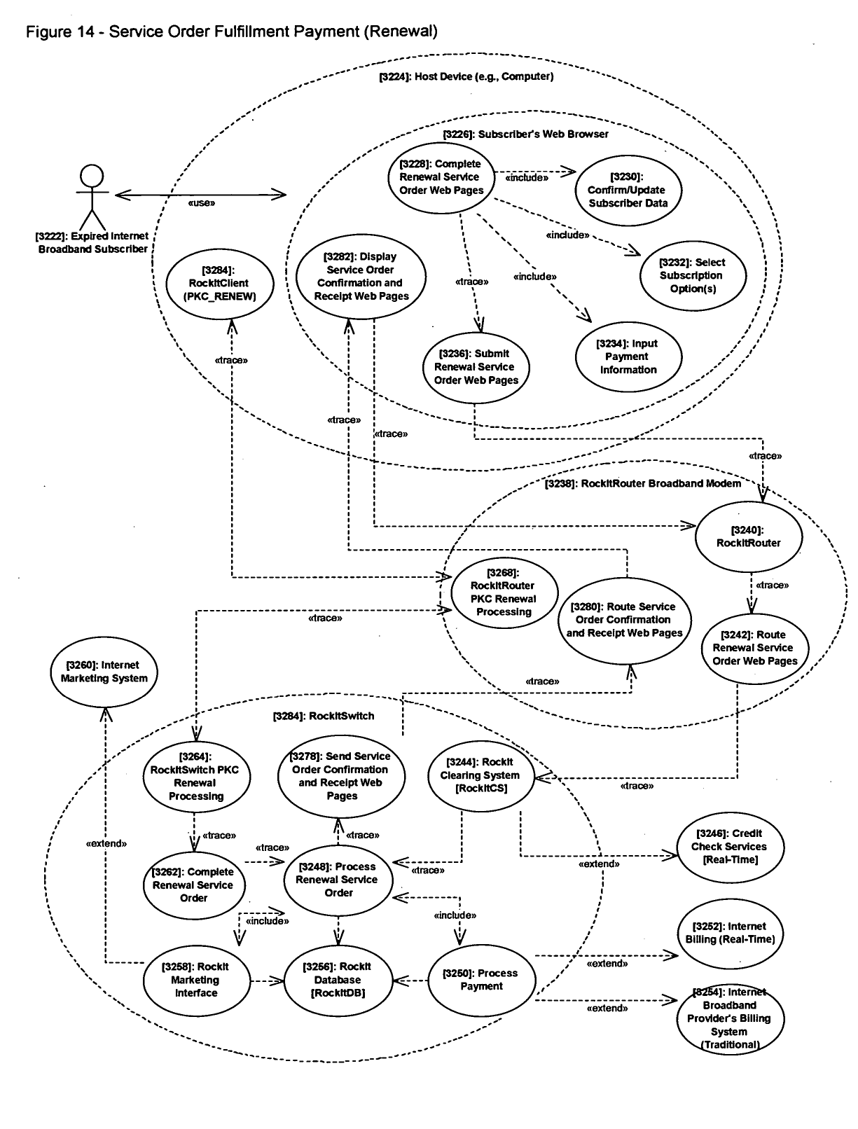

FIG. 14 is a use case diagram that illustrates the service order fulfillment use case for payment of a renewal service order request. An expired Internet broadband subscriber actor, block 3222, uses a web browser, block 3226, on a host device, block 3224, to complete payment for a renewal service order. This drawing starts where FIG. 13, display service order web pages use case, block 3068, leaves off. As the reader will recall, the display service order web pages use case, in FIG. 13, represents the service order web pages that are displayed in the subscriber's web browser. The expired Internet broadband subscriber uses the web pages to order or modify service, as represented by the complete renewal service order web pages use case, block 3228, in FIG. 14. To complete a service order, an expired customer confirms, and optionally updates, their subscriber data, inputs payment information, and selects a subscription option(s), as depicted by the use cases, confirm/update subscriber data, block 3230, input payment information, block 3234, and select subscription option(s), block 3232. The use case includes connectors depict the relationship between block 3228 and blocks 3230, 3232, and 3234, respectively.

The use case trace connector, between the complete renewal service order web pages use case, block 3228, and the submit renewal service order web pages use case, block 3236, denotes the steps the customer takes to process payment. The customer then submits the renewal service order web pages, as illustrated by use case submit renewal service order web pages, block 3236. The browser then sends the competed service order URL and query string to the RockItRouter™ broadband modem, block 3238, where it is routed via the RockItRouter™, block 3240, as represented by the use case trace connector between blocks 3236 and 3240. The use case trace connector represents the TCP/IP packet filter action of the RockItRouter™ IPsec processing between the RockItRouter™ and the route renewal service order web pages use case, block 3242. The route renewal service order web pages use case sends the competed service order URL and query string to the RockItSwitch™ use case collaboration, block 3284, for processing, and is depicted by the use case trace between blocks 3242 and 3244.

The RockIt™ Clearing System (RockItCS) use case, block 3244, is the central RockIt™ Switch process used to manage the completion of the service order. The RockIt™ Clearing System is the RockItSwitch™ process responsible for optional credit check servicing, financial clearing, generating the web pages and HTML content (e.g., service order confirmation, receipt and marketing ads), and the PKC renewal process. During the service order completion process, customers may have the option of selecting a traditional billing method, or bill in the mail, used by Internet service providers. The credit check service (real-time) use case, block 3246, represents the external systems used to perform a credit check for customers who use traditional billing. The use case extend connector depicts the relationship between blocks 3244 and 3246.

The RockIt™ Clearing System then forwards the complete service order request to the process renewal service order use case, block 3248, depicted by the use case trace connector between blocks 3244 and 3248. The process renewal service order use case manages the real-time Internet and traditional financial clearing, by passing the complete service order request to the process payment use case, block 3250. The use case include connector depicts the relationship between blocks 3248 and 3250. The process payment use case manages the financial transactions through the Internet real-time billing use case, block 3252, and Internet broadband provider's traditional billing system use case at block 3254. Payments made through the Internet real-time billing use case process Automatic Clearing House (ACH, e.g., check and debit card clearing), credit card (e.g., MasterCard and Visa), and PayPal transactions. Customers may have the option of setting up recurring billing while completing the renewal service order to provide, in real-time, automated monthly billing. The use case extend connectors depict the relationship between block 3250, and blocks 3252 and 3254, respectively.

The process renewal service order use case, utilizes the RockIt™ Marketing Interface, block 3258, to connect to the Internet marketing services use case, block 3260. The RockIt™ Marketing Interface utilizes external Internet marketing systems (e.g., DoubleClick's Enterprise Marketing Solutions) for the process of generating marketing ads for the renewal service order web pages. The use case include and extend connectors depict the relationship between blocks 3248 and 3258, and 3258 and 3260, respectively.

The process renewal service order use case issues several response web pages back to the customer to confirm the order and provide a transactional receipt (e.g., service order and payment receipt). The process renewal service order use case utilizes the send services order confirmation and receipt web pages use case, block 3278, to send web pages to the customer. Web pages are sent back to the customer through the RockItRouter™ and are handled by the route service order confirmation and receipt web pages use case, block 3280. The use case trace connector depicts the path of the sent web pages between blocks 3278 and 3280. The route service order confirmation and receipt web pages use case represents the IPsec filter action for routing incoming packets from the RockItSwitch™. The use case trace connector between block 3280 and the display service order confirmation and receipt web pages use case, block 3282, illustrate the routed packets. The display service order confirmation and receipt web pages use case represents the service order confirmation and transactional receipt web pages that are displayed in the subscriber's web browser.

The use case traces connectors, starting at block 3282, and indicating a direction toward the RockItSwitch™ collaboration use case, passing between blocks 3240, 3242, 3244, and ending at the process renewal service order use case, block 3248, illustrate the communication flow of web pages from the web browser to the RockItSwitch™, thereby to facilitate renewal service order completion.

The RockItSwitch™ processes a renewal service order in the following order: order confirmation, RockItClient™ PKC renewal, and payment processing. Customers use the service order confirmation web pages to verify their subscription options, cost, and payment information. If real-time Internet billing is utilized by the system during order confirmation, financial authorization is preformed through the process payment use case, block 3248. If a problem is encountered with payment authorization, an exchange of web pages is sent between the RockItSwitch™ and the customer that results in a successful financial authorization or the decline of the renewal service order. A successful financial authorization results in the PKC renewal processing.

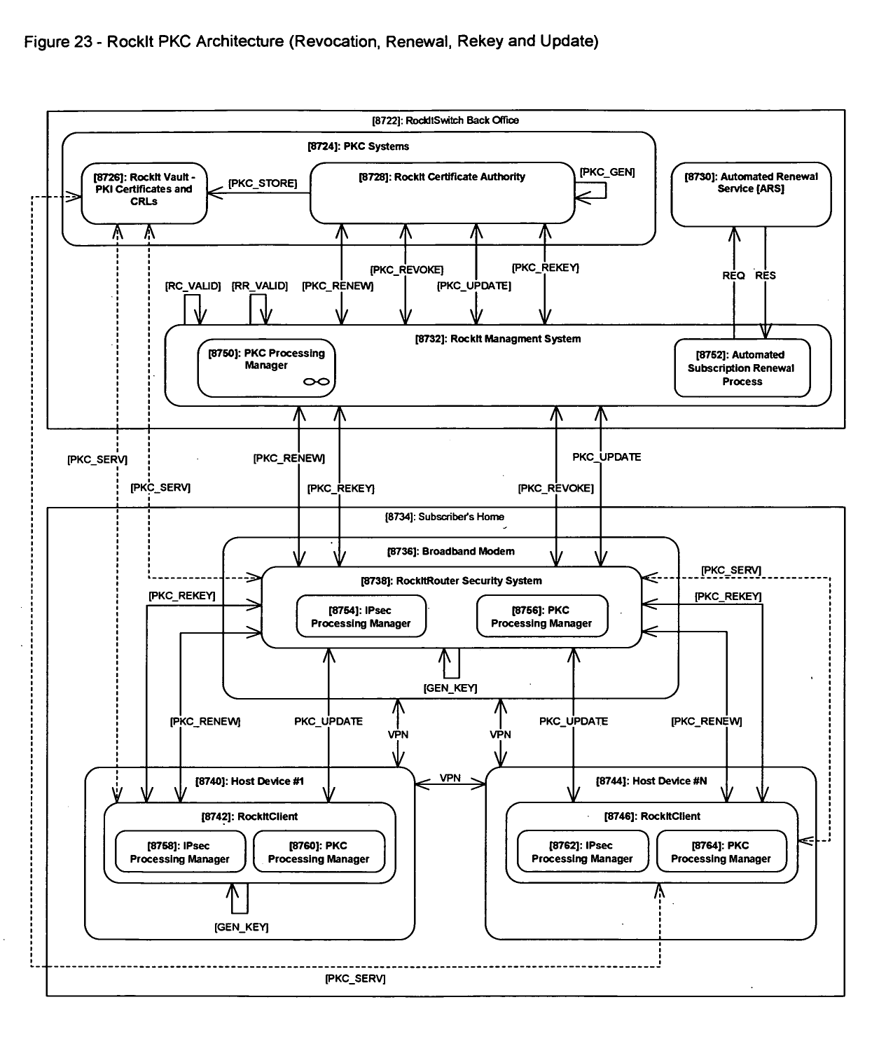

After service order confirmation, and financial authorization in the case of real-time billing, the RockItSwitch™ issues a PKC renewal request. The RockItClient™ (PKC_RENEW) use case, block 3284, sends a PKC_RENEW request to the RockItRouter™. This is illustrated by the bi-directional use case trace connector between the RockItClient™ (PKC_RENEW) use case, block 3284, and the RockItRouter™ PKC renewal processing use case, block 3268. The RockItRouter™ PKC renewal processing use case plays a pivotal role in facilitating PKC_RENEW request. See FIG. 23—RockIt™ PKC Architecture (Revocation, Renewal, Rekey and Update) and the FIG. 23 narrative below for the RockIt™ PKC Architecture (Revocation, Renewal, Rekey and Update) use case processing and communications details. Additionally, the RockItRouter™ PKC renewal processing use case is responsible for RockItRouter™ IPsec and PKC storage and configuration for each host device connected to the RockItRouter™. The RockItRouter™ PKC renewal processing use case utilizes the RockItSwitch™ back office to facilitate a PKC_RENEW request; it provides PKC_RENEW processing and coordinates request and response messages between the RockItClient™ and RockItSwitch™ back office systems: RockIt Management System™, RockIt Certificate Authority™, RockIt Vault™, and RockIt Policy Directory™. The RockItSwitch™ PKC renewal processing use case, block 3264, represents the back office systems, and their processing, for PKC renewal. The bi-directional use case trace connectors depict the communication flow between blocks 3284 and 3268, and blocks 3268 and 3264, respectively.

After the RockItRouter™ confirms successful PKC renewal to the RockItSwitch™ PKC renewal processing use case, the service order fulfillment process is marked for completion by the complete renewal service order use case, block 3262. The use case trace connector represents the relationship between blocks 3264 and 3262. The complete renewal service order use case communicates that the service order fulfillment process is ready for completion to the process renewal service order, as depicted by the trace use case connector between blocks 3262 and 3248. The process renewal service order use case then performs the financial clearing of the payment for the customer. The bi-directional use case trace connector, between blocks 3248 and 3250, depicts the communication flow between the process renewal service order and the process payment use cases. Following the completion of the financial clearing of payment, the process renewal service order use case generates and sends a service order receipt to the customer to conclude the service order fulfillment payment use case.

FIG. 14, the Service Order Fulfillment Payment (Renewal) use case, demonstrates the business process model for completing the renewal service order fulfillment payment process. The business process model is implemented through a system that provides an automated, real-time, payment process that eliminates, for customers, the time-consuming process to reorder Internet broadband service. Customers are no longer required to place telephone calls to Internet broadband provider customer service representatives, or to use an Internet broadband provider's web site, to reorder service. The typical time period to implement Internet service, resulting in days or weeks before service activation, is eliminated. Internet broadband providers reduce SAC by gaining economic efficiencies through a business process that implements real-time automation of service order processing. IBPs reduce costs by reducing labor and capital requirements of customer service and technical support representatives to process service order requests, payment, and fulfillment.

FIG. 15 is a use case diagram that illustrates the RockItSwitch™ automated subscription renewal processing. This primary back office process is responsible for processing recurring real-time billing for a customer subscription. The RockItSwitch™ automated subscription renewal process automatically processes payment to renew subscriptions for customers who opt in for recurring billing during service order fulfillment. The RockItSwitch™ activity, block 3422, contains the related UML activity, action, and decision blocks utilized in FIG. 15 to illustrate the RockItSwitch™ automated subscription renewal process.

Activity RockIt Management System™, block 3424, is the central process that is responsible for subscriptions management. The RockItMS initiates single or batch subscription renewal requests for recurring billing subscription accounts, represented by the initiate automated subscription renewal process initial UML, block 3456. The RockItMS runs a daily batch process to renew recurring billing subscription accounts. The RockItMS can also process transactions for recurring billing subscription account records; an example of the single process business case, details a subscriber, upon notification of invalid subscriber account information (e.g., credit billing address change), corrects the subscriber information, and submits payment. Following the instantiation of the automated subscription renewal process, the RockItMS sends the automated subscriptions renewal request(s), as depicted by the send automated subscription renewal requests action, block 3426, to the Automated Renewal Service (ARS), as represented by the automated renewal service activity, block 3428, for processing. The ARS listens for automated subscription renewal requests from the RockIt Management System™; the control flow connector, labeled, “REQ,” depicts the subscription renewal requests from the RockItES to the ARS. Upon receipt of REQ, the ARS processes the recurring subscriptions, as illustrated by the action, process recurring subscriptions, block 3430. Financial clearing is the primary function of the process recurring subscriptions action, as represented by the bi-directional trace use case connectors between the process recurring subscriptions action and RockIt™ Clearing System action, block 3432, and RockIt™ Clearing System action and Internet billing (real-time) action, block 3434. A transactional record is generated for each subscription renewal request. The update customer accounts action, block 3436, depicts the ARS process following financial clearing. The update customer accounts function of the ARS is used to store the financial transaction records in the RockIt™ Database, block 3438. The dependence use case connector depicts the relationship between the update customer accounts function of the ARS and the RockIt™ Database.

After storing the financial transaction records, the ARS sends the financial clearing results back to the RockItMS for further processing, as depicted by the RES control flow connector between the ARS and the receive automated subscription renewal response, block 3440. Upon receipt of RES, the RockItMS utilizes the process automated subscription renewal response activity, block 3442. The process automated subscription renewal response analyzes each automated subscription renewal response record, and any associated financial transaction result (an appended success or failure indicator and optional message), to determine the success or failure of financial clearing, as represented by the financial clearing decision, block 3444. The control flow connector between the process automated subscription renewal response activity and financial clearing decision depicts processing flow.

If the financial clearing of an automated subscription renewal response record is designated a failure (e.g., invalid credit card), the ARS utilizes the certificate revocation (PKC_REVOKE) action, block 3446, to revoke the PKC for the subscription. The bi-directional trace use case connectors between the certificate revocation (PKC_REVOKE) action and RockIt Certificate Authority™, block 3448, and RockIt Certificate Authority™ and RockIt Vault™, block 3450, respectively, illustrate the communication flow between the systems to facilitate PKC revocation.

If the financial clearing of an automated subscription renewal response record is designated a success, the ARS utilizes the certificate renewal (PKC_RENEW) action, block 3452, to renew the PKC for the subscription. The bi-directional trace use case connectors between the certificate renewal (PKC_RENEW) action and RockIt Certificate Authority™, block 3448, and RockIt Certificate Authority™ and RockIt Vault™, block 3450, respectively, illustrates the communication flow between the systems to facilitate PKC renewal. See FIG. 23 and the FIG. 23 narrative below for the RockIt™ PKC Architecture (Revocation, Renewal, Rekey, and Update) processing and communications details.

For each automated subscription renewal response record, a financial clearing transaction e-mail is sent to the customer, at block 3454 in FIG. 15, to provide the customer with a receipt for the transaction and to notify them of their account standing. In the business case of the failed automated subscription renewal response, the e-mail sent to a customer details the failure message of the automated subscription renewal response record and a payment URL addressed to the RockItMS. The payment URL enables the user to retrieve and correct information (e.g., personal and financial clearing) for real-time payment processing. Until payment is successfully processed, the PKC of the subscription is revoked; it is listed in the RockIt Vault™'s CRL and removed from the RockIt Vault™ certificate repository. If the customer fails to utilize the payment URL, all web traffic generated by the subscriber's web browser on their host device is redirected to the RockItMS for subscription renewal by the RockItRouter Security System™ and HTTP Redirector on the customer's RockItRouter™ broadband modem.

The RockIt™ system for revocation of expired customer's subscriptions allows Internet broadband providers flexibility in terms of PKC revocation policy. For example, the IBP may provide a grace period to the subscriber to make payment. In this business case the process automated subscription renewal response processing, block 3442, may generate a list of failures for delayed processing, thereby skipping the certificate revocation (PKC_REVOKE) action, block 3446 and proceeding directly to the send billing transaction receipt action. Until the PKC is revoked, the customer will have authorized access to the Internet. The RockItRouter Security System™ can also provide flexibility in generating a cohesive business case policy. The RockItRouter Security System™ can be configured to manage the security association (e.g., IPsec filter actions) and HTTP redirector to allow customers access to the Internet for a specific grace period even with the PKC in the CRL. In this case, the RockItRouter Security System can activate the HTTP Redirector to redirect the customer's web requests on a time interval basis. For example, the RockItRouter Security System™, utilizing the HTTP Redirector, can be configured to redirect web traffic each time the security association renews.

The complete automated subscription renewal process action, block 3456, depicts the completion of the automated renewal process. The control flow connector between the process automated subscription renewal response activity and the complete automated subscription renewal process action, illustrates processing flow.

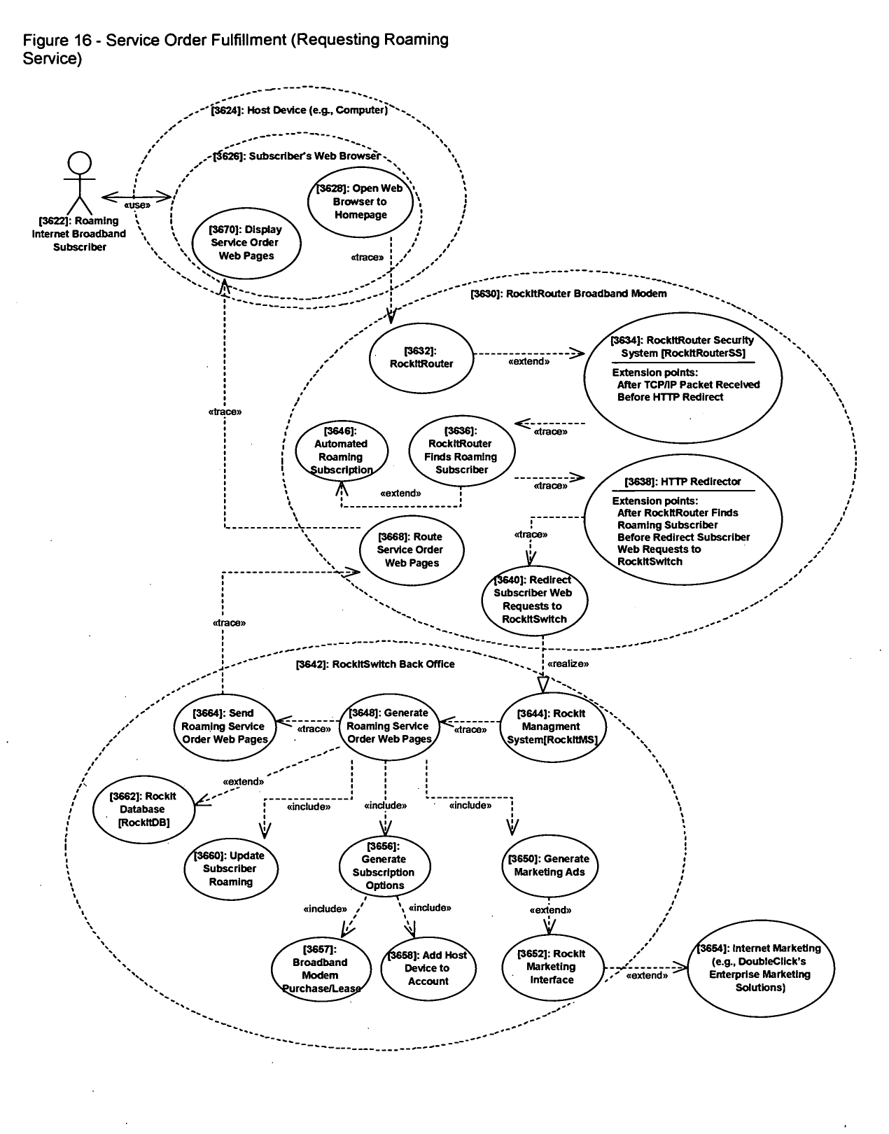

FIG. 16 is a use case diagram that illustrates the roaming service order fulfillment process for customers requesting roaming service. This drawing is analogous to FIG. 13—Service Order Fulfillment (Requesting Service Renewal), except that it illustrates the use case for issuing a service order fulfillment request for roaming subscriptions.

A roaming Internet broadband subscriber actor, block 3622, uses a web browser, block 3626, on a host device, block 3624, to access the Internet. A roaming Internet broadband subscriber is an Internet broadband customer with a roaming subscription. A roaming subscription enables subscribers to roam across the Internet broadband provider's network. Roaming subscribers can use their host device (e.g., laptop or handheld) on a neighbor's or friend's Internet broadband connection. The RockIt™ business process model extends the roaming capability beyond a single Internet broadband provider network. It supports a business case for roaming a single Internet broadband provider network, as well as a business case for roaming across multiple Internet broadband provider networks. As an example, if Comcast and SBC have a roaming agreement in place and both utilize the RockIt™ business process model, Comcast and SBC customers, with roaming subscriptions, can access the Comcast and SBC networks. Furthermore, an Internet broadband provider can offer roaming subscriptions for a single network or multiple networks.

The open web browser to homepage use case, block 3628, illustrates the web browser request for the browser home page. The requested URL is sent to the RockItRouter™ broadband modem, block 3630. The RockItRouter™ broadband modem collaboration contains the RockItRouter™, block 3632. The use case trace depicts the flow of TCP/IP packets between blocks 3628 and 3632. The RockItRouter™ utilizes IPsec and PKC technologies to manage all TCP/IP communications. The use case extend indicates that the RockItRouter Security System™ (RockItRouterSS), block 3634, use case manages the TCP/IP communications. See FIG. 11 and the FIG. 11 narrative above for the RockItRouter Security System™ processing and communications details. As illustrated by the use case extension points in block 3634, the use case starts after a TCP/IP packet is received and before the HTTP Redirector, block 3638, takes over processing for the RockItRouterSS. Following the use case trace from block 3634 to block 3636, FIG. 16 indicates that the RockItRouter Security System™ finds a roaming subscriber, as depicted by the RockItRouter™ finds roaming subscriber, block 3636. See FIG. 24 and the FIG. 24 narrative below for the RockItRouter™ IPsec processing and communications details.

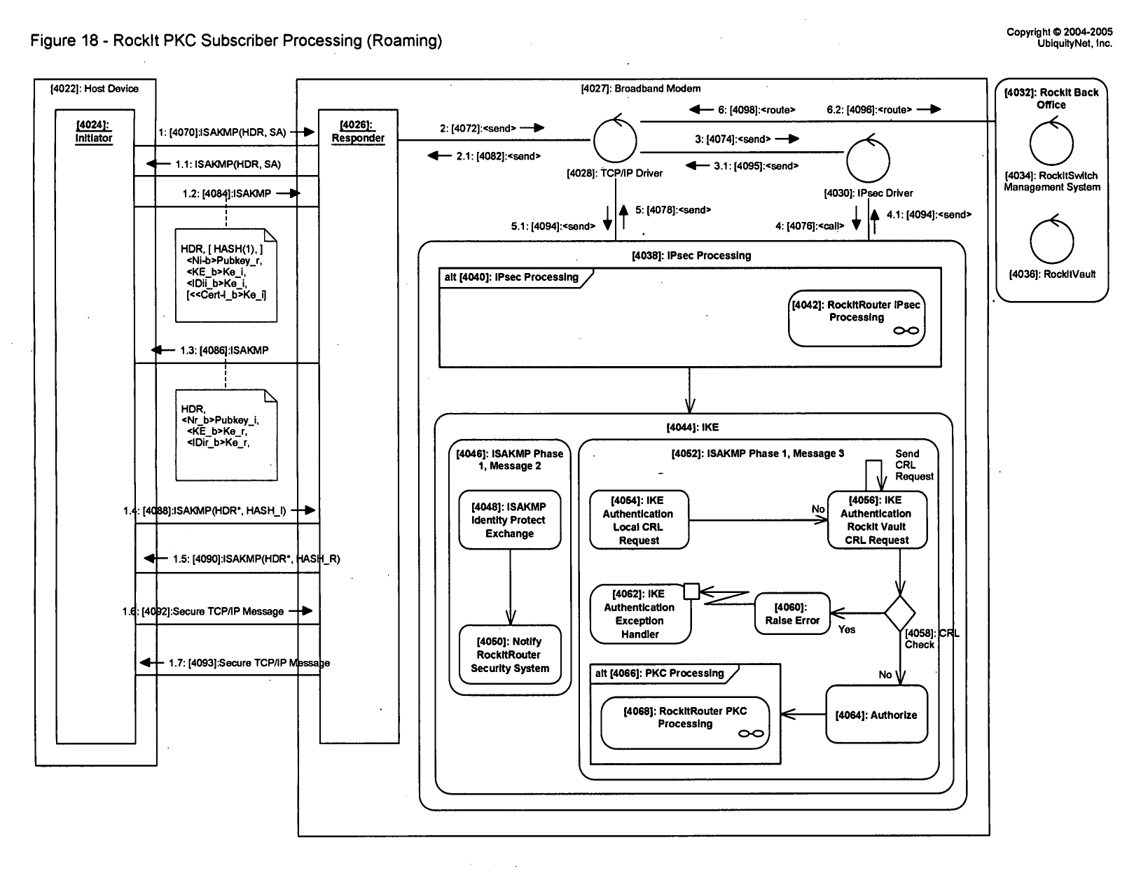

The automated roaming subscription use case, block 3646, automatically processes roaming service requests, as depicted by the use case extend connector between blocks 3636 and 3646. In this case, a customer with a roaming subscription is roaming the Internet broadband provider's network, perhaps utilizing a friend's connection. If during IPsec authorization of the roaming subscriber's host device the subscriber's certificate is found to be current and valid for roaming services, but the PKC information is not found locally on the RockItRouter™, the RockItRouter Security System™ checks the PKC against the RockItSwitch™ back office certificate revocation list (CRL). Additionally, the RockItRouter Security System™ may issue a PKC confirmation request to the RockIt Management System™, seeking an integrity check of the certificate. See FIG. 18—RockIt™ PKC roaming subscriber processing and the FIG. 18 narrative below for the RockIt™ PKC roaming subscriber processing and communications details.

If the PKC is not listed in the RockItSwitch™ CRL, and optionally, if the PKC integrity is verified by the RockIt Management System™, the RockItRouter Security System™ IPsec processing authorizes the subscriber's host device for accessing the network and stores the certificate locally. If the certificate is invalid, the RockItRouter Security System™ utilizes the HTTP redirector to instantiate a roaming service order fulfillment request. Additionally, the RockItRouter Security System™, through utilization of the HTTP Redirector, automates roaming service order fulfillment requests for customers with a current non-roaming account, a roaming account that falls outside a roaming service area, or a roaming account from a different Internet broadband provider. The RockIt™ business process model for roaming subscribers enables Internet service providers to offer roaming service plans based on geographic service areas and across Internet broadband provider networks.

The use case extend depicts the relationship between the RockIt Management System™ and the automated roaming subscription use cases, blocks 3644 and 3646. The use case trace connector continues from RockItRouter™ finds roaming subscriber, block 3636, to the HTTP Redirector use case, block 3638. The HTTP Redirector extension points indicate that the use case occurs after the RockItRouter Security System™ finds a roaming subscriber and before the redirect subscriber web requests to the RockItSwitch™ use case. The use case trace continues between blocks 3638 and 3640. Block 3640 describes the URL redirect process whereby a URL Redirect is issued back to the host device web browser for further processing. See FIG. 12 and the FIG. 12 narrative above for the URL Redirector processing and communications details.

The RockItSwitch™ back office collaboration use case, block 3642, illustrates the roaming service order fulfillment process. The use case realize connector between the redirect subscriber web requests to the RockItSwitch™, block 3640, and the RockIt Management System™ (RockItES), block 3642, illustrates the first step in the request for roaming service after HTTP Redirector processing. An alternative path not illustrated in FIG. 16, would be a direct HTTP request from the web browser to the subscription web page hosted on the RockItMS. In this scenario, a packet filter triggered during IPsec processing would route packets from the host device directly to the RockItMS, thereby bypassing the RockItRouter Security System™ and HTTP Redirector. Such an alternative process path is contemplated as being within the spirit and scope of the invention.

Once a URL redirect is received by the RockItMS, the URL redirect query string is parsed to determine how to process the request. The use case trace from the RockItMS use case to the generate roaming service order web pages use case, block 3648, denotes the use case responsible for generating the service order web pages response. The generate roaming service order web pages use case includes three use cases: the generate marketing ads, block 3650, generate subscription options, block 3656, and the update subscriber roaming, block 3660. The use case include depicts the relationship between block 3648 and blocks 3650, 3656, and 3660, respectively.

The generate marketing ads sub-process, block 3650, utilizes the RockIt™ Marketing Interface, block 3652, to connect to Internet marketing services for the process of generating marketing ads for the service order web pages. Use case Internet marketing (e.g., DoubleClick's Enterprise Marketing Solutions), block 3654, illustrates and Internet marketing system used to generate marketing ads. The use case extend depicts this relationship between blocks 3650, 3652 and 3654, respectively. The generate subscription options use case, block 3656, is the use case responsible for generating subscription options based on profiles that consider geographic location, special offers, cost, duration, and bandwidth. The generate subscription options use case includes two use cases. The add host device to account use case, block 3658, represents the use case responsible for creating a “Add New Host Device” option for an active service account, whereby, a customer may wish to add a host device(s) during a roaming service order request. The broadband modem purchase or lease use case, block 3657, denotes the use case responsible for creating “Broadband Modem Purchase or Lease” options for the business case where roaming customers have an option to purchase or lease a broadband modem. The use case include depicts this relationship between blocks 3656, 3658 and 3657, respectively. The update subscriber roaming use case, block 3660, is the use case responsible for updating the customer account records; updating the subscriber account and the account association with the currently used RockItRouter™ broadband modem for future processing.

The generate renewal services order web pages use case, and related use cases, utilize the RockIt™ database (RockItDB), block 3662, for system processing. The use case extend depicts the relationship between block 3648 and 3662. The send renewal service order web pages use case, block 3664, illustrates the final processing by the RockItSwitch™, sending the service order web pages from the RockItSwitch™ back office to the route service order web pages use case, block 3668, contained in the RockItRouter™ broadband-modem collaboration, block 3630. The use case trace between block 3664 and 3668 denotes the path traversed by the TCP/IP packets. The route service order web pages use case, represents the IPsec filter action for the routing incoming packets from the RockItSwitch™. The use case trace between block 3668 and the display service order web pages use case, block 3670, illustrates the routed packets. The display service order web page use case represents the service order web pages that are displayed in the subscriber's web browser. The roaming Internet broadband subscriber uses the web pages to order roaming and/or modify other service options.

FIG. 16, the Service Order Fulfillment (Requesting Roaming Service) use case, demonstrates the business process model for roaming service order fulfillment. The business process model is implemented through a system that provides network security for the home network and the Internet broadband provider network, by restricting unlimited access to Internet broadband modem to current and roaming customers. The system detects customers with non-roaming subscriptions and redirects their TCP/IP HTTP traffic to the back office automated order entry system for service order fulfillment processing. The back office system automatically processes service orders by generating and displaying subscription options—based on profiles that consider geographic location, special offers, cost, duration, and bandwidth—for roaming customers. The back office system enables customers to purchase or lease an Internet broadband modem, and provides for automated process to add additional host devices to their existing account. The back office system also provides for automated generation and delivery of real-time marketing ad content during service order fulfillment.

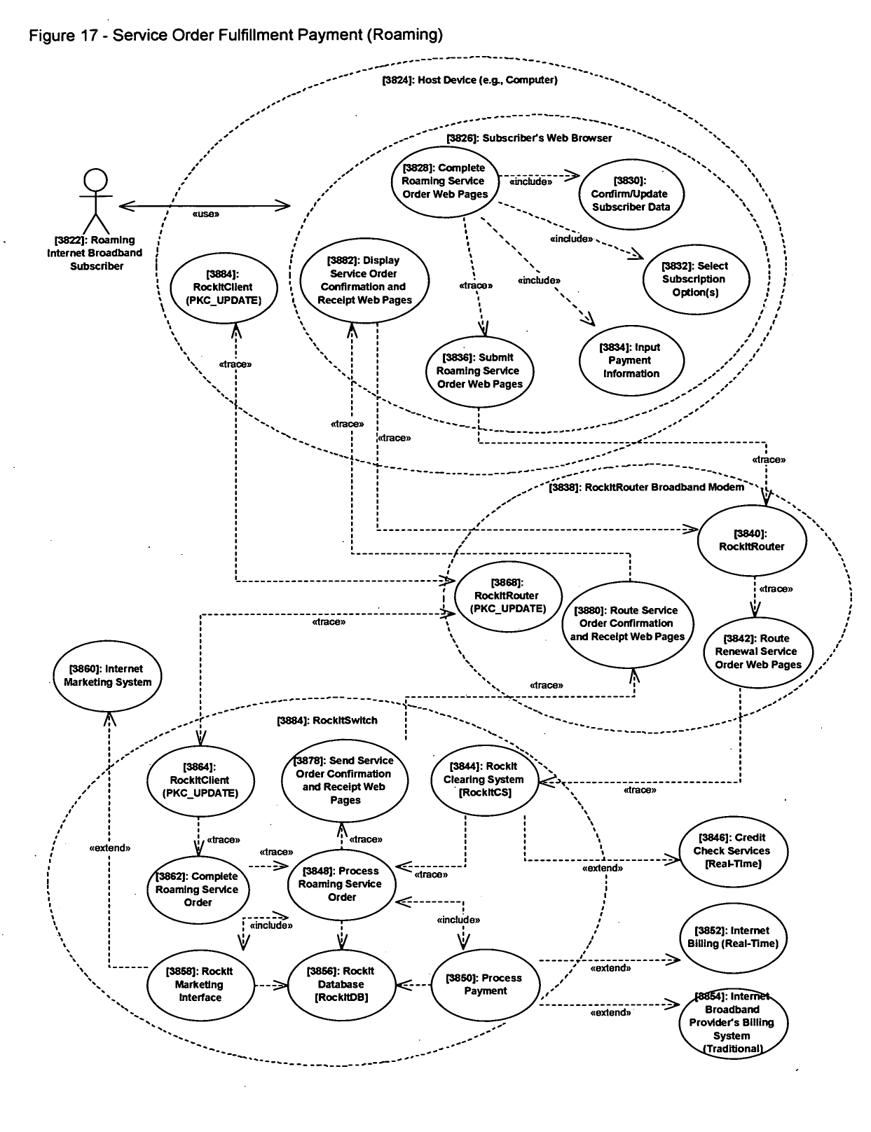

FIG. 17 is a use case diagram that illustrates the service order fulfillment use case for payment of a roaming service order request. A roaming Internet broadband subscriber actor, block 3822, uses a web browser, block 3826, on a host device, block 3824, to complete payment for a roaming service order. This drawing starts where FIG. 16, display service order web pages use case, block 3670, leaves off. As the reader will recall, the display service order web pages use case, in FIG. 16, represents the service order web pages that are displayed in the subscriber's web browser. The roaming Internet broadband subscriber uses the web pages to order or modify service, as represented by the complete roaming service order web pages use case, block 3828, in FIG. 17. To complete a service order, a roaming customer confirms, and optionally updates, their subscriber data, inputs payment information, and selects a subscription option(s), as depicted by the use cases, confirm/update subscriber data, block 3830, input payment information, block 3834, and select subscription option(s), block 3832. The use case includes connectors depict the relationship between block 3828 and blocks 3830, 3832, and 3834, respectively.

The use case trace connector between the complete roaming service order web pages use case, block 3828, and the submit roaming service order web pages use case, block 3836, denotes the steps the customer takes to process payment. The customer then submits the roaming service order web pages, as illustrated by use case submit roaming service order web pages, block 3836. The browser then sends the completed service order URL and query string to the RockItRouter™ broadband modem, block 3838, where it is routed via the RockItRouter™, block 3840, as represented by the use case trace connector between blocks 3836 and 3840. The use case trace connector represents the TCP/IP packet filter action of the RockItRouter™ IPsec processing between the RockItRouter™ and the route roaming service order web pages use case, block 3842. The route roaming service order web pages use case sends the completed service order URL and query string to the RockItSwitch™ use case collaboration, block 3884, for processing, and is depicted by the use case trace between blocks 3842 and 3844.

The RockIt™ Clearing System use case, block 3844, is the central RockIt™ Switch process used to manage the completion of the service order. The RockIt™ Clearing System is the RockItSwitch™ process responsible for optional credit check servicing, financial clearing, generating the web pages and HTML content (e.g., service order confirmation, receipt and marketing ads), and the PKC update process. During the service order completion process, customers may have the option of selecting a traditional billing method, or bill in the mail, used by Internet service providers. The credit check service (real-time) use case, block 3846, represents the external systems used to perform a credit check for customers who use traditional billing. The use case extend connector depicts the relationship between blocks 3844 and 3846.

The RockIt™ Clearing System then forwards the complete service order request to the process roaming service order use case, block 3848, depicted by the use case trace connector between blocks 3844 and 3848. The process roaming service order use case manages the real-time Internet and traditional financial clearing, by passing the complete service order request to the process payment use case, block 3850. The use case include connector depicts the relationship between blocks 3848 and 3850. The process payment use case manages the financial transactions through the Internet real-time billing use case, block 3852, and Internet broadband provider's traditional billing system use case at block 3854. Payments made through the Internet real-time billing use case process Automatic Clearing House (ACH, e.g., check and debit card clearing), credit card (e.g., MasterCard and Visa), and PayPal transactions. Customers may have the option of setting up recurring billing while completing the roaming service order to provide, in real-time, automated monthly billing. The use case extend connectors depict the relationship between block 3850, and blocks 3852 and 3854, respectively.

The process roaming service order use case, utilizes the RockIt™ Marketing Interface, block 3858, to connect to the Internet marketing services use case, block 3860. The RockIt™ Marketing Interface utilizes external Internet marketing systems (e.g., DoubleClick's Enterprise Marketing Solutions) for the process of generating marketing ads for the roaming service order web pages. The use case include and extend connectors depict the relationship between blocks 3848 and 3858, and 3858 and 3860, respectively.

The process roaming service order use case issues several response web pages back to the customer to confirm the order and provide a transactional receipt (e.g., service order and payment receipt). The process roaming service order use case utilizes the send services order confirmation and receipt web pages use case, block 3878, to send web pages to the customer. Web pages are sent back to the customer through the RockItRouter™ and are handled by the route service order confirmation and receipt web pages use case, block 3880. The use case trace connector depicts the path of the sent web pages between blocks 3878 and 3880. The route service order confirmation and receipt web pages use case, block 3880, represents the IPsec filter action for routing incoming packets from the RockItSwitch™. The use case trace connector between block 3880 and the display service order confirmation and receipt web pages use case, block 3882, illustrate the routed packets. The display service order confirmation and receipt web pages use case represents the service order confirmation and transactional receipt web pages that are displayed in the subscriber's web browser.

The use case traces connectors, starting at block 3882, and indicating a direction toward the RockItSwitch™ collaboration use case, passing between blocks 3840, 3842, 3844, and ending at the process roaming service order use case, block 3848, illustrate the communication flow of web pages from the web browser to the RockItSwitch™, thereby to facilitate roaming service order completion.

The RockItSwitch™ processes a roaming service order in the following order: order confirmation, RockItClient™ PKC update, and payment processing. Customers use the service order confirmation web pages to verify their subscription options, cost, and payment information. If real-time Internet billing is utilized by the system during order confirmation, financial authorization is preformed through the process payment use case, block 3848. If a problem is encountered with payment authorization, an exchange of web pages is sent between the RockItSwitch™ and the customer, and results in a successful financial authorization or the decline of the roaming service order. A successful financial authorization results in the PKC update processing.

After service order confirmation, and financial authorization in the case of real-time billing, the RockItSwitch™ issues a PKC update request. The RockItClient™ (PKC_UPDATE) use case, block 3884, sends a PKC_UPDATE request to the RockItRouter™. This is illustrated by the bi-directional use case trace connector between the RockItClient™ (PKC_UPDATE) use case and RockItRouter™ PKC update processing use case, block 3868. The RockItRouter™ PKC update processing use case plays a pivotal role in facilitating PKC_UPDATE request. See FIG. 23—RockIt™ PKC Architecture (Revocation, Renewal, Rekey, and Update) and the FIG. 23 narrative below for the RockIt™ PKC Architecture (Revocation, Renewal, Rekey, and Update) use case processing and communications details. Additionally, the RockItRouter™ PKC update processing use case is responsible for RockItRouter™IPsec and PKC storage and configuration for each host device connected to the RockItRouter™. The RockItRouter™ PKC update processing use case utilizes the RockItSwitch™ back office to facilitate a PKC_UPDATE request; it provides PKC_UPDATE processing and coordinates request and response messages between the RockItClient™ and RockItSwitch™ back office systems: RockIt Management System™, RockIt Certificate Authority™, RockIt Vault™, and RockIt Policy Directory™. The RockItSwitch™ PKC update processing use case, block 3864, represents the back office systems, and their processing, for PKC update. The bi-directional use case trace connectors depict the communication flow between blocks 3884 and 3868, and blocks 3868 and 3864, respectively.

After the RockItRouter™ confirms successful PKC update to the RockItSwitch™ PKC update processing use case, the service order fulfillment process is marked for completion by the complete roaming service order use case, block 3862. The use case trace connector represents the relationship between blocks 3864 and 3862. The complete roaming service order use case communicates that the service order fulfillment process is ready for completion to the process roaming service order, as depicted by the trace use case connector between blocks 3862 and 3848. The process roaming service order use case then performs the financial clearing of the payment for the customer. The bi-directional use case trace connector, between blocks 3848 and 3850, depicts the communication flow between the process roaming service order and the process payment use cases. Following the completion of the financial clearing of payment, the process roaming service order use case generates and sends a service order receipt to the customer to conclude the service order fulfillment payment use case.

FIG. 17, the Service Order Fulfillment Payment (Roaming) use case, demonstrates the business process model for completing the roaming service order fulfillment payment process. The business process model is implemented through a system that provides an automated, real-time, payment process that eliminates, for customers, the time consuming process to reorder Internet broadband service. Customers are no longer required to place telephone calls to Internet broadband provider customer service representatives, or to use an Internet broadband provider's web site, to reorder service. The typical time period to implement Internet service, resulting in days or weeks before service activation, is eliminated. Internet broadband providers reduce SAC by gaining economic efficiencies through a business process that implements real-time automation of service order processing. IBPs reduce costs, by reducing labor and capital requirements of customer service and technical support representatives to process service order requests, payment, and fulfillment.

FIG. 18 is a communication diagram that illustrates the RockIt™ PKC roaming subscriber processing. The RockIt™ PKC roaming subscriber processing provides the communication and processing details for authorizing a roaming subscriber. This drawing starts where FIG. 16, service order fulfillment (requesting roaming service) use case, block 3646, leaves off. As the reader will recall, the automated roaming subscription use case, in FIG. 16, represents the use case responsible for processing roaming requests, wherein a roaming customer is using a RockItRouter™ that has no knowledge of the customer's host device.

The automated roaming subscription process automatically processes roaming service requests for the RockItRouter Security System™. In this case, a customer with a roaming subscription is roaming the Internet broadband provider's network, perhaps utilizing a friend's connection, as depicted by block 4027. Upon connecting a host device, block 4022, to the RockItRouter™ broadband modem, an IKE key exchange, via the Internet Security Association and Key Management Protocol (ISAKMP), between the two devices sets up EPsec communications. The host device is said to be the initiator, block 4024, and the RockItRouter™ broadband modem is said to be the responder, block 4026, of the ISAKMP main mode negotiation exchange.

Those of skill in the art will appreciate the system's IKE implementation, and more specifically, the phase 1 authentication with revised mode of public key exchange. The communication association connector, block 4070, represents the ISAKMP phase 1, message 1, sent to the responder. The ISAKMP phase 1 negotiation exchange, is further illustrated by the communication association connectors, phase 1, message 2, block 4082; phase 1, message 3, block 4084; phase 1, message 4, block 4086; phase 1, message 5, block 4088; and phase 1, message 6, block 4090. The resulting secure TCP/IP message, depicted by the communication association connector, block 4092, illustrates successful main mode authentication establishing IPsec communications between the initiator and responder.

At the beginning of the ISAKMP negotiation exchange, the responder receives the ISAKMP message via its LAN network interface and forwards the message to the TCP/IP driver, block 4028, managing the interface, as depicted by the communication association connector, block 4072. The TCP/IP driver in turn sends the ISAKMP message to the IPsec Driver, block 4030, depicted by the communication association connector, block 4074. The IPsec driver is coupled to the TCP/IP driver to provide IPsec processing; it monitors, decrypts, and secures inbound unicast Internet Protocol (IP) packets and monitors and secures outbound unicast IP packets transported through the RockItRouter™ broadband modem system. The IPsec driver utilizes the IPsec processing service, represented by the IPsec Processing activity, block 4038. The communication and processing details of the IPsec processing are illustrated by the diagram fragment, block 4040, and the RockItRouter™ IPsec processing subactivity, block 4042, contained within the IPsec Processing diagram fragment. See FIG. 24—RockItRouter™ IPsec Processing and the FIG. 24 narrative below for the RockItRouter™ IPsec processing and communications details. The IPsec processing activity utilizes the IKE activity, block 4044, to processes the ISAKMP exchange negotiation, as represented by the control flow connector between blocks 4040 and 4044.

The first activity of note, contained in the IKE activity, is the ISAKMP phase 1, message 2 activity, block 4046, responsible for generating the responder ISAKMP phase 1, message 2. The main mode instantiation of the ISAKMP identity protection exchange action, block 4048, generates the ISAKMP header (HDR) and security association (SA) negotiation payload that is sent back to the initiator. The ISAKMP identity protection exchange action is responsible for notifying the RockItRouter Security System™ of the ISAKMP identity protection exchange for future processing during phase 1, message 3, as depicted by notify the RockItRouter Security System™ action, block 4050, and the control flow connector between blocks 4048 and 4050. The ISAKMP phase 1, message 2 is sent back to the initiator through the TCP/IP driver, as illustrated by the communication association connector, block 4078, between the IPsec processing activity and the TCP/IP driver. The TCP/IP driver then sends the ISAKMP phase 1, message 2 via the LAN port on the RockItRouter™ broadband modem to the initiator, depicted by the communication association connector, block 4082.

The initiator's RockItClient™ software processes the ISAKMP phase 1, message 2, and sends ISAKMP phase 1, message 3 back to the responder, as depicted by the communication association connector, block 4084. ISAKMP phase 1, message 3 is passed to the IKE activity, via the TCP/IP driver, IPsec driver, and IPsec processing activity and the communication association connectors, blocks 4072, 4074, and 4076. The ISAKMP phase 1, message 3 activity, block 4052, illustrates the IKE processing of ISAKMP phase 1, message 3, that contains the PKC as requested in the ISAKMP phase 1, message 2 SA negotiation payload proposal. The IKE authorization processing of the PKC is illustrated by the actions depicted in block 4052.

The PKC is checked against the local certificate revocation list (CRL) through the RockItRouter Security System™, as represented by the IKE authorization local CRL request action, block 4054. The local CRL check decision, block 4055, and the control flow connector between blocks 4054 and 4055, illustrates the IKE activity analysis of the local CRL check.

If the local CRL check decision is true the ISAKMP proceeds normally and an IKE authentication exception handler is raised, as depicted by the process error and authorize action, block 4060, and the control flow connector, labeled, “Yes,” between blocks 4055 and 4060, and IKE authentication exception handler, block 4062, and the interrupt flow connector between blocks 4060 and 4062. The ISAKMP identity protection exchange proceeds normally to establish IPsec communications between the initiator and responder—that is, the ISAKMP phase 1, message 3, results in the ISAKMP phase 1, message 4 being created and sent back to the initiator. The RockItRouter Security System™ processes the IKE authentication exception handler and configures the RockItRouter™ broadband modem to redirect customer outbound TCP/IP requests to the RockItSwitch™ back office for renewal service order fulfillment. The RockItRouter Security System™ configuration process dynamically generates IPsec rules for the host device and stores them in the security policy database for future processing. The resulting IPsec rules associate the IPsec filters for the host device with filter actions configured to drop all outbound TC/IP packets from the customer's host device, except packets destined to ports 80, 8080, and 443. See FIG. 24—FIG. 24—RockItRouter™ IPsec Processing and the FIG. 24 narrative above for the FIG. 24—RockItRouter™ IPsec processing and communications details.

If the PKC is not listed in the local CRL, the PKC is checked against the RockIt Vault's™ CRL, as illustrated by the IKE authentication RockIt Vault™ CRL request action, block 4056, and the control flow connector, labeled, “No,” between blocks 4055 and 4056. The IKE authentication RockIt Vault™ CRL request action sends a CRL request to the RockIt Vault™ located in the RockItSwitch™ back office, as depicted by the self-message association connector, labeled, “Send CRL Request.” IKE utilizes the RockItRouter Security System™ to send CRL check request messages to the RockIt™ back office for processing, as depicted by the bi-directional control flow connector between blocks 4044 and 4069. Messages sent between the RockItRouter Security System™ and the RockIt™ back office can be sent directly through the TCP/IP driver, as depicted by the communication connectors at blocks 4078 and 4096, and 4098 and 4094. Messages between the two systems can also use IPsec communications, as illustrated by the communication connectors at blocks 4094, 4095 and 4096, and 4098, 4074 and 4076, respectively.

The CRL check request message arrives at the RockItSwitch™ back office activity, block 4032, which contains the RockIt™ Management System, block 4034, and the RockIt Vault™, block 4036. The RockIt Vault™ handles the CLR check requests by checking the PKC against the CRL. The result of the CRL check is sent to the RockItRouter Security System™ and IKE authentication RockIt Vault™ CRL request action via communication association connectors, at blocks 4098 and 4094. The IKE authentication RockIt Vault™ CRL request action processes the result message from the RockIt Vault™ to determine if the PKC is listed in the RockIt Vault™ CRL, as depicted by the RockIt Vault™ CRL check decision, block 4058.

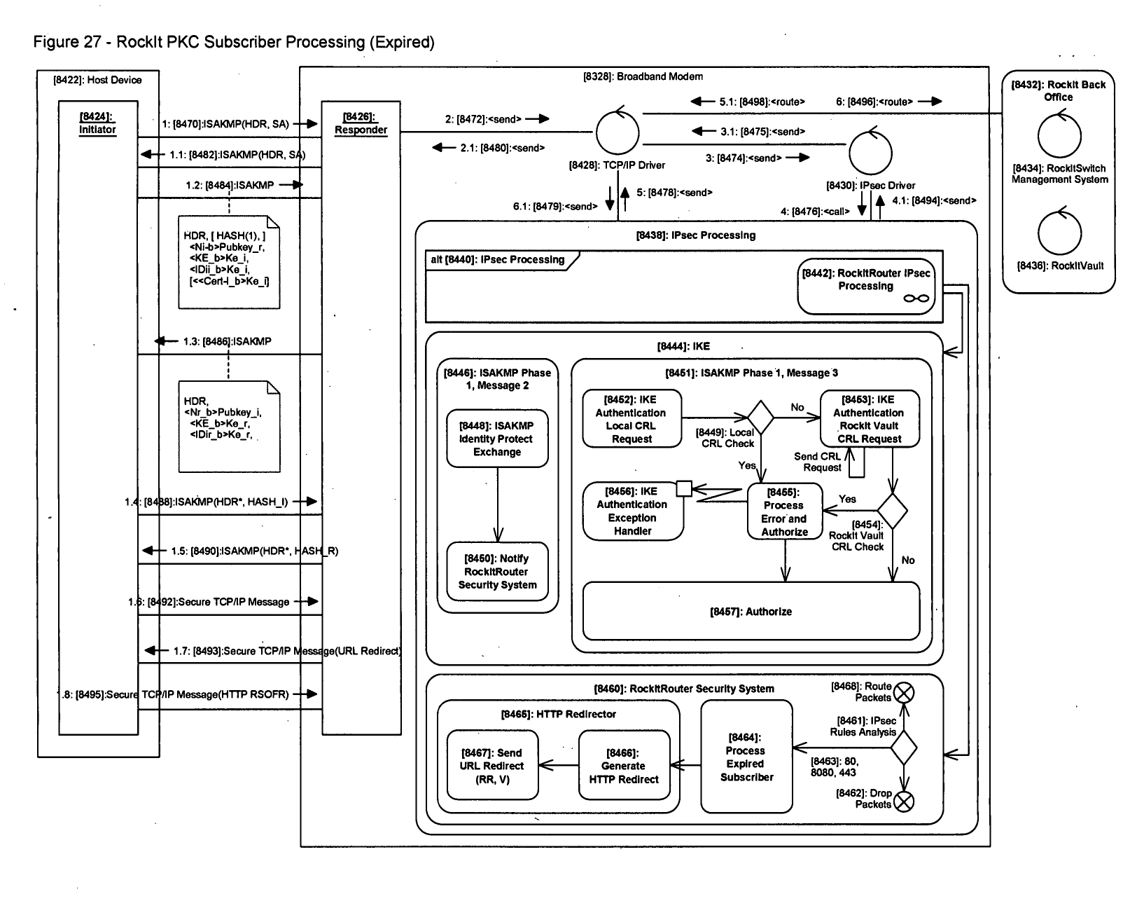

If the RockIt Vault™ CRL check decision is true, then the ISAKMP proceeds normally; however, the ISAKMP Phase 1, Message 3 activity raises an error to the RockItRouter Security System™, which redirects the customer to the renewal service order fulfillment process—as illustrated above when the local CRL check decision is true. The ISAKMP Phase 1, Message 3 activity processing, when the RockIt Vault™ CRL check decision is true, is depicted by the process error and authorize action, block 4060, and the control flow connector, labeled, “Yes,” between the RockIt Vault™ CRL check decision and block 4060, and the IKE authentication exception handler action and the interrupt flow connector between blocks 4060 and 4062. See FIG. 27—RockIt™ PKC Subscriber Processing (Expired) and the FIG. 27 narrative above for the RockIt™ PKC processing and communications details for expired accounts.

If the CRL check decision is false, then IKE authorizes the ISAKMP identity protection exchange, as depicted by the authorize action, and the control flow connector, labeled, “No,” between blocks 4058 and 4064. As detailed above, the authorize action generates the ISAKMP phase 1, message 4 and the system proceeds thereafter to complete the ISAKMP identity protection exchange.

The resulting secure TCP/IP message, depicted by the communication association connector, block 4092, illustrates successful main mode authentication establishing IPsec communications between the initiator and responder. The host device RockItClient™ software utilizes IPsec to monitor and secures outbound unicast IP packets destined to the Internet, or other RockItClient™ host devices on the WLAN/LAN, via the broadband modem. IPsec communications destined to the Internet are received by the RockItRouter™ broadband modem TCP/IP driver, via communication association connector 4072, proceed to the IPsec Driver, via communication association connector 4074, and proceed to the IPsec Processing action, via communication association connector 4076.

Conversely, TCP/IP communications destined to a RockItClient™ host device from the Internet are received by the RockItRouter™ broadband modem TCP/IP driver, via communication association connector 4098, proceed to the IPsec Driver, via communication association connector 4074, and proceed to the IPsec Processing action, via communication association connector 4076. IPsec Processing action encrypts the TCP/IP communication and sends the packet to the IPsec driver, via communication association connector 4094, where it is sent to the TCP/IP driver, via communication association connector 4095. The TCP/IP driver then sends the secured communication to the RockItClient™ host device via communication association connectors 4082 and 4093.

Those of skill in the art will appreciate that the RockItRouter™ broadband modem can also facilitate IPsec communications between RockItClient™ host devices on the WLAN/LAN.

Concurrent with authorization to facilitate IPsec communications between the RockItRouter™ broadband modem and the RockItClient™ host device, the IKE activity stores the roaming customer's certificate through the RockItRouter Security System™, as represented by the PKC process diagram fragment, block 4066, and the RockItRouter™ PKC processing subactivity, block 4068, and the control flow connector between blocks 4064 and 4066. This effectively reduces ISAKMP phase 1, message 3 processing and response times for future ISAKMP identity protection exchanges that take place when SAs timeout or when a roaming customer uses the RockItRouter™ broadband modem at a later date.

Additionally, the RockItRouter Security System™ can validate the integrity of a PKC through a PKC confirmation request to the RockItSwitch™ Management System at block 4034. Integrity checks provide an additional layer of system security. Moreover, the RockItRouter Security System™ and RockIt™ Management System can use this mechanism to provide for automated roaming service order fulfillment requests for customers with a roaming account that falls outside a roaming service area or with a roaming account from a different Internet broadband provider. The RockIt™ business process model for roaming subscribers thus enables Internet service providers to offer roaming service plans based on geographic service areas and across Internet broadband provider networks. In these business use cases, the PKC confirmation request is processed by the RockIt™ Management System to check the subscriber's account to determine access authorization for different geographic service areas and across Internet broadband provider networks. The PKC confirmation response that is sent back from the RockIt™ Management System to the RockItRouter Security System™ provides the system information to determine how to process the customer's access to the network. By analogy, the RockItRouter Security System™ utilizes the same system processing depicted in the ISAKMP Phase 1, Message 3 activity at block 4052.

The IKE authentication RockIt Vault™ CRL request, block 4056, becomes the IKE authentication RockItSwitch™ CRL and PKC confirmation requests. The control flow self-send CRL Request becomes the CRL and PKC confirmation requests. The requests are sent to the RockItSwitch™ back office for processing; the RockIt™ Management System handles the CRL and PKC confirmation requests. The RockIt™ Management System sends back a CRL and PKC confirmation response to the RockItRouter Security System™, where the ISAKMP Phase 1, Message 3 activity continues processing. The RockIt Vault™ CRL Check decision, block 4058, becomes the CRL and PKC confirmation decision. The CRL and PKC confirmation decision then analyzes the CRL check and PKC confirmation accordingly.

If the CRL and PKC confirmation decision returns true then the appropriate error is raised via the process error and authorize action, block 4060, the IKE authentication exception handler, block 4062, and the interrupt flow connector between block 4060 and 4062, to handle the following cases:
a roaming service order fulfillment request for a subscriber who wants to extended geographic or additional Internet broadband provider access to their account;
a roaming service order fulfillment request for a current and valid customer who wants to extend roaming access to their account; and/or
a renewal service order fulfillment request for a customer with an expired subscription, or certificate.

If the CRL and PKC confirmation decision returns false, then IKE authorizes the ISAKMP identity protection exchange, as depicted by the authorize action, block 4064, the control flow connector labeled “No” between blocks 4058 and 4064. The ISAKMP phase 1, message 4 is generated and the system proceeds thereafter to complete the ISAKMP identity protection exchange. The resulting secure TCP/IP message, depicted by the communication association connector, block 4092, illustrates successful main mode authentication establishing IPsec communications between the initiator and responder. Concurrent with authorization to facilitate IPsec communications between the RockItRouter™ broadband modem and the RockItClient™ host device, the IKE activity stores the roaming customer's certificate through the RockItRouter Security System™, as represented by the PKC process diagram fragment, block 4066, and the RockItRouter™ PKC processing subactivity, block 4068, and the control flow connector between blocks 4064 and 4066.

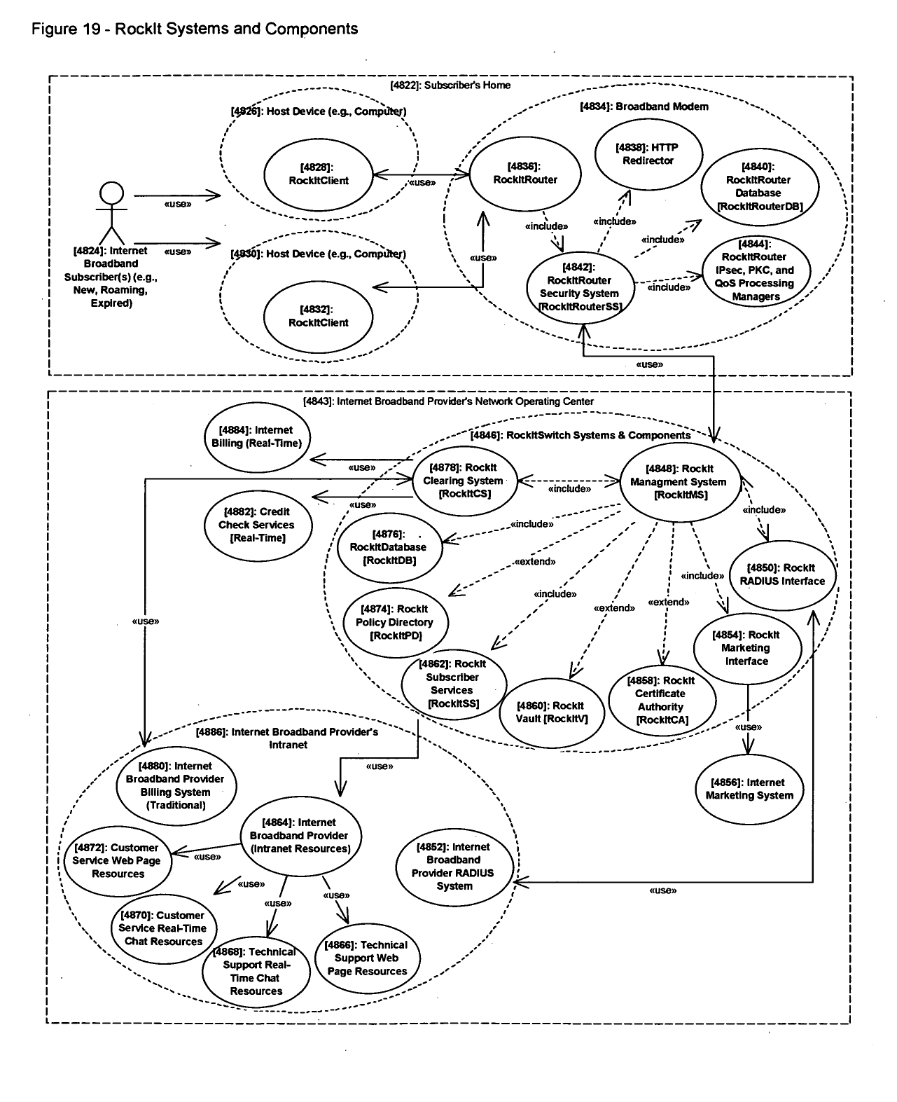

FIG. 19 is a use case diagram that illustrates the RockIt™ Systems and Components resident in the Subscriber's Home and Internet Broadband Provider's Network Operating Center. The subscriber's home boundary, block 4822, illustrates the RockIt™ systems and components found in the customer's home. The Internet broadband subscriber(s) (e.g., New, Roaming, or Expired) actor, block 4824, depicts a new, roaming, or expired Internet broadband subscriber. The subscriber uses their host devices to access the Internet, as illustrated by the host devices, blocks 4826 and 4830, the RockItClient™ software installed on the host devices, blocks 4828 and 4832, respectively, and the use connectors between blocks 4834 and 4826, and 4834 and 4830, respectively. RockItClient™ software is the primary system installed on host devices to implement the RockIt™ business process. The host devices utilize the broadband modem, block 4834, and the RockItRouter™ software on the broadband modem, block 4836, to access the Internet. This is illustrated by the bi-directional use connectors between blocks 4828 and 4836, and 4832 and 4836, respectively.

The RockItRouter™ software includes the RockItRouter Security System™, block 4842, as illustrated by the include connector between blocks 4836 and 4842. The RockItRouter Security System™ includes several sub-systems and components, the HTTP Redirector, block 4838, RockItRouter™ Database, block 4840, and RockItRouter™ IPsec, PKC, and QoS Processing Managers at block 4844. This is illustrated by the include connectors between blocks 4842 and 4838, 4842 and 4840, and 4842 and 4844, respectively.

The RockItRouter™ broadband modem utilizes various systems in the RockItSwitch™ back office at block 4846, located in the Internet broadband provider's network operating system boundary, block 4843. The RockIt Management System™, block 4848, is the primary system in the RockItSwitch™ back office that provides the EPsec, PKC, and QoS framework implementation, as well as service order fulfillment and account processing. The RockIt Management System™ includes the following sub-systems: RockIt™ Clearing System™, block 4878, RockIt™ database, block 4876, RockIt Subscriber Services™, block 4862, RockIt Marketing Interface™, block 4854, and the RockIt RADIUS Interface™ at block 4850. The include connectors depicts the relationship between blocks 4848 and 4878, 4848 and 4876, 4848 and 4862, 4848 and 4854, and 4848 and 4850, respectively.

The RockIt Clearing System™ utilizes Internet billing, block 4884, and credit check services, block 4882, systems, as well as the Internet broadband provider billing system, block 4880, to facilitate customer billing during service order fulfillment and account processing. The use connectors depict the relationship between blocks 4878 and 4884, 4878 and 4882, and 4878 and 4880, respectively. The RockIt Subscriber Services™ utilizes the Internet broadband provider Intranet resources, block 4864, and its external systems—the customer service web page resources, block 4872, customer real-time chat resources, block 4870, technical support real-time chat resources, block 4868, and technical support web page resources at block 4866—to provide customer and technical support services during service order fulfillment and account processing. The use connectors depict the relationship between blocks 4862 and 4864, 4864 and 4872, 4864 and 4870, 4864 and 4868, and 4864 and 4866, respectively. The RockIt Marketing Interface™ utilizes Internet marketing systems, block 4856, located in the Internet Broadband Provider's Network Operating Center, block 4843, to generate marketing content ads during service order fulfillment and account processing. The use connector depicts the relationship between blocks 4854 and 4856. The RockIt RADIUS Interface™ utilizes the Internet broadband provider RADIUS systems, located in the Internet broadband provider Intranet, to facilitate network provisioning during service order fulfillment and account processing. The use connector depicts the relationship between blocks 4850 and 4852.

In addition, the RockIt Management System™ utilizes several external systems to facilitate IPsec, PKC, and QoS framework implementation, as well as service order fulfillment and account processing. These systems include the RockIt Policy Directory™, block 4874, RockIt Vault™, block 4860, RockIt Certificate Authority™ at block 4858.

The diagrams and respective narratives that follow provide the processing and communication details of each of the systems and components detailed above.

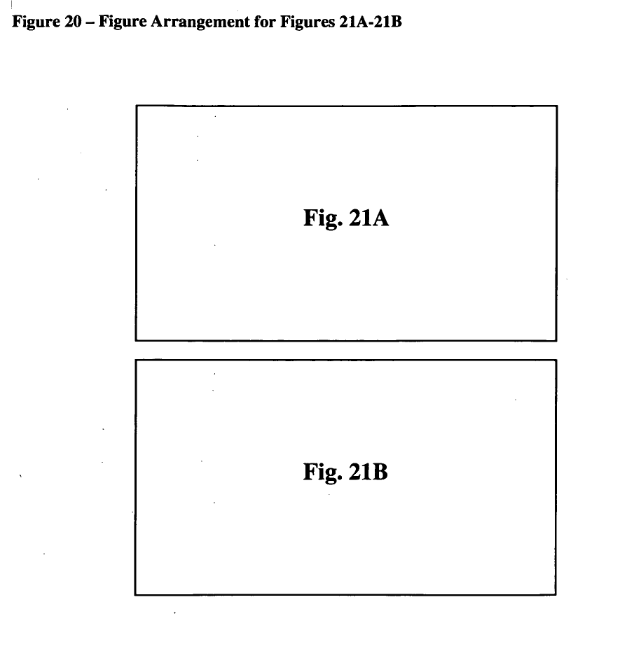

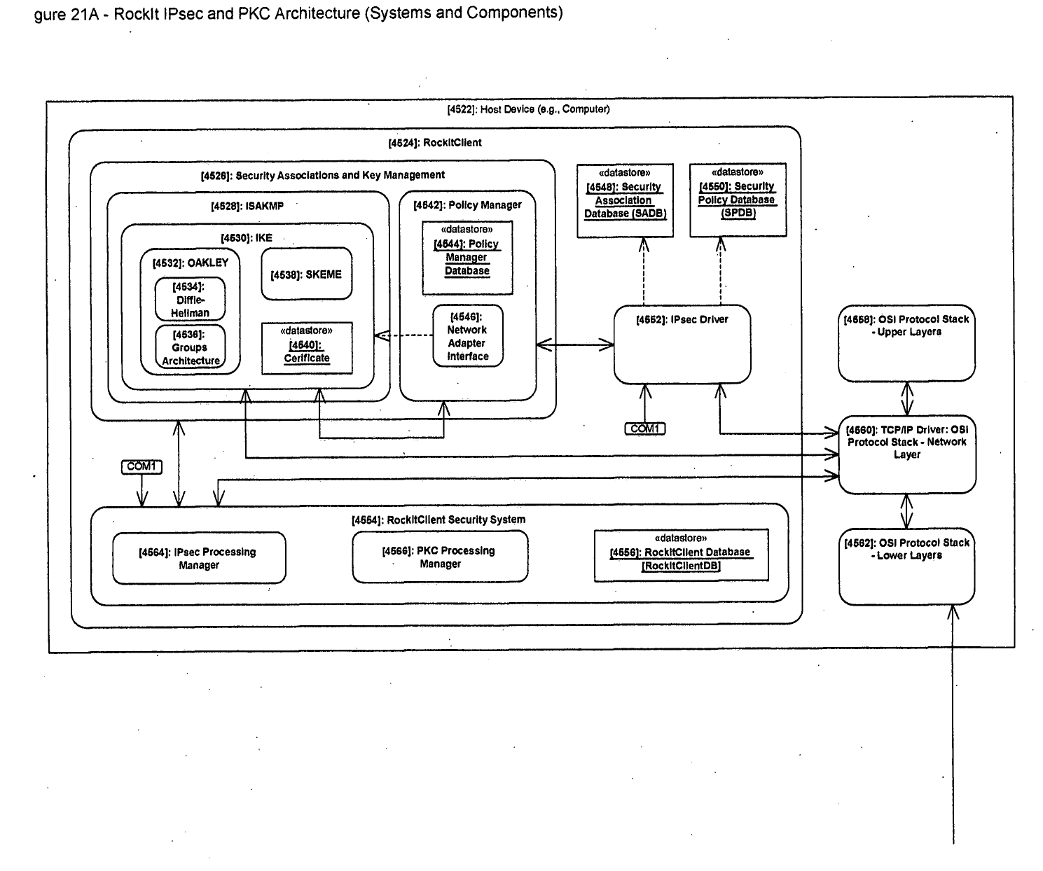

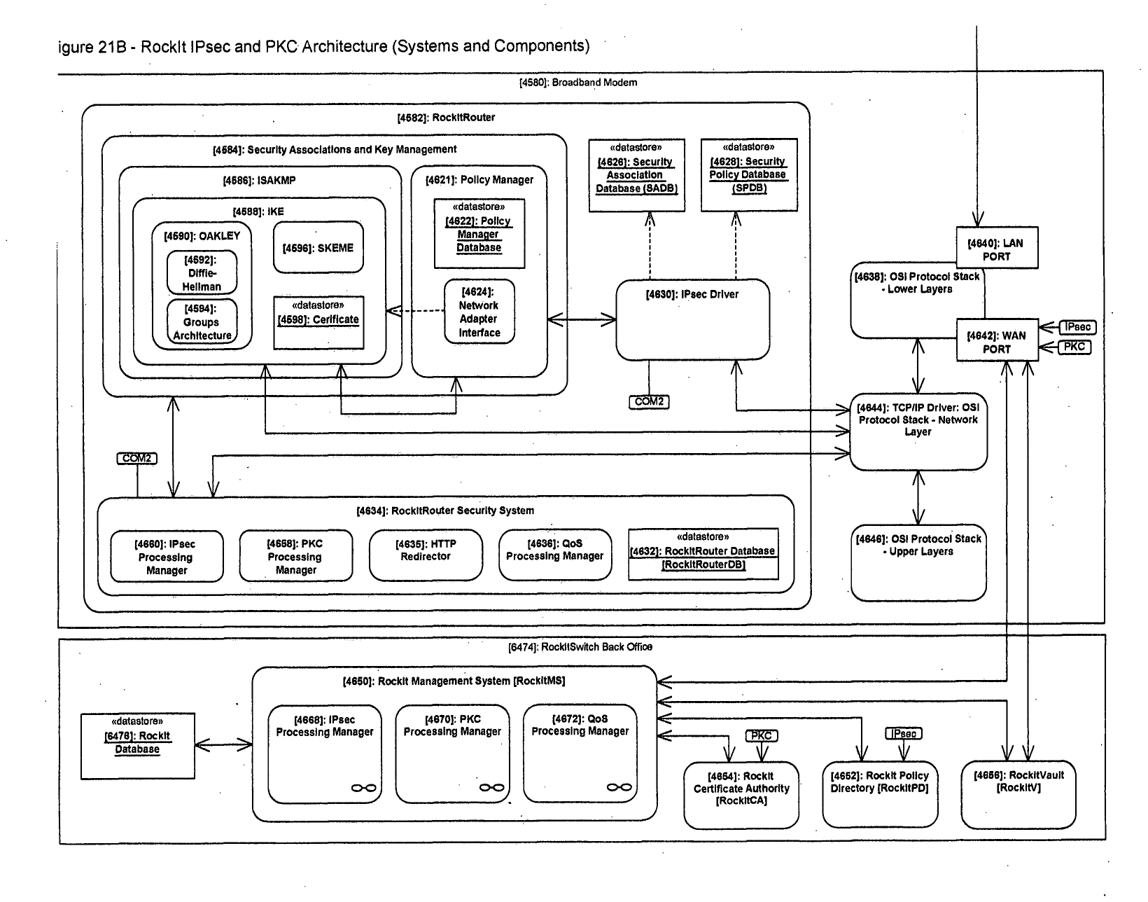

FIG. 20 is a high-level layout diagram that illustrates the proper arrangement of FIGS. 21A-21B for comprehensive viewing.

FIGS. 21A-21B are high-level activity diagrams that illustrate the RockIt™ IPsec, PKC, and QoS architecture components, processes and communication details for the RockItClient™, RockItRouter™, and RockItSwitch™ systems. Those of skill in the art will appreciate the IPsec PKC, and QoS architecture components, processes and communications details illustrated in the drawings, as well as the architecture components, processes and communications extensions provided by the RockItClient™, RockItRouter™, and RockItSwitch™ systems to mandate, automate and manage network security, authorization, and quality of service for customer's host devices connected to a RockIt™ Router broadband modem, resulting in network performance (including throughput, transmit delay, priority) and security for a customer's host devices, and their WLAN/LAN network, and their access to the Internet broadband provider network.

FIG. 21A illustrates a host device use case boundary, block 4522, and the activities and actions contained within that depict the architecture components, processes and communications details of the RockItClient™, block 4524. The RockItClient™ software illustrates the typical IPsec and PKC components, processes, and communication details that make up its IPsec and PKC subsystems. Of particular note are the security associations and key management activity, block 4526, security association database (SADB), block 4548, the security policy database (SPDB), block 4550, and the IPsec driver, block 4552.

The security associations and key management activity contains the ISAKMP activity, block 4528, and the policy manager activity at block 4542. The ISAKMP activity contains the IKE activity, block 4530. The IKE activity contains the OAKLEY activity, block 4532, SKEME action, block 4538, and certificate datastore at block 4550. The OAKLEY activity contains the Diffie-Hellman action, block 4534, and the groups architecture action at block 4536. The policy manager activity contains the policy manager database, block 4544, and the network adapter interface at block 4546.

The host device also contains the OSI protocol stack—upper layers action, block 4558, the TCP/IP driver: OSI protocol stack—network layer action, block 4560, and the OSI protocol stack—lower layers action at block 4562. Those of skill in the art will appreciate the IPsec and PKC architecture communications details illustrated between said subsystem components and processes. Specifically, the bi-directional control flow connector between the blocks 4558 and 4560, and 4560 and 4562, respectively. These control flow connectors depict the TCP/IP communications of the host device TCP/IP network stack.

Those of skill in the art will appreciate the IPsec and PKC architecture communications illustrated by the bi-directional control flow connectors between blocks 4560 and 4552, 4552 and 4542, 4542 and 4530, and 4530 and 4560, respectively, as well as the dependency connectors between blocks 4552 and 4548, 4552 and 4550, and 4546 and 4530, respectively. These control flow connectors depict the communications of the IPsec and PKC between the RockItClient™ and TCP/IP stack subsystems.

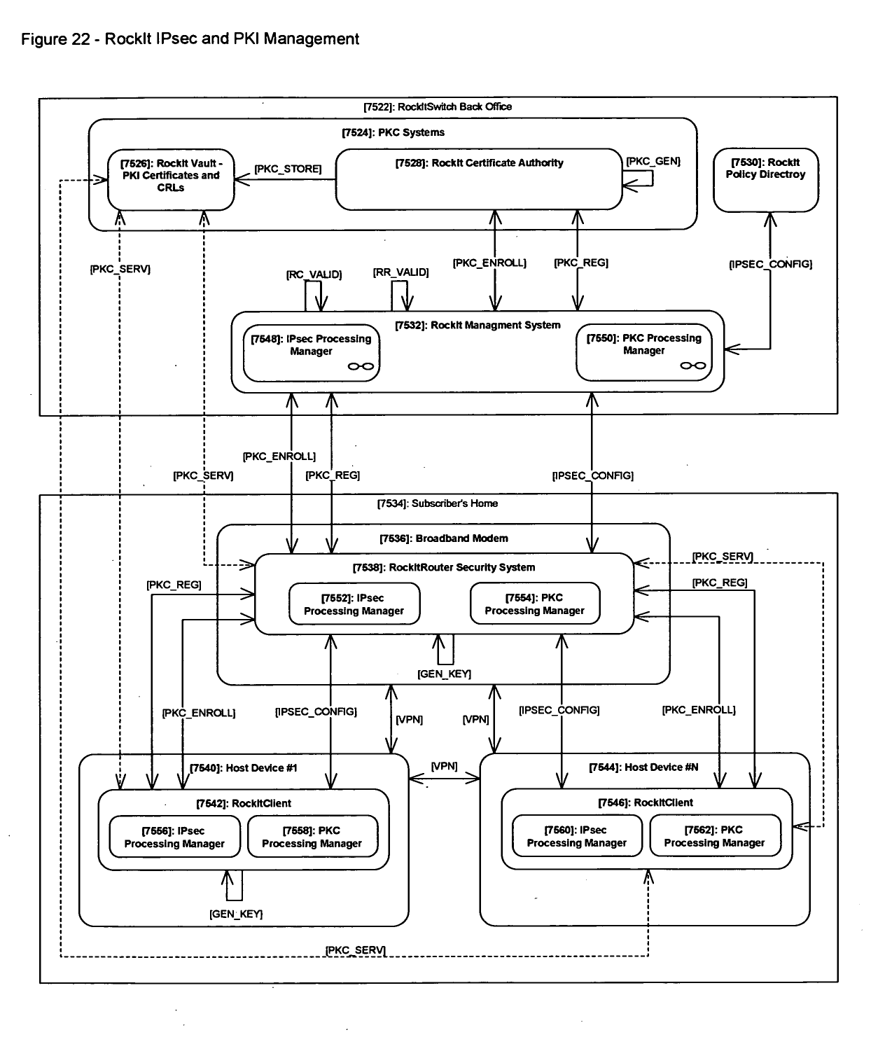

The RockIt™ technologies that make the IPsec and PKC subsystem processing of the RockItClient™ unique are found in RockItClient Security System™ activity at block 4554. The RockItClient Security System™ contains several actions that illustrate the IPsec and PKC components, processes, and communication details that comprise the subsystem and its ability to mandate, automate, and manage network security and authorization for a customer's host devices connected to a RockItRouter™ broadband modem. The IPsec processing manager, block 4564, manages the RockIt™ IPsec framework communication, processing, configuration, and maintenance for the RockItClient™ IPsec subsystems. The PKC processing manager, block 4566, manages the RockIt™ PKC framework communication, processing, configuration, and maintenance for the RockItClient™ PKC subsystems. The RockItClient™ database, block 4556, is the datastore for RockItClient™ IPsec and PKC subsystems. The bi-directional control flow connectors between blocks 4554 and 4560, 4554 and 4526, respectively, and the bi-directional control flow connectors with the segments labeled “COM1” (between blocks 4554 and 4552; between blocks 4554 and 4526) illustrate the communications between the RockItClient Security System™ IPsec and PKC subsystems and datastore, and the RockItClient™ security associations and key management subsystems, and EPsec and TCP/IP drivers. See FIG. 22, RockIt IPsec and PKI Management, and FIG. 23, RockIt PKC. Architecture (Revocation, Renewal, Rekey and Update), and the FIGS. 22 and 23 narratives below for the RockItClient™ IPsec and PKC subsystem's processing and communications within the RockIt™ IPsec and PKC architecture. See FIGS. 41A through 41C, RockItClient IPsec and PKC Management (New), and the FIGS. 41A through 41C narrative below for the RockItClient™ IPsec and PKC management processing and communication details for new customers.

The bi-directional control flow connector between block 4562 in FIG. 21A and the LAN port at block 4640 in FIG. 21B, depicts the TCP/IP communication flow between the host device and the broadband modem boundary at block 4580 in FIG. 21B. Those of skill in the art will appreciate the TCP/IP communications represented on FIGS. 21A and 21B between the host device and the RockItRouter™ broadband modem illustrate a direct connection and that the TCP/IP protocol supports various WLAN and LAN topologies, which are beyond the scope of the invention. The LAN port depicts the network adapter for the WLAN or LAN network and the WAN port, block 4642, depicts the network adapter for the broadband modem wide area network connection to the Internet broadband provider's network. The LAN and WAN ports connect to the OSI protocol stack—lower layers action, block 4638. The OSI protocol stack—lower layers action works in conjunction with the TCP/IP driver: OSI protocol stack—network layer action, block 4644, and OSI protocol stack—upper layers action, block 4646, to facilitate TCP/IP communications for the RockItRouter™ broadband modem. The bi-directional control flow connectors between blocks 4638 and 4644, and 4644 and 4646, depict the TCP/IP communication flow between the OSI network layers.

The broadband modem boundary contains activities and actions that depict the subsystem architecture of the RockItRouter™, block 4582, and illustrate its IPsec, PKC, and QoS components, processes and communications details. Of particular note are the security associations and key management activity, block 4584; security association database (SADB), block 4626, the security policy database (SPDB), block 4628, and the IPsec driver, block 4630.

The security associations and key management activity contains the ISAKMP activity, block 4586, and the policy manager activity at block 4621. The ISAKMP activity contains the IKE activity, block 4588. The IKE activity contains the OAKLEY activity, block 4590, SKEME action, block 4596, and certificate datastore at block 4598. The OAKLEY activity contains the Diffie-Hellman action, block 4592, and the groups architecture action at block 4594. The policy manager activity contains the policy manager database, block 4622, and the network adapter interface at block 4624.

Those of skill in the art will appreciate the IPsec and PKC architecture communications illustrated by the bi-directional control flow connectors between blocks 4644 and 4630, 4630 and 4621, 4621 and 4588, and 4588 and 4644, respectively, as well as the dependency connectors between blocks 4630 and 4628, 4630 and 4626, and 4624 and 4588, respectively. These control flow connectors depict the communications of the IPsec and PKC between the RockItRouter™ and TCP/IP stack subsystems.

The RockIt™ technologies that make the IPsec, PKC, and QoS subsystem processing of the RockItRouter™ unique are found in RockItRouter Security System™ activity at block 4634. The RockItRouter Security System™ contains several actions that illustrate the IPsec, PKC, and QoS components, processes, and communication details that comprise the subsystem and its ability to mandate, automate, and manage network security, authorization, and quality of service for a customer's host devices connected to a RockItRouter™ broadband modem. The IPsec processing manager, block 4660, manages the RockIt™ IPsec framework communication, processing, configuration, and maintenance for the RockItRouter™ and RockItClient™ IPsec subsystems. The PKC processing manager, block 4658, manages the RockIt™ PKC framework communication, processing, configuration, and maintenance for the RockItRouter™ and RockItClient™ PKC subsystems. The HTTP Redirector, block 4635, manages the URL redirect processing and communication for the RockItRouter Security System™. The QoS processing manager, block 4636, manages the RockIt™ QoS framework communication, processing, configuration, and maintenance for the RockItRouter™ QoS subsystem. The RockItRouter™ database, block 4632, is the datastore for RockItRouter™ IPsec, PKC, HTTP Redirector, and QoS subsystems. The bi-directional control flow connectors between blocks 4634 and 4644, 4634 and 4584, respectively, and the bi-directional control flow connectors with the segments labeled “COM2” (between blocks 4634 and 4630; between blocks 4634 and 4584), illustrate the communications between the RockItRouter Security System™ IPsec, PKC, HTTP Redirector, and QoS subsystems and datastore, and the RockItRouter™ security associations and key management subsystems, and IPsec and TCP/IP drivers.

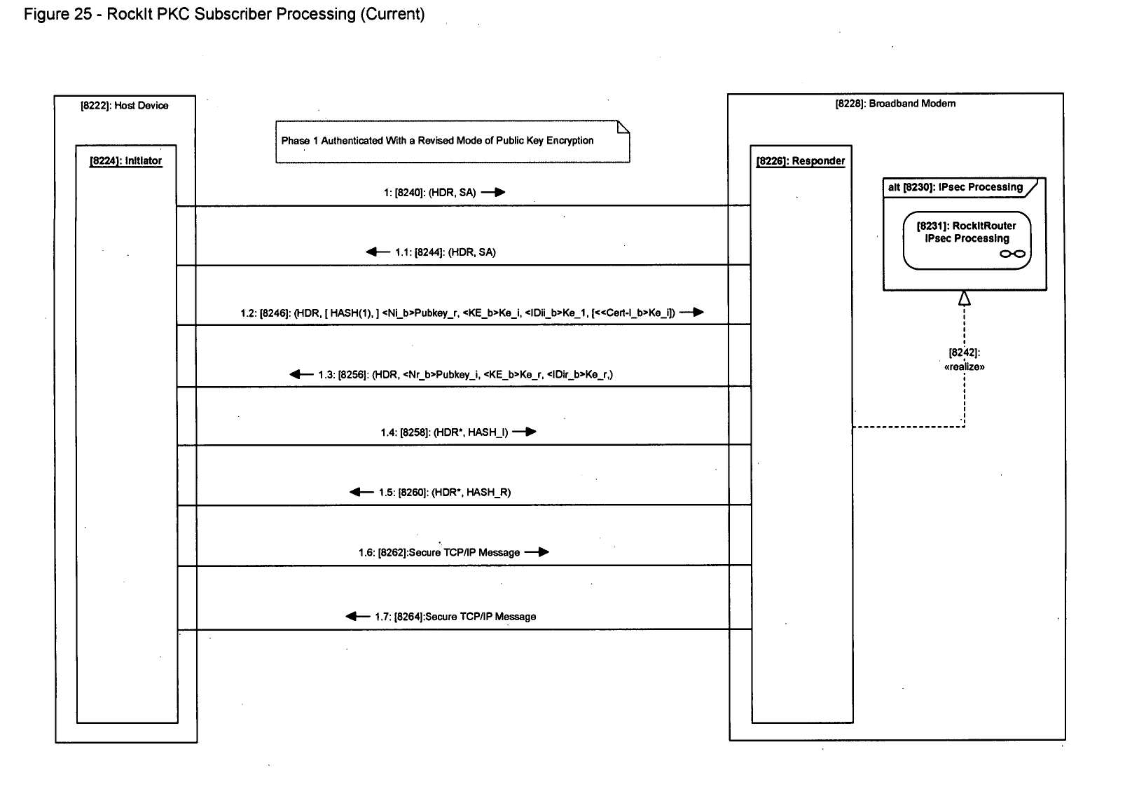

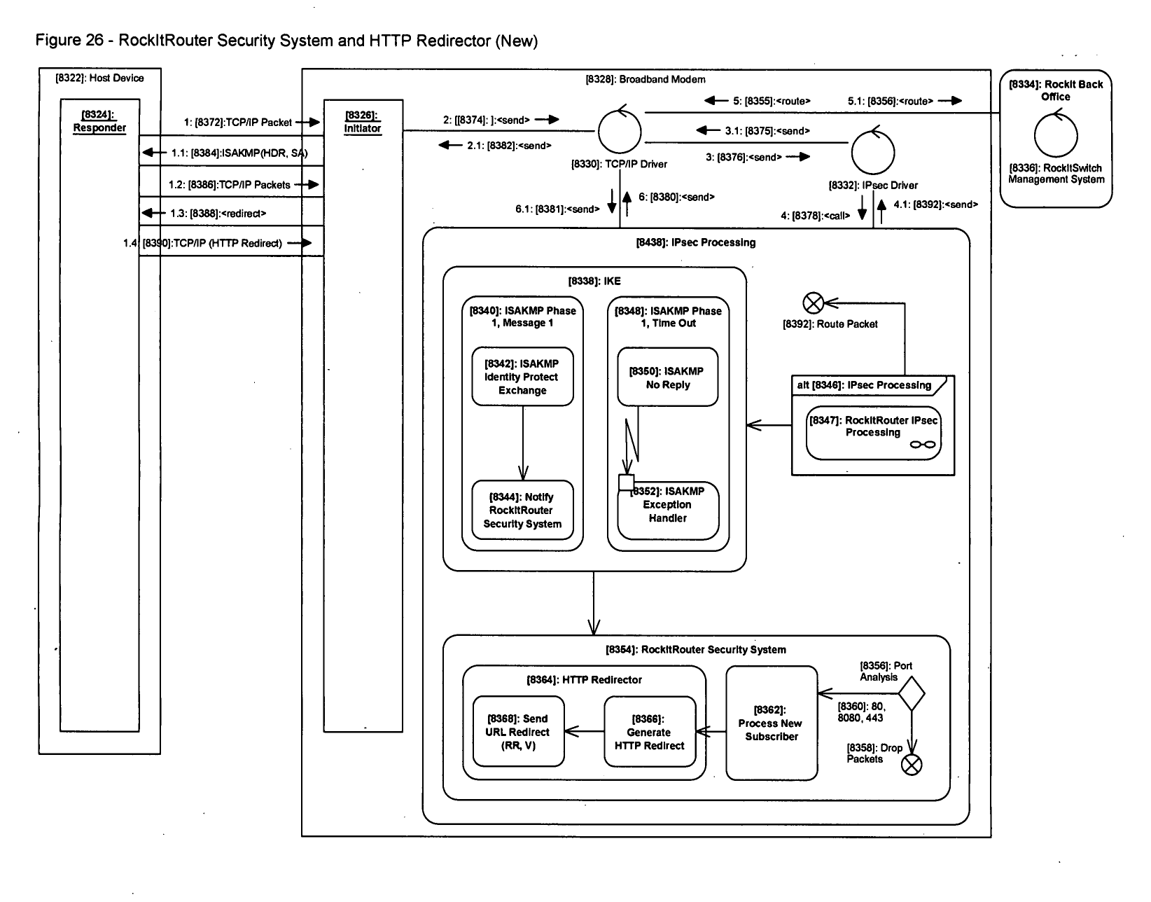

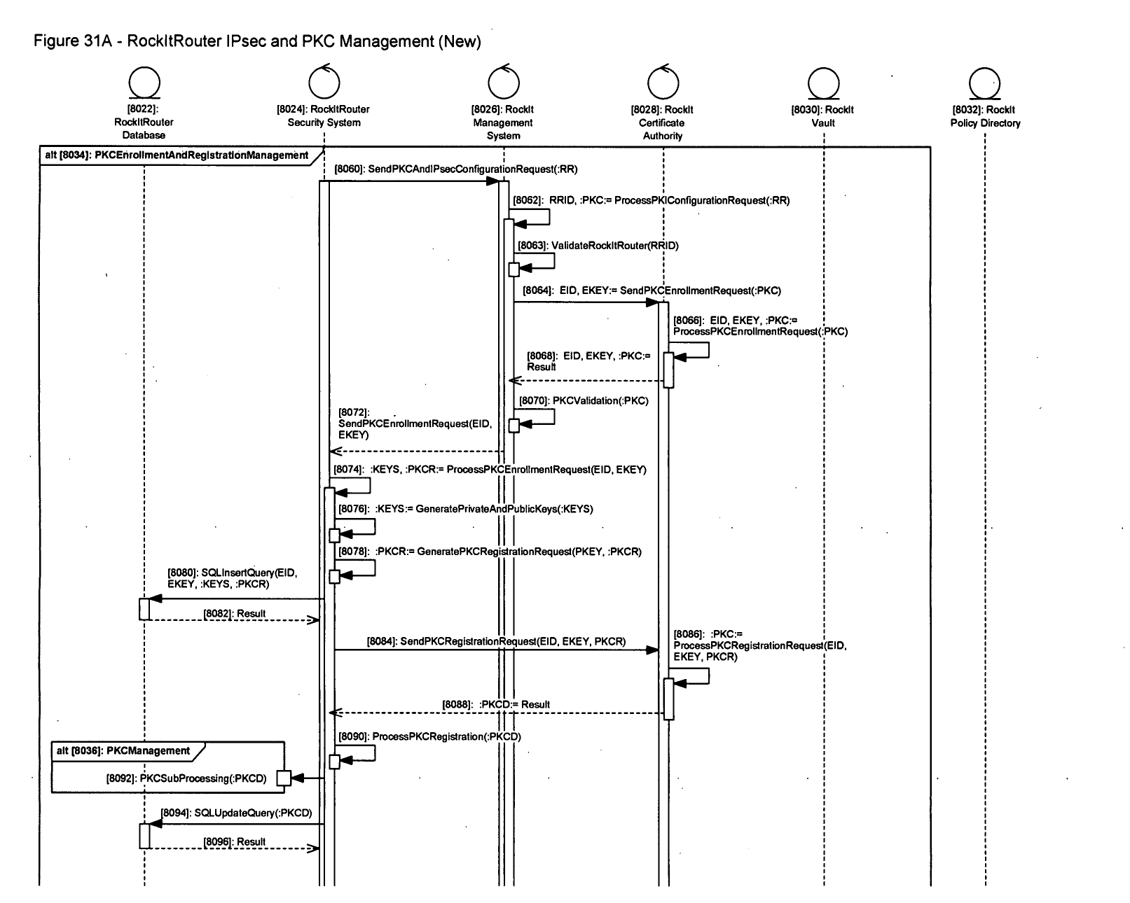

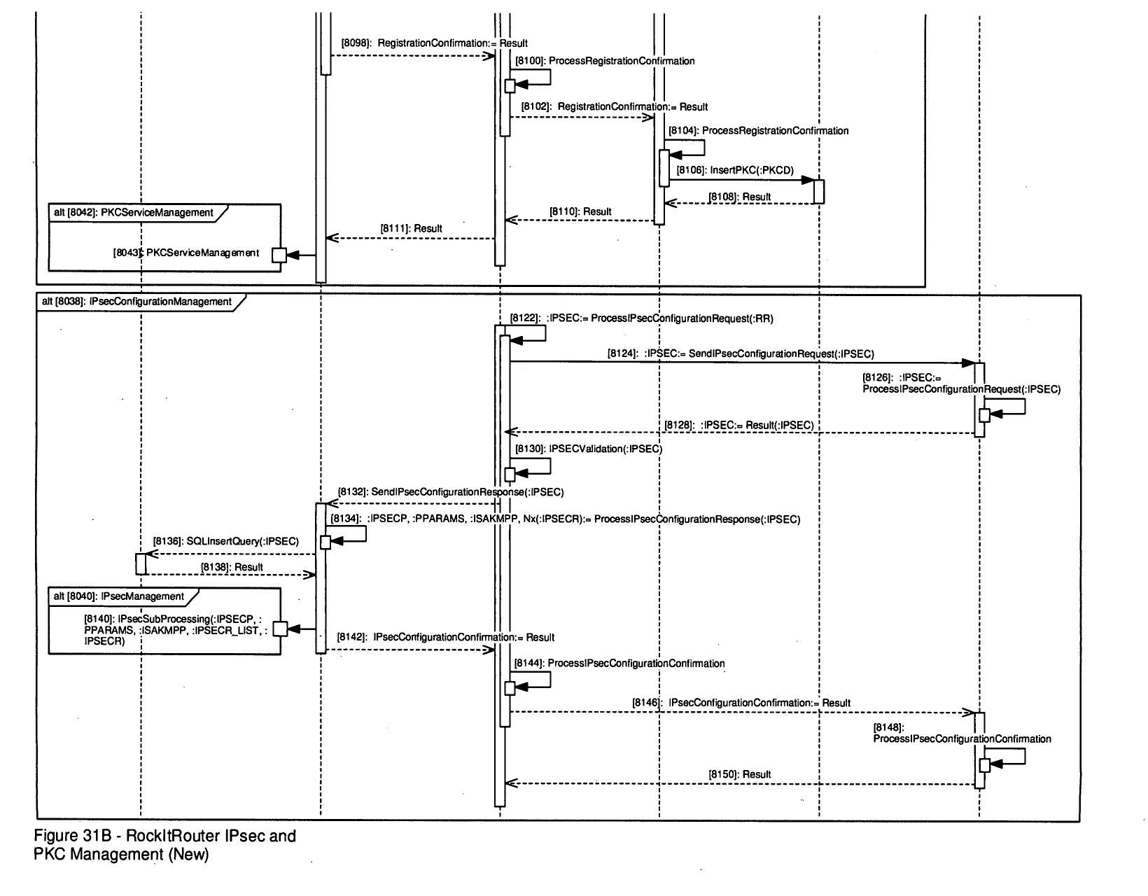

See FIG. 22, RockIt IPsec and PKI Management, and FIG. 23, RockIt PKC Architecture (Revocation, Renewal, Rekey and Update), and the FIGS. 22 and 23 narratives below for the RockItRouter™ IPsec and PKC subsystem's processing and communication details within the RockIt™ IPsec and PKC architecture. See FIG. 24, RockItRouter IPsec Processing, and the FIG. 24 narrative below for the RockItRouter™ IPsec processing and communication details. See FIG. 18, RockIt PKC Subscriber Processing (Roaming), FIG. 25, RockIt PKC Subscriber Processing (Current), FIG. 26, RockItRouter Security System and HTTP Redirector (New), and FIG. 27, RockIt PKC Subscriber Processing (Expired), and the FIGS. 18, 25, 26, and 27 narratives below for the RockItRouter Security System™ and HTTP Redirector subsystem's processing and communication details within the RockIt™ IPsec and PKC architecture. See FIGS. 31A and 31B, RockItRouter IPsec and PKC Management (New), and the FIGS. 31A and 31B narrative below for the RockItRouter™ IPsec and PKC management processing and communication details for new customers.

The RockIt™ technologies that make the IPsec, PKC, and QoS subsystem processing and systems of the RockItSwitch™ back office unique are found in The RockItSwitch™ back office boundary, block 6474. The RockItSwitch™ back office contains several sub-activities and actions that illustrate the IPsec, PKC, and QoS components, processes, and communication details that comprise the RockIt™ IPsec, PKC, and QoS framework and its ability to mandate, automate, and manage network security, authorization, and quality of service for a customer's host devices connected to a RockItRouter™ broadband modem resulting in network performance optimization (including throughput, transmit delay, priority) and security for a customer's host devices, and their WLAN/LAN network, and their access to the Internet broadband provider network.

The RockItSwitch™ back office boundary contains the RockIt Management System™, block 4650, RockIt Policy Directory™, block 4652, RockIt Certificate Authority™, block 4654, RockIt Vault™, block 4656, and RockIt™ database at block 6476. The bi-directional control flow connector between block 4642 and the RockIt Management System™ activity at block 4650 depicts the TCP/IP communication flow between the broadband modem and the RockItSwitch™ back office. The RockIt Management System™ is the central system responsible for managing the RockIt™ IPsec, PKC, and QoS framework communication, processing, configuration, and maintenance. It contains the IPsec processing manager, block 4668, PKC processing manager, block 4670, and QoS processing manager at block 4672.

The RockIt Policy Directory™ is the primary subsystem responsible for the IPsec policy communication, processing, configuration, and maintenance within the RockIt™ IPsec framework. The RockIt Certificate Authority™ is the primary subsystem responsible for the PKC communication, processing, configuration, and maintenance within the RockIt™ PKC framework. The RockIt Vault™ is the primary system responsible for the communication of PKC data inquiries (e.g., CRL) within the RockIt™ PKC framework. The bi-directional control flow connectors between blocks 4650 and 4654, 4650 and 4652, and 4650 and 4656, respectively, depict the relationship between the central and subsystem processing within the RockIt™ IPsec, PKC, and QoS framework.

The bi-directional control flow connectors with the segments labeled “PKC” between the blocks 4654 and 4642 illustrate the direct connection and flow of TCP/IP communications between the RockItRouter™ broadband modem and the RockIt Certificate Authority™. This connection allows the RockItRouter™ broadband modem and RockItClient™, vis-à-vis the broadband modem, to utilize the RockIt Certificate Authority™ for PKC services within the RockIt™ PKC framework. The bi-directional control flow connectors with the segments labeled “IPsec” between the blocks 4652 and 4642 illustrate the direct connection and flow of TCP/IP communications between the RockItRouter™ broadband modem and the RockIt Policy Directory™. This connection allows the RockItRouter™ broadband modem and RockItClient™, vis-à-vis the broadband modem, to utilize the RockIt Policy Directory™ for IPsec services within the RockIt™ IPsec framework. The bi-directional control flow connector between blocks 4656 and 4642 illustrates the direct connection and flow of TCP/IP communications between the RockItRouter™ broadband modem and the RockIt Vault™. This connection allows the RockItRouter™ broadband modem and RockItClient™, vis-à-vis the broadband modem, to utilize the RockIt Vault™ for PKC data inquiry services within the RockIt™ PKC framework.

The RockIt™ technologies that make the PKC framework of the RockIt™ IPsec and PKI Management system unique are found in systems utilization of PKC templates and PKC requests to facilitate PKC communication, processing, configuration, and maintenance, within the context of Internet broadband provider's customer account processing and status. That is, the RockIt™ PKC framework mandates, automates, and manages certificate creation and constraint validation based on customer account processing and status.

The RockIt™ PKC framework mandates, automates, and manages the creation, deletion, and alteration of PKC for RockItRouter™ broadband modems and customer's host devices during new, renewal, and update service order fulfillment processing, and account revocation and rekey processing. Certificates are issued by the RockIt Management System™ and RockIt Certificate Authority™ to customers who verify and validate their identity during the new or renewal service order fulfillment processes, thereby creating or updating an association between the PKC and the customer account. Certificates are revoked by the RockIt Management System™ and RockIt Certificate Authority™ for customers whose accounts have expired or for whom attempted account payment fails. Certificates are updated by the RockIt Management System™ and RockIt Certificate Authority™ for customers whose account type or information has changed (e.g., change of service or customer move). Certificates are rekeyed by the RockIt Management System™ and RockIt Certificate Authority™ for customers whose PKC have been compromised and for whom security policy mandates (e.g., a customer loses his or her laptop or an Internet broadband provider requires periodic certificate rekey for security requirements). The RockIt™ PKC framework utilizes RockItClient™ and RockItRouter Security System™ to restrict Internet broadband provider network access to only those customer host devices having valid and trustworthy public keys and certificates.

The RockIt™ PKC framework mandates, automates, and manages certificate policy constraint validation during certificate processing. The RockIt Management System™ and RockIt Certificate Authority™ policy constraints ensure that specific constraints are satisfied when a PKC is issued or used within the RockIt™ PKC framework. Policy constraints are divided into two categories, issuance and application policy.

An issuance policy is a set of administrative rules required for certificate issuance. Issuance policies, or certificate policies extensions, enable the RockIt™ PKC framework to define the circumstances and requirements for certificate issuance. They are implemented through PKC template selection and use during PKC processing. Application policies, that is, key usage extension and extended key usage as defined by the X.509 v3 certificate format, specify how certificates and public keys are issued and used within the RockIt™ PKC framework. As an example, the RockItRouter Security Systemυ uses application policies to regulate RockItClient™ certificate public key use with in the RockIt™ PKC framework.

During new (or enrollment and registration), renewal, update, revocation, and rekey PKC processing, the RockIt Management System™ and RockIt Certificate Authority™ systems also utilize PKC templates to provide default attributes beyond authorized uses for the certificate and issuance requirements detailed above. PKC templates are utilized to provide default attributes including the cryptographic algorithms used with the certificate, the format of the subject, the public key length, the certificate lifetime, etc.

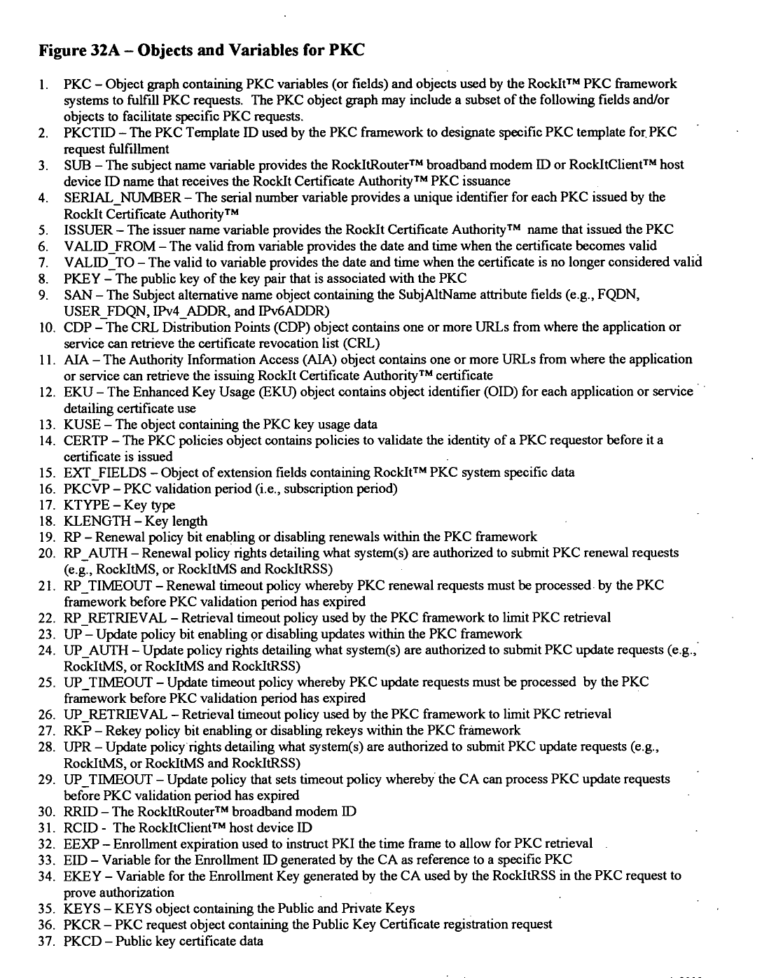

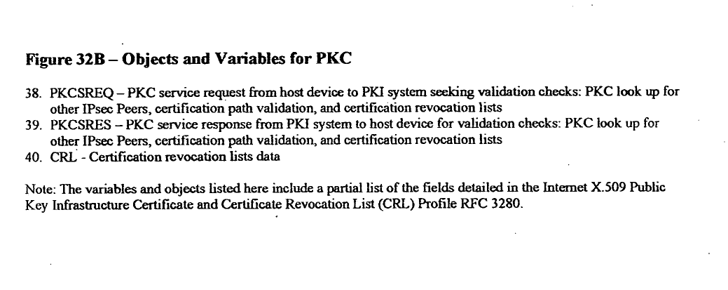

The RockIt Management System™ and RockIt Certificate Authority™ systems utilize PKC requests as a communication protocol for PKC processing and maintenance instructions, PKC template designation, and PKC data transfer for generating and formatting PKC content during PKC enrollment and registration, as well as, PKC renewal, rekey, and update. To facilitate new (or enrollment and registration), renewal, update, revocation, and rekey PKC processing, the RockIt Management System™ dynamically generates and sends PKC requests to the RockIt Certificate Authority™. The PKC request contains the PKC processing instruction (e.g., enroll, register, renew, update, rekey, and revoke), PKC template designation (e.g., template ID), and PKC data. The PKC data contain the dynamically generated data for the PKC fields and processing. Those of skill in the art will appreciate PKC field usage within the PKC template framework. See FIG. 32, Objects and Variables for PKC, for the PKC objects and variables utilized by the PKC framework systems.

The RockIt™ technologies that make the IPsec framework of the RockIt™ IPsec and PKI Management system unique are found in systems utilization of IPsec policies and IPsec policy requests to facilitate real-time and automated IPsec communication, processing, configuration, and maintenance, within the context of Internet broadband provider's customer account processing and status. The RockIt™ IPsec framework mandates, automates, and manages the creation, deletion, and alteration of IPsec policy for RockItRouter™ broadband modems and RockItClient™ host devices. The RockIt™ IPsec framework, in conjunction with the RockIt™ PKC framework, provides network security and authorization, and facilitates service order fulfillment and account processing. Network security and authorization for customer's RockItClient™ host devices connected to a RockItRouter™ broadband modem results in security for a customer's host devices, their WLAN/LAN network, and their access to the Internet broadband provider network. Service order fulfillment and account processing creates economic efficiencies—generating increased revenues and reduced costs for IBPs.

FIG. 22 is an activity diagram that illustrates the RockIt™ IPsec and PKI Management system. It details the relationships between the subsystems that provide new PKC during new service order fulfillment (through the PKC enrollment and registration process), PKC validation services, and IPsec configuration. See FIG. 23, RockIt PKC Architecture (Revocation, Renewal, Rekey and Update), and the FIG. 23 narrative below for the RockIt PKC renewal, rekey, and update processing and communication details. Those of skill in the art will appreciate the EPsec and PKC architecture components, processes and communications details illustrated in the FIG., as well as the IPsec and PKC architecture components, processes and communications extensions provided by the RockItClient™, RockItRouter™, and RockItSwitch™ systems to mandate, automated and manage network security and authorization, and facilitate service order fulfillment and account processing.

The RockItSwitch™ back office boundary, block 7522, details the RockIt Management System™ activity, block 7532, PKC systems activity, including the RockIt Certificate Authority™ activity and RockIt Vault™ activity, blocks 7524, 7528, and 7526, respectively, and the RockIt Policy Directory™ activity, block 7530. The RockIt Management System™ activity contains the PKC processing manager activity, block 7550, and the IPsec processing manager activity at block 7548. The RockIt Management System™ is the central system responsible for coordinating PKC and IPsec systems communication, processing, configuration, and maintenance. The PKC processing manager is the central process within the RockIt™ PKC framework that mandates, automates, and manages the creation, deletion, and alteration of PKC for RockItRouter™ broadband modems and customer's host devices during new and renewal service order fulfillment processing, and account revocation, update, and rekey processing. The IPsec processing manager is the central process within the RockIt™ IPsec framework that mandates, automates, and manages the creation, deletion, and alteration of IPsec policy for RockItRouter™ broadband modems and RockItClient™ host devices. The PKC processing manager and IPsec processing manager are the central processes within the RockIt™ IPsec and PKC framework that provide network security and authorization, and facilitate service order fulfillment and account processing.

During the new PKC issuance process, the RockIt Management System™ activity, through the PKC processing manager, issues a PKC enrollment and registration request message to the RockIt Certificate Authority™. This is depicted by the bi-directional control flow connectors labeled “PKC_ENROLL” and “PKC_REG” between blocks 7532 and 7528. Enrollment is the process whereby the RockItRouter™ broadband modem and RockItClient™ host devices are authorized and enrolled into the PKC system. Registration is the process whereby the RockItRouter™ broadband modem and RockItClient™ host devices register a PKC. The RockIt Management System™ is responsible for validating RockItRouter™ broadband modems and RockItClient™ host devices during PKC processing, as depicted by the self-message association connectors labeled “RR_VALID” and “RC_VALID” at block 7532. The RockIt Certificate Authority™ processes new PKC issuance, by generating new PKC (i.e., certificate creation and constraint validation), as depicted by the self-message association connector labeled “PKC_GEN” at block 7528. The RockIt Certificate Authority™ utilizes the PKC enrollment and registration request messages, PKC_ENROLL and PKC_REG, which communicate PKC processing instructions, PKC template designation, and PKC data, to generate new PKC. After completing new PKC, the RockIt Certificate Authority™ stores the PKC in the RockIt Vault™, as depicted by the control flow connector labeled “PKC_STORE” between blocks 7528 and 7526. The RockIt Vault™ is the PKC repository for PKC validation within the PKC framework.

The subscriber's home boundary, block 7534, contains the broadband modem activity, block 7536, RockItRouter™ security system activity, block 7538, IPsec processing manager activity, block 7552, PKC processing manager activity, block 7554, host device #1 activity, block 7540, RockItClient™ activity, block 7542, IPsec processing manager activity, block 7556, PKC processing manager activity, block 7558, host device #N activity, block 7544, RockItClient™ activity, block 7546, IPsec processing manager activity, block 7560, and PKC processing manager activity at block 7562. The RockItRouter Security System™ is the central process within the IPsec and PKC framework responsible for communication, processing, configuration, and maintenance of IPsec policy and PKC for RockItRouter™ broadband modems and RockItClient™ host devices.

In the case of PKC issuance for RockItRouter™ broadband modems, the RockItRouter Security System™ utilizes the PKC processing manager to issue a PKC enrollment and registration request message to the RockIt Management System™. This is depicted by the bi-directional control flow connectors labeled “PKC_ENROLL” and “PKC_REG” between blocks 7538 and 7532. In the case of PKC issuance for RockItClient™ hose devices, the RockItRouter Security System™ utilizes the PKC processing manager to facilitate PKC enrollment and registration processing and request messaging between the RockItClient™ host devices and RockIt Management System™. This is depicted by the bi-directional flow control connectors, labeled “PKC_ENROLL” and “PKC_REG” between blocks 7538 and 7542, and 7538 and 7546, respectively. The RockItRouter Security System™, through the PKC processing manager, is also responsible for generating PKC public and private keys for RockItClient™ host devices having limited CPU processing power, as depicted by the self-message association connector labeled “GEN_KEY” at block 7538, and the RockItClient™ (having no GEN_KEY self-message association connector associated with it) at block 7546. The PKC processing manager is also responsible for PKC validation and storage for the RockItRouter Security System™ (e.g. IKE PKC validation). The RockItClient™ and its PKC processing manager represent the central process within the PKC framework responsible for communication, processing, configuration, and maintenance of PKC for host devices. The RockItClient™ is also responsible for generating PKC keys for host devices having sufficient CPU processing power, as depicted by the self-message association connector, labeled “GEN_KEY” at block 7542. The PKC processing manager is also responsible for PKC validation and storage for the RockItClient™.

During new service order fulfillment processing, and after new PKC issuance, the RockItRouter Security System™ utilizes the IPsec processing manager to initiate IPsec policy configuration issuance. The RockItRouter Security System™ manages the IPsec policy configuration request messages for the RockItRouter™ broadband modem and RockItClient™ host devices. This is illustrated by the bi-directional control flow connector labeled IPSEC_CONFIG between blocks 7538 and 7542, 7538 and 7546, and 7538 and 7532, respectively. The RockIt Management System™, through its IPsec processing manager, utilizes the RockIt Policy Directory™ to retrieve IPsec policy configurations for RockItRouter™ broadband modems and RockItClient™ host devices. This is illustrated by the bi-directional control flow connector labeled “IPSEC_CONFIG” between blocks 7532 and 7530. The RockItRouter Security System™ is the central system within the RockIt™ IPsec framework responsible for real-time and automated IPsec policy configuration, within the context of Internet broadband provider's customer account processing and status. Beyond IPsec policy configuration setup, the RockItRouter Security System™ through the IPsec processing manager dynamically mandates, automates, and manages the creation, deletion, and alteration of IPsec policy for RockItRouter™ broadband modems and RockItClient™ host devices. See FIG. 24, RockItRouter IPsec Processing, and the FIG. 24 narrative below for the RockItRouter™ IPsec processing and communication details. The RockItClient™, and its IPsec processing manager, is the central process within the IPsec framework responsible for communication, processing, configuration, and maintenance of IPsec policy for host devices.

Upon completion of new PKC issuance—through the PKC enrollment and registration process, and IPsec configuration—RockItRouter™ broadband modems and RockItClient™ host devices utilize PKC validation (e.g., PKC look up and path validation, and certification revocation lists) to provide security and authorization, as well as service order fulfillment and account processing. RockItClient™ host devices utilize PKC validation via RockItRouter Security System™ and RockIt Vault™, and the RockItRouter Security System™ utilizes PKC validation via its local PKC storage and CRL, and RockIt Vault™. PKC validation messaging is depicted by the bi-directional dependency connectors labeled “PKC_SERV” between blocks 7538 and 7538 and 7546, 7546 and 7526, 7542 and 7526, and 7538 and 7526, respectively. The RockIt™ IPsec and PKC frameworks provide network security and authorization for RockItRouter™ broadband modems and RockItClient™ host devices, and results in security for a customer's host devices, their WLAN/LAN network, and their access to the Internet broadband provider network. This is illustrated by the bi-directional control flow connectors labeled “VPN” between blocks 7536 and 7540, 7536 and 7544, and 7540 and 7544, respectively.

See FIGS. 31A and 31B, RockItRouter IPsec and PKC Management (New), and the FIGS. 31A and 31B narrative below for the RockItRouter™ IPsec and PKC management processing and communication details for new customers. See FIGS. 41A through 41C, RockItClient IPsec and PKC Management (New), and the FIGS. 41A through 41C narrative below for the RockItClient™ IPsec and PKC management processing and communication details for new customers.

FIG. 23 is an activity diagram that illustrates PKC revocation, renewal, rekey, and update of the RockIt™ PKC architecture. Those of skill in the art will appreciate the PKC architecture components, processes and communications details illustrated in the drawing, as well as, the PKC architecture components, processes and communications extensions provided by the RockItClient™, RockItRouter™, and RockItSwitch™ systems to mandate, automated and manage network security and authorization, and facilitate service order fulfillment and account processing within the context of PKC revocation, renewal, rekey, and update.

PKC renewal is the process whereby the RockItRouter™ broadband modem and RockItClient™ host devices acquire new PKC with the same public key due to the expiration of their existing PKC, and occurs prior to the expiration of their existing PKC to avoid any connection outages. PKC revocation is the process whereby the RockItRouter™ broadband modem and RockItClient™ host devices PKC validation is revoked. PKC revocation is facilitated through RockIt Vault™ and RockItRouter Security System CRL, and through RockIt Vault™ PKC deletion. PKC update is the process whereby the RockItRouter™ broadband modem and RockItClient™ host devices PKC need to be changed prior to expiration due to a change in its subject's information (e.g., customer change of address or service). PKC rekey is the process whereby the RockItRouter™ broadband modem and RockItClient™ host devices PKC are replaced with a new PKC and public key. The rekey process utilizes the existing PKC key pair to facilitate authentication for the new PKC enrollment and registration.

The RockItSwitch™ back office boundary, block 8722, details the RockIt Management System™ activity, block 8732, PKC systems activity including the RockIt Certificate Authority™ activity and RockIt Vault™ activity, blocks 8724, 8728, and 8726 respectively, and the automated renewal service (ARS) activity, block 8730. The RockIt Management System™ activity contains the PKC processing manager activity, block 8750, and the automated subscription renewal process activity at block 8752. The RockIt Management System™ is the central system responsible for coordinating PKC systems communication, processing, configuration, and maintenance for PKC renewal, revocation, update, and rekey. The PKC processing manager is the central process within the RockIt™ PKC framework that mandates, automates, and manages the creation, deletion, and alteration of PKC for RockItRouter™ broadband modems and customer's host devices during renewal service order fulfillment processing, account revocation and update processing, and security policy rekey processing. The PKC processing manager is the central process, within the RockIt™ PKC framework, that provides ongoing network security and authorization, and facilitates service order fulfillment and account processing.

The automated subscription renewal process is the central process, within the RockIt Management System™, that is responsible for subscriptions management processing of recurring real-time billing for customer subscriptions. The automated subscription renewal process utilizes the automated renewal service for subscriptions management processing. It sends automated subscription renewal request messages to the automated renewal service for processing, as depicted by the control flow connector, labeled “REQ” between blocks 8752 and 8730. After processing the automated subscription renewal requests, the automated renewal service sends automated subscription renewal response messages back to the automated subscription renewal process for further processing, as depicted by the control flow connector labeled “RES” between blocks 8730 and 8752. See FIG. 15, RockItSwitch™ Automated Subscription Renewal, and the FIG. 15 narrative above for the RockItSwitch™ automated subscription renewal processing and communication details. Upon receipt of the automated subscription renewal response message, the automated subscription renewal process analyzes the response message to determine if a customer's account PKC, for RockItClient™ host devices, is renewed or revoked.

The following details renewal PKC issuance for RockItClient™ host devices processing by the RockIt Management System™ after analysis by the automated subscription renewal process. In the case of PKC renewal for RockItClient™ host devices, the RockIt Management System™, through its PKC processing manager, issues a PKC renewal request message to the RockIt Certificate Authority™. This is depicted by the bi-directional control flow connector labeled “PKC_RENEW” between blocks 8732 and 8728. The PKC renewal process illustration represents the PKC enrollment and registration processes that were detailed in FIG. 22 and the FIG. 22 narrative above.

The RockIt Management System™ is responsible for validating RockItClient™ host devices during PKC renewal processing, as depicted by the self-message association connector, labeled “RC_VALID” at block 8732. The RockIt Certificate Authority™ processes renewal PKC issuance, by generating new PKC (i.e., certificate creation and constraint validation), as depicted by the self-message association connector labeled “PKC_GEN” at block 8728. The RockIt Certificate Authority™ utilizes the PKC enrollment and registration request messages, via PKC_RENEW, which communicate PKC processing instructions, PKC template designation, and PKC data, to generate new PKC. After completing a new PKC issuance, the RockIt Certificate Authority™ stores the PKC in the RockIt Vault™, as depicted by the control flow connector, labeled “PKC_STORE” between blocks 8728 and 8726. The RockIt Vault™ is the PKC repository for PKC validation within the PKC framework.

The subscriber's home boundary, block 8734, contains the broadband modem activity, block 8736, RockItRouter™ security system activity, block 8738, IPsec processing manager activity, block 8754, PKC processing manager activity, block 8756, host device #1 activity, block 8740, RockItClient™ activity, block 8742, IPsec processing manager activity, block 8758, PKC processing manager activity, block 8760, host device #N activity, block 8744, RockItClient™ activity, block 8746, IPsec processing manager activity, block 8762, and PKC processing manager activity at block 8764. The RockItRouter Security System™ is the central process within the PKC framework responsible for communication, processing, configuration, and maintenance of PKC renewal, revocation, update, and rekey for RockItRouter™ broadband modems and RockItClient™ host devices.

After RockIt Certificate Authority™ PKC processing for RockItClient™ host device PKC, the RockIt Management System™ utilizes its PKC processing manager to issue PKC renewal requests messages to the RockItRouter Security System™, as depicted by the bi-directional control flow connector labeled “PKC_RENEW” between blocks 8738 and 8732. See FIG. 27, RockIt PKC Subscriber Processing (Expired), and the FIG. 27 narrative below for the RockIt renewal PKC processing and communication details for expired customers.

For renewal PKC issuance for RockItClient™ hose devices, the RockItRouter Security System™ utilizes the PKC processing manager to facilitate renewal PKC processing and request messaging between the RockItClient™ host devices and RockIt Management System™. This is depicted by the bi-directional flow control connectors labeled “PKC_RENEW” between blocks 8738 and 8742, and 8738 and 8746, respectively. The RockItRouter Security System™, through its PKC processing manager, is responsible for local RockItClient™ PKC storage, for future validation of said RockItClient™ PKC (e.g. IKE PKC validation). The RockItClient™, through its PKC processing manager, is the central process within the PKC framework responsible for communication, processing, configuration, and maintenance of PKC for host devices. The RockItClient™ PKC processing manager is responsible for local PKC validation and storage.

Depending upon IBP PKC security policy, the system is capable of renewal PKC issuance for RockItRouter™ broadband modems as part of the renewal PKC issuance process for RockItClient™ host device, or as a separate renewal PKC issuance process for RockItRouter™ broadband modems. In the former case, the RockItRouter™ broadband modem renewal PKC issuance processing occurs prior to the renewal PKC issuance for RockItClient™ host devices as detailed above.

In the latter case, renewal PKC issuance processing for RockItRouter™ broadband modems, the RockItRouter Security System™ utilizes its PKC processing manager to instantiate renewal PKC request messages to the RockIt Management System™ separate from the renewal PKC issuance process for RockItClient™ host device as detailed above. Upon receipt of renewal PKC request messages from the RockItRouter Security System™ of a RockItRouter™ broadband modem, the RockIt Management System™ is responsible for validating RockItRouter™ broadband modems during PKC processing, as depicted by the self-message association connector labeled “RR_VALID” at block 8732. After validation of RockItRouter™ broadband modem, the RockIt Management System™ issues a PKC renewal request message to the RockIt Certificate Authority™ for renewal PKC issuance processing, as depicted by the bi-directional control flow connector labeled “PKC_RENEW” between blocks 8732 and 8728. The RockIt Certificate Authority™ processes renewal PKC issuance, by generating new PKC (i.e., certificate creation and constraint validation), as depicted by the self-message association connector, labeled “PKC_GEN” at block 8728. The RockIt Certificate Authority™ utilizes the PKC enrollment and registration request messages, via PKC_RENEW, which communicate PKC processing instructions, PKC template designation, and PKC data, to generate new PKC. After completing a new PKC issuance, the RockIt Certificate Authority™ stores the PKC in the RockIt Vault™, as depicted by the control flow connector, labeled “PKC_STORE” between blocks 8728 and 8726. After RockIt Certificate Authority™ renewal PKC processing for RockItRouter™ broadband modems, the RockIt Management System™ utilizes its PKC processing manager to issue PKC renewal response messages back to the RockItRouter Security System™, as depicted by the bi-directional control flow connector labeled “PKC_RENEW” between blocks 8738 and 8732. The RockItRouter Security System™, upon receipt of the renewal PKC issuance response message from the RockIt Management System™, processes the renewal PKC issuance by retrieving the PKC and storing it locally.

The following details PKC revocation processing for RockItClient™ host devices by the RockIt Management System™ after analysis by the automated subscription renewal process. In the case of PKC revocation for RockItClient™ host devices, the RockIt Management System™, through its PKC processing manager, issues a PKC revocation request message, to the RockIt Certificate Authority™. This is depicted by the bi-directional control flow connector labeled “PKC_REVOKE” between blocks 8732 and 8728. The RockIt Certificate Authority™ processes the PKC revocation request, adding the PKC(s) to the CRL contained in the RockIt Vault™, as depicted by the control flow connector labeled “PKC_STORE.”

After RockIt Certificate Authority™ PKC revocation processing for RockItClient™ host device PKC, the RockIt Management System™ utilizes its PKC processing manager to issue PKC revocation requests messages to the RockItRouter Security System™, as depicted by the bi-directional control flow connector labeled “PKC_REVOKE” between blocks 8738 and 8732. Upon receipt of the PKC revocation requests messages from the RockIt Management System™, the RockItRouter Security System™ utilizes its PKC processing manager to facilitate PKC revocation processing. The PKC processing manager processes the PKC revocation request by adding the PKC to the local CRL and by dynamically modifying the IPsec configuration by creating appropriate IPsec filters for the RockItClient™ host device associated with the PKC. During future ISAKMP identity protect exchanges, specifically, ISAKMP Phase 1, Message 3, the validation of said RockItClient™ PKC fails and failed authentication results in an IKE exception handler being raised. In this case, when a customer's host device's authentication fails, the RockItRouter Security System™ allows IPsec authentication to proceed and the IPsec filters for the RockItClient™ host device restrict the customer's Internet access and facilitate renewal service order fulfillment. Customer automated subscription renewal is completely automated and processed in real-time. Going forward, the RockIt™ IPsec and PKI management system provides ongoing network security and authorization, and facilitates service order fulfillment and account processing. See FIG. 27, RockIt PKC Subscriber Processing (Expired), and the FIG. 27 narrative below for the PKC revocation processing and communication details.

The following details PKC revocation processing for RockItClient™ host devices and RockItRouter™ broadband modems by the RockIt Management System™. In the event that a customer cancels service, a customer service representative or the customer uses the RockIt Management System™ e-commerce site to cancel service, whereupon, the RockIt Management System™ instantiates the processes for PKC revocation. The RockIt Management System™ through its PKC processing manager issues a PKC revocation request message to the RockIt Certificate Authorityυ. This is depicted by the bi-directional control flow connector labeled “PKC_REVOKE” between blocks 8732 and 8728. The RockIt Certificate Authority™ processes the PKC revocation request, adding the PKC(s) to the CRL contained in the RockIt Vault™ and deletes the customer's relevant PKC for RockItRouter™ broadband modem and RockItClient™ host devices, as depicted by the control flow connector labeled “PKC_STORE.”

After RockIt Certificate Authority™ PKC revocation processing, the RockIt Management System™ utilizes its PKC processing manager to issue PKC revocation request messages to the RockItRouter Security System™, as depicted by the bi-directional control flow connector, labeled “PKC_REVOKE” between blocks 8738 and 8732. Upon receipt of the PKC revocation request messages from the RockIt Management System™, the RockItRouter Security System™ utilizes its PKC processing manager to facilitate PKC revocation processing. All customer RockItClient™ host device PKCs are added to the local CRL and the RockItRouter Security System™ and dynamically modify IPsec configuration by creating appropriate IPsec filters for the RockItClient™ host devices and associated PKC. Customer account cancellation is completely automated and processed in real-time. Going forward, a customer host device Internet access is limited and its web requests are redirected to the RockIt Management System™ for new service order fulfillment. The customer also loses the IPsec security services provided by the RockItRouter™ broadband modem of their WLAN or LAN.

The following details PKC update processing for a customer who changes their service (e.g., added roaming service) or account information (e.g., customer name change) by the RockIt Management System™. In the event that a customer wishes to change service or update their account information, a customer service representative or the customer uses the RockIt Management System™ e-commerce site to modify service or change account information, whereupon, the RockIt Management System™ instantiates the processes for PKC update. The RockIt Management System™ through its PKC processing manager issues a PKC update request message, to the RockIt Certificate Authority™. This is depicted by the bi-directional control flow connector labeled “PKC_UPDATE” between blocks 8732 and 8728. The RockIt Certificate Authority™ processes the PKC update request, applying applicable modifications to the relevant PKC for the customer's RockItRouter™ broadband modem and RockItClient™ host devices. The modified PKCs are then stored in the RockIt Vault™, as depicted by the control flow connector labeled “PKC_STORE” between blocks 8728 and 8726. After RockIt Certificate Authority™ PKC update processing, the RockIt Management System™ utilizes its PKC processing manager to issue PKC update requests messages to the RockItRouter Security System™, as depicted by the bi-directional control flow connector labeled “PKC_UPDATE” between blocks 8738 and 8732. Upon receipt of the PKC update request messages from the RockIt Management System™, the RockItRouter Security System™ utilizes its PKC processing manager to facilitate PKC update processing. The RockItRouter Security System™, through its PKC processing manager, sends PKC update request messages to the customer's RockItClient™ host devices. Moreover, in the case of modified service, the RockItRouter Security System™ through its IPsec processing manage, dynamically modifies IPsec configuration for the customer's RockItClient™ host devices. A customer's service or account information changes are completely automated and processed in real-time. Going forward, the RockIt™ IPsec and PKI management system provides ongoing network security and authorization, and facilitates service order fulfillment and account processing.

The following details PKC rekey processing. The RockIt™ IPsec and PKI management system allows for flexible security policy configuration and application. An Internet broadband provider may use the RockIt™ IPsec and PKI management system to create and implement a security policy that requires a PKC rekey after a specified time interval or bandwidth use limitation has been met. In addition, the RockIt™ IPsec and PKI management system can be utilized to initiate an automated and real-time rekey of PKC in the case of customer's host device security being compromised (e.g., a customer's laptop is stolen). In the former case, the RockIt™ IPsec and PKI management system utilizes the RockIt Management System™ to instantiate the processes for PKC rekey. An Internet broadband provider systems administrator uses the RockIt Management System™ to configure PKC rekey time intervals or bandwidth use limitations. In the latter case, a customer service representative, or the customer, uses the RockIt Management System™ e-commerce site to rekey PKC, whereupon, the RockIt Management System™ instantiates the processes for PKC rekey. The RockIt Management System™ through its PKC processing manager issues a PKC rekey request message to the RockIt Certificate Authority™. This is depicted by the bi-directional control flow connector labeled “PKC_REKEY” between blocks 8732 and 8728. The PKC rekey process is analogous to a new PKC issuance, and it represents the PKC enrollment and registration processes that were detailed in FIG. 22 and the FIG. 22 narrative above.

The RockIt Management System™ is responsible for validating RockItRouter™ broadband modems and RockItClient™ host devices during PKC rekey processing, as depicted by the self-message association connectors labeled “RR_VALID” and “RC_VALID” at block 8732. The RockIt Certificate Authority™ processes PKC rekey issuance, by generating new PKC (i.e., certificate creation and constraint validation), as depicted by the self-message association connector labeled “PKC_GEN” at block 8728. The RockIt Certificate Authority™ utilizes the PKC enrollment and registration request messages, via PKC_REKEY, which communicate PKC processing instructions, PKC template designation, and PKC data, to generate new PKC. After completing a new PKC issuance, the RockIt Certificate Authority™ stores the PKC in the RockIt Vault™, as depicted by the control flow connector labeled “PKC_STORE” between blocks 8728 and 8726.

After RockIt Certificate Authority™ PKC rekey processing for RockItRouter™ broadband modems and RockItClient™ host devices, the RockIt Management System™ utilizes its PKC processing manager to issue PKC rekey request messages to the RockItRouter Security System™, as depicted by the bi-directional control flow connector labeled “PKC_REKEY” between blocks 8732 and 8738. For RockItRouter™ broadband modem PKC rekey issuance, the RockItRouter Security System™ utilizes its PKC processing manager to facilitate rekey PKC processing and local storage of said PKC. For RockItClient™ hose device PKC rekey issuance, the RockItRouter Security System™ utilizes its PKC processing manager to facilitate rekey PKC processing and request messaging between the RockItClient™ host devices and RockIt Management System™. This is depicted by the bi-directional flow control connectors labeled “PKC_REKEY” between blocks 8738 and 8742, and 8738 and 8746, respectively. The RockItRouter Security System™, through its PKC processing manager, is responsible for local RockItClient™ PKC storage, for future validation of said RockItClient™ PKC (e.g. IKE PKC validation). The RockItRouter Security System™ through its PKC processing manager is also responsible for generating PKC public and private keys for RockItClient™ host devices with limited CPU capacity, as depicted by the self-message association connector labeled “GEN_KEY” at block 8738 and the RockItClient™ (without a GEN_KEY self-message association connector) at block 8746. The RockItClient™ PKC processing manager is responsible for local PKC validation and storage and for generating PKC keys for host devices with sufficient CPU processing power, as depicted by the self-message association connector labeled “GEN_KEY” at block 8742.

Upon completion of renewal, update, and rekey PKC issuance, the RockItRouter™ broadband modem and RockItClient™ host devices utilize PKC validation (e.g., PKC look up and path validation, and certification revocation lists) to provide security and authorization as well as service order fulfillment and account processing. RockItClient™ host devices utilize PKC validation via RockItRouter Security System™ and RockIt Vault™, and the RockItRouter Security System™ utilizes PKC validation via its local PKC storage and CRL, and RockIt Vault™. PKC validation messaging is depicted by the bi-directional dependency connectors, labeled “PKC_SERV” between blocks 8738 and 8726, 8738 and 8746, 8742 and 8726, and 8746 and 8726, respectively. The RockIt™ IPsec and PKC frameworks provide network security and authorization for RockItRouter™ broadband modems and RockItClient™ host devices, and results in security for a customer's host devices, their WLAN/LAN network, and their access to the Internet broadband provider network. This is illustrated by the bi-directional control flow connectors labeled “VPN” between blocks 8736 and 8740, 8736 and 8744, and 8740 and 8744, respectively.

FIG. 24 is an activity diagram that illustrates the RockItRouter IPsec processing. Those of skill in the art will appreciate the IPsec architecture components, processes and communications details illustrated in the drawing, as well as the IPsec architecture components, processes and communications extensions provided by the RockItRouter™ system to mandate, automate and manage network security and authorization, and facilitate service order fulfillment and account processing. The drawing illustrates the RockItSwitch™ back office object, block 9022, host device object, block 9024, TCP/IP driver object, block 9026, IPsec driver, block 9028, and IPsec processing activity at block 9029.

The TCP/IP driver object represents the broadband modem TCP/IP driver bound to the WAN and LAN ports. The RockItSwitch™ back office object represents the RockItSwitch™ back office and the bi-directional control flow connector between blocks 9022 and 9026 illustrates the TCP/IP communications that occur between the RockItRouter™ broadband modem and the RockItSwitch on the WAN port of the broadband modem. The host device object represents a customer host device on the customer's WLAN/LAN home network, and the bi-directional control flow connector between blocks 9024 and 9026 illustrates the TCP/IP communications that occur between the RockItRouter™ broadband modem and the host device on the LAN port of the broadband modem. The IPsec driver object represents the IPsec driver of the broadband modem. The bi-directional control flow connector between blocks 9026 and 9028 depicts the communications between the TCP/IP driver and IPsec driver.

The IPsec processing activity, block 9029, illustrates the IPsec processing details of the RockItRouter™ broadband modem. The bi-directional control flow connectors between block 9029 and 9026, and 9029 and 9028, depict the communication flows between the IPsec processing activity, and the TCP/IP driver and IPsec driver, respectively. The IPsec processing activity illustrates the lower level implementation details of the RockIt™ IPsec and PKC framework processing within the RockItRouter™ broadband modem.

The IPsec driver, being bound to the TCP/IP driver, monitors, decrypts, and validates all inbound unicast IP, and monitors and secures all outbound unicast IP traffic on each port. This relationship is depicted by the bi-directional control flow connectors between blocks 9024, 9026, and 9028, and blocks 9022, 9026, and 9028, respectively. The IPsec driver monitors network packet traffic to determine how packets are processed and routed. The incoming packet initial node, block 9027, illustrates an incoming packet for the IPsec processing activity. The packet is compared to the filter list in the Security Policy Database (SPDB), block 9030, and the result of the comparison is illustrated by the filter match decision, block 9032. A control flow connector illustrates the relationship between blocks 9030 and 9032. The filter match results in either the packet being routed, depicted by the route packet final flow, block 9034, and the control flow connector labeled “No” at block 9031, between blocks 9032 and 9034, or a search for a security association, depicted by the find security association in Security Association Database (SADB) action at block 9036, and the control flow connector labeled “Yes” at block 9090, between blocks 9032 and 9036. If the filter match decision results in the packet being routed it is sent back to the TCP/IP driver for routing to its destination; otherwise a search for a security association in the SADB is processed.

The SA found decision, block 9038, depicts the result of the search, a control flow connector illustrates the relationship between blocks 9030 and 9032. If no security association is found the process performs a filter action check, as depicted by the check filter action, block 9040, and the control flow connector labeled “No”, block 9092, that illustrates the relationship between blocks 9038 and 9040. The check filter action results in the appropriate filter action applied to a packet, as depicted by the filter actions action, block 9042, and the control flow connector between blocks 9040 and 9042. There are five filter actions used to handle the following packet processing and routing cases:
a packet filter designates that a packet is not permitted to be routed through the system and results in the packet being dropped;
a packet filter designates that a packet is permitted to be routed through the system and results in IPsec processing;
a packet filter designates that a packet is permitted to be routed through the system;
a packet filter designates that a packet is redirected and results in service order fulfillment processing;
a packet filter designates that a packet is secured and results in IKE processing.

These cases are illustrated by the drop packet final flow, block 9041, route IPsec final flow, block 9097, route final flow, block 9096, service order fulfillment action, block 9043, and the negotiate security (IKE) action at block 9044. The control flow connectors illustrate the relationships between block 9042 and 9041, 9042 and 9097, 9042 and 9096, 9042 and 9043, and 9042 and 9044, respectively. Those of skill in the art will appreciate the systems IPsec filter action implementation. The UbiquityNet, Inc. technologies that make the filter action implementation unique are found in the system's capability to dynamically mandate, automate and manage the creation, deletion and modification of filter actions to promote network security and authorization, and to facilitate service order fulfillment and account processing.

The drop packet final flow illustrates the packet being dropped. The route IPsec final flow illustrates the packet being secured by IPsec processing, whereby the IPsec driver secures the packet and sends the packet back to the TCP/IP driver for routing. This is illustrated by the bi-directional control flow connectors between blocks 9029, 9028, and 9026. The route final flow illustrates the packet being routed, whereby the packet is sent to the TCP/IP driver for routing, as illustrated by the bi-directional control flow connector between blocks 9029 and 9026. The service order fulfillment action illustrates the packet is forwarded to the RockItRouter Security System™ for service order fulfillment sub-processing, as depicted by the control flow connector and associated line segments labeled SOF at blocks 9098, connected to blocks 9043 and 9076, respectively. The negotiate security (IKE) action illustrates that the packet requires an ISAKMP negotiation exchange between the two devices sets up IPsec communications.

The IKE activity contains the Phase 1 (main mode or aggressive mode) action, block 9048, and the Phase 2 (quick mode) action at block 9050. The negotiate security (IKE) filter action utilizes the IKE Phase 1 (main mode or aggressive mode) action to facilitate an ISAKMP negotiation exchange between the two devices that sets up IPsec communications. ISAKMP negotiation exchange involves communications from the RockItRouter™ broadband modem back to the host device through the TCP/IP driver. This is illustrated by the send packet final flow at block 9052 and bi-directional the control flow connectors between blocks 9029 and 9026, and 9026 and 9024. Those of skill in the art will appreciate the systems IKE implementation, and more specifically, the phase 1 authentication with revised mode of public key exchange. What makes the RockIt™ IKE implementation unique lies in the interpretation and handling of ISAKMP errors that are raised during the ISAKMP negotiation exchange. Specifically, the RockIt™ IKE implementation monitors ISAKMP negotiation exchange and creates, or raises, ISAKMP errors for the following cases:
ISAKMP phase 1, message 1 timeout;
ISAKMP phase 1, message 1 message count limitation;
ISAKMP phase 1, message 3 authentication exception.

The ISAKMP phase 1, message 1 timeout or ISAKMP phase 1, message 1 message count limitation exceptions typically occur when a new customer or an unauthorized user attempts to access the Internet. The ISAKMP phase 1, message 3 authentication exceptions typically occur during the following use cases:
an expired customer account subscription;
customer account billing and/or payment processing error;
customer account requires processing;
a current customer with a non-roaming subscription is attempting to roam the Internet broadband provider network; and/or
a current customer with a roaming subscription is attempting to roam beyond a geographic or alternative Internet broadband provider network constraint.

The system implements the use case depicted above through PKC validation. ISAKMP phase 1, message 3 exceptions for the above use cases are equivalent to the following PKC validation exception cases:
a PKC is expired;
a PKC is listed in a CRL;
a roaming PKC is being used outside its designated geographic area;
a roaming PKC is not authorized to access the Internet broadband provider network which the customer is currently attempting to access; and/or
a non-roaming PKC is being used to for roaming access.

PKC validation determines an Internet broadband provider's customer account status and limitations. During the ISAKMP negotiation exchange, the IKE sub-system of the RockItRouter™ broadband modem utilizes the RockItRouter Security System™ (RockItRSS) to monitor the ISAKMP negotiation exchange status and to facilitate PKC validation (e.g., PKC look up and path validation, and certification revocation lists). This is illustrated by the bi-directional control flow connector labeled “IKE/RockItRSS Calls” between the IKE activity and the RockItRouter Security System™ activity at block 9076. Those of skill in the art will appreciate the systems IKE implementation for PKC validation. The RockIt™ IKE implementation is unique, in that the system uses the RockItRouter Security System™ to monitor the ISAKMP negotiation exchange status, to facilitate PKC validation, and logically to determine and manage customer account status and limitations. The IKE subsystem notifies the RockItRouter Security System™ of ISAKMP negotiation exchange after ISAKMP phase1, message 1, and ISAKMP phase 1, message 2 processing. This enables the RockItRouter Security System™ to monitor the ISAKMP negotiation exchange status, and to utilize the knowledge of the ISAKMP negotiation exchange status during ISAKMP exception handling, and for dynamic generation of filter actions.

In addition, the RockItRouter Security System™ provides the IPsec and PKC framework processes to mandate, automate and manage network security and authorization, and to facilitate service order fulfillment and account processing. While the lower level implementation details of the RockItRouter Security System™ are beyond the scope of the present application, those of skill in the art will appreciate the RockItRouter Security System sub-systems and business processes that provide real-time and automated IPsec policy, PKC, and QoS management processing. The RockItRouter Security System™ activity contains the HTTP Redirector to automate service order fulfillment and account processing in real-time. It also contains several sub-systems to implement and support the RockIt™ IPsec, PKC, and QoS frameworks, the IPsec processing manager, block 9070, PKC processing manager, block 9071, QoS processing manager, block 9072, and the RockItRouter™ Database at block 9074. See FIG. 22—RockIt IPsec and PKI Management, and the FIG. 22 narrative above for the IPsec and PKI processing and communication details provided by the RockItRouter™ within the RockIt™ IPsec and PKI framework. See FIG. 23—RockIt PKC Architecture (Revocation, Renewal, Rekey and Update), and the FIG. 23 narrative above for the RockIt™ PKC processing and communication details provided by the RockItRouter within the PKC framework for PKC revocation, renewal, rekey and update.

The RockItRouter™ broadband modem system is designed to trap ISAKMP exceptions, and to create and raise ISAKMP exception handlers for system processing. The RockItRouter Security System™ receives the ISAKMP exception handlers and performs the appropriate service order fulfillment and account processing. This is illustrated by the interrupt flow connectors between the IKE activity and the ISAKMP exception handler, block 9078, authentication exception handler—expired certificate, block 9080, and the authentication exception handler—non-roaming certificate at block 9082. The realize connectors between blocks 9078, 9080, 9082 and the HTTP redirector sub-activity, block 9084, illustrate the RockItRouter Security System™ ISAKMP exception handling—resulting in service order fulfillment and account processing. The RockItRouter Security System™ utilizes IKE, ISAKMP exception handling, and filter actions to mandate, automate, and manage network security and authorization, and to facilitate service order fulfillment and account processing. During ISAKMP exception handling, the RockItRouter Security System™ utilizes the IPsec processing manager, block 9070, to dynamically generate IPsec rules for the host device and to store them in the security policy database for future processing.

In the first of four examples, consider the case of a customer with an expired subscription. During the ISAKMP identity protection exchange, IKE notifies the RockItRouter Security System™ of the ISAKMP phase 1, message 2. During ISAKMP phase1, message 3, the PKC is found to be expired (i.e., the customer's subscription period is over) or the PKC is list in a CRL (e.g., the customer's credit card billing information is not valid, automatic billing failed and the RockIt Management System™ listed the customer's PKC in the CRL). The PKC being invalid causes IKE to trap the ISAKMP phase 1, message 3 authorization error, and to create and raise the ISAKMP exception handler to the RockItRouter Security System™ for processing, and, concurrently, allows the ISAKMP identity protection exchange to complete, resulting in IPsec communications being authorized between the two devices. However, the RockItRouter Security System™ processes the ISAKMP exception handler, dynamically creating several IPsec rules to mandate, automate, and manage network security and authorization, and to facilitate service order fulfillment and account processing. It creates several IPsec rules that associate an IPsec filter for a customer's host device(s) with a filter action. IPsec rules including the following:
a filter action configured to PERMIT, that is permit routing of, all outbound TCP/IP packets from the customer's host device(s), destined to any RockItSwitch™ back office system;
a filter action configured to REDIRECT, that is redirect routing of, all outbound TCP/IP packets from the customer's host device(s), destined to any IP address on port 80, 8080, or 443, to the HTTP Redirector;
a filter action configured to DROP, that is to drop, all outbound TCP/IP packets from the customer's host device(s).

The IPsec communication between the host device and RockItRouter™ broadband modem enables continued security on the customer's WLAN/LAN network. The IPsec rules automate the authorization status (e.g., unauthorized) of the customer's host device communication with the Internet broadband provider network—e.g. denying that customer access to the Internet, This advantageously results in security for the Internet broadband provider network. Moreover, the IPsec rules automate renewal service order fulfillment and account processing.

With these IPsec rules in place, when the customer attempts to access the Internet, TCP/IP packets from their host device are permitted, redirected, or dropped. Communication between the customer's host device and the RockItSwitch™ back office is always permitted. TCP/IP packets from the customer's host device to any other destination are dropped by the RockItRouter™ broadband modem, except those packets destined to ports 80, 8080, and 443. TCP/IP packets destined to ports 80, 8080, and 443 are redirected to the HTTP Redirector for renewal service order fulfillment processing. The customer's Internet access is limited to the automated, real-time, renewal service order fulfillment processing. Regardless of the URL the customer attempts to use with their web browser, they are redirected to the RockItSwitch™ back office for renewal service order fulfillment processing. Once the customer completes the renewal service order fulfillment processing, their account is made current. As part of the subscription renewal processing, the RockIt Management System™ utilizes the RockItRouter Security System™ IPsec and PKC processing managers to dynamically manage the PKC renewal and IPsec rule deletion processing—resulting in Internet broadband provider network access for the customer. See FIG. 27—RockIt PKC Subscriber Processing (Expired) and the FIG. 27 narrative below for the processing and communication details of IKE, ISAKMP exception handling, and filter actions to mandate, automate, and manage network security and authorization, and to facilitate renewal service order fulfillment and account processing.

In the second of four examples, consider the case of a customer, with current “non-roaming” subscription. During the ISAKMP identity protection exchange, IKE notifies the RockItRouter Security System™ of the ISAKMP phase 1, message 2. During ISAKMP phase1, message 3, the PKC is found to be current; however, the PKC is found to be invalid. There are several use cases where a current PKC may be found invalid when used for roaming access. The customer account and associated PKC does not a support a roaming subscription or the customer account and associated PKC does support a roaming subscription, but it is being used out of bounds. The customer may be roaming outside a geographic area or is roaming an Internet broadband provider network for which their subscription does not authorize use. During the ISAKMP phase1, message 3, PKC validation, the IKE sub-process utilizes the RockItRouter Security System™ method calls and processing to determine how to process the customer's PKC. The RockItRouter Security System™ communicates with the RockIt Management System™ and RockIt Vault™ to determine acceptable use policy for the PKC. The acceptable use policy for the PKC is communicated back to the IKE sub-process and the customer is granted Internet access or redirected to the roaming service order fulfillment process. If the acceptable use policy for the PKC is determined to be invalid, the IKE processing of the ISAKMP phase1, message 3 results in an authorization error. The IKE sub-process creates and raises an ISAKMP exception handler to the RockItRouter Security System™ for processing, and, concurrently, allows the ISAKMP identity protection exchange to complete, resulting in IPsec communications being authorized between the two devices. By analogy, the system performs that same process going forward as was illustrated above for an expired customer account. The RockItRouter Security System™ processes the ISAKMP exception handler, dynamically creating several IPsec rules to mandate, automate, and manage network security and authorization, and to facilitate service order fulfillment and account processing. It creates several IPsec rules that associate an IPsec filter for a customer's host device(s) with a filter action. IPsec rules including the following:
a filter action configured to PERMIT, that is permit routing of, all outbound TCP/IP packets from the customer's host device(s), destined to any RockItSwitch™ back office system;
a filter action configured to REDIRECT, that is redirect routing of, all outbound TCP/IP packets from the customer's host device(s), destined to any IP address on port 80, 8080, or 443, to the HTTP Redirector;
a filter action configured to DROP, that is to drop, all outbound TCP/IP packets from the customer's host device(s).

The IPsec communication between the host device and RockItRouter™ broadband modem enables continued security on the customer's WLAN/LAN network. The IPsec rules automate the authorization status (e.g., unauthorized) of the customer's host device communication with the Internet broadband provider network—e.g. denying that customer access to the Internet. This advantageously results in security for the Internet broadband provider network. Moreover, the IPsec rules automate roaming service order fulfillment and account processing.

With these IPsec rules in place, when the customer attempts to access the Internet, TCP/IP packets from their host device are permitted, redirected, or dropped. Communication between the customer's host device and the RockItSwitch™ back office is always permitted. TCP/IP packets from the customer's host device to any other destination are dropped by the RockItRouter™ broadband modem, except those packets destined to ports 80, 8080, and 443. TCP/IP packets destined to ports 80, 8080, and 443 are redirected to the HTTP Redirector for renewal service order fulfillment processing. The customer's Internet access is limited to the automated, real-time, roaming service order fulfillment processing. Regardless of the URL the customer attempts to use with their web browser, they are redirected to the RockItSwitch™ back office for roaming service order fulfillment processing. Once the customer completes the roaming service order fulfillment processing, their account is updated to reflect their roaming access—acceptable use policy for their PKC includes roaming, additional geographic areas, or additional Internet broadband provider network access. As part of the subscription roaming processing, the RockIt Management System™ utilizes the RockItRouter Security System IPsec and PKC processing managers to dynamically manage PKC update and storage, and IPsec rule deletion processing—resulting in roaming access for the customer. See FIG. 18—RockIt PKC Subscriber Processing (Roaming) and the FIG. 18 narrative above for the processing and communication details of IKE, ISAKMP exception handling, and filter actions to mandate, automate, and manage network security and authorization, and to facilitate roaming service order fulfillment and account processing.

In the third of four examples, consider the case of a new customer. During the ISAKMP identity protection exchange, IKE notifies the RockItRouter Security System™ of the ISAKMP phase 1, message 1. During ISAKMP identity protection exchange processing for new customers, the IKE sub-process of the ISAKMP phase1, message 1 results in an authorization error. There are two use cases, which illustrate an ISAKMP phase1, message 1 authorization error. The ISAKMP identity protection exchange, during ISAKMP phase1, message 1, experiences a timeout—that is, after a period of time, the IKE sub-process raises an error condition if an ISAKMP phase1, message 2 has not been received by IKE to continue ISAKMP identity protection exchange. Additionally, if the number of ISAKMP identity protection exchange attempts by the IKE sub-system exceeds its configured limit, then the IKE sub-process raises an error condition. Both error conditions result in an ISAKMP authorization error, or no reply event, and the IKE sub-process creates and raises an ISAKMP exception handler to the RockItRouter Security System™ for processing. The RockItRouter Security System processes the ISAKMP exception handler by taking over packet processing, to mandate, automate, and manage network security and authorization, and to facilitate service order fulfillment and account processing.

The ISAKMP exception handler in this case passes the packet data to the RockItRouter Security System™ for processing. The RockItRouter Security System™ performs a destination IP and port analysis to determine ISAKMP exception handler processing. Packets destined to ports 80, 8080, 443 are processed by the HTTP redirector for new service order fulfillment processing; all others are dropped by the system. Additionally, the RockItRouter Security System™ provides default IPsec rules to mandate, automate, and manage network security and authorization, and to facilitate service order fulfillment and account processing. Default IPsec rules including the following:
a filter for all host devices and corresponding a filter action configured to PERMIT, that is permit routing of, all outbound TCP/IP packets from host device(s), destined to any RockItSwitch™ back office system;
a filter for all host devices and corresponding a filter action to SECURE, that is setup IPsec communications, all inbound TCP/IP packets from the host device(s);
a filter action configured to DROP, that is to drop, all outbound TCP/IP packets from the customer's host device(s).

The TCP/IP communications between the customer's host device and RockItRouter™ broadband modem are not secure using IPsec communication until new service order fulfillment is complete. However, the default IPsec rules and RockItRouter Security System™ ISAKMP authorization error handling automates the authorization status (e.g., unauthorized) of the customer's host device communication with the Internet broadband provider network—e.g. denying that customer access to the Internet and results in security for the Internet broadband provider network. Moreover, the RockItRouter Security System ISAKMP authorization error handling automates new service order fulfillment and account processing.

With these default IPsec rules in place, when the customer attempts to access the Internet, TCP/IP packets from their host device are permitted, secured, or dropped. Communication between the customer's host device and the RockItSwitch™ back office is always permitted. All TCP/IP packets received from a customer's host device(s) require security. All packets destined to the Internet are dropped by the system. In addition to the default IPsec rules detailed above, an IPsec rule can be added which redirects all outbound TCP/IP packets destined to any address, except RockItSwitch™ back office systems, and ports 80, 8080, and 443, to the HTTP Redirector for new service order fulfillment and account processing. The IPsec rules and RockItRouter Security System ISAKMP authorization error handling restrict a new customer's Internet access to the automated, real-time, new service order fulfillment process. Regardless of the URL the customer attempts to use with their web browser, they are redirected to the RockItSwitch™ back office for new service order fulfillment processing. Once the customer completes the new service order fulfillment processing, their account is activated. As part of new subscription processing, the RockIt Management System™ utilizes the RockItRouter Security System™ IPsec and PKC processing managers to dynamically manage PKC enrollment, registration and storage, and IPsec configuration processing—resulting in Internet access for the customer. See FIG. 26—RockItRouter Security System and HTTP Redirector (New) and the FIG. 26 narrative below for the processing and communication details of IKE, ISAKMP exception handling, and filter actions to mandate, automate, and manage network security and authorization, and to facilitate new service order fulfillment and account processing.

In the fourth example, consider the case of a current customer. The IPsec processing action proceeds as detailed above, an unsecured incoming packet from a current customer's host device is analyzed and compared to the filter actions. The packet is designated to be secured, and the ISAKMP identity protection exchange proceeds. During the ISAKMP identity protection exchange, IKE PKC authorization proceeds normally and IPsec communications are established between the customer's host device(s) and the RockItRouter™ broadband modem. See FIG. 26—RockItRouter Security System and HTTP Redirector (New) and the FIG. 26 narrative below for the processing and communication details of IKE, ISAKMP exception handling, and filter actions to mandate, automate, and manage network security and authorization, and to facilitate new service order fulfillment and account processing.

All future packets received by the RockItRouter™ broadband modem from the RockItClient™ host device proceed through IPsec Processing as before, with the exception that there is an established security association. As such, these packets traverse the system through a different processing path. When the system performs a search for the security association in the SADB, as illustrated by the find security association in SADB, block 9036, the SA found decision, block 9038, returns true, and the system sets SA aging, as illustrated by the set SA aging action, block 9054, and the control flow connector at block 9094 labeled “Yes” between blocks 9038 and 9054. The set SA aging results in the system's check of the SA age, as depicted by the check SA age action, block 9056, and the control flow connector between blocks 9054 and 9056.

The SA age check results in the SA age analysis, as illustrated SA age decision, block 9058, and the control flow connector between blocks 9056 and 9058. The SA age decision, block 9058, illustrates the possible three processing paths resulting from the analysis: the SA is expiring, expired, or current. If the SA is expiring then the system utilizes IKE to initiate the ISAKMP identity protection exchange, by means of, ISAKMP Phase 2 (i.e., Quick Mode). This is illustrated by the Phase II (Quick Mode) action, block 9050, and the control flow connector labeled “SA Expiring” at block 9062. If the SA is expired then the system utilizes IKE to initiate the ISAKMP identity protection exchange, by means of ISAKMP Phase 1 (i.e., Main Mode or Aggressive Mode). In addition, the current packet may be dropped or retained until IPsec communications are reestablished. This is illustrated by the Phase 1 (Main Mode or Aggressive Mode) action, block 9048, the control flow connector labeled “SA Expired” at block 9060, and between block 9058 and the fork (representing the two concurrent process paths), the control flow connector labeled “Enter Phase 1” at block 9066, the drop packet final flow at block 9064, and the control flow connector between the fork and block 9064. If the SA is current then the packet is analyzed against the filter action, as illustrated by the check filter action, block 9040, and the control flow labeled “Current” at block 9061. As detailed above the appropriate filter action is applied by the system: redirect, permit unsecured, permit secured, or drop filter actions.

In the case of a redirect filter action, the use cases illustrated above detail the system processing for renewal and roaming service order fulfillment. In the case of a permit unsecured filter action, the packet is sent to the IPsec driver where it is decrypted and sent to the TCP/IP driver for routing to its destination. In the case of a permit secured filter action, the packet is sent to the IPsec driver where it is decrypted, that is the SA between the RockItRouter™ broadband modem and the RockItClient™ host device is removed, and the SA between the RockItRouter™ broadband modem and destination is applied, thereupon, the secured packet is sent to the TCP/IP driver for routing to its destination. Secured communication between the RockItRouter™ broadband modem and the RockItSwitch™ back office systems is a use case that illustrates this example of IPsec processing. In the case of a drop filter action, the packet is dropped by the system.

FIG. 25 illustrates the RockIt™ PKC current subscriber processing for a current customer using a RockItClient™ host device connected to a RockItRouter™ broadband modem. Upon connecting a subscriber's host device, block 8222, to the RockItRouter™ broadband modem, block 8228, an ISAKMP negotiation exchange between the two devices sets up IPsec communications. The host device is said to be the initiator, block 8224, and the RockItRouter™ broadband modem is said to be the responder, block 8226, of the ISAKMP main mode negotiation exchange.

Those of skill in the art will appreciate the systems IKE implementation, and more specifically, the phase 1 authentication with revised mode of public key exchange. The communication association connector, block 8240, represents the ISAKMP phase 1, message 1, sent to the responder. The ISAKMP phase 1 negotiation exchange, is further illustrated by the communication association connectors, phase 1, message 2, block 8244, phase 1, message 3, block 8246, phase 1, message 4, block 8256, phase 1, message 5, block 8258, and phase 1, message 6, block 8260. The resulting secure TCP/IP messages, depicted by the communication association connectors at blocks 8262 and 8264 illustrate successful main mode authentication establishing IPsec communications between the initiator and responder.

The diagram fragment, block 8230, and the RockItRouter™ IPsec processing subactivity illustrate the system's utilization of RockItRouter™ IPsec processing during the ISAKMP negotiation exchange and IPsec communications. The realize connector at block 8242 depicts the relationship between blocks 8226 and 8230. See FIG. 24—RockItRouter™ IPsec Processing and the FIG. 24 narrative above for the RockItRouter™ IPsec processing and communications details.

The RockItRouter™ IPsec processing monitors, decrypts, and secures inbound unicast IP packets, and it monitors and secures outbound unicast IP packets transported through the RockItRouter™ broadband modem.

FIG. 26 is a communication diagram that illustrates the RockItRouter Security System™ and HTTP Redirector processing for a new customer. A new subscriber connects their host device, block 8322, to the RockItRouter™ broadband modem, block 8328. The host device is said to be the responder, block 8324, and the RockItRouter™ broadband modem is said to be the initiator, block 8326, of the ISAKMP main mode negotiation exchange.

At the beginning of the ISAKMP negotiation exchange the initiator receives the TCP/IP message, block 8372, via its LAN network interface and forwards the message to the TCP/IP driver, block 8330, managing the interface, as depicted by the communication association connector, block 8374. The TCP/IP driver in turn sends the TCP/IP message to the IPsec Driver, block 8332, depicted by the communication association connector, block 8376. The IPsec driver is coupled with the TCP/IP driver to provide IPsec processing; it monitors, decrypts, and secures inbound unicast IP packets and monitors and secures outbound unicast IP packets transported through the RockItRouter™ broadband modem system. The IPsec driver utilizes the IPsec processing service, represented by the IPsec Processing activity, block 8438. The communication and processing details of the IPsec processing are illustrated by the diagram fragment, block 8346, and the RockItRouter™ IPsec processing subactivity, block 8347, contained within the IPsec processing diagram fragment. See FIG. 24—RockItRouter™ IPsec Processing and the FIG. 24 narrative above for the RockItRouter™ IPsec processing and communications details.

When the new host device sends a TCP/IP packet to the RockItRouter™ broadband modem to access the internet, the RockItRouter™ broadband modem initiates an ISAKMP negotiation exchange to set up IPsec communications. The IPsec processing subactivity utilizes the IKE activity, block 8338, to processes the ISAKMP exchange negotiation, as represented by the control flow connector between blocks 8346 and 8338. The first activity of note, contained in the IKE activity, is the ISAKMP phase 1, message 1 activity, block 8340, responsible for generating the initiator ISAKMP phase 1, message 1. The main mode instantiation of the ISAKMP identity protection exchange action, block 8342, generates the ISAKMP header (HDR) and security association (SA) negotiation payload that is sent to the responder. The ISAKMP identity protection exchange action is responsible for notifying the RockItRouter Security System™ of the ISAKMP identity protection exchange for future processing during phase 1, timeout, as depicted by notify the RockItRouter Security System™ action, block 8344, and the control flow connector between blocks 8342 and 8344. The notification is used by the IPsec processing to monitor the status of ISAKMP communications and set a timeout for the ISAKMP identity protection exchange. The ISAKMP phase 1, message 1 is sent to the responder through the TCP/IP driver, as illustrated by the communication association connector, block 8380, between the IPsec processing activity and the TCP/IP driver. The TCP/IP driver then sends the ISAKMP phase 1, message 1 via the LAN port on the RockItRouter™ broadband modem to the responder, depicted by the communication association connector, block 8382, and the ISAKMP phase 1, message 1 at block 8384.

The host device, having no RockItClient™ software to facilitate IPsec communications, continues to send TCP/IP packets without responding to the ISAKMP identity protection exchange, as depicted by the communication association connector, block 8386. The IKE activity will continue to generate plural instances of ISAKMP phase 1, message 1 and send them to the responder until the timeout period or the number of ISAKMP phase 1, message 1 limit has been reached. When the timeout period or number of ISAKMP phase 1, message 1 messages limit is reached, IKE instantiates an ISAKMP phase 1 timeout, as depicted by the ISAKMP phase 1 timeout activity at block 8348. The ISAKMP no reply action, block 8350, depicts the IKE error processing, which raises an ISAKMP exception handler, block 8352, via the interrupt flow connector between blocks 8350 and 8352.

When an ISAKMP exception handler is instantiated, the RockItRouter Security System™, block 8354, is notified, and it dynamically handles the packet. The communication association connector between blocks 8338 and 8354 depicts the instantiation. The RockItRouter Security System™ then performs a port analysis to determine what to do with the packet, as illustrated by the port analysis decision, block 8356. If the packet is determined to be an HTTP message, utilizing ports 80, 8080, or 443, then the system instantiates the process new subscriber action, block 8362, as depicted by the control flow connector, labeled, “80, 8080, 443,” block 8360. If the packet is destined for any other port, then the packets are dropped, as illustrated by the final flow labeled “Drop packets”, at block 8358.

The process new subscriber action instantiates the HTTP Redirector activity block 8364, to further process to the packet, as depicted by the control flow connector between blocks 8362 and 8366. The generate HTTP redirect action, block 8366, creates an HTTP URL redirect addressed to the RockIt™ Management System and a response TCP/IP message to be sent back to the host device web browser. The URL redirect also contains an appended query string containing encrypted data, such as RockItRouter™ Id and system information, relevant to new service order fulfillment processing preformed by the RockIt™ Management System. The URL redirect is passed from the generate HTTP redirect to the send URL redirect (RR,V) action, block 8368, as depicted by the control flow connector between blocks 8366 and 8368. RR represents the RockItRouter™ data and V represents the message version contained in the URL redirect query string. The URL redirect is sent by the send URL redirect (RR, V) action through the TCP/IP diver, via communication association connectors at blocks, 8380, 8382, and 8388.

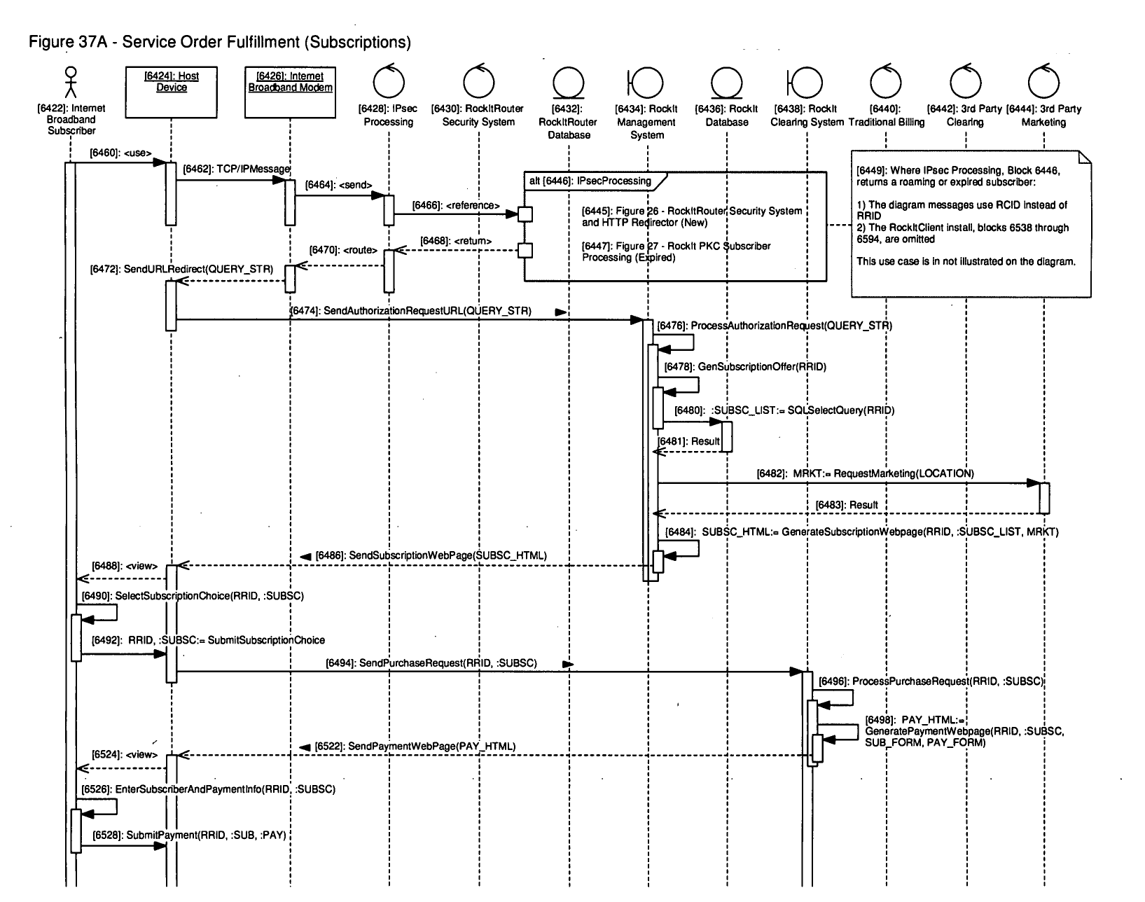

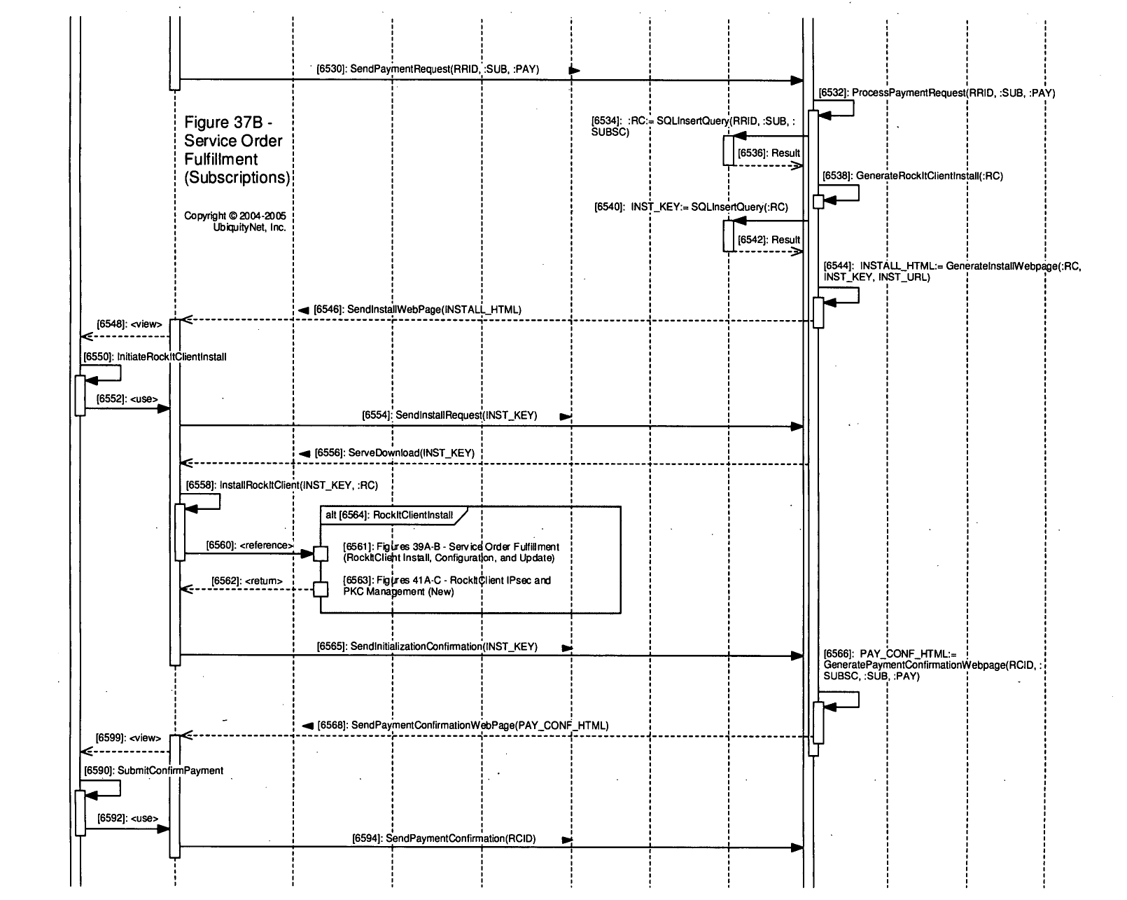

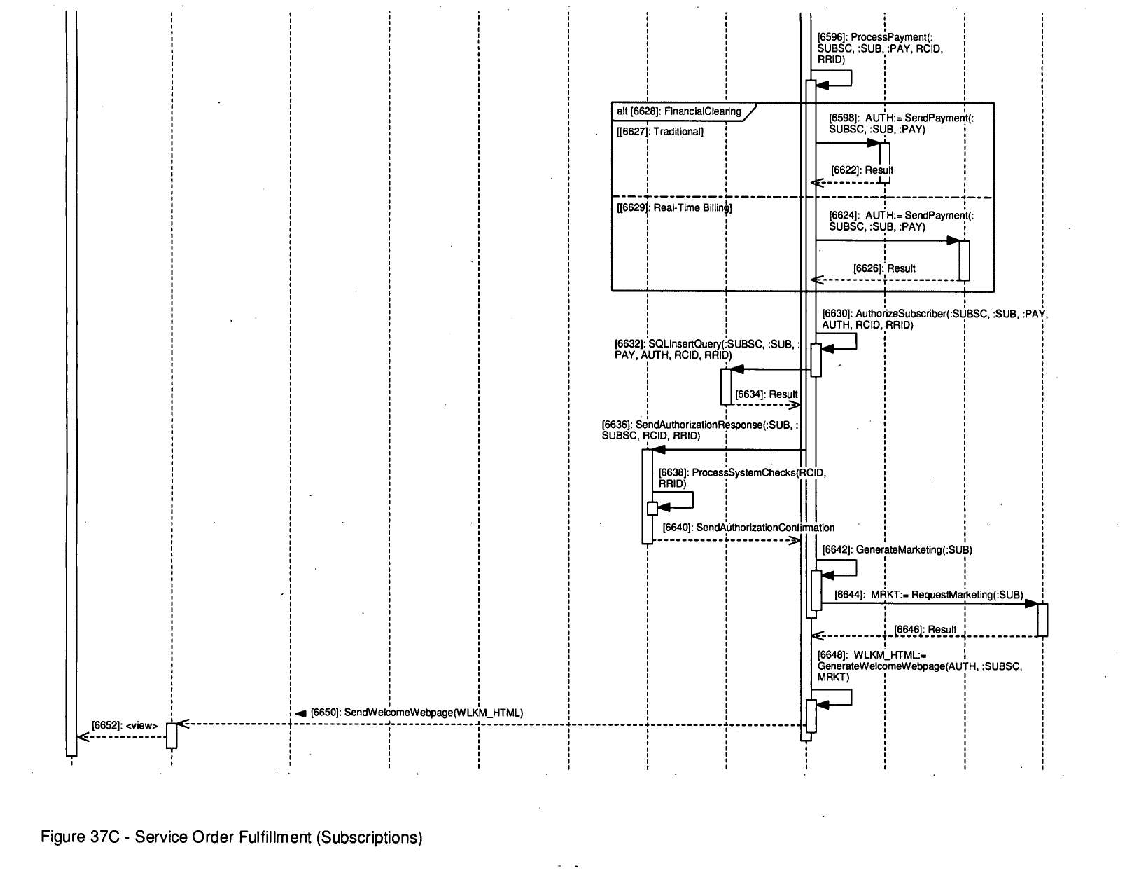

The host device web browser handles the URL redirect and sends the HTTP message to the RockIt™ Management System for new service order fulfillment processing, as depicted by the communication association connector at block 8390. The TCP/IP packets, containing the HTTP message, are passed through the RockItRouter™ broadband modem TCP/IP and EPsec drivers, and the communication association connectors at blocks 8374, 8376, and 8378. The IPsec processing filter action allows routing of the packet to the RockItSwitch™ back office, as depicted by the route packet final flow, block 8392, and the communication association connectors at blocks 8380 and 8356, and 8355 and 8381. An alternative flow of the TCP/IP packets between the RockItRouter™ broadband modem and the RockIt™ Management System may utilize IPsec communications between the systems and follow the communication association connectors at blocks 8392, 8375 and 8356, and 8355, 8376 and 8378. The RockIt™ Management System, block 8336, located in the RockItSwitch™ back office, block 8334, receives the HTTP message, and instantiates a new service order fulfillment process. See FIGS. 37A-37C—service order fulfillment (subscriptions) and the FIGS. 37A-37C narrative below for the service order fulfillment (subscriptions) processing and communications details.

It is possible that the host device has IPsec software that will respond to the ISAKMP identity protection exchange. However, the phase 1, message 1, SA proposal requires a valid certificate for processing. Any host device ISAKMP identity protection exchange without a valid certificate will cause IKE to raise an ISAKMP error, since the host device will not be able to provide a valid response given the phase 1, message 1 SA proposal sent by the initiator. An ISAKMP error in this case results in a new service order fulfillment request as detailed above.

The system provides great interoperability between WLAN and LAN devices connected to the RockItRouter™ broadband mode. Most home networks employ a 3rd party Wi-Fi Access Point connected to an Internet broadband modem to create WLAN or use Cat5 wired routers connected to an Internet broadband modem to create LAN. The RockItRouter™ broadband modem provides basic network connectivity and services, such as DHCP, while maintaining security integrity of the Internet broadband provider network. Any host device that resides behind a Wi-Fi Access Point or wired router which utilize Network Address Translation (NAT, also known as network masquerading or IP-masquerading) will not be able to access the Internet broadband provider's network without IPsec authorization. Those of skill in the art will appreciate the systems utilization of NAT Traversal (NAT-T) or RFC 3948 UDP Encapsulation of IPsec ESP Packets.

FIG. 27 is a communication diagram that illustrates the communication and processing details for issuing renewal service order fulfillment for a customer with an expired subscription. This drawing provides the communication and processing details for FIG. 13; specifically, use cases RockItRouter™ security system [RockItRouterSS], block 3034, RockItRouter™ finds expired subscriber, block 3036, HTTP redirector, block 3038, and Redirect subscriber web requests to RockItSwitch™, block 3040. As the reader will recall, these use cases represent the RockItRouter Security System™ processing for finding a subscriber with an expired subscription and issuing a renewal service order request.

Upon connecting the host device, block 8422, to the RockItRouter™ broadband modem, block 8328, an ISAKMP negotiation exchange between the two devices sets up IPsec communications. The host device is said to be the initiator, block 8424, and the RockItRouter™ broadband modem is said to be the responder, block 8426, of the ISAKMP main mode negotiation exchange.

Those of skill in the art will appreciate the systems IKE implementation, and, more specifically, the phase 1 authentication with a revised mode of public key exchange. The communication association connector, block 8470, represents the ISAKMP phase 1, message 1, sent to the responder. The ISAKMP phase 1 negotiation exchange is further illustrated by the communication association connectors, phase 1, message 2, block 8482, phase 1, message 3, block 8484, phase 1, message 4, block 8486, phase 1, message 5, block 8488, and phase 1, message 6, block 8490. The resulting secure TCP/IP message, depicted by the communication association connector, block 8492, illustrates successful main mode authentication establishing IPsec communications between the initiator and responder.

At the beginning of the ISAKMP negotiation exchange, the responder receives the ISAKMP message via its LAN network interface and forwards the message to the TCP/IP driver, block 8428, managing the interface, as depicted by the communication association connector, block 8472. The TCP/IP driver in turn sends the ISAKMP message to the IPsec Driver, block 8430, depicted by the communication association connector, block 8474. The IPsec driver is coupled with the TCP/IP driver to provide IPsec processing; it monitors, decrypts, and secures inbound unicast IP packets and monitors and secures outbound unicast IP packets transported through the RockItRouter™ broadband modem system. The IPsec driver utilizes the IPsec processing service, represented by the IPsec Processing activity, block 8438. The communication and processing details of the IPsec processing are illustrated by the diagram fragment, block 8440, and the RockItRouter™ IPsec processing subactivity, block 8442, contained within the IPsec Processing diagram fragment. See FIG. 24—RockItRouter™ IPsec Processing and the FIG. 24 narrative above for the RockItRouter™ IPsec processing and communications details. The IPsec processing activity utilizes the IKE activity, block 8444, to process the ISAKMP exchange negotiation, as represented by the control flow connector between blocks 8440 and 8444.

The first activity of note, contained in the IKE activity, is the ISAKMP phase 1, message 2 activity, block 8446, responsible for generating the responder ISAKMP phase 1, message 2. The main mode instantiation of the ISAKMP identity protection exchange action, block 8448, generates the ISAKMP header (HDR) and security association (SA) negotiation payload that is sent back to the initiator. The ISAKMP identity protection exchange action is responsible for notifying the RockItRouter Security System™ of the ISAKMP identity protection exchange for future processing during phase 1, message 3, as depicted by notify the RockItRouter Security System™ action, block 8450, and the control flow connector between blocks 8448 and 8450. The ISAKMP phase 1, message 2 is sent back to the initiator through the TCP/IP driver, as illustrated by the communication association connector, block 8478, between the IPsec processing activity and the TCP/IP driver. The TCP/IP driver then sends the ISAKMP phase 1, message 2 via the LAN port on the RockItRouter™ broadband modem to the initiator, depicted by the communication association connector at block 8482.

The initiator's RockItClient™ software processes the ISAKMP phase 1, message 2, and sends ISAKMP phase 1, message 3 back to the responder, as depicted by the communication association connector, block 8484. ISAKMP phase 1, message 3 is passed to the IKE activity, via the TCP/IP driver, IPsec driver, and IPsec processing activity and the communication association connectors, blocks 8472, 8474, and 8476. The ISAKMP phase 1, message 3 activity, block 8451, illustrates the IKE processing of ISAKMP phase 1, message 3, that contains the PKC as requested in the ISAKMP phase 1, message 2 SA negotiation payload proposal. The IKE authorization processing of the PKC is illustrated by the actions depicted in block 8451. Table 3 summarizes the three possible cases of the IKE authorization processing of the PKC for expired subscribers:

TABLE 3

| | Local | RockIt | Raise | |
|---|---|---|---|---|
| Case | CRL | Vault CRL | IKE Exception | Authorize |
| 1 | Yes | NA | Yes | Yes |
| 2 | No | Yes | Yes | Yes |
| 3 | No | No | No | Yes |

The PKC is checked against the local certificate revocation list (CRL) through the RockItRouter Security System™, as represented by the IKE authorization local CRL request action, block 8452. The local CRL check decision, block 8449, and the control flow connector between blocks 8452 and 8449, illustrates the IKE activity analysis of the local CRL check.

If the local CRL check decision is true the ISAKMP proceeds normally and an IKE authentication exception handler is raised, as depicted by the process error and authorize action, block 8455, and the control flow connector labeled “Yes”, between blocks 8449 and 8455, and IKE authentication exception handler, block 8456, and the interrupt flow connector between blocks 8455 and 8456. The ISAKMP identity protection exchange proceeds normally to establish IPsec communications between the initiator and responder—that is, the ISAKMP phase 1, message 3, results in the ISAKMP phase 1, message 4 being created and sent back to the initiator. The RockItRouter Security System™ processes the IKE authentication exception handler and configures the RockItRouter™ broadband modem to redirect customer outbound TCP/IP requests to the RockItSwitch™ back office for renewal service order fulfillment. The RockItRouter Security System™ configuration process dynamically generates IPsec rules for the host device and stores them in the security policy database for future processing. The resulting IPsec rules associate the IPsec filters for the host device with filter actions configured to drop all outbound TCP/IP packets from the customer's host device, except packets destined to ports 80, 8080, and 443. See FIG. 24—FIG. 24—RockItRouter™ IPsec Processing and the FIG. 24 narrative above for the FIG. 24—RockItRouter™ IPsec processing and communications details.

If the PKC is not listed in the local CRL, the PKC is checked against the RockIt Vault's™ CRL, as illustrated by the IKE authentication RockIt Vault™ CRL request action, block 8453, and the control flow connector labeled “No” between blocks 8449 and 8453. The IKE authentication RockIt Vault™ CRL request action sends a CRL request to the RockIt Vault™ located in the RockItSwitch™ back office, as depicted by the self-message association connector labeled “Send CRL Request.” IKE utilizes the RockItRouter Security System™ to send CRL check request messages to the RockIt™ back office for processing, as depicted by the bi-directional control flow connector between blocks 8444 and 8460. Messages sent between the RockItRouter Security System™ and the RockIt™ back office can be sent directly through the TCP/IP driver, as depicted by the communication connectors at blocks 8478 and 8496, and 8498 and 8479. Messages between the two systems can also use IPsec communications, as illustrated by the communication connectors at blocks 8494, 8475 and 8496, and 8498, 8474 and 8476, respectively.

The CRL check request message arrives at the RockItSwitch™ back office activity, block 8432, which contains the RockIt™ Management System, block 8434, and the RockIt Vault™, block 8436. The RockIt Vault™ handles the CLR check requests by checking the PKC against the CRL. The result of the CRL check is sent to the RockItRouter Security System™ and IKE authentication RockIt Vault™ CRL request action via communication association connectors, at blocks 8498 and 8479. The IKE authentication RockIt Vault™ CRL request action processes the result message from the RockIt Vault™ to determine if the PKC is listed in the RockIt Vault™ CRL, as depicted by the RockIt Vault™ CRL check decision, block 8454.

If the RockIt Vault™ CRL check decision is true, then the ISAKMP proceeds normally; however, the ISAKMP Phase 1, Message 3 activity raises an error to the RockItRouter Security System™, which redirects the customer to the renewal service order fulfillment process—as illustrated above when the local CRL check decision is true. The ISAKMP Phase 1, Message 3 activity processing, when the RockIt Vault™ CRL check decision is true, is depicted by the process error and authorize action, block 8455, and the control flow connector labeled “Yes”, between the RockIt Vault™ CRL check decision and block 8455, and the IKE authentication exception handler action and the interrupt flow connector between blocks 8455 and 8456.

If the CRL check decision is false, then IKE authorizes the ISAKMP identity protection exchange, as depicted by the authorize action, and the control flow connector labeled “No”, between blocks 8454 and 8457. As detailed above, the authorize action generates the ISAKMP phase 1, message 4 and the system proceeds thereafter to complete the ISAKMP identity protection exchange.

The resulting secure TCP/IP message, depicted by the communication association connector, block 8492, illustrates successful main mode authentication establishing IPsec communications between the initiator and responder. The host device RockItClient™ software utilizes IPsec to monitor and secures outbound unicast IP packets destined to the Internet, or other RockItClient™ host devices on the WLAN/LAN, via the broadband modem. IPsec communications destined to the Internet are received by the RockItRouter™ broadband modem TCP/IP driver, via communication association connector 8472, proceed to the IPsec Driver, via communication association connector 8474, and proceed to the IPsec Processing action, via communication association connector 8476.

The RockItRouter™ IPsec processing subactivity, block 8442, and RockItRouter Security System™, block 8460, illustrate, respectively, the IPsec Processing action for decrypting, and analyzing the packets against the IPsec rules whereby it applies the appropriate filter actions to drop all outbound TCP/IP packets from the customer's host device, except packets destined to ports 80, 8080, and 443. The control flow connector between blocks 8442 and 8460 depicts IPsec rules processing. The RockItRouter Security System™ utilizes the IPsec by rules finding a filter in the filter list and applying the appropriate filter action—whereby a destination IP and port analysis is performed, for the expired host device, to determine what to do with the packet, as illustrated by the IPsec rules analysis decision at block 8461. Table 4 details the IPsec rules analysis results in the application of five filters and corresponding filter actions:

TABLE 4

| | | | | Destina- | |
|---|---|---|---|---|---|
| | Destination | | Source | tion | |
| Source Address | Address | Protocol | Port | Port | Action |
| Host Device IP | Any | Any | Any | Any | Permit |
| Address | RockItSwitch | | | | |
| | IP Address | | | | |
| Host Device IP | Any IP Address | TCP | Any | 80 | Redirect |
| Address | | | | | |
| Host Device IP | Any IP Address | TCP | Any | 8080 | Redirect |
| Address | | | | | |
| Host Device IP | Any IP Address | TCP | Any | 443 | Redirect |
| Address | | | | | |
| Host Device IP | Any IP Address | Any | Any | Any | Drop |
| Address | | | | | |

If the packet destination IP address is to the RockItSwitch™ server, then the system applies the filter action “Permit”, which allows packets to be routed; as illustrated by the route packets final flow at block 8468, and the control flow connector between the IPsec rules analysis decision and block 8468. If the packet is determined to be an HTTP message, not destined to the RockItSwitch™ servers and utilizing ports 80, 8080, or 443, then the system applies the filter action “Redirect”, which instantiates the process expired subscriber action, block 8464; as depicted by the control flow connector labeled “80, 8080, 443” at block 8463. If the packet is destined to any other destination IP and port, then the system applies the filter action “Drop”, which drops the packets; as illustrated by the final flow labeled “Drop packets” at block 8462.

In the case of the filter action “Redirect”, the process expired subscriber action instantiates the HTTP Redirector activity block 8465, to further process the packet, as depicted by the control flow connector between blocks 8464 and 8466. The generate HTTP redirect action, block 8466, creates an HTTP URL redirect, addressed to the RockIt™ Management System, and response TCP/IP message to be sent back to the host device web browser. The URL redirect also contains an appended query string containing encrypted data, such as RockItRouter™ Id and system information, relevant for new service order fulfillment processing preformed by the RockIt™ Management System. The URL redirect is passed from the generate HTTP redirect to the send URL redirect (RR,V) action, block 8467, and depicted by the control flow connector between blocks 8466 and 8467. RR represents the RockItRouter™ data and V represents the message version contained in the URL redirect query string. The URL redirect is sent by the send URL redirect (RR, V) action through the IPsec diver, via communication association connectors at blocks, 8494, 8475, 8480, and represented by the secure TCP/IP message (URL redirect), communication association connector at block 8493.

The host device web browser handles the URL redirect and sends the HTTP message to the RockIt™ Management System for renewal service order fulfillment processing, as represented by the secure TCP/IP message (HTTP RSOFR), communication association connector at block 8495. The HTTP RSOFR depicts the HTTP renewal service order fulfillment request message contained in the secured packet. The TCP/IP packets, containing the HTTP RSOFR message, are passed through the RockItRouter™ broadband modem TCP/IP and IPsec drivers, and the communication association connectors at blocks 8472, 8474, and 8476. The IPsec processing filter action “Permit” is applied and allows routing of the packets to the RockItSwitch™ back office, as depicted by the RockItRouter™ IPsec processing subactivity, RockItRouter Security System™, via communication association connector between blocks 8440 and 8460, the IPsec rules analysis decision, at block 8461, and the route packets final flow, at block 8468, via communication association connector between blocks 8461 and 8468. The HTTP RSOFR message is routed to the RockIt™ Management System via communication association connector blocks 8478 and 8496. An alternative flow of the TCP/IP packets from the RockItRouter™ broadband modem to the RockIt™ Management System may utilize IPsec communications between the systems and follow the communication association connectors at blocks 8494, 8475, and 8496.

The RockIt™ Management System, block 8434, located in the RockItSwitch™ back office, block 8432, receives the HTTP RSOFR message, and instantiates a renewal service order fulfillment process. Following successful renewal service order fulfillment, the RockItRouter Security System™ alters the IPsec rules table accordingly, and the expired customer is granted access to the Internet broadband provider's network. See FIGS. 37A-37C—service order fulfillment (subscriptions) and the FIGS. 37A-37C narrative below for the service order fulfillment (subscriptions) processing and communications details.

Additionally, as detailed in FIG. 18, RockIt™ PKC Subscriber Processing (Roaming), and the FIGS. 18 narrative above for the RockIt™ PKC subscriber processing and communications details, the RockItRouter Security System™ can validate the integrity of an expired customer's PKC via a PKC confirmation request to the RockIt™ Management System. Integrity checks provide an additional layer of system security.

Those of skill in the art will appreciate that the RockItRouter™ broadband modem utilizes IPsec and PKC technologies to facilitate security and authorization. The RockIt™ technologies that make this system unique are found in the ability to mandate, automate and manage network security and authorization for a customer's host device connected to a RockItRouter™ broadband modem, resulting in security for the customer's host devices, and their WLAN/LAN network, and their access to the Internet broadband provider network. FIG. 27 and narrative for FIG. 27 above illustrates the unique technologies and business processes that provide a system to restrict Internet broadband provider network access to current customers.

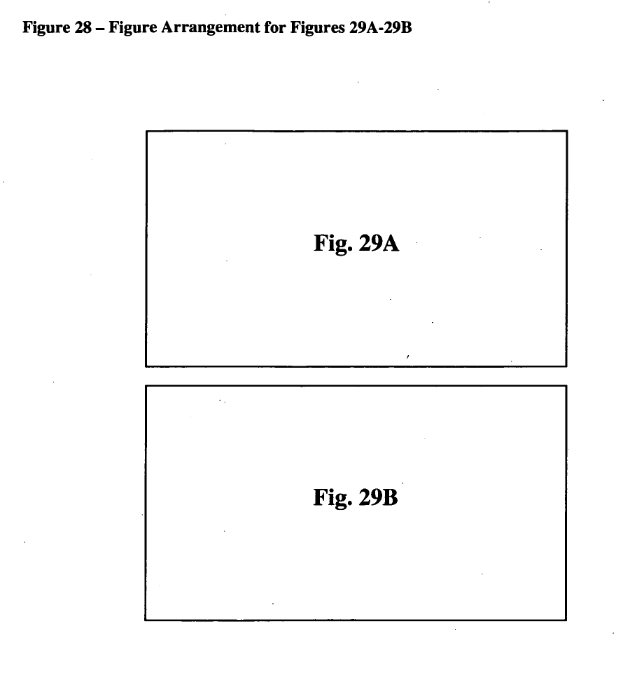

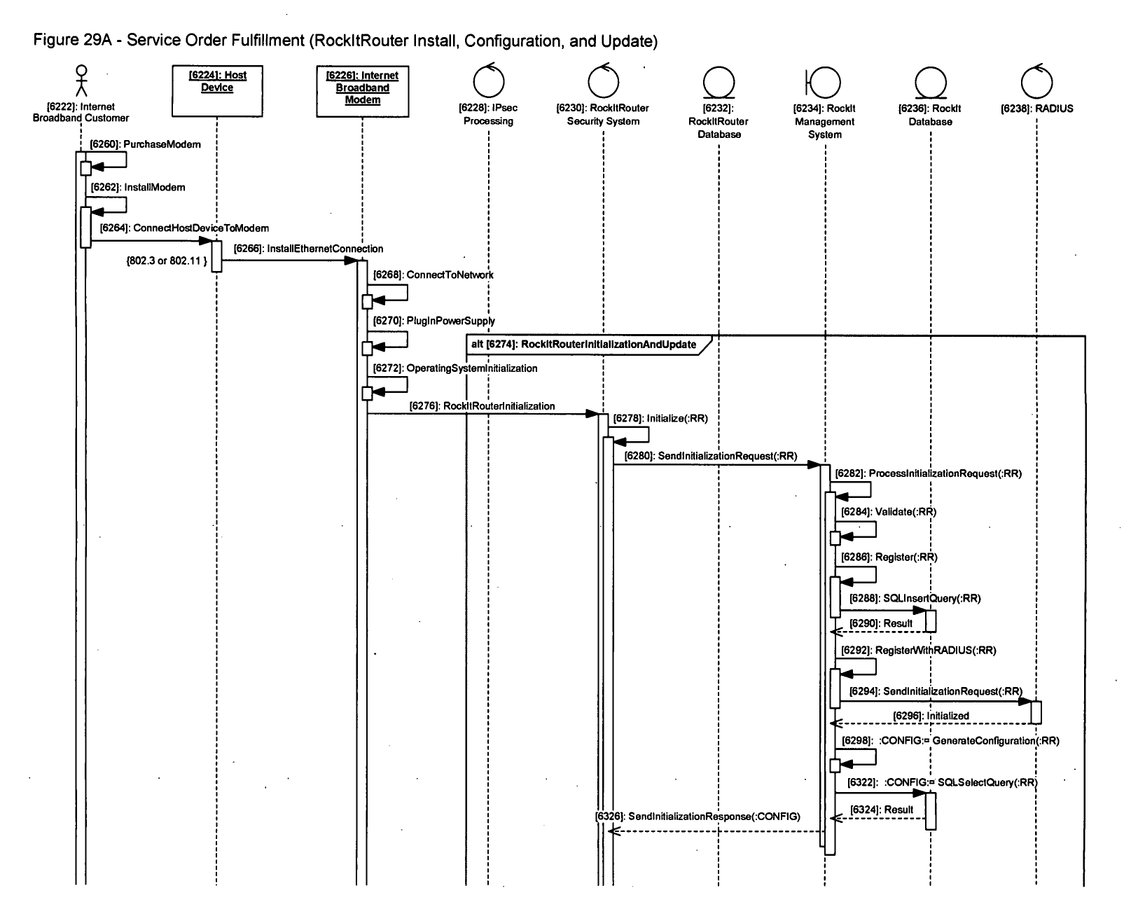

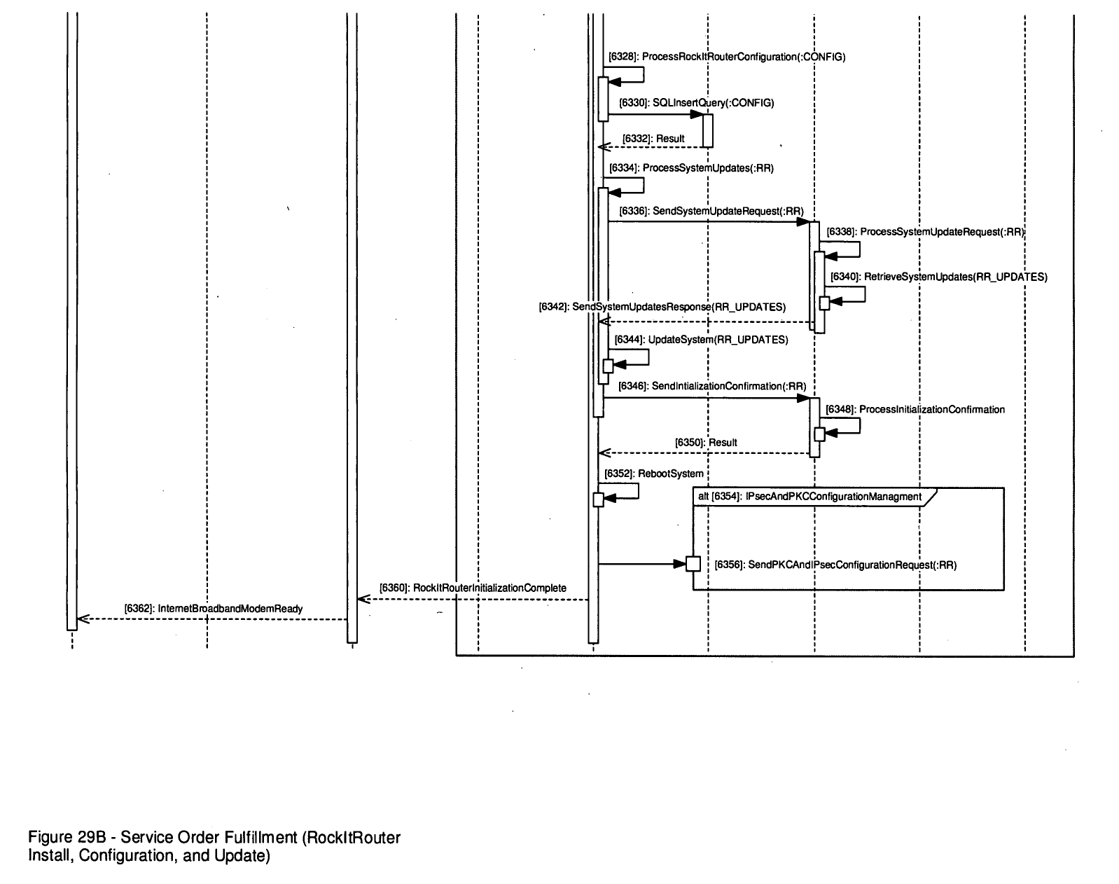

FIG. 28 is a high-level layout diagram that illustrates the proper arrangement of FIGS. 29A-29B for comprehensive viewing.

FIGS. 29A and 29B are a sequence diagram that illustrates the Service Order Fulfillment process involving RockItRouter™ Install, Configuration, and Update. The drawings contain the Internet Broadband Customer actor, block 6222, Host Device lifeline, block 6224, Internet Broadband Modem lifeline, block 6226, IPsec Processing control, block 6228, RockItRouter Security System™ control, block 6230, RockItRouter Database™ entity, block 6232, RockIt Management System™ boundary, block 6234, RockIt Database™ entity, block 6236, and RADIUS control at block 6238. The drawings also contain the diagram fragments RockItRouterInitializationAndUpdate, block 6274, and IPsecAndPKCConfigurationManagment at block 6354. The RockItRouterInitializationAndUpdate diagram fragment details the sequence messaging and processing for the RockItRouter™ initialization and update. The diagram fragment IPsecAndPKCConfigurationManagment illustrates the RockItRouter Security System™'s IPsec and PKC configuration management.

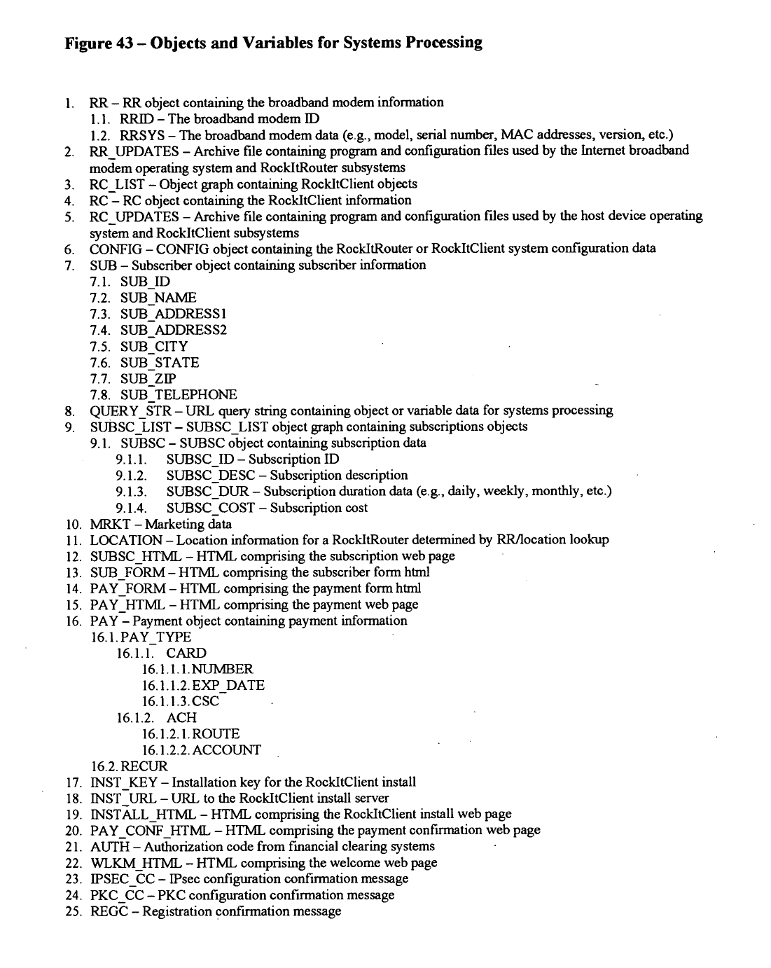

The following describes the sequence messages and self-messages for these drawings. See FIG. 43, Objects and Variables for System Processing, for descriptions of the system processing objects and variables used in these drawings. Variables proceeded with a colon indicate an object. All sequence messaging and processing via the Internet broadband customer actor is synonymous with their use of a web browser.
1. The sequence self-message connector labeled PurchaseModem at block number 6260 is a method call instantiated by the Internet Broadband Customer. It represents customer's purchase of the RockItRouter™ Internet broadband modem.
2. The sequence self-message connector labeled InstallModem at block number 6262 is a method call instantiated by the Internet Broadband Customer. It represents customer's installation of the RockItRouter™ Internet broadband modem.
3. The sequence message connector labeled ConnectHostDeviceToModem at block number 6264 is sent from the Internet Broadband Customer to the Host Device. It represents the host device being connected to the RockItRouter™ Internet broadband modem.
4. The sequence message connector labeled InstallEthernetConnection at block number 6266 is sent from the Host Device to the Internet Broadband Modem. It represents the Ethernet connection being installed from the host device to the RockItRouter Internet broadband modem. The text labeled {802.3 or 802.11}, depicts typical LAN/WLAN Ethernet connections, i.e. 802.3 via Cat5 cable and 802.11 (including B, A, and G) via wireless transport.
5. The sequence self-message connector labeled ConnectToNetwork at block number 6268 is a method call instantiated by the Internet Broadband Modem. It illustrates the connection being installed from the RockItRouter™ Internet broadband modem to the Internet broadband provider's network. Examples include a xDSL telephone wire connection or a COAX cable connection.
6. The sequence self-message connector labeled PlugInPowerSupply at block number 6270 is a method call instantiated by the Internet Broadband Modem. It illustrates the RockItRouter™ Internet broadband modem electrical connection plug-in.
7. The sequence self-message connector labeled OperatingSystemInitialization at block number 6272 is a method call instantiated by the Internet Broadband Modem. It illustrates the RockItRouter™ Internet broadband modem operating system initialization after the RockItRouter™ Internet broadband modem has an electrical connection.
8. The sequence message connector labeled RockItRouterInitialization at block number 6276 is sent from the Internet Broadband Modem to the RockItRouter Security System™. It illustrates a call to the RockItRouter™ system initialization processes during the operating system initialization process.
9. The sequence self-message connector labeled Initialize at block number 6278 is a method call instantiated by the RockItRouter Security System™. The method call passes the following parameter(s): :RR. It illustrates the RockItRouter™ system initialization process.
10. The sequence message connector labeled SendInitializationRequest at block number 6280 is sent from the RockItRouter Security System™ to the RockIt Management System™. The sent message passes the following parameter(s): :RR.
11. The sequence self-message connector labeled ProcessInitializationRequest at block number 6282 is a method call instantiated by the RockIt Management System™. The method call passes the following parameter(s): :RR.
12. The sequence self-message connector labeled Validate at block number 6284 is a method call instantiated by the RockIt Management System™. The method call passes the following parameter(s): :RR.
13. The sequence self-message connector labeled Register at block number 6286 is a method call instantiated by the RockIt Management System™. The method call passes the following parameter(s): :RR.
14. The sequence message connector labeled SQLInsertQuery at block number 6288 is sent from the RockIt Management System™ to the RockIt Database™. The sent message passes the following parameter(s): :RR.
15. The sequence message connector labeled Result at block number 6290 is sent from the RockIt Database™ to the RockIt Management System™.
16. The sequence self-message connector labeled RegisterWithRADIUS at block number 6292 is a method call instantiated by the RockIt Management System™. The method call passes the following parameter(s): :RR.
17. The sequence message connector labeled SendInitializationRequest at block number 6294 is sent from the RockIt Management System to the RADIUS. The sent message passes the following parameter(s): :RR.
18. The sequence message connector labeled Initialized at block number 6296 is sent from the RADIUS to the RockIt Management System.
19. The sequence self-message connector labeled GenerateConfiguration at block number 6298 is a method call instantiated by the RockIt Management System™. The method call passes the following parameter(s): :RR, and returns the following result(s): :CONFIG.
20. The sequence message connector labeled SQLSelectQuery at block number 6322 is sent from the RockIt Management System™ to the RockIt Database™. The sent message passes the following parameter(s): :RR, and the RockIt Management System™ expects the following return result(s): :CONFIG.
21. The sequence message connector labeled Result at block number 6324 is sent from the RockIt Database™ to the RockIt Management System™.
22. The sequence message connector labeled SendInitializationResponse at block number 6326 is sent from the RockIt Management System™ to the RockItRouter Security System™. The sent message passes the following parameter(s): :CONFIG.
23. The sequence self-message connector labeled ProcessRockItRouterConfiguration at block number 6328 is a method call instantiated by the RockItRouter Security System™. The method call passes the following parameter(s): :CONFIG.
24. The sequence message connector labeled SQLInsertQuery at block number 6330 is sent from the RockItRouter Security System™ to the RockItRouter Database™. The sent message passes the following parameter(s): :CONFIG.
25. The sequence message connector labeled Result at block number 6332 is sent from the RockItRouter Database to the RockItRouter Security System™.
26. The sequence self-message connector labeled ProcessSystemUpdates at block number 6334 is a method call instantiated by the RockItRouter Security System™. The method call passes the following parameter(s): :RR.
27. The sequence message connector labeled SendSystemUpdateRequest at block number 6336 is sent from the RockItRouter Security System™ to the RockIt Management System™. The sent message passes the following parameter(s): :RR.
28. The sequence self-message connector labeled ProcessSystemUpdateRequest at block number 6338 is a method call instantiated by the RockIt Management System™. The method call passes the following parameter(s): :RR.
29. The sequence self-message connector labeled RetrieveSystemUpdates at block number 6340 is a method call instantiated by the RockIt Management System™. The method call passes the following parameter(s): RR_UPDATES.
30. The sequence message connector labeled SendSystemUpdatesResponse at block number 6342 is sent from the RockIt Management System™ to the RockItRouter Security System™. The sent message passes the following parameter(s): RR_UPDATES.
31. The sequence self-message connector labeled UpdateSystem at block number 6344 is a method call instantiated by the RockItRouter Security System™. The method call passes the following parameter(s): RR_UPDATES.
32. The sequence message connector labeled SendIntializationConfirmation at block number 6346 is sent from the RockItRouter Security System™ to the RockIt Management System™. The sent message passes the following parameter(s): :RR.
33. The sequence self-message connector labeled ProcessInitializationConfirmation at block number 6348 is a method call instantiated by the RockIt Management System™.
34. The sequence message connector labeled Result at block number 6350 is sent from the RockIt Management System™ to the RockItRouter Security System™.
35. The sequence self-message connector labeled RebootSystem at block number 6352 is a method call instantiated by the RockItRouter Security System™.
36. The sequence message connector labeled SendPKCAndIPsecConfigurationRequest at block number 6356 is sent from the RockItRouter Security System™ to the IPsecAndPKCConfigurationManagment diagram fragment. The sent message passes the following parameter(s): :RR.
37. The sequence message connector labeled RockItRouterInitializationComplete at block number 6360 is sent from the RockItRouter Security System™ to the Internet Broadband Modem.
38. The sequence message connector labeled InternetBroadbandModemReady at block number 6362 is sent from the Internet Broadband Modem to the Internet broadband customer.

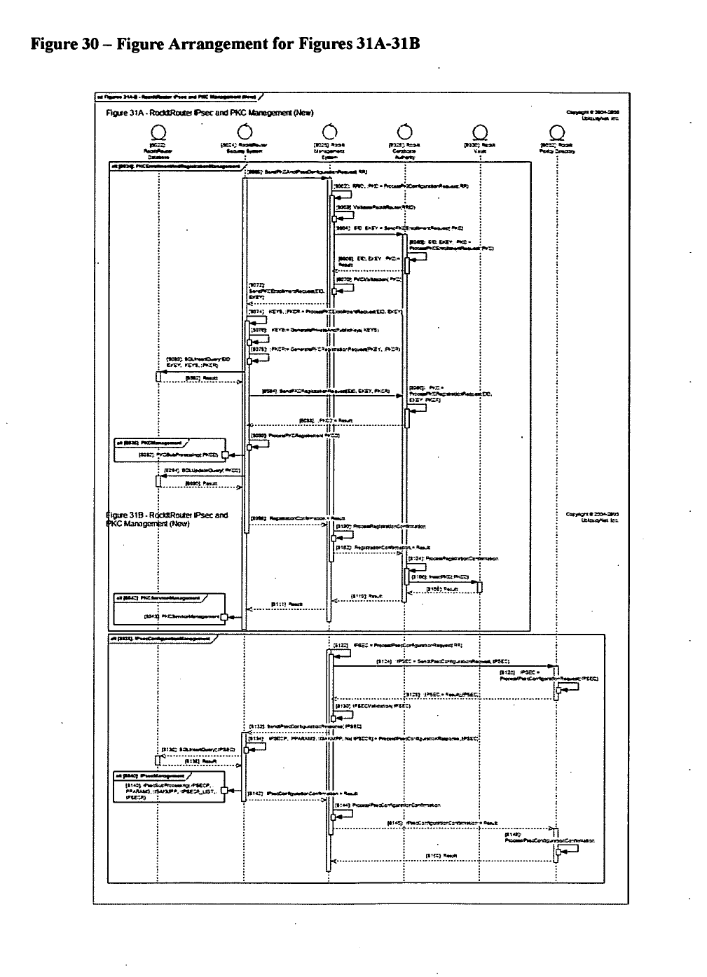

FIG. 30 is a high-level layout diagram that illustrates the proper arrangement of FIGS. 31A-31B for comprehensive viewing.

FIGS. 31A and 31B are a sequence diagram that illustrates the RockItRouter™ IPsec and PKC management systems and process flow. The drawings contain the RockItRouter Database™, block 8022, RockItRouter Security System™, block 8024, RockIt Management System™, block 8026, RockIt Certificate Authority™, block 8028, RockIt Vault™, block 8030, and RockIt Policy Directory™ at block 8032. The drawings also contain the diagram fragments PKCEnrollmentAndRegistrationManagement, block 8034, PKCManagement, block 8036, PKCServiceManagement, block 8042, IPsecConfigurationManagement, block 8038, and IPsecManagement at block 8040.

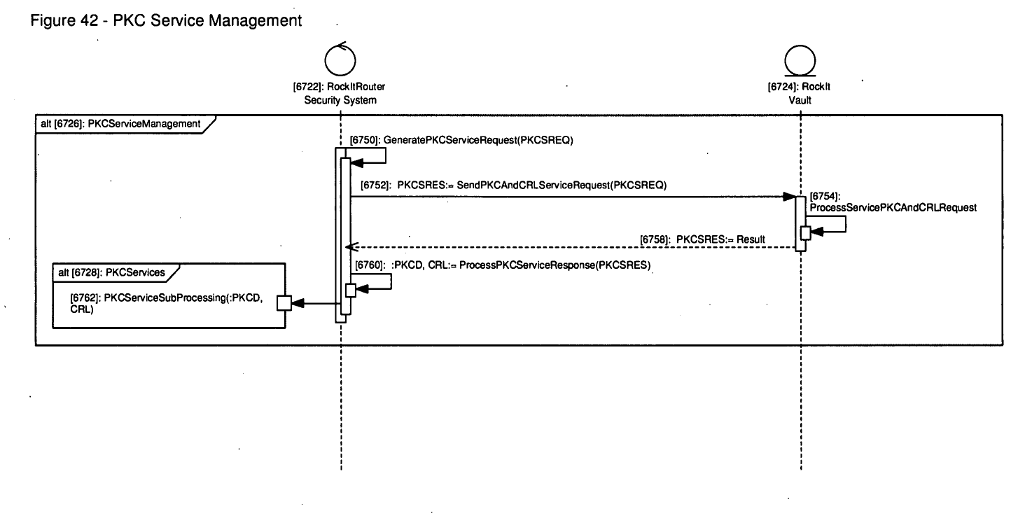

The PKCEnrollmentAndRegistrationManagement diagram fragment details the sequence messaging and processing for PKC enrollment and registration management. The IPsecConfigurationManagement diagram fragment details the sequence messaging and processing IPsec configuration management. The diagram fragments PKCManagement and IPsecManagement illustrate the RockItRouter Security System's PKC and IPsec processing. The PKCServiceManagement diagram fragment depicts PKC validation processing. See FIG. 42, PKC Service Management, and the FIG. 42 narrative below for the PKC service management processing and communications details.

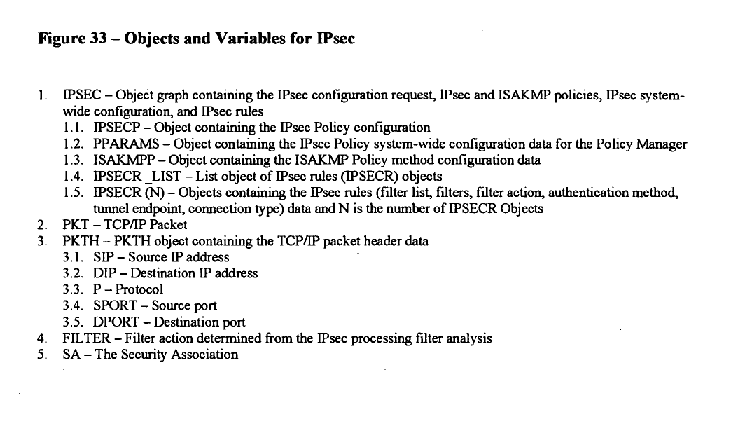

The following describes the sequence messages and self-messages for these drawings. See FIG. 32, Objects and Variables for PKC, for descriptions of the PKC objects and variables used in these drawings. See FIG. 33, Objects and Variables for IPsec, for descriptions of the IPsec objects and variables used in these drawings. Variables proceeded with a colon indicate an object.
1. The sequence message connector labeled SendPKCAndIPsecConfigurationRequest at block number 8060 is sent from the RockItRouter Security System™ to the RockIt Management System™. The sent message passes the following parameter(s): :RR.
2. The sequence self-message connector labeled ProcessPKIConfigurationRequest at block number 8062 is a method call instantiated by the RockIt Management System™. The method call passes the following parameter(s): :RR, and returns the following result(s): RRID, :PKC.
3. The sequence self-message connector labeled ValidateRockItRouter at block number 8063 is a method call instantiated by the RockIt Management System™. The method call passes the following parameter(s): RRID.
4. The sequence message connector labeled SendPKCEnrollmentRequest at block number 8064 is sent from the RockIt Management System™ to the RockIt Certificate Authority™. The sent message passes the following parameter(s): :PKC, and the RockIt Management System™ expects the following return result(s): EID, EKEY.
5. The sequence self-message connector labeled ProcessPKCEnrollmentRequest at block number 8066 is a method call instantiated by the RockIt Certificate Authority™. The method call passes the following parameter(s): :PKC, and returns the following result(s): EID, EKEY, :PKC.
6. The sequence message connector labeled Result at block number 8068 is sent from the RockIt Certificate Authority™ to the RockIt Management System™. The RockIt Certificate Authority™ expects the following return result(s): EID, EKEY, :PKC.
7. The sequence self-message connector labeled PKCValidation at block number 8070 is a method call instantiated by the RockIt Management System™. The method call passes the following parameter(s): :PKC.
8. The sequence message connector labeled SendPKCEnrollmentRequest at block number 8072 is sent from the RockIt Management System™ to the RockItRouter Security System™. The sent message passes the following parameter(s): EID, EKEY.
9. The sequence self-message connector labeled ProcessPKCEnrollmentRequest at block number 8074 is a method call instantiated by the RockItRouter Security System™. The method call passes the following parameter(s): EID, EKEY, and returns the following result(s): :KEYS, :PKCR.
10. The sequence self-message connector labeled GeneratePrivateAndPublicKeys at block number 8076 is a method call instantiated by the RockItRouter Security System™. The method call passes the following parameter(s): :KEYS, and returns the following result(s): :KEYS.
11. The sequence self-message connector labeled GeneratePKCRegistrationRequest at block number 8078 is a method call instantiated by the RockItRouter Security System™. The method call passes the following parameter(s): PKEY, :PKCR, and returns the following result(s): :PKCR.
12. The sequence message connector labeled SQLInsertQuery at block number 8080 is sent from the RockItRouter Security System™ to the RockItRouter Database™. The sent message passes the following parameter(s): EID, EKEY, :KEYS, :PKCR.
13. The sequence message connector labeled Result at block number 8082 is sent from the RockItRouter Database™ to the RockItRouter Security System™.
14. The sequence message connector labeled SendPKCRegistrationRequest at block number 8084 is sent from the RockItRouter Security System™ to the RockIt Certificate Authority™. The sent message passes the following parameter(s): EID, EKEY, PKCR.
15. The sequence self-message connector labeled ProcessPKCRegistrationRequest at block number 8086 is a method call instantiated by the RockIt Certificate Authority™. The method call passes the following parameter(s): EID, EKEY, PKCR, and returns the following result(s): :PKC.
16. The sequence message connector labeled Result at block number 8088 is sent from the RockIt Certificate Authority™ to the RockItRouter Security System™. The RockIt Certificate Authority™ expects the following return result(s): :PKCD.
17. The sequence self-message connector labeled ProcessPKCRegistration at block number 8090 is a method call instantiated by the RockItRouter Security System™. The method call passes the following parameter(s): :PKCD.
18. The sequence message connector labeled PKCSubProcessing at block number 8092 is sent from the RockItRouter Security System™ to the PKCManagement diagram fragment. The sent message passes the following parameter(s): :PKCD.
19. The sequence message connector labeled SQLUpdateQuery at block number 8094 is sent from the RockItRouter Security System™ to the RockItRouter Database™. The sent message passes the following parameter(s): :PKCD.
20. The sequence message connector labeled Result at block number 8096 is sent from the RockItRouter Database™ to the RockItRouter Security System™.
21. The sequence message connector labeled Result at block number 8098 is sent from the RockItRouter Security System™ to the RockIt Management System™. The RockItRouter Security System™ expects the following return result(s): RegistrationConfirmation.
22. The sequence self-message connector labeled ProcessRegistrationConfirmation at block number 8100 is a method call instantiated by the RockIt Management System™.
23. The sequence message connector labeled Result at block number 8102 is sent from the RockIt Management System™ to the RockIt Certificate Authority™. The RockIt Management System™ expects the following return result(s): RegistrationConfirmation.
24. The sequence self-message connector labeled ProcessRegistrationConfirmation at block number 8104 is a method call instantiated by the RockIt Certificate Authority™.
25. The sequence message connector labeled InsertPKC at block number 8106 is sent from the RockIt Certificate Authority™ to the RockIt Vault™. The sent message passes the following parameter(s): :PKCD.
26. The sequence message connector labeled Result at block number 8108 is sent from the RockIt Vault™ to the RockIt Certificate Authority™.
27. The sequence message connector labeled Result at block number 8110 is sent from the RockIt Certificate Authority™ to the RockIt Management System™.
28. The sequence message connector labeled Result at block number 8111 is sent from the RockIt Management System™ to the RockItRouter Security System™.
29. The sequence message connector labeled PKCServiceManagement at block number 8043 is sent from the RockItRouter Security System™ to the PKCServiceManagement diagram fragment.
30. The sequence self-message connector labeled ProcessIPsecConfigurationRequest at block number 8122 is a method call instantiated by the RockIt Management System™. The method call passes the following parameter(s): :RR, and returns the following result(s): :IPSEC.
31. The sequence message connector labeled SendIPsecConfigurationRequest at block number 8124 is sent from the RockIt Management System™ to the RockIt Policy Directory™. The sent message passes the following parameter(s): :IPSEC, and the RockIt Management System™ expects the following return result(s): :IPSEC.
32. The sequence self-message connector labeled ProcessIPsecConfigurationRequest at block number 8126 is a method call instantiated by the RockIt Policy Directory™. The method call passes the following parameter(s): :IPSEC, and returns the following result(s): :IPSEC.
33. The sequence message connector labeled Result at block number 8128 is sent from the RockIt Policy Directory™ to the RockIt Management System™. The sent message passes the following parameter(s): :IPSEC, and the RockIt Policy Directory™ expects the following return result(s): :IPSEC.
34. The sequence self-message connector labeled IPSECValidation at block number 8130 is a method call instantiated by the RockIt Management System™. The method call passes the following parameter(s): :IPSEC.
35. The sequence message connector labeled SendIPsecConfigurationResponse at block number 8132 is sent from the RockIt Management System™ to the RockItRouter Security System™. The sent message passes the following parameter(s): :IPSEC.
36. The sequence self-message connector labeled ProcessIPsecConfigurationResponse at block number 8134 is a method call instantiated by the RockItRouter Security System™.

The method call passes the following parameter(s): :IPSEC, and returns the following result(s): :IPSECP, :PPARAMS, :ISAKMPP, Nx(:IPSECR).
37. The sequence message connector labeled SQLInsertQuery at block number 8136 is sent from the RockItRouter Security System™ to the RockItRouter Database™. The sent message passes the following parameter(s): :IPSEC.
38. The sequence message connector labeled Result at block number 8138 is sent from the RockItRouter Database™ to the RockItRouter Security System™.
39. The sequence message connector labeled IPsecSubProcessing at block number 8140 is sent from the RockItRouter Security System™ to the IPsecManagement diagram fragment. The sent message passes the following parameter(s): :IPSECP, :PPARAMS, :ISAKMPP, :IPSECR_LIST, :IPSECR.
40. The sequence message connector labeled Result at block number 8142 is sent from the RockItRouter Security System™ to the RockIt Management System™. The RockItRouter Security System™ expects the following return result(s): IPsecConfigurationConfirmation.
41. The sequence self-message connector labeled ProcessIPsecConfigurationConfirmation at block number 8144 is a method call instantiated by the RockIt Management System™.
42. The sequence message connector labeled Result at block number 8146 is sent from the RockIt Management System™ to the RockIt Policy Directory™. The RockIt Management System™ expects the following return result(s):
IPsecConfigurationConfirmation.
43. The sequence self-message connector labeled ProcessIPsecConfigurationConfirmation at block number 8148 is a method call instantiated by the RockIt Policy Directory™.
44. The sequence message connector labeled Result at block number 8150 is sent from the RockIt Policy Directory™ to the RockIt Management System™.

FIGS. 32A-B are a glossary of terms explaining the objects and variables used by the PKC systems and processes that implement the RockIt™ security architecture.

FIG. 33 is a glossary of terms explaining the objects and variables used by the IPsec systems and processes that implement the RockIt™ security architecture.

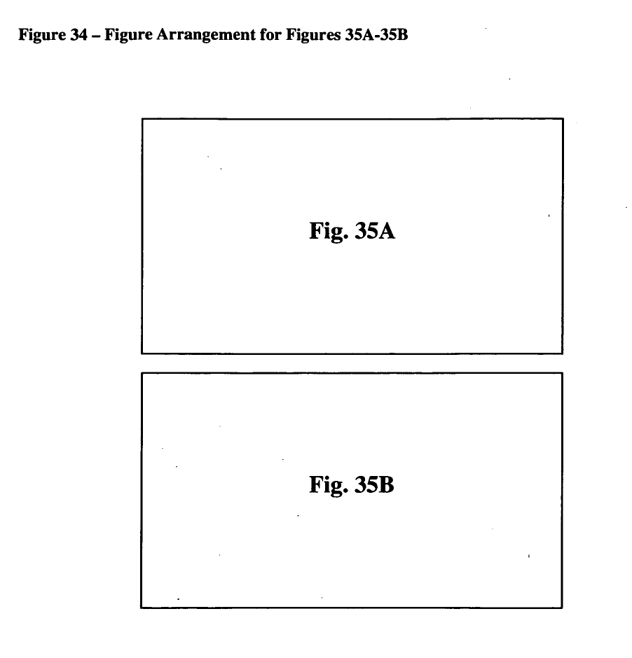

FIG. 34 is a high-level layout diagram that illustrates the proper arrangement of FIGS. 35A-35B for comprehensive viewing.

FIGS. 35A and 35B are a sequence diagram that illustrates the Service Order Fulfillment process including Support Services. The drawing contains the Internet Broadband Customer actor, block 6024, Host Device lifeline, block 6026, Internet Broadband Modem lifeline, block 6028, IPsec Processing control, block 6030, RockItRouter Security System™ control, block 6032, RockItRouter Database™ entity, block 6034, RockIt Database™ entity, block 6036, RockIt Subscriber Services™ control, block 6038, and Internet Broadband Provider's Intranet Resources control at block 6040. The drawing also contains the diagram fragments SubscriberDifferentiation at block 6084 and InternetBroadbandProviderSupportServices at block 6154. The SubscriberDifferentiation diagram fragment includes the interaction operands “Current, Roaming & Expired” at block 6083 and “New” at block 6085. The InternetBroadbandProviderSupportServices diagram fragment includes the interaction operands “Web Page Resources” block 6156, “Chat Page Resources,” block 6158, and “Telephone Resources” at block 6160.

The SubscriberDifferentiation diagram fragment details the sequence messaging and processing of the RockItRouter Security System™ for subscriber differentiation. The interaction operand “Current, Roaming & Expired” details the sequence messaging and processing by the RockItRouter Security System™ for current, roaming and expired customers. The interaction operand “Sew” details the sequence messaging and processing by the RockItRouter Security System™ for new customers.

The InternetBroadbandProviderSupportServices diagram fragment details the sequence messaging and processing of the RockItSwitch™ back office and Internet broadband provider's Intranet resources for customers requesting support services. The interaction operand “Web Page Resources” details the sequence messaging and processing for providing web page resources to customers for support services. The interaction operand “Chat Page Resources” details the sequence messaging and processing for providing chat page resources to customers requesting support services. The interaction operand “Telephone Resources” details the sequence messaging and processing for providing Internet broadband provider and technical support representatives and RockItRouter™ broadband modem information during customer support telephone calls.

The following describes the sequence messages and self-messages for this drawing. See FIG. 33, Objects and Variables for IPsec, for descriptions of the IPsec objects and variables used in this drawing. See FIG. 43, Objects and Variables for Systems Processing, for descriptions of the systems processing objects and variables used in this drawing. Variables proceeded with a colon “:” indicate an object. All sequence messaging and processing via the Internet broadband subscriber actor is synonymous with their use of a web browser.
1. The sequence message connector labeled SupportResourceRequestURL at block number 6050 is sent from the Internet broadband customer to the Host Device.
2. The sequence message connector labeled TCP/IPMessage at block number 6052 is sent from the Host Device to the Internet Broadband Modem.
3. The sequence message connector labeled <send> at block number 6054 is sent from the Internet Broadband Modem to the IPsec Processing.
4. The sequence self-message connector labeled ComparePacketToFilter at block number 6056 is a method call instantiated by the IPsec Processing. The method call passes the following parameter(s): PKT, and returns the following result(s): :PKTH, FILTER.
5. The sequence self-message connector labeled SAAnalysis at block number 6058 is a method call instantiated by the IPsec Processing. The method call passes the following parameter(s): PKT, and returns the following result(s): SA.
6. The sequence self-message connector labeled CheckFilterAction at block number 6060 is a method call instantiated by the IPsec Processing. The method call passes the following parameter(s): FILTER.
7. The sequence message connector labeled SendServiceOrderFulfillmentRequest at block number 6062 is sent from the IPsec Processing to the RockItRouter Security System™. The sent message passes the following parameter(s): :PKTH, FILTER, SA, PKT.
8. The sequence self-message connector labeled ProcessServiceOrderFulfillmentRequest at block number 6064 is a method call instantiated by the RockItRouter Security System™. The method call passes the following parameter(s): :PKTH, FILTER, SA, PKT.
9. The sequence self-message connector labeled GenerateSupportData at block number 6066 is a method call instantiated by the RockItRouter Security System™. The method call passes the following parameter(s): SA, and returns the following result(s): :RC, :RR.
10. The sequence message connector labeled SQLSelectQuery at block number 6068 is sent from the RockItRouter Security System™ to the RockItRouter Database™. The sent message passes the following parameter(s): SA, and the RockItRouter Security System™ expects the following return result(s): :RC, :RR.
11. The sequence message connector labeled Result at block number 6070 is sent from the RockItRouter Database™ to the RockItRouter Security System™.
12. The sequence self-message connector labeled GenerateURLRedirect at block number 6072 is a method call instantiated by the RockItRouter Security System™. The method call passes the following parameter(s): :RR, :RC, and returns the following result(s): QUERY_STR.
13. The sequence self-message connector labeled GenerateSupportData at block number 6074 is a method call instantiated by the RockItRouter Security System™. The method call returns the following result(s): :RR.
14. The sequence message connector labeled SQLSelectQuery at block number 6076 is sent from the RockItRouter Security System™ to the RockItRouter Database™. The RockItRouter Security System™ expects the following return result(s): :RR.
15. The sequence message connector labeled Result at block number 6078 is sent from the RockItRouter Database™ to the RockItRouter Security System™.
16. The sequence self-message connector labeled GenerateURLRedirect at block number 6080 is a method call instantiated by the RockItRouter Security System™. The method call passes the following parameter(s): :RR, and returns the following result(s): QUERY_STR.
17. The sequence message connector labeled SendURLRedirect at block number 6082 is sent from the RockItRouter Security System™ to the Host Device. The sent message passes the following parameter(s): QUERY_STR.
18. The sequence message connector labeled SendSupportServiceRequestURL at block number 6086 is sent from the Host Device to the Internet Broadband Provider's Intranet Resources. The sent message passes the following parameter(s): QUERY_STR.
19. The sequence self-message connector labeled ProcessHTMLResponse at block number 6088 is a method call instantiated by the Internet Broadband Provider's Intranet Resources.
20. The sequence message connector labeled SendSupportServiceWebPage at block number 6090 is sent from the Internet Broadband Provider's Intranet Resources to the Host Device.
21. The sequence message connector labeled Display at block number 6089 is sent from the Host Device to the Internet broadband subscriber. The endpoint labeled View, block 6091, illustrates that the Internet broadband subscriber views the returned web page resource.
22. The sequence message connector labeled SendSupportServiceRequestURL at block number 6092 is sent from the Host Device to the RockIt Subscriber Services™. The sent message passes the following parameter(s): QUERY_STR. N
23. The sequence self-message connector labeled ProcessSupportServicesRequestURL at block number 6094 is a method call instantiated by the RockIt Subscriber Services™. The method call passes the following parameter(s): QUERY_STR, and returns the following result(s): :RC, :RR.
24. The sequence message connector labeled SQLSelectQuery at block number 6096 is sent from the RockIt Subscriber Services™ to the RockIt Database™. The sent message passes the following parameter(s): :RC, :RR, and the RockIt Subscriber Services™ expects the following return result(s): :SUB.
25. The sequence message connector labeled Result at block number 6098 is sent from the RockIt Database™to the RockIt Subscriber Services™.
26. The sequence self-message connector labeled GenerateURLRedirect at block number 6122 is a method call instantiated by the RockIt Subscriber Services™. The method call passes the following parameter(s): :RC, :RR, :SUB, and returns the following result(s): QUERY_STR.
27. The sequence message connector labeled SendURLRedirect at block number 6124 is sent from the RockIt Subscriber Services™ to the Host Device. The sent message passes the following parameter(s): QUERY_STR.
28. The sequence message connector labeled SendSupportServicesRequest at block number 6126 is sent from the Host Device to the Internet Broadband Provider's Intranet Resources. The sent message passes the following parameter(s): QUERY_STR.
29. The sequence self-message connector labeled ProcessChatRequest at block number 6128 is a method call instantiated by the Internet Broadband Provider's Intranet Resources.

The method call passes the following parameter(s): QUERY_STR.
30. The sequence message connector labeled SendSupportServiceChatPage at block number 6130 is sent from the Internet Broadband Provider's Intranet Resources to the Host Device.
31. The sequence message connector labeled Display at block number 6132 is sent from the Host Device to the Internet broadband subscriber. The endpoint labeled Use, block 6134, illustrates that the Internet broadband subscriber uses the chat page resource.
32. The sequence message connector labeled TelephoneSupportServicesCall at block number 6136 is sent from the Internet broadband subscriber to the Internet Broadband Provider's Intranet Resources.
33. The sequence self-message connector labeled RetrieveSubscriberInfo at block number 6138 is a method call instantiated by the Internet Broadband Provider's Intranet Resources. The method call passes the following parameter(s): RRID, and returns the following result(s): :SUB, :RC, :RR.
34. The sequence message connector labeled SendSubscriberInfoRequest at block number 6140 is sent from the Internet Broadband Provider's Intranet Resources to the RockIt Subscriber Services™. The sent message passes the following parameter(s): RRID.
35. The sequence self-message connector labeled ProcessSubscriberInfoRequest at block number 6142 is a method call instantiated by the RockIt Subscriber Services™. The method call passes the following parameter(s): RRID.
36. The sequence message connector labeled SWLSelectQuery at block number 6144 is sent from the RockIt Subscriber Services™ to the RockIt Database™. The sent message passes the following parameter(s): RRID, and the RockIt Subscriber Services™ expects the following return result(s): :SUB, :RR, :RC_LIST.
37. The sequence message connector labeled Result at block number 6148 is sent from the RockIt Database™ to the RockIt Subscriber Services™.
38. The sequence message connector labeled SendSubscriberInfoResponse at block number 6150 is sent from the RockIt Subscriber Services™ to the Internet Broadband Provider's Intranet Resources. The RockIt Subscriber Services™ expects the following return result(s): :SUB, :RR, :RC_LIST. The endpoint labeled Report, block 6152, illustrates that the Internet broadband provider customer or technical support representative views the returned web page resource.

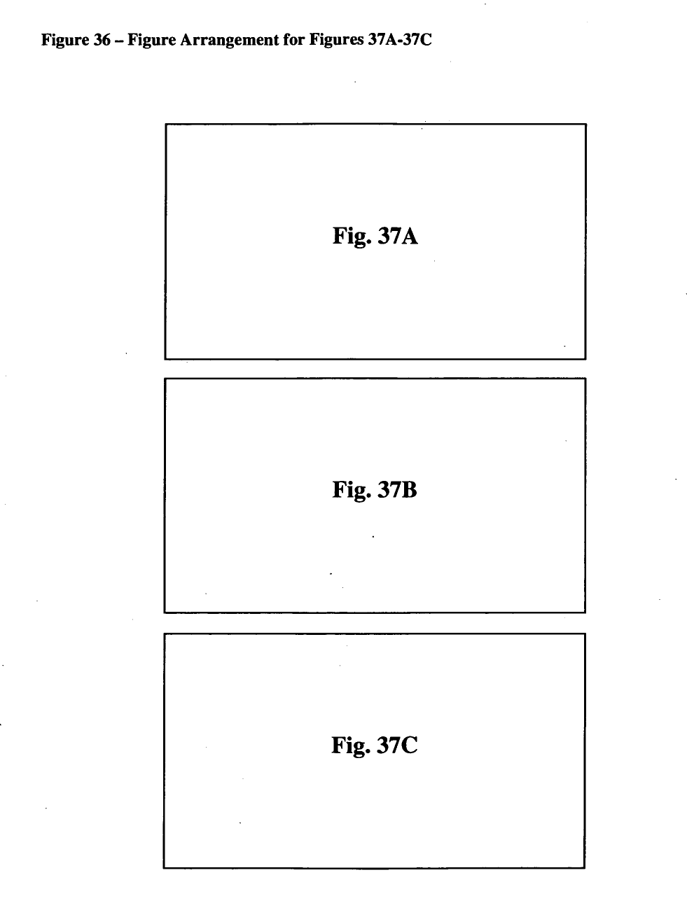

FIG. 36 is a high-level layout diagram that illustrates the proper arrangement of FIGS. 37A-37C for comprehensive viewing.

FIGS. 37A through 37C are a sequence diagram that illustrates the Service Order Fulfillment process including Subscriptions. The drawing contains the Internet broadband subscriber actor, block 6422, Host Device lifeline, block 6424, Internet Broadband Modem lifeline, block 6426, IPsec Processing control, block 6428, RockItRouter Security System™ control, block 6430, RockItRouter Database™ entity, block 6432, RockIt Management System™ boundary, block 6434, RockIt Database™ entity, block 6436, RockIt Clearing System™ boundary, block 6438, Traditional Billing control, block 6440, 3rd Party Clearing control, block 6442, and 3rd Party Marketing control at block 6444.

The drawing also contains the diagram fragments IPsecProcessing, block 6446, RockItClientInstall, block 6564, and FinancialClearing at block 6628. The IPsecProcessing diagram fragment depicts the IPsec processing that the diagram utilizes, and contains the references to FIG. 26, RockItRouter Security System™ and HTTP Redirector (New), block 6445, and FIG. 27, RockIt™ PKC Subscriber Processing (Expired) at block 6447. The IPsecProcessing diagram fragment is linked to a note at block 6449. The note details instructions for reading the diagram, where the IPsec processing returns a roaming or expired subscriber for service order fulfillment processing. In the case of roaming or expired subscriber, the note instructs the reader to substitute the RCID variable with the RRID variable, and to omit RockItClient™™ install sequence messages 6538 through 6594. The note also states that this use case is in not illustrated on the diagram.

The RockItClientInstall diagram fragment depicts the RockItClient™ install process that the diagram utilizes, and contains references to FIGS. 39A-B, Service Order Fulfillment (RockItClient™ Install, Configuration, and Update), block 6561, and FIGS. 41A-C, RockItClient™ IPsec and PKC Management (New) at block 6563. The FinancialClearing diagram fragment details sequence messaging and processing for financial clearing, and contains the interaction operands “Traditional”, block 6627, and “Real-Time Billing” at block 6629. The interaction operand “Traditional” details the sequence messaging and processing by the RockItSwitch™ back office for traditional, or paper billing by mail, bill processing. The interaction operand “Real-Time Billing” details the sequence messaging and processing by the RockItSwitch™ back office for real-time billing processing.

The following describes the sequence messages and self-messages for this drawing. See FIG. 43, Objects and Variables for Systems Processing, for descriptions of the systems processing objects and variables used in this drawing. Variables proceeded with a colon “:” indicate an object. All sequence messaging and processing via the Internet broadband subscriber actor is synonymous with their use of a web browser.
1. The sequence message connector labeled <use> at block number 6460 is sent from the Internet broadband subscriber to the Host Device.
2. The sequence message connector labeled TCP/IPMessage at block number 6462 is sent from the Host Device to the Internet Broadband Modem.
3. The sequence message connector labeled <send> at block number 6464 is sent from the Internet Broadband Modem to the IPsec Processing.
4. The sequence message connector labeled <reference> at block number 6466 is sent from the IPsec Processing to the IPsec processing diagram fragment.
5. The sequence message connector labeled <return> at block number 6468 is sent from the IPsec processing diagram fragment to the IPsec Processing.
6. The sequence message connector labeled <route> at block number 6470 is sent from the IPsec Processing to the Internet Broadband Modem.
7. The sequence message connector labeled SendURLRedirect at block number 6472 is sent from the Internet Broadband Modem to the Host Device. The sent message passes the following parameter(s): QUERY_STR.
8. The sequence message connector labeled SendAuthorizationRequestURL at block number 6474 is sent from the Host Device to the RockIt Management System™. The sent message passes the following parameter(s): QUERY_STR.
9. The sequence self-message connector labeled ProcessAuthorizationRequest at block number 6476 is a method call instantiated by the RockIt Management System™. The method call passes the following parameter(s): QUERY_STR.
10. The sequence self-message connector labeled GenSubscriptionOffer at block number 6478 is a method call instantiated by the RockIt Management System™. The method call passes the following parameter(s): RRID.
11. The sequence message connector labeled SQLSelectQuery at block number 6480 is sent from the RockIt Management System™ to the RockIt Database™. The sent message passes the following parameter(s): RRID, and the RockIt Management System™ expects the following return result(s): :SUBSC_LIST.
12. The sequence message connector labeled Result at block number 6481 is sent from the RockIt Database™ to the RockIt Management System™.
13. The sequence message connector labeled RequestMarketing at block number 6482 is sent from the RockIt Management System™ to the 3rd Party Marketing. The sent message passes the following parameter(s): LOCATION, and the RockIt Management System™ expects the following return result(s): MRKT.
14. The sequence message connector labeled Result at block number 6483 is sent from the 3rd Party Marketing to the RockIt Management System™.
15. The sequence self-message connector labeled GenerateSubscriptionWebpage at block number 6484 is a method call instantiated by the RockIt Management System™. The method call passes the following parameter(s): RRID, :SUBSC_LIST, MRKT, and returns the following result(s): SUBSC_HTML.
16. The sequence message connector labeled SendSubscriptionWebPage at block number 6486 is sent from the RockIt Management System™ to the Host Device. The sent message passes the following parameter(s): SUBSC_HTML.
17. The sequence message connector labeled <view> at block number 6488 is sent from the Host Device to the Internet broadband subscriber.
18. The sequence self-message connector labeled SelectSubscriptionChoice at block number 6490 is a method call instantiated by the Internet broadband subscriber. The method call passes the following parameter(s): RRID, :SUBSC.
19. The sequence message connector labeled SubmitSubscriptionChoice at block number 6492 is sent from the Internet broadband subscriber to the Host Device. The Internet broadband subscriber expects the following return result(s): RRID, :SUBSC.
20. The sequence message connector labeled SendPurchaseRequest at block number 6494 is sent from the Host Device to the RockIt Clearing System™. The sent message passes the following parameter(s): RRID, :SUBSC.
21. The sequence self-message connector labeled ProcessPurchaseRequest at block number 6496 is a method call instantiated by the RockIt Clearing System™. The method call passes the following parameter(s): RRID, :SUBSC.
22. The sequence self-message connector labeled GeneratePaymentWebpage at block number 6498 is a method call instantiated by the RockIt Clearing System™. The method call passes the following parameter(s): RRID, :SUBSC, SUB_FORM, PAY_FORM, and returns the following result(s): PAY_HTML.
23. The sequence message connector labeled SendPaymentWebPage at block number 6522 is sent from the RockIt Clearing System™ to the Host Device. The sent message passes the following parameter(s): PAY_HTML.
24. The sequence message connector labeled <view> at block number 6524 is sent from the Host Device to the Internet broadband subscriber.
25. The sequence self-message connector labeled EnterSubscriberAndPaymentInfo at block number 6526 is a method call instantiated by the Internet broadband subscriber. The method call passes the following parameter(s): RRID, :SUBSC.
26. The sequence message connector labeled SubmitPayment at block number 6528 is sent from the Internet broadband subscriber to the Host Device. The sent message passes the following parameter(s): RRID, :SUB, :PAY.
27. The sequence message connector labeled SendPaymentRequest at block number 6530 is sent from the Host Device to the RockIt Clearing System™. The sent message passes the following parameter(s): RRID, :SUB, :PAY.
28. The sequence self-message connector labeled ProcessPaymentRequest at block number 6532 is a method call instantiated by the RockIt Clearing System™. The method call passes the following parameter(s): RRID, :SUB, :PAY.
29. The sequence message connector labeled SQLInsertQuery at block number 6534 is sent from the RockIt Clearing System™ to the RockIt Database™. The sent message passes the following parameter(s): RRID, :SUB, :SUBSC, and the RockIt Clearing System™ expects the following return result(s): :RC.
30. The sequence message connector labeled Result at block number 6536 is sent from the RockIt Database™ to the RockIt Clearing System™.
31. The sequence self-message connector labeled GenerateRockItClientInstall at block number 6538 is a method call instantiated by the RockIt Clearing System™. The method call passes the following parameter(s): :RC.
32. The sequence message connector labeled SQLInsertQuery at block number 6540 is sent from the RockIt Clearing System™ to the RockIt Database™. The sent message passes the following parameter(s): :RC, and the RockIt Clearing System™ expects the following return result(s): INST_KEY.
33. The sequence message connector labeled Result at block number 6542 is sent from the RockIt Database™ to the RockIt Clearing System™.
34. The sequence self-message connector labeled GenerateInstallWebpage at block number 6544 is a method call instantiated by the RockIt Clearing System™. The method call passes the following parameter(s): :RC, INST_KEY, INST_URL, and returns the following result(s): INSTALL_HTML.
35. The sequence message connector labeled SendInstallWebPage at block number 6546 is sent from the RockIt Clearing System™ to the Host Device. The sent message passes the following parameter(s): INSTALL_HTML.
36. The sequence message connector labeled <view> at block number 6548 is sent from the Host Device to the Internet broadband subscriber.
37. The sequence self-message connector labeled InitiateRockItClientInstall at block number 6550 is a method call instantiated by the Internet broadband subscriber.
38. The sequence message connector labeled <use> at block number 6552 is sent from the Internet broadband subscriber to the Host Device.
39. The sequence message connector labeled SendInstallRequest at block number 6554 is sent from the Host Device to the RockIt Clearing System™. The sent message passes the following parameter(s): INST_KEY.
40. The sequence message connector labeled ServeDownload at block number 6556 is sent from the RockIt Clearing System™ to the Host Device. The sent message passes the following parameter(s): INST_KEY.
41. The sequence self-message connector labeled InstallRockItClient at block number 6558 is a method call instantiated by the Host Device. The method call passes the following parameter(s): INST_KEY, :RC.
42. The sequence message connector labeled <reference> at block number 6560 is sent from the Host Device to the RockItClient™ install diagram fragment.
43. The sequence message connector labeled <return> at block number 6562 is sent from the RockItClient™ install diagram fragment to the Host Device.
44. The sequence message connector labeled SendInitializationConfirmation at block number 6565 is sent from the Host Device to the RockIt Clearing System™. The sent message passes the following parameter(s): INST_KEY.
45. The sequence self-message connector labeled GeneratePaymentConfirmationWebpage at block number 6566 is a method call instantiated by the RockIt Clearing System™. The method call passes the following parameter(s): RCID, :SUBSC, :SUB, :PAY, and returns the following result(s): PAY_CONF_HTML.
46. The sequence message connector labeled SendPaymentConfirmationWebPage at block number 6568 is sent from the RockIt Clearing System™ to the Host Device. The sent message passes the following parameter(s): PAY_CONF_HTML.
47. The sequence message connector labeled <view> at block number 6599 is sent from the Host Device to the Internet broadband subscriber.
48. The sequence self-message connector labeled SubmitConfirmPayment at block number 6590 is a method call instantiated by the Internet broadband subscriber.
49. The sequence message connector labeled <use> at block number 6592 is sent from the Internet broadband subscriber to the Host Device.
50. The sequence message connector labeled SendPaymentConfirmation at block number 6594 is sent from the Host Device to the RockIt Clearing System™. The sent message passes the following parameter(s): RCID.
51. The sequence self-message connector labeled ProcessPayment at block number 6596 is a method call instantiated by the RockIt Clearing System™. The method call passes the following parameter(s): :SUBSC, :SUB, :PAY, RCID, RRID.
52. The sequence message connector labeled SendPayment at block number 6598 is sent from the RockIt Clearing System™ to the Traditional Billing. The sent message passes the following parameter(s): :SUBSC, :SUB, :PAY, and the RockIt Clearing System™ expects the following return result(s): AUTH.
53. The sequence message connector labeled Result at block number 6622 is sent from the Traditional Billing to the RockIt Clearing System™.
54. The sequence message connector labeled SendPayment at block number 6624 is sent from the RockIt Clearing System™ to the 3rd Party Clearing. The sent message passes the following parameter(s): :SUBSC, :SUB, :PAY, and the RockIt Clearing System™ expects the following return result(s): AUTH.
55. The sequence message connector labeled Result at block number 6626 is sent from the 3rd Party Clearing to the RockIt Clearing System™.
56. The sequence self-message connector labeled AuthorizeSubscriber at block number 6630 is a method call instantiated by the RockIt Clearing System™. The method call passes the following parameter(s): :SUBSC, :SUB, :PAY, AUTH, RCID, RRID.
57. The sequence message connector labeled SQLInsertQuery at block number 6632 is sent from the RockIt Clearing System™ to the RockIt Database™. The sent message passes the following parameter(s): :SUBSC, :SUB, :PAY, AUTH, RCID, RRID.
58. The sequence message connector labeled Result at block number 6634 is sent from the RockIt Database™ to the RockIt Clearing System™.
59. The sequence message connector labeled SendAuthorizationResponse at block number 6636 is sent from the RockIt Clearing System™ to the RockIt Management System™. The sent message passes the following parameter(s): :SUB, :SUBSC, RCID, RRID.
60. The sequence self-message connector labeled ProcessSystemChecks at block number 6638 is a method call instantiated by the RockIt Management System™. The method call passes the following parameter(s): RCID, RRID.
61. The sequence message connector labeled SendAuthorizationConfirmation at block number 6640 is sent from the RockIt Management System™ to the RockIt Clearing System™.
62. The sequence self-message connector labeled GenerateMarketing at block number 6642 is a method call instantiated by the RockIt Clearing System™. The method call passes the following parameter(s): :SUB.
63. The sequence message connector labeled RequestMarketing at block number 6644 is sent from the RockIt Clearing System™ to the 3rd Party Marketing. The sent message passes the following parameter(s): :SUB, and the RockIt Clearing System™ expects the following return result(s): MRKT.
64. The sequence message connector labeled Result at block number 6646 is sent from the 3rd Party Marketing to the RockIt Clearing System™.
65. The sequence self-message connector labeled GenerateWelcomeWebpage at block number 6648 is a method call instantiated by the RockIt Clearing System™. The method call passes the following parameter(s): AUTH, :SUBSC, MRKT, and returns the following result(s): WLKM_HTML.
66. The sequence message connector labeled SendWelcomeWebpage at block number 6650 is sent from the RockIt Clearing System™ to the Host Device. The sent message passes the following parameter(s): WLKM_HTML.
67. The sequence message connector labeled <view> at block number 6652 is sent from the Host Device to the Internet broadband subscriber.

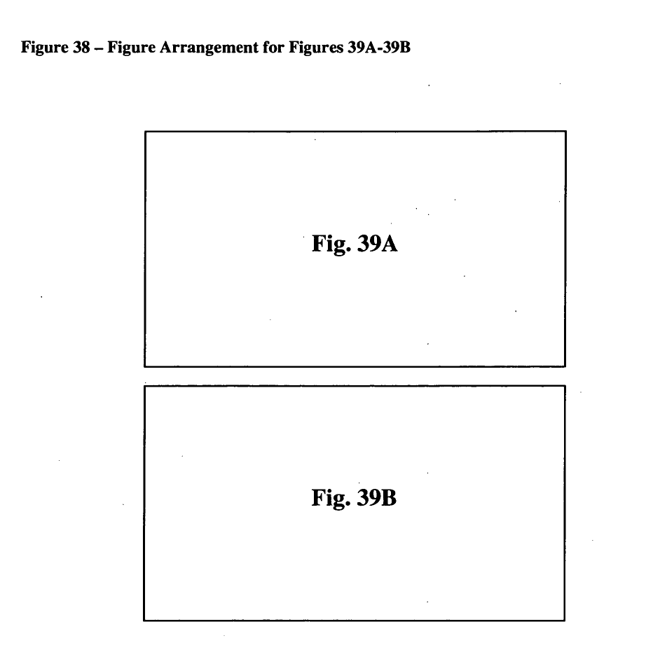

FIG. 38 is a high-level layout diagram that illustrates the proper arrangement of FIGS. 39A-39B for comprehensive viewing.

FIGS. 39A and 39B are a sequence diagram that illustrates the Service Order Fulfillment process including RockItClient™ Install, Configuration, and Update. The drawing contains the Host Device lifeline, block 6822, RockItClient Security System™ control, block 6826, RockItClient Database™ entity, block 6828, RockIt Management System™ boundary, block 6830, and RockIt Database™ entity at block 6832.

The drawing also contains the diagram fragment IPsecAndPKCConfigurationManagment at block 6934. The IPsecAndPKCConfigurationManagment diagram fragment depicts the IPsec and PKC configuration management processing that the diagram utilizes, and contains a reference to FIG. 41A-C, RockItClient™ IPsec and PKC Management (New) at block 6933.

The following describes the sequence messages and self-messages for this drawing. See FIG. 43, Objects and Variables for Systems Processing, for descriptions of the systems processing objects and variables used in these FIGS. Variables proceeded with a colon “:” indicate an object.
1. The sequence message connector labeled RockItClientInitialization at block number 6860 is sent from the Host Device to the RockItClient Security System™.
2. The sequence self-message connector labeled Initialize at block number 6862 is a method call instantiated by the RockItClient Security System™. The method call passes the following parameter(s): :RC.
3. The sequence message connector labeled SendInitializationRequest at block number 6864 is sent from the RockItClient Security System™ to the RockIt Management System™. The sent message passes the following parameter(s): :RC.
4. The sequence self-message connector labeled ProcessInitializationRequest at block number 6866 is a method call instantiated by the RockIt Management System™. The method call passes the following parameter(s): :RC.
5. The sequence self-message connector labeled Validate at block number 6868 is a method call instantiated by the RockIt Management System™. The method call passes the following parameter(s): :RC.
6. The sequence self-message connector labeled Register at block number 6870 is a method call instantiated by the RockIt Management System™. The method call passes the following parameter(s): :RC.
7. The sequence message connector labeled SQLInsertQuery at block number 6872 is sent from the RockIt Management System™to the RockIt Database™. The sent message passes the following parameter(s): :RC.
8. The sequence message connector labeled Result at block number 6874 is sent from the RockIt Database™ to the RockIt Management System™.
9. The sequence self-message connector labeled GenerateConfiguration at block number 6876 is a method call instantiated by the RockIt Management System™. The method call passes the following parameter(s): :RC, and returns the following result(s): :CONFIG.
10. The sequence message connector labeled SQLSelectQuery at block number 6876 is sent from the RockIt Management System™ to the RockIt Database™. The sent message passes the following parameter(s): :RC, and the RockIt Management System™ expects the following return result(s): :CONFIG.
11. The sequence message connector labeled Result at block number 6878 is sent from the RockIt Database™ to the RockIt Management System™.
12. The sequence message connector labeled SendInitializationResponse at block number 6880 is sent from the RockIt Management System™ to the RockItClient Security System™. The RockIt Management System™ expects the following return result(s): :CONFIG.
13. The sequence self-message connector labeled ProcessRockItClientConfiguration at block number 6882 is a method call instantiated by the RockItClient Security System™. The method call passes the following parameter(s): :CONFIG.
14. The sequence message connector labeled SQLInsertQuery at block number 6884 is sent from the RockItClient Security System™ to the RockItClient Database™. The sent message passes the following parameter(s): :CONFIG.
15. The sequence message connector labeled Result at block number 6886 is sent from the RockItClient Database to the RockItClient Security System™.
16. The sequence self-message connector labeled ProcessSystemUpdates at block number 6888 is a method call instantiated by the RockItClient Security System. The method call passes the following parameter(s): :RC.
17. The sequence message connector labeled SendSystemUpdateRequest at block number 6890 is sent from the RockItClient Security System™ to the RockIt Management System. The sent message passes the following parameter(s): :RC.
18. The sequence self-message connector labeled ProcessSystemUpdateRequest at block number 6892 is a method call instantiated by the RockIt Management System. The method call passes the following parameter(s): :RC.
19. The sequence self-message connector labeled RetrieveSystemUpdates at block number 6894 is a method call instantiated by the RockIt Management System™. The method call passes the following parameter(s): RC_UPDATES.
20. The sequence message connector labeled SendSystemUpdatesResponse at block number 6896 is sent from the RockIt Management System™ to the RockItClient Security System™. The sent message passes the following parameter(s): RC_UPDATES.
21. The sequence self-message connector labeled UpdateSystem at block number 6898 is a method call instantiated by the RockItClient Security System™. The method call passes the following parameter(s): RC_UPDATES.
22. The sequence message connector labeled SendIntializationConfirmation at block number 6922 is sent from the RockItClient Security System™ to the RockIt Management System™. The sent message passes the following parameter(s): :RC.
23. The sequence self-message connector labeled ProcessInitializationConfirmation at block number 6924 is a method call instantiated by the RockIt Management System™.
24. The sequence message connector labeled Result at block number 6926 is sent from the RockIt Management System™ to the RockItClient Security System™.
25. The sequence self-message connector labeled RebootSystem at block number 6928 is a method call instantiated by the RockItClient Security System™.
26. The sequence message connector labeled SendPKCAndIPsecConfigurationRequest at block number 6930 is sent from the RockItClient Security System™ to the IPsecAndPKCConfigurationManagment diagram fragment at block 6934. The sent message passes the following parameter(s): :RC.
27. The sequence message connector labeled RockItClientInitializationComplete at block number 6932 is sent from the RockItClient Security System™ to the Host Device.

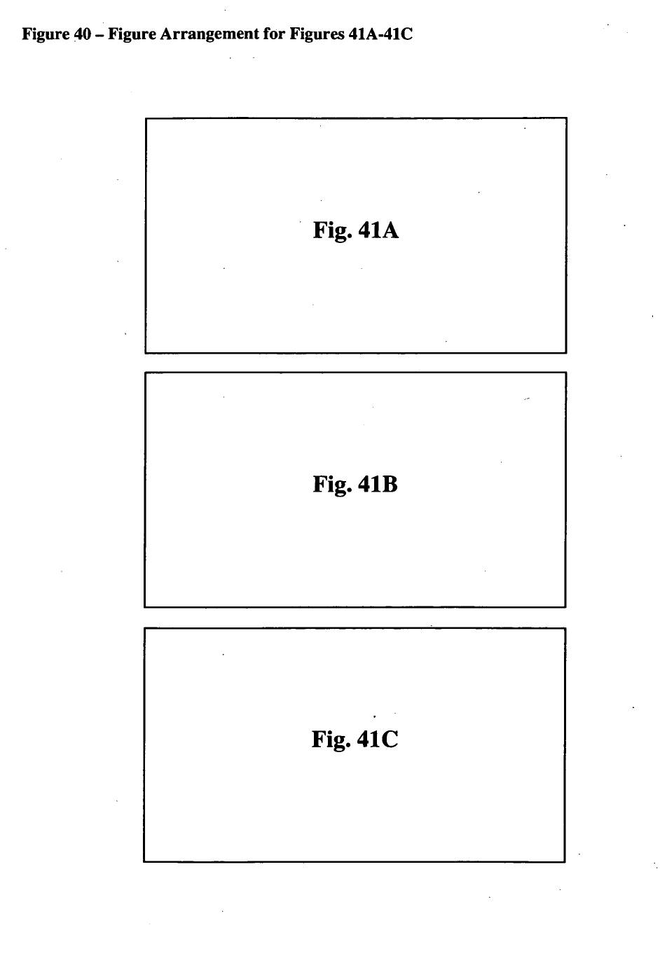

FIG. 40 is a high-level layout diagram that illustrates the proper arrangement of FIGS. 41A-41C for comprehensive viewing.

FIGS. 41A through 41C are a sequence diagram that illustrates the RockItClient™ IPsec and PKC Management processes for a new customer.

The drawing contains the and RockItClient™, block 8522, RockItRouter Database™, block 8524, RockItRouter Security System™, block 8526, RockIt Management System™, block 8528, RockIt Certificate Authority™, block 8530, RockIt Vault™, block 8532, and RockIt Policy Directory™ at block 8534. The drawing also contains the diagram fragments PKCEnrollmentAndRegistrationManagement, block 8536, RockItClientSpecific, block 8537, RockItClientSpecific, block 8559, PKCManagement, block 8576, PKCServiceManagement, block 8698, IPsecConfigurationManagement, block 8696, IPsecManagement, block 8656, RockItClientConfigurationResponse, block 8675, PKCManagement, block 8680, and IPsecManagement at block 8686.

The PKCEnrollmentAndRegistrationManagment diagram fragment illustrates the sequence messages and self-messages that implement the PKC enrollment and registration management processing. The two RockItClientSpecific diagram fragments illustrate alternative sequence messages and self-messages for RockItClient™ software installed on host devices with different processing power. They contain two interaction operands, the “RockItClient” and “RockItClient—Handheld.” The “RockItClient” depicts host devices with sufficient CPU processing power to generate public and private keys for PKC, and the “RockItClient—Handheld” depicts host devices with insufficient CPU processing power to generate public and private keys for PKC. The two PKCManagement diagram fragments depict a reference to the PKC management processing of the RockItRouter Security System™. The PKCServiceManagement diagram fragment depicts PKC validation processing. See FIG. 42, PKC Service Management, and the FIG. 42 narrative below for the PKC service management processing and communications details. The IPsecConfigurationManagement diagram fragment illustrates the sequence messages and self-messages that implement IPsec configuration management processing. The two IPsecManagement diagram fragments depict a reference to the IPsec management processing of the RockItRouter Security System™. The RockItClientConfigurationResponse diagram fragment illustrates the sequence messages and self-messages that implement PKC and IPsec configuration response processing.

The following describes the sequence messages and self-messages for this drawing. See FIG. 32, Objects and Variables for PKC, for descriptions of the PKC objects and variables used in these FIGS. See FIG. 33, Objects and Variables for IPsec, for descriptions of the IPsec objects and variables used in this drawing. See FIG. 43, Objects and Variables for Systems Processing, for descriptions of the systems processing objects and variables used in this drawing. Variables proceeded with a colon “:” indicate an object.
1. The sequence message connector labeled SendConfigurationRequest at block number 8538 is sent from the RockItClient™ to the RockItRouter Security System™. The sent message passes the following parameter(s): :RC, PKEY.
2. The sequence self-message connector labeled ProcessConfigurationRequest at block number 8540 is a method call instantiated by the RockItRouter Security System™. The method call passes the following parameter(s): :RC, PKEY, and returns the following result(s): :RC, PKEY.
3. The sequence message connector labeled SendConfigurationRequest at block number 8539 is sent from the RockItClient™ to the RockItRouter Security System™. The sent message passes the following parameter(s): :RC.
4. The sequence self-message connector labeled ProcessConfigurationRequest at block number 8541 is a method call instantiated by the RockItRouter Security System™. The method call passes the following parameter(s): :RC, and returns the following result(s): :RC.
5. The sequence message connector labeled SendConfigurationRequest at block number 8542 is sent from the RockItRouter Security System™ to the RockIt Management System™. The sent message passes the following parameter(s): :RC, :RR.
6. The sequence self-message connector labeled ProcessPKIConfigurationRequest at block number 8544 is a method call instantiated by the RockIt Management System™. The method call passes the following parameter(s): :RC, :RR, and returns the following result(s): RCID, RRID, :PKC.
7. The sequence self-message connector labeled ValidateRockItClient™ at block number 8546 is a method call instantiated by the RockIt Management System™. The method call passes the following parameter(s): RCID, RRID.
8. The sequence message connector labeled SendPKCEnrollmentRequest at block number 8548 is sent from the RockIt Management System™ to the RockIt Certificate Authority™. The sent message passes the following parameter(s): :PKC, and the RockIt Management System™ expects the following return result(s): EID, EKEY.
9. The sequence self-message connector labeled ProcessPKCEnrollmentRequest at block number 8550 is a method call instantiated by the RockIt Certificate Authority™. The method call passes the following parameter(s): :PKC, and returns the following result(s): EID, EKEY, :PKC.
10. The sequence message connector labeled Result at block number 8552 is sent from the RockIt Certificate Authority™ to the RockIt Management System™. The RockIt Certificate Authority™ expects the following return result(s): EID, EKEY, :PKC.
11. The sequence self-message connector labeled PKCValidation at block number 8554 is a method call instantiated by the RockIt Management System™. The method call passes the following parameter(s): :PKC.
12. The sequence message connector labeled SendPKCEnrollmentRequest at block number 8556 is sent from the RockIt Management System™ to the RockItRouter Security System™. The sent message passes the following parameter(s): EID, EKEY.
13. The sequence self-message connector labeled ProcessPKCEnrollmentRequest at block number 8558 is a method call instantiated by the RockItRouter Security System™. The method call passes the following parameter(s): EID, EKEY, and returns the following result(s): :KEYS, :PKCR.
14. The sequence self-message connector labeled GeneratePrivateAndPublicKeys at block number 8560 is a method call instantiated by the RockItRouter Security System™. The method call passes the following parameter(s): :KEYS, PKEY, and returns the following result(s): :KEYS.
15. The sequence self-message connector labeled GeneratePrivateAndPublicKeys at block number 8561 is a method call instantiated by the RockItRouter Security System™. The method call passes the following parameter(s): :KEYS, and returns the following result(s): :KEYS.
16. The sequence self-message connector labeled GeneratePKCRegistrationRequest at block number 8562 is a method call instantiated by the RockItRouter Security System™. The method call passes the following parameter(s): PKEY, :PKCR, and returns the following result(s): :PKCR.
17. The sequence message connector labeled SQLInsertQuery at block number 8564 is sent from the RockItRouter Security System™ to the RockItRouter Database™. The sent message passes the following parameter(s): :RC, EID, EKEY, :KEYS, :PKCR.
18. The sequence message connector labeled Result at block number 8566 is sent from the RockItRouter Database™ to the RockItRouter Security System™.
19. The sequence message connector labeled SendPKCRegistrationRequest at block number 8568 is sent from the RockItRouter Security System™ to the RockIt Certificate Authority™. The sent message passes the following parameter(s): EID, EKEY, :PKCR.
20. The sequence self-message connector labeled ProcessPKCRegistrationRequest at block number 8570 is a method call instantiated by the RockIt Certificate Authority™. The method call passes the following parameter(s): EID, EKEY, :PKCR, and returns the following result(s): :PKC.
21. The sequence message connector labeled Result at block number 8572 is sent from the RockIt Certificate Authority™ to the RockItRouter Security System™. The RockIt Certificate Authority™ expects the following return result(s): :PKCD.
22. The sequence self-message connector labeled ProcessPKCRegistration at block number 8574 is a method call instantiated by the RockItRouter Security System™. The method call passes the following parameter(s): :PKCD.
23. The sequence message connector labeled PKCSubProcessing at block number 8578 is sent from the RockItRouter Security System™ to the PKCManagement diagram fragment. The sent message passes the following parameter(s): :PKCD.
24. The sequence message connector labeled SQLUpdateQuery at block number 8580 is sent from the RockItRouter Security System™ to the RockItRouter Database™. The sent message passes the following parameter(s): RCID, :PKCD.
25. The sequence message connector labeled Result at block number 8582 is sent from the RockItRouter Database™ to the RockItRouter Security System™.
26. The sequence message connector labeled Result at block number 8584 is sent from the RockItRouter Security System™ to the RockIt Management System™. The RockItRouter Security System™ expects the following return result(s): REGC.
27. The sequence self-message connector labeled ProcessRegistrationConfirmation at block number 8586 is a method call instantiated by the RockIt Management System™.
28. The sequence message connector labeled Result at block number 8588 is sent from the RockIt Management System™ to the RockIt Certificate Authority™. The RockIt Management System™ expects the following return result(s): REGC.
29. The sequence self-message connector labeled ProcessRegistrationConfirmation at block number 8590 is a method call instantiated by the RockIt Certificate Authority™.
30. The sequence message connector labeled InsertPKC at block number 8592 is sent from the RockIt Certificate Authority™ to the RockIt Vault™. The sent message passes the following parameter(s): :PKCD.
31. The sequence message connector labeled Result at block number 8594 is sent from the RockIt Vault™ to the RockIt Certificate Authority™.
32. The sequence message connector labeled Result at block number 8596 is sent from the RockIt Certificate Authority™ to the RockIt Management System™.
33. The sequence message connector labeled Result at block number 8598 is sent from the RockIt Management System™ to the RockItRouter Security System™.
34. The sequence message connector labeled PKCServiceManagement at block number 8699 is sent from the RockItRouter Security System™ to the PKCServiceManagement diagram fragment. The sent message passes the following parameter(s): :PKCD, :CRL.
35. The sequence self-message connector labeled ProcessIPsecConfigurationRequest at block number 8634 is a method call instantiated by the RockIt Management System™. The method call passes the following parameter(s): :RC, :RR, and returns the following result(s): :IPSEC.
36. The sequence message connector labeled SendIPsecConfigurationRequest at block number 8638 is sent from the RockIt Management System™ to the RockIt Policy Directory™. The sent message passes the following parameter(s): :IPSEC, and the RockIt Management System™ expects the following return result(s): :IPSEC.
37. The sequence self-message connector labeled ProcessIPsecConfigurationRequest at block number 8640 is a method call instantiated by the RockIt Policy Directory™. The method call passes the following parameter(s): :IPSEC, and returns the following result(s): :IPSEC.
38. The sequence message connector labeled Result at block number 8642 is sent from the RockIt Policy Directory™ to the RockIt Management System™. The sent message passes the following parameter(s): :IPSEC, and the RockIt Policy Directory™ expects the following return result(s): :IPSEC.
39. The sequence self-message connector labeled IPSECValidation at block number 8644 is a method call instantiated by the RockIt Management System™. The method call passes the following parameter(s): :IPSEC.
40. The sequence message connector labeled SendIPsecConfigurationResponse at block number 8648 is sent from the RockIt Management System™ to the RockItRouter Security System™. The sent message passes the following parameter(s): :IPSEC.
41. The sequence self-message connector labeled ProcessIPsecConfigurationResponse at block number 8650 is a method call instantiated by the RockItRouter Security System™. The method call passes the following parameter(s): :IPSEC, and returns the following result(s): :IPSECP, :PPARAMS, :ISAKMPP, Nx(:IPSECR).
42. The sequence message connector labeled SQLInsertQuery at block number 8652 is sent from the RockItRouter Security System™ to the RockItRouter Database™. The sent message passes the following parameter(s): RCID, :IPSEC.
43. The sequence message connector labeled Result at block number 8654 is sent from the RockItRouter Database™ to the RockItRouter Security System™.
44. The sequence message connector labeled IPsecSubProcessing at block number 8658 is sent from the RockItRouter Security System™ to the IPsecManagement diagram fragment. The sent message passes the following parameter(s): :IPSECP, :PPARAMS, :ISAKMPP, :IPSECR_LIST, :IPSECR.
45. The sequence message connector labeled Result at block number 8660 is sent from the RockItRouter Security System™ to the RockIt Management System™. The RockItRouter Security System™ expects the following return result(s): IPSEC_CC.
46. The sequence self-message connector labeled ProcessIPsecConfigurationConfirmation at block number 8662 is a method call instantiated by the RockIt Management System™.
47. The sequence message connector labeled Result at block number 8664 is sent from the RockIt Management System™ to the RockIt Policy Directory™. The RockIt Management System™ expects the following return result(s): IPSEC_CC.
48. The sequence self-message connector labeled ProcessIPsecConfigurationConfirmation at block number 8668 is a method call instantiated by the RockIt Policy Directory™.
49. The sequence message connector labeled Result at block number 8670 is sent from the RockIt Policy Directory™ to the RockIt Management System™.
50. The sequence message connector labeled Result at block number 8672 is sent from the RockIt Management System™ to the RockItRouter Security System™.
51. The sequence self-message connector labeled GenerateConfigurationResponse at block number 8674 is a method call instantiated by the RockItRouter Security System™. The method call returns the following result(s): :PKCD, :IPSEC.
52. The sequence message connector labeled SendConfigurationResponse at block number 8676 is sent from the RockItRouter Security System™ to the RockItClient. The sent message passes the following parameter(s): :PKCD, :IPSEC.
53. The sequence self-message connector labeled ProcessPKCConfigurationResponse at block number 8678 is a method call instantiated by the RockItClient. The method call passes the following parameter(s): :PKCD.
54. The sequence message connector labeled PKCSubProcessing at block number 8682 is sent from the RockItClient™ to the PKCManagement diagram fragment. The sent message passes the following parameter(s): :PKCD.
55. The sequence self-message connector labeled ProcessIPsecConfigurationResponse at block number 8684 is a method call instantiated by the RockItClient. The method call passes the following parameter(s): :IPSEC, and returns the following result(s): :IPSECP, :PPARAMS, :ISAKMPP, Nx(:IPSECR).
56. The sequence message connector labeled IPsecSubProcessing at block number 8688 is sent from the RockItClient™ to the IPsecManagement diagram fragment. The sent message passes the following parameter(s): :IPSECP, :PPARAMS, :ISAKMPP, :IPSECR_LIST, :IPSECR.
57. The sequence message connector labeled Result at block number 8690 is sent from the RockItClient™ to the RockItRouter Security System™. The sent message passes the following parameter(s): PKC CC, IPSEC_CC.
58. The sequence self-message connector labeled ProcessPKCAndIPsecConfigurationConfirmation at block number 8692 is a method call instantiated by the RockItRouter Security System™.

FIG. 42 is a sequence diagram that illustrates the PKC Service Management process. The drawing contains the RockItRouter Security System™, block 6722, and the RockIt Vault™ at block 6724. The drawing also contains the diagram fragments PKCServiceManagement, block 6726, PKCServices at block 6728. The PKCServiceManagement diagram fragment illustrates the sequence messaging and processing for PKC service management. The PKCServices diagram fragment illustrates the PKC services management processing of the RockItRouter Security System™.

The following describes the sequence messages and self-messages for this drawing. See FIG. 32, Objects and Variables for PKC, for descriptions of the PKC objects and variables used in this drawing. Variables proceeded with a colon “:” indicate an object.
1. The sequence self-message connector labeled GeneratePKCServiceRequest at block number 6750 is a method call instantiated by the RockItRouter Security System™. The method call passes the following parameter(s): PKCSREQ.
2. The sequence message connector labeled SendPKCAndCRLServiceRequest at block number 6752 is sent from the RockItRouter Security System™ to the RockIt Vault™. The sent message passes the following parameter(s): PKCSREQ, and the RockItRouter Security System™ expects the following return result(s): PKCSRES.
3. The sequence self-message connector labeled ProcessServicePKCAndCRLRequest at block number 6754 is a method call instantiated by the RockIt Vault™.
4. The sequence message connector labeled Result at block number 6758 is sent from the RockIt Vault™ to the RockItRouter. Security System™. The RockIt Vault™ expects the following return result(s): PKCSRES.
5. The sequence self-message connector labeled ProcessPKCServiceResponse at block number 6760 is a method call instantiated by the RockItRouter Security System™. The method call passes the following parameter(s): PKCSRES, and returns the following result(s): :PKCD, CRL.
6. The sequence message connector labeled PKCServiceSubProcessing at block number 6762 is sent from the RockItRouter Security System™ to the PKCServices diagram fragment. The sent message passes the following parameter(s): :PKCD, CRL.

FIG. 43 is a glossary of terms explaining the objects and variables used by the RockIt™ architecture for Systems Processing.

In brief summary, the invention's high level of security against piracy of bandwidth and services or confidential customer data is accomplished by its capacity to distinguish different types of customers, and customer account status, limitations and use. The invention utilizes its unique awareness to provide real-time automation of network security and authorization, and service order fulfillment and account management Thus, customers receive unprecedented management and services from their Internet broadband provider while the Internet broadband provider realize cost savings and reach prospective subscribers they might otherwise have missed. Moreover, Internet broadband providers receive protection against unauthorized use of their bandwidth and other installed resources and more pro-actively mandate, automate and manage network security and authorization.

Finally, those of skill in the art will appreciate that the invented method, system and apparatus described and illustrated herein may be implemented in software, firmware or hardware, or any suitable combination thereof. Preferably, the method, system and apparatus are implemented in a combination of the three, for purposes of low cost and flexibility. Thus, those of skill in the art will appreciate that the method, system and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

Accordingly, while the present invention has been shown and described with reference to the foregoing preferred system, apparatus and method, it will be apparent to those skilled in the art that other changes in form and detail may be made therein without departing from the spirit and scope of the invention as defined in the appended claims.

I claim:

1. A system for managing a network, the system comprising:
a security mechanism configured to provide automatic network security and authorization for one or more Internet broadband provider broadband modems and for one or more customer host devices connectable thereto within the network, and
a fulfillment mechanism coupled with the security mechanism, the fulfillment mechanism configured to provide automatic service order fulfillment and account processing in real-time to the one or more customer host devices.

2. The system of claim 1, wherein the security mechanism is configured further to mandate, automate and manage network security for the one or more Internet broadband provider broadband modems and for the one or more customer host devices.

3. The system of claim 2, wherein the security mechanism is configured further to define network security policy for the one or more Internet broadband provider broadband modems and for the one or more customer host devices.

4. The system of claim 2, wherein the security mechanism is configured further automatically to regulate and enforce a defined network security policy for the one or more Internet broadband provider broadband modems and for the one or more customer host devices.

5. The system of claim 4, wherein the security mechanism operates such that the one or more broadband modems and the one or more customer connectable host devices communicate securely with one another.

6. The system of claim 4, wherein Internet broadband providers utilize the systems and process architecture capability to survey, monitor, and regulate, by way of one or more operations including restricting, permitting, securing, and redirecting, the network communications of the one or more broadband modems and of the one or more customer connectable host devices on a home network, the one or more connectable host devices connecting either directly to the one or more Internet service provider broadband modems or indirectly through a defined home network topology.

7. The system of claim 2, wherein the security mechanism is configured further to install, configure, and maintain network security policy for the one or more Internet broadband provider broadband modems and for the one or more customer connectable host devices.

8. The system of claim 2, wherein the security mechanism further provides and facilitates security between the one or more Internet broadband provider broadband modems and the one or more customer connectable host devices.

9. The system of claim 8, wherein the security mechanism is configured further to provide and facilitate security for wireless local area networks (WLANs) independent of open system interconnection (OSI) Layer 1 and 2 encryption.

10. The system of claim 1, wherein the fulfillment mechanism is configured further to mandate, automate and manage network authorization for the one or more Internet broadband provider broadband modems and for the one or more customer connectable host devices.

11. The system of claim 10, wherein the fulfillment mechanism is configured further to define a network authorization policy for the one or more Internet broadband provider broadband modems and for the one or more customer connectable host devices.

12. The system of claim 11, wherein the fulfillment mechanism is configured further automatically to regulate and enforce network authorization policy for the one or more Internet broadband provider broadband modems and for the one or more customer connectable host devices.

13. The system of claim 12, wherein the fulfillment mechanism is configured further to enable Internet broadband providers to survey, monitor, and permit, without authorization, the network communications of the one or more broadband modems and of the one or more customer connectable host devices to predefined, restricted Internet broadband provider network resources including one or more of customer support services and technical support services via one or more of web pages and chat as may be in accordance with the network authorization policy.

14. The system of claim 13, wherein the security mechanism is configured further to protect the Internet broadband provider network from one or more of attack and abuse.

15. The system of claim 12, wherein the security mechanism is configured further to associate a customer account with the one or more broadband modems and with the one or more customer host devices to enforce the network authorization policy.

16. The system of claim 12, wherein the security mechanism is configured further to require an authorization, based upon the network authorization policy, for the one or more broadband modems and for the one or more customer host devices before permitting network communication from and to the Internet through the Internet broadband provider network connection.

17. The system of claim 16, wherein the security mechanism is configured further to be used by one or more Internet broadband providers dynamically to regulate and to enforce the network authorization policy based upon customer account status and customer account use variables.

18. The system of claim 17, wherein a customer account status variable is dynamically determined by the security mechanism to be one of new, expired, roaming and current.

19. The system of claim 18, wherein a customer account use variable is dynamically determined to be one of roaming, non-roaming, roaming-out-of-network, and roaming-out-of-area.

20. The system of claim 16, wherein Internet broadband providers utilize the systems and process architecture capability to survey, monitor, and regulate by way of one or more operations including restricting, permitting, securing and redirecting the network communications of the one or more broadband modems and of the one or more customer host devices to enforce the network authorization policy based at least in part on customer account status and use variables.

21. The system of claim 20, wherein, if the customer account status variable is new, then authorization fails.

22. The system of claim 21, wherein the network traffic of the one or more customer host devices is substantially restricted by the security mechanism to a customer WLAN/LAN, but wherein network communications to relatively few defined Internet broadband provider network resources including one or more of a customer support services web page and chat and a technical support services web page and chat is permitted by the security mechanism.

23. The system of claim 21, wherein the security mechanism is configured further to redirect web page requests to a new service order fulfillment processor portion of the fulfillment mechanism.

24. The system of claim 23, wherein the security mechanism is configured further to pass customer specific data for the one or more customer host devices including one or more of connected customer account number, broadband equipment and customer system metrics to a renewal service order fulfillment processor portion of the fulfillment mechanism.

25. The system of claim 20, wherein, if the security mechanism determines that the customer account status variable is expired, then authorization fails.

26. The system of claim 25, wherein the security mechanism and the fulfillment mechanism collectively secure network communication for the one or more broadband modems and for the one or more customer host devices.

27. The system of claim 25, wherein the network traffic of the one or more customer host devices is substantially restricted by the security mechanism to a customer WLAN/LAN, but wherein network communications to relatively few defined Internet broadband provider network resources including one or more of a customer support services web page and chat and a technical support services web page and chat is permitted by the security mechanism.

28. The system of claim 25, wherein the security mechanism automatically redirects web page requests from the customer host devices to either a renewal service order fulfillment or account management process of the fulfillment mechanism.

29. The system of claim 28, wherein the security mechanism is configured further to pass customer specific data for the one or more customer host devices including one or more of connected customer account number, broadband equipment and customer system metrics to either a renewal service order fulfillment or account management processor portion of the fulfillment mechanism.

30. The system of claim 20, wherein, if customer account status is roaming, and account use is roaming, then authorization succeeds.

31. The system of claim 30, wherein secure network communication is provided and facilitated for the one or more broadband modems and for the one or more customer host devices.

32. The system of claim 30, wherein the security mechanism is configured further to permit network traffic originating from the one or more customer connectable host devices to the Internet.

33. The system of claim 30, wherein the security mechanism is configured further to permit network traffic originating from the Internet to the one or more customer host devices.

34. The system of claim 20, wherein, if customer account status is current, and account use is roaming, then authorization fails.

35. The system of claim 34, wherein the security mechanism and the fulfillment mechanism are configured further to secure network communication for the one or more broadband modems and the one or more customer host devices.

36. The system of claim 34, wherein the network traffic of the one or more customer host devices is substantially restricted by the security mechanism to a customer WLAN/LAN, but wherein network communications to relatively few defined Internet broadband provider network resources including one or more of a customer support services web page and chat and a technical support services web page and chat is permitted by the security mechanism.

37. The system of claim 34, wherein the security mechanism automatically redirects web page requests to either a roaming service order fulfillment or account management processor portion of the fulfillment mechanism.

38. The system of claim 37, wherein the security mechanism passes customer specific data including one or more of account number, broadband equipment, and system metrics to either the roaming service order fulfillment or account management processor portion of the fulfillment mechanism.

39. The system of claim 20, wherein, if customer account status is roaming, and account use is one of roaming-out-of-network and roaming-out-of-area, then authorization fails.

40. The system of claim 39, wherein the security mechanism and the fulfillment mechanism are configured further collectively to secure network communication for the one or more broadband modems and the one or more customer host devices.

41. The system of claim 39, wherein the network traffic of the one or more customer host devices is substantially restricted by the security mechanism to a customer WLAN/LAN, but wherein network communications to relatively few defined Internet broadband provider network resources including one or more of a customer support services web page and chat and a technical support services web page and chat is permitted by the security mechanism.

42. The system of claim 39, wherein the security mechanism is configured further automatically to redirect web page requests to either a roaming service order fulfillment or account management processor portion of the fulfillment mechanism.

43. The system of claim 42, wherein the security mechanism passes customer specific data including one or more of account number, broadband equipment, and system metrics to either the roaming service order fulfillment or account management processor portion of the fulfillment mechanism.

44. The system of claim 20, wherein, if customer account status is current, and account use is non-roaming, then authorization succeeds.

45. The system of claim 44, wherein the security mechanism and the fulfillment mechanism are configured further collectively to secure network communication for the one or more broadband modems and the one or more customer host devices.

46. The system of claim 44, wherein the security mechanism is configured further to permit network traffic originating from the one or more customer connectable host devices to the Internet.

47. The system of claim 44, wherein the security mechanism is configured further to permit network traffic originating from the Internet to the one or more customer host devices.

48. The system of claim 20, wherein the security mechanism is configured further to install, configure, and maintain network security policy for the one or more Internet broadband provider broadband modems and for the one or more customer connectable host devices.

49. The system of claim 1, wherein a systems and process architecture which provides and facilitates real-time automation of service order fulfillment and account processing

50. The system of claim 49, wherein the security mechanism and the fulfillment mechanism are configured further collectively to provide real-time automation of one of new, renewal, and roaming service order fulfillment for one of new, expired, and roaming customers, respectively.

51. The system of claim 50, wherein the security mechanism and the fulfillment mechanism collectively are configured further dynamically and in real-time to redirect network traffic from the one or more customer host devices to an e-commerce system for service order fulfillment.

52. The system of claim 50, wherein the security mechanism and the fulfillment mechanism collectively are configured further to generate and display dynamically and in real-time one or more of Internet broadband provider service offerings, information, costs and terms.

53. The system of claim 50, wherein the security mechanism and the fulfillment mechanism collectively are configured further to gather, process and store Internet broadband provider one or more of customer personal and payment data, and service order request, payment, and fulfillment data.

54. The system of claim 50, wherein the security mechanism and the fulfillment mechanism collectively are configured further to install host device software automatically and in real-time.

55. The system of claim 50, wherein the security mechanism and the fulfillment mechanism collectively are configured further automatically and in real-time to provision the one or more broadband modems and of the one or more customer host devices.

56. The system of claim 50, wherein the security mechanism and the fulfillment mechanism collectively are configured further automatically and in real-time to deliver marketing information including one or more advertisements.

57. The system of claim 50, wherein the security mechanism and the fulfillment mechanism collectively are configured further automatically and in real-time to generate and display one or more of Internet broadband provider customer or technical support web pages and customer or technical support chat services.

58. The system of claim 49, wherein the security mechanism and the fulfillment mechanism are configured collectively further to provide real-time automation of customer account processing.

59. The system of claim 58, wherein the real-time automation includes dynamically redirecting network traffic from a customer host device to an e-commerce system for the customer account processing.

60. The system of claim 58 which further comprises:
a systems and process architecture that provides real-time automation of renewal service order fulfillment for current and roaming customers.

61. The system of claim 60, wherein the architecture further provides recurring real-time automation of customer billing via one or more of credit card, debit card and checking.

62. The system of claim 60, wherein the architecture further provides real-time automation for the correction of any customer billing problems and collection of any past due payment.

63. The system of claim 58, wherein the architecture further provides real-time automation for dynamically generating and displaying one or more of Internet broadband provider special offers, service changes and news to current and roaming customers.

64. An Internet broadband security and fulfillment method comprising:
mandating IPsec, PKC, and QoS for one or more Internet broadband provider broadband modems and for one or more customer connectable host devices;
automating the IPsec, PKC and QoS; and
managing the IPsec, PKC and QoS.

65. The method of claim 64 which further comprises:
automating a customer host device software installation, configuration and update process in real-time.

66. The method of claim 64 which further comprises:
automating an IPsec setup, configuration and update process associated with the one or more Internet broadband provider broadband modems and of the one or more customer host devices.

67. The method of claim 66, wherein the mandating, automating and managing includes creating, altering and deleting IPsec policy and rules for the one or more Internet broadband provider broadband modems and the one or more customer host devices during new and renewal service order fulfillment processing and during customer account revocation, update and rekey processing.

68. The method of claim 67, wherein the IPsec policy and rules creating, altering and deleting is provided and facilitated automatically and in real-time based upon customer account processing and status for the one or more Internet broadband provider broadband modems and for the one or more customer host devices.

69. The method of claim 67, wherein the IPsec policy and rules creating, altering and deleting is provided and facilitated automatically and in real-time based upon Internet broadband provider service changes or security policy.

70. The method of claim 66, wherein the automating of the IPsec setup, configuration and update process provides and facilitates real-time automation for defining, managing and implementing IPsec security policy and rules for an Internet broadband provider.

71. The method of claim 64 which further comprises:
automating a PKC enrollment and registration process and a revocation, renewal, rekey, and update process in real-time for the one or more Internet broadband provider broadband modems and for the one or more customer host devices.

72. The method of claim 71, wherein the mandating, automating and managing includes creating, altering and deleting IPsec policy and rules for the one or more Internet broadband provider broadband modems and the one or more customer host devices during new and renewal service order fulfillment processing and during customer account revocation, update and rekey processing.

73. The method of claim 72, wherein the IPsec policy and rules creating, altering and deleting is provided and facilitated automatically and in real-time to create, alter, revoke, delete and issue PKC based upon customer account processing and status.

74. The method of claim 73, wherein, if the system is processing a new or renewal service order, then a new PKC is provided and facilitated for the one or more Internet provider broadband modems and the one or more customer host devices.

75. The method of claim 74, wherein real-time automation of PKC creation and issuance including one or more of PKC enrollment and registration is provided and facilitated.

76. The method of claim 73, wherein, in the case of account revocation, PKC revocation is provided and facilitated for the one or more Internet broadband modems and for the one or more customer host devices.

77. The method of claim 76, wherein real-time automation of PKC inclusion with one or more appropriate CRLs is provided and facilitated.

78. The method of claim 76, wherein real-time automation of PKC deletion from one or more appropriate repositories is provided and facilitated.

79. The method of claim 73, wherein, in the case of an account update, a PKC update is provided and facilitated for the one or more Internet broadband modems and the one or more customer host devices.

80. The method of claim 79, wherein real-time automation of PKC alteration and issuance is provided and facilitated.

81. The method of claim 72, wherein real-time automation of PKC creation, alteration, revocation, deletion and issuance is provided and facilitated based upon Internet broadband provider service changes or security policy.

82. The method of claim 81, wherein real-time automation for new PKC, PKC revocation, renewal, rekey and update is provided and facilitated for the one or more Internet broadband provider modems and for the one or more customer host devices.

83. The method of claim 72, wherein the mandating, automating and managing includes automatic PKC request and response communication in real-time.

84. The method of claim 72, wherein the mandating, automating and managing includes automatically generating PKC public and private keys for the one or more Internet broadband modems and for the one or more customer host devices in real-time.

85. The method of claim 72, wherein the mandating, automating and managing includes automatically constraint-validating PKC issuance and application policy in real-time.

86. The method of claim 72, wherein the mandating, automating and managing includes automatically verifying and validating the one or more Internet broadband modems and the one or more customer host devices in real-time.

87. The method of claim 72, wherein the mandating, automating and managing includes automatically creating or updating an association of the one or more Internet broadband modems and the one or more customer host devices in real-time with a corresponding one or more Internet broadband provider customer accounts.

88. The method of claim 72, wherein the mandating, automating and managing includes automatically storing PKC within one or more of a back office system, an Internet broadband modem and a customer host repository.

89. The method of claim 71, wherein the mandating, automating and managing provides and facilitates real-time automation for defining, managing and implementing PKC issuance and application policy for an Internet broadband provider.

90. The method of claim 71, wherein the mandating, automating and managing provides and facilitates real-time automation for defining, managing and implementing PKC security policy for an Internet broadband provider.

91. The method of claim 71, wherein the mandating, automating and managing provides and facilitates real-time automation for PKC renewal or revocation for the one or more Internet broadband modems and the one or more customer host devices during automated subscription renewals processing.

92. The method of claim 64 which further comprises:
validating PKC including one or more of PKC look up and path validation, and certification revocation list validation, thereby to provide security, authorization, and service order fulfillment and customer account processing.

93. The method of claim 64 which further comprises:
providing for automatic processing for broadband modem configuration to manage host devices service level agreement for, and access to, an Internet broadband provider network connection.

94. An Internet broadband modern system architecture comprising:
means for determining broadband customer type including one of new, expired, roaming and current user types.

95. The architecture of claim 94 which further comprises:
means for raising and handling ISAKMP exceptions to provide and facilitate real-time automation of security, authorization, service order fulfillment, and account processing.

96. The architecture of claim 95 which further comprises:
means for including an ISAKMP phase 1, message 1 timeout exception handler.

97. The architecture of claim 96, wherein new customers or unauthorized users attempting to access the broadband network are redirected to a new service order fulfillment process.

98. The architecture of claim 95 which further comprises:
means for including an ISAKMP phase 1, message 1 message count limitation exception handler.

99. The architecture of claim 98, wherein new customers or unauthorized users attempting to access the broadband network are redirected to a new service order fulfillment process.

100. The architecture of claim 95 which further comprises:
means for including an ISAKMP phase 1, message 3 authentication exception handler.

101. The architecture of claim 100, wherein PKC validation analysis is utilized to determine customer account status, use, and constraint variables.

102. The architecture of claim 101, wherein, if a PKC is expired, then the architecture realizes an expired customer account.

103. The architecture of claim 102, wherein the architecture provides real-time automation of security and restricted Internet access.

104. The architecture of claim 102, wherein the architecture provides and facilitates real-time automation of renewal service order fulfillment.

105. The architecture of claim 105, wherein, if a PKC is listed in a local or remote CRL, then the system realizes one of expired customer account, recurring payment processing error, billing processing error, and customer account maintenance requirement.

106. The architecture of claim 105, wherein the systems and process architecture provides real-time automation of security and restricted Internet access.

107. The architecture of claim 105, wherein the architecture provides real-time automation of renewal service order fulfillment or account processing.

108. The architecture of claim 101, wherein, if a PKC is current, then the system realizes a current customer account.

109. The architecture of claim 108, wherein the PKC type of roaming or non-roaming is compared to customer account use and constraint variables.

110. The architecture of claim 109, wherein, if the PKC type is non-roaming and the customer account use is non-roaming, then the architecture provides real-time automation of security, authorization, and unrestricted Internet access.

111. The architecture of claim 109, wherein, if the PKC type is non-roaming and the customer account use is roaming, then the architecture provides real-time automation of security, restricted Internet access, and roaming service order fulfillment.

112. The architecture of claim 109, wherein, if the PKC type is roaming and the customer account use is roaming-out-of-network, then the architecture provides real-time automation of security, restricted Internet access, and roaming service order fulfillment.

113. The architecture of claim 109, wherein, if the PKC type is roaming and the customer account use is roaming-out-of-area, then the architecture provides real-time automation of security, restricted Internet access, and roaming service order fulfillment.

114. The architecture of claim 94 which further comprises:
means for raising and handling ISAKMP exceptions to provide real-time automation of IPsec rule creation, modification, and deletion for Internet broadband provider broadband modems.

115. The architecture of claim 114, wherein the architecture utilizes IPsec rules to mandate, automate, manage, survey, monitor, and regulate Internet traffic security including one or more of operations to restrict, permit, secure, and redirect the network communications of one or more broadband modems and of one or more customer connectable host devices to enforce a defined network security authorization policy.

116. The architecture of claim 94 which further comprises:
means for raising and handling ISAKMP exceptions to provide real-time automation of service order fulfillment or account processing.

117. The architecture of claim 116 which further comprises:
HTTP redirector software that redirects customer web page requests including TCP/IP network communications utilizing ports 80, 8080, and 443, of the one or more customer connectable host devices.

118. The architecture of claim 117, wherein the network communications are analyzed to determine destination and service.

119. The architecture of claim 117 which further comprises:
means providing data for back office e-commerce and support processing.

120. The architecture of claim 119, wherein the e-commerce and support processing means utilize one or more of service order fulfillment data, account servicing data, broadband modem data, customer host devices data and system metrics.

121. The architecture of claim 117, wherein the architecture dynamically creates the service order fulfillment or account servicing request.

122. The architecture of claim 121 which further comprises:
means for creating a URL redirect message.

123. The architecture of claim 117, wherein a URL redirect is sent to the customer host device that made the initial web page request.
